(19) United States
(12) Patent Application Publication
(10) Pub. No.: US 2011/0290899 A1
(43) Pub. Date: Dec. 1, 2011

(54) GC boundaries

(76) Inventor: Svetozar B. Petrovich, Chicago, IL (US)

(21) Appl. No.: 12/153,036

(22) Filed: May 13, 2008

Related U.S. Application Data
(62) Division of application No. 11/809,132, filed on May 31, 2007, now abandoned.
Application No. 11/809,132 is a division of application No. 11/807,748, filed on May 30, 2007, now abandoned.
Application No. 11/807,748 is a division of application No. 11/788,172, filed on Jun. 4, 2007, now abandoned.
Application No. 11/788,172 is a division of application No. 11/724,752, filed on Mar. 15, 2007, now abandoned.
Application No. 11/809,132 is a continuation of application No. 11/807,748, filed on May 30, 2007, now abandoned.
Application No. 11/807,748 is a continuation of application No. 11/504,304, filed on Aug. 14, 2006, now abandoned.
Application No. 11/504,304 is a continuation of application No. 11/385,078, filed on Mar. 20, 2006, now abandoned.
Application No. 11/385,078 is a continuation of application No. 11/724,752, filed on Mar. 15, 2007, now abandoned.
Application No. 11/724,752 is a continuation of application No. 11/418,157, filed on May 3, 2006, now abandoned.
Application No. 11/418,157 is a continuation of application No. 11/342,006, filed on Jan. 30, 2006, now abandoned.
Application No. 11/342,006 is a continuation of application No. 11/233,546, filed on Sep. 23, 2005, now abandoned.
Application No. 11/233,546 is a continuation of application No. 11/212,943, filed on Aug. 25, 2005, now abandoned.
Application No. 11/212,943 is a continuation of application No. 11/188,339, filed on Jul. 25, 2005, now abandoned.
Application No. 11/188,339 is a continuation of application No. 11/028,982, filed on Jan. 3, 2005, now abandoned.
Application No. 11/028,982 is a continuation of application No. 10/869,752, filed on Jun. 16, 2004, now abandoned.
Application No. 10/869,752 is a continuation of application No. 10/840,152, filed on May 5, 2004, now abandoned.
Application No. 10/840,152 is a continuation of application No. 10/742,485, filed on Dec. 19, 2003, now abandoned.
Application No. 10/742,485 is a continuation of application No. 10/190,993, filed on Jul. 8, 2002, now abandoned.
Application No. 10/190,993 is a continuation of application No. 10/156,192, filed on May 28, 2002, now abandoned.
Application No. 10/156,192 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 10/869,752 is a continuation of application No. 10/840,152, filed on May 5, 2004, now abandoned.
Application No. 10/840,152 is a continuation of application No. 10/156,192, filed on May 28, 2002, now abandoned.
Application No. 10/156,192 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,844, filed on Mar. 3, 2000, now Pat. No. 6,774,926.
Application No. 09/518,844 is a continuation of application No. 09/376,957, filed on Aug. 18, 1999, now abandoned.
Application No. 09/376,957 is a continuation of application No. 10/195,668, filed on Jul. 15, 2002, now abandoned.
Application No. 10/195,668 is a continuation of application No. 10/073,914, filed on Feb. 14, 2002, now abandoned.
Application No. 10/073,914 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 10/742,485 is a continuation of application No. 10/156,192, filed on May 28, 2002, now abandoned.
Application No. 10/156,192 is a continuation of application No. 10/190,993, filed on Jul. 8, 2002, now abandoned.
Application No. 10/190,993 is a continuation of application No. 10/073,914, filed on Feb. 14, 2002, now abandoned.
Application No. 10/073,914 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 08/950,898, filed on Oct. 15, 1997, now Pat. No. 5,941,273.
(60) Provisional application No. 60/231,514, filed on Sep. 9, 2000.
(60) Provisional application No. 60/223,750, filed on Aug. 8, 2000.
(60) Provisional application No. 60/220,358, filed on Jul. 24, 2000.
(60) Provisional application No. 60/217,308, filed on Jul. 11, 2000.
(60) Provisional application No. 60/123,153, filed on Mar. 6, 1999.
(60) Provisional application No. 60/123,207, filed on Mar. 8, 1999.
(60) Provisional application No. 60/123,504, filed on Mar. 9, 1999.
(60) Provisional application No. 60/123,153, filed on Mar. 6, 1999.
(60) Provisional application No. 60/123,207, filed on Mar. 8, 1999.
(60) Provisional application No. 60/123,504, filed on Mar. 9, 1999.

(51) Int. Cl. A01G 15/00

(52) U.S. Cl. 239/14.1

(57) ABSTRACT

Four generic claims, physics, chemistry, thermodynamics and forbidden mechanisms laws merge. Quintessential, core, natural, buried GC aqueducts perimeters heat energy transfer up to insulated globose crown with or without irrigation for mass energy highest conserving combats fluxing ocean levels ‘global warming’ effects, the Earth's surface cooling. Near vacuum, least density globose masses light pushed to infinity, globose-conduits (GC) Sets approach the speeds of light. The GC aqueducts cycle heat energy of subatomic submicroscopic to cosmos mass energy systems, for electro-thermodynamics, electromagnetics perimeters bound universe having buoyancy/density, evaporation, and suction forcing. Atmospheric, GC mass forms energy sequential equilibriums transport, generic claims compliant, forcing temperatures with pressures funnel spouts, gravitational potential energy, dipolar electromagnetic field, ions driven electrons boundaries flux forces mass hydrodynamic thermodynamics electro-superconducting, up to speed of light. Analogies group humans and Earth as the respective advanced Globose-Conduit Sets, categories.

This application is a continuation of the following applications serial numbers:

Ser. No. 11/809,132 May 31, 2007 and is a continuation of

Ser. No. 11/807,748 May 30, 2007 and is a continuation of

Ser. No. 11/788,172 Apr. 18, 2007 Confirmation No. 5382 and is a continuation of

Ser. No. 11/724,752 claiming filing date Mar. 9, 2007, assigned Mar. 15, 2007 and is a continuation of

Ser. No. 11/504,304 Aug. 14, 2006 and is a continuation of

Ser. No. 11/418,157 May 3, 2006 and is a continuation of

Ser. No. 11/385,078 Mar. 20, 2006 and said Ser. No. 11/418,157 is a continuation of

Ser. No. 11/233,546 Sep. 3, 2005 and is a continuation of

Ser. No. 10/869,752 Jun. 16, 2004 and is a continuation of

Ser. No. 10/156,192 May 28, 2002 and said Ser. No. 11/504,304 that is a continuation of said

Ser. No. 11/385,078 Mar. 20, 2006 and is a continuation of

Ser. No. 11/342,006 Jun. 30, 2006 and is a continuation of said

Ser. No. 11/233,546 Sep. 3, 2005 and is a continuation of

Ser. No. 11/212,943 Aug. 25, 2005 and is a continuation of

Ser. No. 10/840,152 May 5, 2004 that is a continuation of said

Ser. No. 10/156,192 May 28, 2002 and is a continuation of

Ser. No. 11/188,339 Jul. 25, 2005 and is a continuation of

Ser. No. 11/028,982 Jan. 3, 2005 and is a continuation of

Ser. No. 10/742,485 Dec. 19, 2003 and is a continuation of

Ser. No. 10/190,993 Jul. 8, 2002 and is a continuation of

Ser. No. 10/195,668 Jul. 15, 2002 that is a continuation of said

Ser. No. 10/190,993 Jul. 8, 2002 and is a continuation of said

Ser. No. 10/156,192 May 28, 2002 and is a continuation of

Ser. No. 10/073,914 Feb. 14, 2002 and is a continuation of

Ser. No. 09/850,927 May 8, 2001 and is a continuation of

Ser. No. 09/376,957 Aug. 18, 1999 and said

Ser. No. 11/223,546 Sep. 3, 2005 that is a continuation of said

Ser. No. 11/212,943 Aug. 25, 2005 and is a continuation of said

Ser. No. 11/188,339 Jul. 25, 2005 and is a continuation of said

Ser. No. 10/869,752 Jun. 16, 2004 and is a continuation of said

Ser. No. 10/840,152 May 5, 2004 that is a continuation of said

Ser. No. 10/156,192 May 28, 2002 which is a continuation of

Ser. No. 10/074,966 Feb. 13, 2002 and which is a continuation of said

Ser. No. 09/850,927 May 8, 2001 and said

Ser. No. 10/869,752 Jun. 16, 2004 and is a continuation of said

Ser. No. 10/742,485 Dec. 19, 2003 that is a continuation of said

Ser. No. 10/190,993 Jul. 8, 2002 that is a continuation of said

Ser. No. 09/850,927 May 8, 2001 and said Ser. No. 10/742,485 that is a continuation of said

Ser. No. 10/156,192 May 28, 2002 that is a continuation of said

Ser. No. 09/376,957 Aug. 18, 1999 and said

Ser. No. 09/850,927 May 8, 2001 claims benefit of

60/231,514 Sep. 9, 2000 and claims benefit of

60/226,750 Aug. 21, 2000 and claims benefit of

60/220,358 Jun. 24, 2000 and claims benefit of

60/217,308 Jul. 11, 2000 and is continuation of

Ser. No. 09/518,884 Mar. 6, 2000 and claims benefit of

60/123,153 Mar. 6, 1999 and claims benefit of

60/123,207 Mar. 8, 1999 and claims benefit of

60/123,504 Mar. 9, 1999 and is a continuation of said

Ser. No. 09/376,957 Aug. 18, 1999 and claims benefit of

60/123,153 Mar. 6, 1999 and claims benefit of

60/123,207 Mar. 8, 1999 and claims benefit of

60/123,504 Mar. 9, 1999 and is a continuation of

Ser. No. 08/950,898 Oct. 15, 1997, U.S. Pat. No. 5,941,273

### BACKGROUND OF THE INVENTION

The First Application general forms make Sets. Continuation applications conforming, least mass energy, least boundary surfaces specific forms, and mass energy and surfaces areas are much smaller than those of conventional, manmade, prototype, known arts. Conforming embodiments, or a globose-conduit, ‘laminar’, ‘flow control’ mass energy highest conserving is inside the first application or known art forms enclosure perimeters, surfaces boundaries. Globose-conduit mass energy self-preserving, self-conserving, quintessential, core, natural disposition mass energy highest conserving (QCNDMEHC) makes other forms immaterial or insignificant. The QCNDMEHC easily dissipates. As phenomena they are most apparent in pure most intensive state boundaries. The continuations applications conforming least mass perimeters of the first application forms by algorithm approximations define the QCNDMEHC mass energy boundaries.

The First Application structures specification and drawings ‘laminar flow’ herein defines a liquid, gas, or solids, fluids of adjacent or neighboring layers which do not mix, enhanced by a relative density or a specific gravity, that flow at different speeds, perimeters forms confined, to a velocities direction having globose-conduits conforming least quanta mass energy least rotations. ‘Flow control means’ are PAP, PP, and PPLD FESD forms geometrics conforming embodiments least quanta mass algorithm approximations PP lengths least sum constituted perimeters interface boundaries surface globose-conduits classical forms.

GC perimeters enclose QCNDMEHC classis; enclosed light QCNDMEHC energy inside the gravity force field makes a black hole. Light and gravity energy force fields unique common boundary constitutes cosmos enclosure. If it is electrons electric charge perimeters boundaries about nuclei, it is atoms. Herein designed best approximations enclosed QCNDMEHC makes for said GC Sets and forms globose-conduits. A flexible or elastic or a solid epidermis membrane boundary energy perimeter makes GC living cells Set. The Generic Claims: conforming embodiments, PAP, path-angle-of-passage; PP, paths-of-passage; paths-of-passage lengths least sum; and PPLD, path-of-passage-of-least-energy-demand, perimeter forms and or Sets are the application Ser. No. 08/950,898 specified Figures “flow control means”, “laminar flow” claimed; Ser. No. 60/123,153, Ser. No. 60/123,207, Ser. No. 60/123,504, thereto shown 115 Figures claims mass energy highest conserving, (is Ser. No. 60/123,153 “lead to, cause low energy demand, least amount of energy needed to pass the waste”). Ser. No. 09/376,957, Ser. No. 09/158,884 continues the 115 with 119 Figures for the Arts or Sciences engineering disciplines invention of four Generic Claims principles and methodologies. Ser. No. 60/217,308, Ser. No. 220,358, Ser. No. 231,514, Ser. No. 226,750 details the Ser. No. 09/376,957 and Ser. No. 09/158,884 continue layman language graphical description of the four Generic Claims PP, PP lengths sum, PPLD (PPLED), and PAP that are the Law of Conservation of Energy for crafts and trades constructions from Arts and Sciences and engineering disciplines forcing procedures globose-conduits GC Sets and forms three modes of operation. The inventions, principles, methodologies conforming embodiments continuations of said “laminar flow”, “flow control means”, mass energy highest conserving, arise within said Laws of Conservation of Energy. The four Generic Claims apply the Law of Conservation of Energy most basic law to most basic elements to define the QCNDMEHC GC forms, Sets aqueducts, sewers, drain lines and traps perimeter boundaries; the four Generic Claims intellectual, layman language summary takes the GC forms Sets into force fields. Electrostatic ionic, electromagnetic magneto-rheological fluids said Ser. No. 09/158,884 describes and claims. Three operating modes: crafts and trades standards; engineering disciplines finite elements; Arts, Sciences infinitesimal to exact solutions taken separate make functionally approved, finite to infinitesimal, and said infinitesimal extended to exact solutions construction QCNDMEHC GC, classical forms, Sets, respectively.

The pending application Forms Presence presents absolute science realities of angled Inlets, only; the Forms application has crafts and trades Sets construction; the Forms Phenomena application takes the appropriate no perceived deviations from sciences ‘upright’, for a structure angles, at least infinitesimally. Off course, Inlet angles do not matter to the four Generic Claims derivations or perimeters boundaries, for QCNDMEHC GC forms and Sets, natural, mass energy natural disposition inventions are said four Generic Claims, the Laws of Conservation of Energy mass energy highest conserving. Herein, algorithm methods approximations following the known universally mass energy classic forms familiar examples universally CONTINUE the accepted comparative, parallel, energy forms analogies to the GC perimeters boundaries.

### SUMMARY OF THE INVENTION

Four generic claims, physics, chemistry, thermodynamics and forbidden mechanisms laws merge. Quintessential, core, natural, buried GC aqueducts perimeters heat energy transfer up to insulated globose crown with or without irrigation for mass energy highest conserving combats fluxing ocean levels ‘global warming’ effects, the Earth's surface cooling. Near vacuum, least density globose masses light pushed to infinity, globose-conduits (GC) Sets approach the speeds of light. The GC aqueducts cycle heat energy of subatomic submicroscopic to cosmos mass energy systems, for electro-thermodynamics, electromagnetics perimeters bound universe having buoyancy/density, evaporation, and suction forcing. Atmospheric, GC mass forms energy sequential equilibriums transport, generic claims compliant, forcing temperatures with pressures funnel spouts, gravitational potential energy, dipolar electromagnetic field, ions driven electrons boundaries flux forces mass hydrodynamic thermodynamics electro-superconducting, up to speed of light.

Said aqueducts are the first and only pro growth, supplied side economics, geological age periods direct interventions for the Earth's living organisms' survival within the Milky Way Galaxy or for highest conserving mass energy transport that saves orbital mass irreplaceable, most precious commodity—water. Aqueducts GC Sets, forms mass energy highest conserving is least potential energy elevation drop toward planned immediate water vapor emissions cuts, more effective than ‘global warming’—‘greenhouse gases’ emissions cuts, in what are called the atmosphere's “fast heating” potentially “irreversible” global effects. Inflows screens, deep water intakes, and GC aqueducts engineering construction technologies exist today.

Aqueducts inverts at steady state temperatures 2-3 m below grade can dissipate heat easier than in stagnant air masses media. As rivers strategic parts, said aqueduct energy highest conserving makes them rise continually in respect to natural-river flows surface elevations. Aqueducts move slowly storm ground water detained mass for heat energy radiated, dissipated one meter underground or below frost elevations. Aqueducts computed perimeters and transported water mass energy steady flows near coolest temperature constitute investing into most precious commodity retention or detention, for transport to designated areas industrial zones assigned to drinking water, recreational, commercial, or heavy industrial usage processes.

Pitched aqueducts into the zones reduce circulating pumps operations, power consumption, repair costs, labor and materials, and plants down time. Good examples are power plant units' condenser pumps preferred least service interruptions or no cost operations. Conserving purified or processed, commercial, industrial zones water, aqueducts rout to the next industrial zone or eventual aqueducts last length cooling prior to its discharge into a major water body. Said mass energy conserving enforces cooler water masses management with no water evaporation loss or mass energy heat irradiations into atmosphere in the entire process prior to eventual release, with rivers land erosion managed or reversed, with industrial waste heat by-products land mass retained. Said heat energy transfers have Earth's crust as heat-sink collect partially cool or in irrigations retain water vapors precipitation, ground water runoffs part. Said processes repeated indefinitely result in cooler oceans, large river bodies, with atmospheric masses smaller water vapor mass.

Aqueducts conducted, radiated heat energy transfers from atmospheric precipitation to the Earth's crust are essential, especially with aqueducts irrigation raised groundwater elevations to preselected levels that control watershed runoffs, topsoil transports, ecosystem support hydronic farming agriculture similar.

Ground water with drainage system raised to about the highest elevation has fresh water retention created storage of significant underground mass, especially when implemented throughout the continental orbital mass climate zones. Underground aqueducts fresh water detentions reduce evaporation, make for riverbanks, flood levies related structures, river water temperature curbs, and topsoil moisture control that counteract higher precipitation rates, raised ocean levels, and melting polar caps and glaciers. Continental crust water evaporation controls conforming to crustal geology, groundwater, and recent topsoil historical data remove significant water vapor mass contained by the gaseous atmosphere in global efforts to control water mass transports by safe best technologies, most cost efficient method for payback through centuries.

Water vapor models tested ‘greenhouse effects’ rates are three times those for the carbon dioxide, with the two combined causing about half of the ‘global warming’, for the earth atmosphere vapor model holding clouds fixed. While not realistic, these tests provide insights into water vapor greenhouse effects. Said structural GC-aqueducts mass energy highest conserving Sets constitute strategic locations in earth's gravity and magnetic field including atmospheric mass energy respective strategic systemic consistencies. On river sides, aqueducts claim orbital globose crust, gravity magnetic field, atmosphere, ionosphere, and solar winds deformed magnetosphere forms fixed strategic systems symmetrically balanced consistencies.

Aforesaid points to oceans masses driving ‘global warming’ with the ionosphere the cooling force for greenhouse gases as peak heat energy transients only, in time replaced by water vapor. Most germane, corrective action with unquestionable, scientific, factual or irrefutable arguments is said buried aqueducts.

The earth's uniform omnidirectional gravitational force spherical field holds orbiting crust masses atmosphere, ionosphere constituted globose forms. The atmosphere, troposphere, and stratosphere similar perimeter forms are contained by the ionosphere with perimeter boundary shapes controlled by the earth's dipolar magnetic field. The dipolar magnetic field lines enclose magnetic ‘cusps’ at the proximities of the geographic poles and are funnel like forms with access to the atmosphere, ionosphere quantum masses for GC, globose-conduits, Set as a basin-outlet drain trap with vents with incoming meteorites its Inlet forms.

Milutin Milankovic's work discovered timing mechanisms that tie earth's motions, rotational tilts from about 21.5 to 24.5 degrees, precession periods, and orbital eccentricities' cycle to the glacial periods.

Milankovich's timing mechanism supplemented herewith with magnetic gravitational field fluids elector-thermodynamic timing mechanism expands to include entire cosmos galaxies and Systems, as the largest, to subatomic submicroscopic, as the smallest, gears of the time clock mechanisms that is universe. The Earth has fluids electro-thermodynamics mass energy sequential equilibriums thermodynamics forms superconducting in the Milky Way galaxy Solar System constituted of smallest to largest globose-conduit forms including living organisms conforming to same universal laws sets. Each detail must fit off-course.

The Earth's magnetic field atmosphere, ionosphere, and “cusps” funnels tilt, wobble, and hold the Moon in a synchronous orbit eccentrically about the Sun, located asymmetrically, within one of the Milky Way galaxy limbs thus generally travel through interstellar dust regions of varied compositions, densities, and radiations, changing gravity, and magnetic fields. To Milankovich's work these are as noise; but, GC mass crust, atmosphere, magnetosphere fluid-thermodynamics electro-superconducting needs accounting.

The atmosphere ionizes 50-80 km above the globose crust from the strength of solar radiation. At these altitudes molecular structures break into ions. This extension of the atmosphere into ionosphere has negatively charged electrons' insignificant mass floating around monatomic ions that lost electrons within the ionosphere masses. Under forcing, said electrons flow along the magnetic field lines. The ionosphere mass is restrained by the gravity and electromagnetic field forces usually stronger than ions, free electrons collisions but not always stronger than the forces caused by said solar winds, radiations or their pressures. The Earth's globose-conduit magnetosphere dynamic perimeter fluctuating boundaries confine the fluxing ionosphere mass wherein one of the ‘cusps’, funnels is a globose-conduit dynamic perimeters outlet form.

The Earth's mass dipole magnetic field perimeters boundaries enclose cusps' funnels to constitute globose perimeter forms. The Earth's magnetosphere dipole magnetic field has its boundaries determined by the solar and interplanetary wind pressures and radiations and magnetic field lines that, also, affect the funnels. As solar winds and pressures deform the magnetosphere, said magnetic field instantly engages to constitute the magnetic field stable equilibrium boundaries. Atmosphere, magnetosphere forcing dynamic has ionosphere temperatures pressures electrons flow along magnetic field lines to counteract thus restore, to reconnect and reassemble magnetic lines into stable fluxing, for its electro-thermodynamic equilibrium.

Recent satellites discovered plasma fountains shaped by the magnetic poles' cusps extend into the magnetosphere from proximities of geographic poles spewing hydrogen, helium, and oxygen ions plasma, into deep space. Cosmic, solar wind pressures coronal mass ejections, plasma outflows distort the Earth's magnetosphere shoulders after skimming passed the orbits rotations tilted magnetic cusps mouths causing said monatomic ions energetic plasma discharges from the ionosphere into deep space. A vacuum suction about ionosphere boundary is believed then to indeed exist, for suction as a catalyst to said plasma losses.

The Earth's magnetosphere cusps are the singular regions where its magnetic field lines converge. Said cusps are the only places where cosmos and solar radiations and winds have direct access to altitudes of molecular air or vice versa. The cusps are the magnetosphere's only places that are connected virtually to everywhere by the magnetic field lines or convection processes. In the cusps, the magnetic lines bunch closely together with said access very much inhibited. Said solar wind pressures especially, together with said interplanetary radiation and magnetic fields and the solar and very close Moon mass forces constitute the atmospheric, oceanic, and Earth's core tidal forces with any suction from the cusp mouth tilted toward Sun mandating ionosphere electro-thermodynamic prompt response. Such pressure relief responses break off incoming and outgoing magnetic lines innermost pair increasing plasma fountain ions' flow. As flows increase, break-offs occur at lower altitudes broadening cusp's breadths. Least molecular density, highest buoyancies hydrogen, helium, and oxygen ions are separated out fountain's concurrent discharge. Ozone, a triatomic oxygen, ionosphere lowest stratified layer above isotropic air suffers depletions near the poles.

Massive electrical currents that may have enormous velocities are generated by ions' flows within the magnetic field lines. Ionosphere funnel cusp spouts with pure pressures large enough suction to cause generic claims, gravitational force potential energy forcing temperatures and pressures compliant fountain flows, within dipolar electromagnetic field ionosphere ions boundaries flux that forces said electron flows to hydrodynamic thermodynamics electro superconducting, less than speeds of light. Least density fluids ‘pure pressures’ constitute ions masses transfers with thermodynamic pressures, electrical forces magnetic field electrons flows with least energy loss. Cusps' axial centerline proximities to incoming and outgoing directionally opposite electrical currents constitute the magnetic field lines constructions disconnect links. Boundary pressures precluding magnetic lines instantaneous reconstruction generally force consequences.

‘Pure pressures’ large enough suction unless alleviated promptly may cause one of the following:
I. At magnetized planets, solar winds wakes forced boundaries vacuum conditions and the polar ionosphere forcing supersonic plasma fountain flows, as “Jean's fountain, atmospheric escape enhancements”, constitute recent observations. Finding universe space huge “hole” with one-billion light years breadth of nothing, entirely devoid of matter vacuum is another recent find. The prior filed applications depict claimed GC inventions that avoid Sets' mechanics suction.
II. Historical geologic evidence confirms ice sheets extended into the Earth's tropical belt. For a time period, the Earth's crust was entirely covered by ice. The Pleistocene glacial interglacial periods, North American land based chronology ice glaciers have the most southern end from most recent to known earlier glacial advances: Wisconsin, Illinoian, Kansan, Nebraskan, and older with interglacial Sangamon, Yarmouth, Aftonian, and older periods. Transition periods Kansan-Nebraskan is a discrepancy in the ice sheets lower latitudes most southerly advances. The Earth's geologic evidence points to the glaciers mass water budget significant depletions.
   The ice age cycle starts modulate with the Earth's variables said deviations three from the circular orbit. Cosmos dynamics, solar winds, atmospheric pressures and radiations make for magnetic field ionosphere's magnetopause boundary fluxed perimeters most critical integrity.
   The ionosphere's temperatures rises under constant pressure expand perimeter boundaries that face the cosmic pressures and radiations, much like air balloons expand to greater surface areas, displacing greater volume. Then, magnetic field lines bound ionosphere must spew out contained mass that is almost entirely water vapor ions along magnetic field cusps making for said plasma flows fountain discharge, rather than implementing a line disconnect mechanism.
III. An extrasolar planet hydrogen, oxygen and carbon observed hydrodynamic escape from a huge volume atmosphere had oxygen, single carbon ions from low elevations with supersonic whirlwinds “swept up”. The ultraviolet radiation inputs from the planet's star allowed for the escape “blow-off'; the hydrogen cloud outside the planet's gravity field was ‘pushed’ by said planet's star light energy, thus thereby show pure pressure no cohesion, adhesions, or friction.

Previous very brief Earth's geologic history details with astronomical observations reveal the iron clad evidence that the Earth is in the fight for the survival of its living organisms, as it is loosing water, its “cooling/heating” fluids, from the aged or less efficient thermodynamics mechanisms. Clearly, we should reciprocate because said organisms in part are us. Density/evaporation, buoyancy, or suction mechanisms force internal processes for mass ‘fountains’, ‘blow-off bursts, or suctions perimeter boundaries dynamic disequilibrium. Earth's gravity, its fluids electro-thermodynamics’ energy responses to said solar-cosmos wind pressures, radiations on its atmospheric mass ionosphere perimeters resort to forbidden mechanisms.

Hundreds of millenniums of tectonic movements and crustal erosion aged the Earth's cooling and heating combined mechanism, which now has, with few exceptions, its major rivers in or flowing into the tropical belt, against the Earth's globose forms of the equatorial bulge. The glacial ice erosions forced the rivers directionality, also, supplied the water to cut shorter established paths. Herewith “fluid” or “hydro” refers to identical liquids with gaseous state phases fully inclusive within the thermodynamic constituents.

The tropical belt concentrated water masses readily evaporate water vapor quantities for fountains discharge, except for periods after the temperatures trigger forced thermodynamics onsets of said ice ages.

Gravitational electromagnetic field higher temperatures project into space larger volume areas for continually retained entire mass, under cosmic/solar pressures on larger volumes surfaces causing volume boundaries larger oscillations. Said oscillations caused fountains plasma mass discharges lower contained mass temperatures. Plasma mass losses are replaced mainly by monatomic ions of the water vapor as part of forcing thermodynamics. Accompanied by significant suction appreciable mass flow bursts discharged amounts trigger singly significant atmospheric mass losses default temperatures drops of an ice age onset.

Milankovich's glacial onset calculations with additional modulations fluctuate considerably. Said scientific community accepted calculations predict no glaciation period within several thousands of years. ‘Green house gases global warming’ natural thermodynamics cycles constitute Earth's 4.5 billion years of water vapor losses that predict Earth's default outcome lifeless freeze, when there is no water vapor mass.

Said boundaries perimeters magnetopause behaves roughly like a liquid-water droplet exposed to supersonic flows. The Earth's ions plasma outermost magnetic field lines as the magnetopause enormous boundaries ripple, or flap, sometimes droplets will break off, or said outermost magnetic line disconnects. Said ions, electrons enormous velocities has the Earth's gravitational electromagnetic field hydrodynamic thermodynamics responses to solar and cosmos pressures, radiations and magnetic, gravitational (cosmos, solar, Moon tidal, seasonal and diurnal) states of equilibrium forces as parts of perimeters bound universe.

The Earth's electromagnetic field, a version of Nikola Tesla's electric motor-generator invention, is reversible, as well, with one driving the other. The motor-generator drives the ‘two turbines’ cusps' as rocket trust engines reaction to external forces for hydrodynamic, thermodynamic responses with internal and external forces equilibrium to disconnect, reconnect, to thus restore the magnetic field lines normalcy.

The atmosphere's ionosphere assists in a return to electromagnetic or thermodynamic equilibrium by ionizing, splitting gaseous air molecules into a reconnected lines larger boundary with a cooling effect. When the uppermost atmosphere ionizes, forced by said motor/generator's continual reversals seeking for equilibriums, seen light energy discharges are analogous to the Nikola Tesla's fluorescent light invention.

The process of ‘magnetic reconnection’ detail is not necessary, for accepted scientific explanation has the auroran lights phenomena, as electrically charged particles, ions, colliding with atoms in the upper atmosphere, mainly altitude above 80 km, which increases the magnetopause volume boundary perimeter. The larger magnetopause volume leads to ionic atmospheric atoms Jean's fountain discharges. Aforesaid Tesla's inventions electrons flow is considered friendly; Aurora electrons inflow from space is unfriendly.

Said ionization of the atmosphere due to ionic masses loss along with electrons or plasma inflows from space, that stabilizes fluctuating magnetic field lines, represents the forbidden mechanism transitions of electrons and ions. Default “forbidden mechanisms” result from forcing temperatures, pressures, along with cosmic-solar pressures and radiations fluxing boundaries magnetopause forms which lead to suction.

Here, suction makes higher densities radiate mass or pure pressures made energetic motions. GC conforming embodiments depict quintessential, core, natural disposition, mass energy highest conserving, wherein the Earth represents globose-conduit domains globose-inverse Sets. GC are cosmos mass energy reservoirs; the meteorites with their gas perimeter constitute an inflow Inlet part with the Earth as the Inlet with the air mixtures atmospheric mass gravitational force held as the Inlet's End 2. Interstellar radiations wind pressures deform outer boundaries magnetic field lines form which encloses dipolar magnetic field's two cusps spout funnels, for electrons bound ions mass fluctuating boundaries globose-inverse form. The cusp toward Sun is an atmospheric forcing temperatures and pressures GC forms mass energy outlet spout funnel to transport sequential equilibrium generic claims compliant, gravitational energy, electromagnetic dipolar field electrons bound ions boundaries flux, making the other outlet cusp as its counterpart vent, for hydrodynamic thermodynamics electro-superconducting less than the speed of light. Temperature forcing triggers its outlet hemisphere “blow off' burst, hydrodynamics thermodynamics default equilibrium to ice age onset default pressures and temperatures drops. The spouts' funnels, cusps, outermost, curved outline perimeters with the dipolar magnetopause outermost perimeters result in the globose-inverse forms or Set.

Magnetic field lines ions distances from a magnetic pole for radiations pressures at equilibriums, low deformed perimeters make Earth's orbital water vapor mass ions perimeters globose oblate forms; the Earth feeds excess water vapor to ions for its polar cusps as rockets reversible engines ions mass balanced discharges toward the Earth's gravitational mass balanced wobbling. Minimal water vapor masses excess conserves the Earth's water mass, for a cooler “global warming” temperatures, for a warmer ice age crust.

Quintessential, core, natural disposition, mass energy highest conserving (QCNDMEHC) form of globose-conduits, GC, Sets is sequential equilibriums that flow from smallest particle to cosmic infinities, from submicroscopic microbes to living cells to humans and by evolutionary processes to omnipotent and omnipresent intelligence constituted in space time infinity. GC QCNDMEHC drain traps ratify analogies of the magnetosphere's mass at rest instantaneous images. Aforesaid Laws forbidden mechanisms govern leading to overriding extinctions laws, for a non-zero acceptability of technically ‘forbidden’ mass energy spontaneous transitions occurrences. Aurora phenomena emitted greenish or dark red glow dominated by light emissions of the atomic oxygen represent forbidden transmissions. The “Aurora ovals” sightings are referred as oval, because they are viewed from oblique angles. Viewed in a polar top view they are round and result from ions mechanisms, electrons at enormous speeds colliding along magnetic lines with atoms of gases at ionosphere's cusps rounded cross-section boundary. ‘Ovals’ illuminate the GC Set outlet First End of the Earth's magnetic field cusps electro-hydrodynamics ‘unfriendly’ into ‘forbidden mechanisms’.

Magnetic field structure contained relatively higher mass density plasmas make basic quite stable fundamental configurations where particles can and cannot go. Solar, interstellar radiations and pressures do contain higher density plasmas to make the magnetic field perimeter deform to suit. The atmosphere's ionosphere mass readily transposes to significantly higher energy excitation states Globose Sidelong Sets.

Said Jean's fountain magnetosphere has perimeters mainly GC globose-inverse Set occasionally a higher energy excitation Globose Set for the four generic claims, physics, chemistry, thermodynamics and forbidden mechanisms laws to merge. GC Globose Set forms higher energy excitation states do allow for transformations to lower energy states globose-inverse Sets complying to the ‘forbidden mechanisms’ that come in pairs. Default states, lowest mass energy excitations, continual rises lead into a significant event.

Accepted Milankovich's statistical calculations predict ice ages onset with the Globose Set higher excitations when its magnetosphere largest volume is multiple times that of its default globose-inverse Set volume due to pressures and radiations after a ‘blow-off’ burst. Aforesaid glacial ice advances are default excitations states which left behind consumed cooling/heating fluids, glacial ice geologic landmarks track.

Herein, variable density mass energy populates omnidirectional space infinities by its unrelenting stratification through ‘mother of all processes’, wherein entire mass perfectly stratifies into its omnipotent black hole mass with the densest mass in the core, for least dense mass perimeter as perfect mass in space. Said stratifications last significant mass circumnavigating cosmos perimeters at the speed of light plunges with speeds greater than that of light, for big or biggest bang stratifications repeats to superior perfections.

Prior applications and claims illustrate conforming embodiments' nonhomogeneous, nonuniform, nonsteady, contained, retained, detained, and transported QCNDMEHC boundaries and perimeters unique origin one-form evolved devolved, rotated, mutated, transposed, or transferred Sets. The Earth's globose-inverse Sets transpose to the globose Sidelong or Offset Sidelong Sets that reflect higher excitation forms.

Each transposed Set constitutes a forbidden mechanism. As they come in pairs, a return to the Set default excitation state completes forbidden mechanism pairs of one or more cycles. During ‘blow off’ bursts the Earth's magnetosphere goes through such Set pairs toward onset of its ice age default state. Set Partitions or cell splits, in a sense unfriendly, must lead to forbidden mechanisms, stratifications, gradations process.

Within said ‘mother of processes’ physical, chemical, forbidden mechanisms infinite mass energy partitioning, splitting is QCNDMEHC growth unique processes, opposite to stratifications, contrary to the end controlling cosmos activities, especially apparent with said stratification occurring universally by first splitting, breaking down fluids to atomic table lowest ranking atoms, for respective plasma ions transport. Deadly radiation energy streams either from a star or a black hole sterilize or decompose. Planets shown tectonic movements by gravity force arrange land masses influenced by minerals specific gravity, density. Lead forbidden mechanisms to the Earth's, Moon's synchronous orbits reconfirm—their origins are of one creation. Whereas, the Earth has fluids action eroded orbital crust, the Moon's is largely regolith covered.

Pluto, Charon locked synchronously orbits show crusts different densities leading some to believe they formed independently. Herein, said differences are explained through said stratification process with the ions of lowest atomic chart elements, especially lighter ions passed around by the planets to noticeable extent, with ongoing stratifications, gradations processes the Milky Way Galaxy, Solar System originated. This finds Solar System perimeter masses such as Pluto, Charon, and Kuiper Belt objects the recipients of the Earth's and other Solar System planets' noticeable fluids plasma fountain masses for billions of years. The Mars' significantly shown fluids erosion to with lighter fluids, atoms, but their ions stoically free crust gives insights to the Solar System planets lost atmospheres to the perimeter orbiting bodies or deep space.

Clearly, the Earth's, the planets' electromagnetic fields are gradation mechanisms of stratification processes primarily passing finest and lightest particles, ions and stellar emitted energies, radiation waves. Larger lighter or heavier atoms or ions escape occurs within significant ionosphere losses concurrent with collapses of highly stressed magnetopause magnetic lines caused by the galaxies systems' stars radiations.

Aforesaid cosmos stratifications implements simultaneously intergalactic, galactic, solar systems, interstellar planetoid stratifications and gradations with the conclusion that the Solar System and the Earth are in yet another process—the process of cooling. In fact, the cooling processes continue from the outset currently manifested through lost cooling or heating mass most significant reserves—the lighter fluids ice, which transfers into solar pressures radiations ions pushed to outer perimeters boundaries and outer space.

In pure pressures, gravity field buoyancy/density, evaporation, and suction forces implement said stratifications gradations. Said forces, in fact relate to density, with suction as a space least mass densities that can lead to perfect vacuum. Aforesaid hydrogen cloud particles low to least density mass ions nearly infinitesimal perimeters when compared to light beams whose translational energy pushes them to infinity will approach with time, in space infinity, the speed of light. Particles, clouds traveling at near light speed cannot surpass such speed circumnavigating the outer space but can grow in mass. From outermost space circumnavigating near the speed of light to point of black hole gravity influence zone will alter said cloud circumferential trajectory to a spiral toward its black hole, with clouds exceeding light's speed making for a larger black hole. Such energy clouds most deadly highest energy radiation particles shooting through a galaxy sections would decompose, burn-up, living organisms with clouds shot planet radiations sterilized.

Hematite bedrock layers show Earth's magnetic field orientations shifted several times during her 4.5 billion years life for an estimated average of once in billion years. The Solar System planets common mass origins should have orbital crust or atmospheric masses common compositions, much similar, status rather than quite different. These are evidence that the Solar System suffered sequence of extreme energy radiation. Electromagnetic outer lines disconnect proximate of the magnetosphere shoulders analogous to electrical power grid's transmission lines disconnects, thus curtailing load to its available electrical energy generation. On a complete overload, magnetic field lines entirely disconnect analogous to electric power grid blackout. Subsequently, the magnetic fields lines took on their QCNDMEHC default orientation, but the radiation winds had stripped the planets atmospheres, especially light gases, leaving behind bare or ice covered crusts. Sun caused extreme events sequences greatly contributed to the planets current state, also.

Aforesaid supports geological evidence that in the past the Earth was entirely iced over even after she had its atmosphere stripped, likely more than once. Also, these events suggest that the Earth was said stratifications, gradations ice water, ions distributions main recipient which explain Nebraskan glacial age ice advances anomaly influenced by preceding iced water meteorites impact. Darwin's classical theory of evolution needs species origin together with the Earth's or other planets' atmosphere forcing air mixtures.

Said forbidden mechanisms nonzero probability, in fact, relates to probabilities, herein described, intrinsically connected to forbidden processes, exemplified by magnetic field blackouts toward its shifting to new geographic orientations. Thus, extremely low probabilities phenomena processes are mechanisms identified as forbidden, as exclusively seen on global scale. Cosmos omnidirectional space-time infinities directional, infinite matrixes' galaxies, and stellar systems are reoccurring highly commonplace forbidden mechanisms, processes of the identified phenomena. Considering the omnidirectional processes matrix of infinities leading to the stratified black hole outcome, only GC Sets actually constitute the valid forbidden mechanisms universal forms Sets that combat, oppose or scramble the stratifications gradations processes.

The QCNDMEHC GC Sets do aforesaid within the same electromagnetic, gravitational fields, for same cosmic interstellar wind pressures, radiations, and said density related forces. Cosmos implemented GC Sets would populate exactly the same omnidirectional infinite matrixes, for each instance with infinite energy and water conserving, QCNDMEHC intelligent processes. Aforesaid four generic claims, physics, chemistry, thermodynamics, and forbidden mechanism laws do merge, again. But, in this instance toward planets contained water mass for living organisms, human habitats, water not lost to space or a black hole.

Aforesaid processes identified said Earth's two critical sequences. One more frequent of the two, glacial interglacial periods sequence Milankovich calculations predict; the other, the electromagnetic field constituted quite infrequent large deviations shift is for the current knowledge valid statistical evaluations. The Sidelong globose Set QCNDMEHC constitutes highest excitation state that will occur at the time of a magnetosphere partial ‘blow off’ default boundaries contracted least size perimeters, unless least densities or suction approaches vacuum in the magnetosphere outlet cusp mouth or at its shoulders, which collapses the electromagnetic field. Partial ‘blow off triggers ice age when sidelong globose Set transposes back to its globose-inverse Set contracted default-smallest perimeters. The electromagnetic field other cusp as the forces equalizing vent restores stable electromagnetics, hydrodynamics and thermodynamics fields, unless they collapse. The ice age trigger executes the Earth's ionosphere significant water ions loss at one time.

Under Sun's radiations ice masses sublime, waters evaporate, ionosphere revives, and atmosphere expands and with time increased activity expands perimeters and boundaries that restart plasma fountains. The Earth glacial periods’ sequences make water budgets continual significant decreases noted landmarks through glaciation geology. Said electromagnetic field's blackouts orientation shifts must have caused at each instance entire atmosphere's mass lost to interstellar, Sun's wind pressures and radiations. Ice mass that the Moon once may have had Sun's radiations and Earth's irradiations melted which, then, was lost at the Earth's first electromagnetic orientation shift. Geological stratifications gradations yield evidence that the Earth once had extensive ice coverings or that she was ice water meteorites repeated recipient or both.

Cyclical heating, cooling thermodynamics, hydrodynamics in billions of years have eroded rivers, channels, drainage features, into the Earth's crustal landscape for water masses transports to the oceans or until they are large water surfaces exposed masses to radiations, evaporations. Cleared forests, developed lands, transportations infrastructures, industrial and commercial complexes greatly speeded warmer water mass delivered to the tropical belt, with much larger evaporated water vapor mass forcing the atmospheric cooling, heating processes. Rivers with few exceptions flow into Earth's tropical globose bulge or basins, such as Amazon. An energy generation and/or mass transfer must generate water vapors formations, also.

Water vapors densities heated masses raise all air mixtures. ‘Greenhouse gases’ higher molecular weights let lighter vapor molecules ascend, first. Said ‘Greenhouse gases’, ‘temperature inversions’ make phenomena known as ‘smog’ that atmospheric thermodynamics push to replace rising tropical.air masses. Rising air masses, especially water vapors until condensed, by molecular density/buoyancy forces expand molecular air perimeters, the troposphere's air-temperatures bubble toward said glaciations period trigger.

Air boundary larger perimeters bubble intakes larger radiated, Earth's irradiated heat energy. The larger air boundary increases probability of Sun's radiation, loose electrons splitting water vapor into ions that by density/buoyancy forces rise into ionosphere expanding its boundary perimeters bubble, also. The water ions enlarging bubbles plasma fountains must implement persistent, repeated, hemorrhaging effects. Clearly, water vapors generate the magnetosphere's sustained ionosphere and said molecular air boundary perimeters bubbles, which by their vapor content are forcing atmospheric temperatures, ‘global warming’. When glaciation periods electromagnetics thermodynamics states of equilibrium enlarged bubbles forcing temperatures boundaries perimeters stop glaciation ice advances, the following ‘global warming’ eventual partial ‘blow-off trigger transposes globose bubbles magnetosphere to inverse-globose default Set forms. Magnetosphere forced buoyancy/density, suction and evaporation transpose inverse-globose, globose Sets forcing subatomic to cosmic masses energy systems electro-thermodynamics electromagnetics gradations. Thus, greenhouse gases fall onto rainforests as beneficial fertilizers with precipitation that some claim, or are carbon dioxide radicals’ smog, human health hazardous, or environment absorbed where they damage greatly the ocean ecosystems, also. As a result, greenhouse gases contribute to crustal mass stratification.

When greenhouse gases curtail water vapors and/or haze blocks Sun radiation Earth's irradiations to reduce water evaporation, the lower but not the upper troposphere is heated, which then would not have the atmosphere's enlarged ionosphere's bubbles boundary perimeters, forcing plasma fountain discharges; The troposphere will radiate more heat energy into space, for a retained water vapor mass smaller content.

Mass equilibriums must include energy generation with its water vapor byproduct forcing effects. Energy productions byproduct is inseparably generated water vapors for causal effect of ‘global warning’. Water vapor hydro-thermodynamics effects and greenhouse gases emissions merge for one global impact.

Earth's stratifications gradations electromagnetic field taken orientation shifts, and the glaciations global warming/cooling cycles geologic history depleted water mass/vapor energy budgets for a waterless state frozen planet status enormously altered hydrodynamics thermodynamics equilibriums function needs no human emissions pollution greenhouse gases effect. Industrial emissions cut goals to turn air pollution back several decades by said gases emissions cuts in energy generations received top rating for preserving the Earth. Foregoing QCNDMEHC processes place highest priorities to control and contain water vapors.

Globose-conduit magnetosphere ions/electrons flows exhibit high electric conductivities of cusps. Mass energy variables compositions in aqueducts vary less than they do for prior applications sewer lines. QCNDMEHC mass energy transitions constitute hydrodynamics energy transformations with perfections. The aqueducts, palpable to ultimate hydroelectric energy generation, have maximum water mass outflows delays into the tropics, without stagnancy, emitting no water vapor into the atmosphere. Their Sets, forms provide for largest heat transfers into subsoil for least eroded soils transported fill into crustal depressions. The Sets, forms forbidden mechanisms processes counter the stratifications processes eroded peaks, filled depressions, smooth, globose spherical, rotating, orbiting sterile surfaces and or ice covered similar forms. Again, there is QCNDMEHC water, vapor mass fundamentals optimal difference in aforesaid final result.

Said two surfaces forms moderate or evolve within the stratifications gradations processes toward final status surfaces results caused by their Solar System galactic or intergalactic transients violent events. Thus, ice covered planets surfaces constitute almost certain water mass water vapor potential atmospheres during surfaces said transitions, within galactic times scale. The classic evolution theory provides little or no data on species origins planet propagated system contained boundaries, their atmospheric gaseous mix, and ability to bridge interplanetary space galactic times scales to evolve, prosper by forced circumstances. There is no data at all of any information if living intelligence is required to accomplish any of such tasks.

The Solar System aforesaid are elementary life evolution events which make for missed scientific works. Only, GC Sets constitute living intelligence with QCNDMEHC. The quintessential, core, natural, buried GC aqueducts perimeters heat energy transfer up to insulated globose crown with or without stated irrigation for mass energy highest conserving combats fluxing oceans levels, ‘global warming’ effects, the Earth's surface cooling. In near vacuum, least density globose masses light pushed to infinity as globose-conduits GC Sets approach speeds of light. Aforesaid GC aqueducts cycle heat energy from subatomic or submicroscopic to cosmos mass energy systems for electro-thermodynamics, electromagnetics perimeters bound universe with buoyancy/density, suction, and evaporation forcing thereby saving the Earth's water.

Cosmos Sets, forms creative intelligence databases do not exist. Globose-conduit, Sets and forms QCNDMEHC liquid physical states mass living intelligence structural arrangements, mass energy highest conserving, counter the gradations, stratifications processes stratified or graded atomic weights, solid state matter, universal forms gaseous, liquids, and solids. Said GC Sets and forms make liquids states universe mechanisms that counter to them mortal, stratifications, gradations, QCNDMEHC forbidden mechanisms.

Consequently, GC aqueducts' structure masses that realize atmospheric heat energy transfers into the orbital crusts stop plasma fountains discharging primarily water ions into deep space, which conserves the Earth's heat energy and water mass by heat containment within the orbital crust. Instrumental to these process are the GC aqueducts Sets, forms inside atmosphere's conforming GC, globose-inverse Set, form. Said aqueducts must make for huge capacities heat sinks for retained water heat transfers to orbital crusts. The GC Sets, forms conserve infinite water masses and energy on prototypes, global and planetary scales, as they curtail or shut-off plasma fountains, prior applications proven mass energy prototypes conserving; Thus, globose-conduits universe makes perimeters boundaries, internal structures intelligent arrangements (IA) functions and stratifications gradations arrangements (SGA) Order atomic weights compositions, IA, SGA continual conflicts of one against the other, confrontations for forbidden mechanisms final outcome;

In conflicts between the two, the one with the higher QCNDMEHC for least dissipations prevails. Mass energy relative densities define aforesaid buoyancy/density, suction, and evaporation forcing. Thus, atmospheric air mass penetrated by water vapor, analogous to water saturating the soil, alters its densities. Moisture, water vapor, especially in soil has ability to penetrate and fill in finest interstitial spaces. In air, however, water vapor must replace other molecules. Triatomic water vapor molecules replacement of the generally diatomic air molecules leads to very slight volume change on small units' bases and for huge air mass huge volume increases. However, rounded more diverse particles avoid uniform sizes of perimeters gap graded masses for higher molecules number compaction of smaller volumes than the sum of diatomic and triatomic separated volumes with molecules same number, for smaller interstitial spaces total volume. The air mass with water vapor triatomic perimeters makes less porous or penetrable compacted volume or greater mass compaction to retain heat energy from radiation, irradiation. Said compaction is a misnomer in a sense that it is made-up of water vapor molecules with least molecular weight forcing their air masses to rise rather than settle. Relatively constant atmospheric pressure air masses' columns that contain water vapors extend to higher elevations proportional to water vapor contents percentages per unit volumes, due to water vapor molecules with much lower molecular weight replacing said diatomic air molecules. Thus, water vapor content expanded atmosphere can retain sufficient heat energy, avoiding planet's deep freeze.

In diatomic masses, triatomic perimeter two molecules compact better than any diatomic oxygen, nitrogen combination of three molecules for equal or slightly higher air masses specific gravity, especially with an air mass uniform gradation of diatomic perimeter forms, with higher specific gravities for greater variety of molecular structures gradations denser forms which include triatomic forms water vapor. Thus, greenhouse gases stratified layers with water vapors make for thermal inversions phenomena, mainly over cities. Said air masses retain even more of the Sun radiated, the Earth irradiated heat energy thus peaking atmosphere's temperatures. Said water vapors gas masses built to high altitudes define ‘global warming’. Condensed vapor precipitated greenhouse gases “acid rain” is stratifications, gradations process increased interstitial voids Earth's larger proportional radiations takes, lesser reradiation, higher irradiation to space.

The Generic Claims QCNDMEHC GC Sets, forms highly defined nonhomogeneous, nonuniform, nonsteady laminar flows perimeters, boundaries make the IA functions perimeters, boundaries constituted GC aqueducts, sewer/drainage lines and drain traps as hydrodynamics, thermodynamics, electromagnetics mass energies respective transistors and processors. Aqueducts GC mass energy stratifications gradations are less diverse than those in sewer/drainage lines; forms, Sets GC conduct process quantum mass energy properties instead of transistors, processors electrons charges binary methods. Aqueducts, sewer/drainage line, drain traps GC QCNDMEHC flows are analogous to respective transistors, processors, programmed laminar flows for quantum masses energies, densities state, perimeter forms, and quantum mass interfaces boundary forces. Fluids/solids specific gravities reflect density respective evaporation/buoyancy, suction.

‘Global warming’ is a misnomer in the sense that it is the Earth's water budget continual, cyclical depletions effects solid masses cooling, pushing the Earth into a frozen state status. Greenhouse gases are unfairly accused of ‘global warming’; here, said ‘global’ is atmospheric warming due to following causes:
I. Multi-atoms molecular perimeters replacing uniform gradation masses of diatomic gases,
II. Nonuniform perimeters molecular compactions reducing interstitial voids' space, volume,
III. Diatomic air mass enlarged atmosphere's volume forms by triatomic water vapor masses;
IV. Air masses rising to higher altitudes with higher water vapor contents lower mass weight,
V. Nonuniform perimeters compacted air mass retains larger radiated, irradiated heat energy,
VI. Air volume larger water vapor contents mass forces the air and ionosphere larger bubbles,
VII. Electromagnetic field must have low moisture contents air mass in proximity of its cusps,
VIII. Hydrodynamics, thermodynamics need heat energy transfers, across its fluids boundaries,
IX. Earth's ice/water and gases cyclical equilibriums fluxing boundaries transfer heat energy,
X. Earth's aging erosional effects accelerate rates in thermodynamics hydrodynamics cycles,
XI. Heat energy adjusted transfers need water budget fluids, solids mass appropriate margins;

Subsequent passages describe aforesaid ‘atmospheric warming’ in greater details.

The Sun's radiation taken instantaneously, as infinitesimal steady state parts, radiates part of its energy onto the Earth's orbital masses, which taken similarly, has a normal distribution, bell curve shape for hypothetical uniform diatomic perimeters, homogeneous, uniform atmospheric air mixtures. Such a curve due to the Earth wobbles, the one year period wobble as predominant, has a symmetrical bell shape only when the Earth's equatorial plane aligns with the Sun. Extending a perfect modes analogy to an extreme, to said evaporation process first start, water vapor triatomic molecules' perimeters first appear at the equator; then, the evaporation process propagates toward the poles together with vapor penetrations into higher elevations. Off course this is idealistic; the Earth's wobbles direct alignments are evaporation probability density value peaks short durations located geographically in the summer hemisphere; the water vapors travel in upward paths to then as condensate fall out of the air mixtures with radiations dynamics among many variables present.

Atmosphere contained water vapor upper boundaries highest altitudes (WVMUSCV)¹ are most critical factor. Said numerous variables existences further include aforesaid cosmic, orbital, seasonal, and diurnal variations for evaporation rates intensity physical property which constitutes the atmosphere's dynamics most illusive WVMUSCV property taken as water vapors compacted-masses unit volume saturation, as parts of 14.7 psi atmospheric pressures uppermost water vapors altitudes. The WVMUSCV penetrations that make air masses highest altitudes form water vapors broad domal peaks at geographical locations directly underneath the Sun, for they follow the Sun, distorted by air currents thermodynamics effects, for constituted water vapors uppermost dynamic penetration thermodynamics equilibrium bulbs, peaks; Said water vapors locally coagulated bulbs at lower elevations constitute clouds. The Polar Regions sublimation rate low intensities increase into smooth transitions into temperate zones WVMUSCV with highly increasing slopes to having gentler slopes to match tropical belt WVMUSCV extensions from said domal peaks. Evaporation higher intensity rates push the water vapor WVMUSCV to higher elevations. The higher variable molecular perimeters generate WVMUSCV globose bulbs of higher compaction, between the two cusps. Higher compactions bulbs can formulate above or within the described WVMUSCV bulb. The WVMUSCV bulbs no-perimeter boundaries volumes retain higher radiations portions of Sun radiations, Earth irradiations, and cloud reflections, due to the higher compactions lower porosity. ¹Water vapors compacted-masses unit volume saturation.

Two triatomic water vapor molecular weight of 2 times 10 have six atoms perimeters total which replaces six atom perimeters of diatomic gases molecular weight of either 3 times 7 for gas nitrogen, 3 times 8 for oxygen. These are compared to two triatomic carbon dioxide molecules of 2 times 6+16 or 2 times 16+16 for sulfur dioxide, which shows that water vapor rises to condense to precipitate out of the atmosphere alone or with the greenhouse gases as acid rains. Two carbon dioxide, sulfur dioxide, water vapor, three-nitrogen, oxygen molecules, each forming a six atomic perimeters have molecular weights 44, 64, 20, 42, 48, respectively. The diatomic, triatomic gases various molecular mixes with water vapor content constitute atmospheric masses compactions for decreased interstitial space porosity masses lower densities validate aforesaid WVMUSCV bulbs.

Air mass vapor contents coagulated into clouds rise to significant altitudes. Water vapors air mixture contents, compactions, with no cloud surfaces, that reach higher altitudes attain higher radiations energy to higher altitudes, for the air masses larger atmosphere volumes globose forms. Sea level 14.7 psi pressures prove water vapor masses larger molecules perimeters lower densities.

Larger water vapor compacted WVMUSCV bubbles make enormous water vapor masses gaseous state amounts, globose forms, surfaces large radiations retentions that forced by aforesaid hydrodynamics thermodynamics cycles feed on themselves to magnify, diminish or reverse cycle.

Said greater globose forms and bulbs mass volume, surfaces generated larger ions masses buoyancy/density, evaporation, and suction due to forcing temperatures pressures hydrodynamics, thermodynamics create a larger ionosphere globose form. The six oxygen atoms ozone molecules loosely bonded three diatomic oxygen pairs perimeters make the ozone layer density less than the atmosphere air masses molecular nitrogen oxygen densities to cover them as a blanket. Hydrogen and helium ions or electrons of least mass density-perimeter split by radiations from water vapors or hydrocarbons readily penetrate through the ozone layer. Oxygen ions, especially ions loosened within or on top of the ozone layer constitute including said cusps the globose ionosphere's mass.

Electromagnetic field retains hydrodynamics, thermodynamics generated ions within said least perimeter boundaries, which by forcing temperatures, pressures, and ions generation enlarge and thereby deform to cosmic, Sun radiations and pressures. Boundaries flux forcing equilibrium deforms boundaries, or a fountain squirts ions into space, an outermost magnetic line disconnects, to avoid forbidden mechanisms magnetic field shifts or Earth's orbit-mechanics induced wobbles.

Larger WVMUSCV bulbs, globose air masses, ions ionosphere and magnetosphere forms or Sets cause electrons, ions enormous velocities leading to said fountain discharges and magnetic lines disconnects, reconnects. Said velocities need aforesaid pure pressures poor compactions for media ions mass densities, especially proximate high speed electrons of magnetic field lines, such as cusps. Thus the Earth's dipolar magnetic field QCNDMEHC, globose forms Set, retains water mass inside magnetosphere, having WVMUSCV least height at Polar Regions cusps, tropical belt highest elevation of magnetic lines, for thermodynamics forcing generated vapor ions least losses.

Aforesaid stratifications gradations hydrodynamics drive the supply side thermodynamics water vapor masses forcing said ionosphere masses fountain discharges or partial or full blow-off.

A greenhouse gas has generally one cycle lifespan. Water masses or their derivative once activated stay in heating cooling cycles to their hydrodynamic, thermodynamic release into space.

The WVMUSCV, air masses and ionosphere respective bulb, globose Set larger volumes retain the cosmic, Sun's radiations larger share for higher internal energy that at constant pressure of 14.7 psi to further expand its volume or radiate internal energy across its perimeter boundaries. The orbital crust is one; magnetosphere/cusps, atmospheric air, and ions are the other boundaries.

The Earth's crust during glaciations periods has greater cooling rates; the cooling/heating phase water vapor masses heat transfer is most important. During the Earth's glaciations periods, the orbital crust increases and enlarges boundaries as the glacial ice, with glaciation ice thickness, while the WVMUSCV bulb shrinks and decreases. A glaciation period continues with continued air masses increasing interstitial volume presence thus higher respective porosity as WVMUSCV bulbs shrink. This phase continues with Earth's irradiated cosmic-Sun's radiated heat energy that irradiates into space until orbital crust generates water vapor WVMUSCV size bulbs which retain proportionally more heat energy reversing WVMUSCV bulb shrinkages and glacial ice advances. Interglacial periods' fluids masses heat energy net radiations losses to space cool the entire orbital masses, also; Earth's model globose-inverse Set has omnidirectional radiations Inlet, outlet forms, for fountain outflows deemed significant unfriendly mechanisms, with a partial blow-off unlikely.

As the WVMUSCV bulb grows during interglacial periods, the radiations net energy gain requires heat transfers across perimeters boundaries; glaciation period ice advances retreat forcing enlarged air bulb masses, magnetosphere, ionosphere Set forms that can trigger a partial blow-off. Enlarged Set forms force ions electrons into said enormous velocities flows. Ionosphere's plasma media are space vacuum temperatures densities that support ions, electrons pure pressures masses flows approaching light velocities, or force outer magnetic lines disconnects or fountain outflows.

Described Tesla's invention friendly mechanism, thus, converts fluids into closed system high velocity ions, electrons, and the auroras are unfriendly stratifications, gradations phenomena. The Earth according to said mathematical computations has started its cyclical interglacial period; thus a partial blow-off is not a concern at this time. It is almost certain that energy growth present rates for the Earth's current fossil fuels would constitute an archaic largely abandoned technology practice at the time of partial blow-offs. Thus, in a long run, if we get there, greenhouse gases are not a concern; but, the Earth's air mass continual water vapor loss constitutes enormous concerns.

Aforesaid data on compaction, porosity interstitial space, or conversely mass continuity is very basic. Science literature has atoms or molecules basic physical data or needed detail. Water vapors science studies refer to vapor behavioral complexities as a confounding ‘lurking’, variable. Its air buoyancy, larger as the temperature rises, is such variable that provides forces for cyclones, tornados, and hurricanes. Air, water vapor compactions density is significant property that shows up on radar imagery. The WVMUSCV bulbs water vapor land ocean masses dim indistinct forms composite radar image shows air masses vapor flux contents highest in tropics, least at polar caps.

Magnetic field's retained ions perimeters outermost boundary interface inner side gravity, magnetic field force is inversely proportional to gravity center, magnetic field dipole line distance squared, cubed, respectively. As the air mass water vapor content increases, said interstitial space decreases, mass continuity and temperatures increase, expanding the air masses, ionosphere forms respective perimeters decreasing the atmosphere's air masses density. The 14.7 psi pressure at sea level moves aforesaid interface out into space, which causes the gravity, magnetic field force fall-off according to aforesaid proportions. Said gravity force fall-off, in turn, has mass densities fall-off at interfaces as the air masses water vapor increased content added critically detrimental effect with unit volume lower densities, lower unit weights for current interglacial period heating phase.

Noteworthy are boundary interaction forces wherein respective energy densities dominate the boundary. When the magnetic field plasma, ions density flows dominate boundary perimeter, its structure is stable. When cosmos, Solar winds dominate, their flows are relatively undisturbed deforming the magnetic field mass energy to suit their motions. Energy densities, electrons spiral movement velocities along magnetic lines increase as boundary deformations increase having the spirals amplitude decrease analogous to a stretching of a spring. When magnetic fields deforming is excessive, electron flows energy demands do not support the outermost magnetic line velocities and the line disconnects, ions droplets form on the boundary and flow away into space. The large deformations perimeter movements can reduce ions densities to near vacuum suction. Thus, cusp mouth suction can create disequilibrium, transpose globose-inverse to highest excitations globose Set, and cause partial blow-offs, important energy release to space Stratifications Gradations (SG) phenomena. Said Gradations forbidden mechanism transforms orbital crust water mass to vapor, to quantum mass energy with blow-offs that may consume most of the ionosphere, along with the atmospheric air masses transferred into ions. The energy releases drop the atmosphere's pressure, to an extent, and drop the temperatures that cause major precipitation events for said variations in pressures that trigger vapor precipitations, ice age. During said partial mass energy blow-offs, the other cusp is a vent that allows least density space plasma mess energy having the Earth's lee side wind pressures, seasonal hemispherical/winter temperatures as forcing change toward equilibrium moderation. Enormous flowing ions mass energy and electrons velocities continue to disconnect the magnetic field outer line, shrinking the atmosphere's globose-inverse/globose form. The vent cusp inflow plasma lower density allows yet higher magnetic field lines equilibrium deformations that may disconnect additional lines until low densities progressing from the vent reach proximity of the density on the perimeter boundary, which significantly shrunk dissipates the cusp's suction.

Thus, the aforesaid water vapor Stratifications Gradations are the ‘global warming’ cause that are interglacial periods atmosphere's warming, geologic times long term Earth's cooling. As afore explained blow-off shrinks ionosphere to least volume globose form plasma inflows energy to space mass densities, temperatures on the Earth's lee side, the atmospheric air vapor condenses and precipitates, shrinking the air masses globose form. The remaining water vapor portion under the radiations has portions ionized, for the air masses water vapor least amounts highest porosities interstitial spaces/volume, the Earth's crusts and air masses radiated irradiate to space heat energy larger portions toward the orbital masses cooling rates increase and glacial ice masses advances to the aforesaid cycle restart; thus, the Earth's cooling/heating system consistency is a clear concern.

Frequent question,—“Have we passed (or are we passing) the tipping point?” is answered by looking at the Earth's impermanent water ice, vapor, and ions inventories budget. Through the stated interglacial, glacial periods, massive tectonic movements occurred. During the more recent geologic periods, the seas maintained relatively stable levels. As stated periods document, glacial ice masses have shrunk in a major way. Presently, glacial ice has least masses on record, with ice covering thicknesses age often, notably much younger than ten years ago. Polar ice caps retreat is reported regularly. Thus glacial ice mass lowest on record appears to melt at an accelerating rate.

Billions of years old river bed erosions have cut deep channels into the continental crusts. The Grand Canyon on the Colorado River is one marvelous example. Thus, the continental crusts groundwater levels are at the historically lowest levels. River beds channels at lowest levels have or will have continental water surfaces, lakes at lowest elevations or the lakes are or may turn into dry beds. Continental SG processes effects have removed water, ice mass in enormous quantities.

If aforesaid ice water masses that once covered this entire planet were managed correctly, they thus could have sustained indefinitely life on several planets with comparable mass climates. Said WVMUSCV tropical belt bulbs water vapor compactions are apparently at historical highest altitudes evidenced by the bulbs' lee side moves to higher latitudes elevations toward most shrunk polar ice caps forced accelerated retreat. Thus, entire air mass has least voids, historically highest compaction mass energy continuities, for least total volume interstitial spaces least voids porosity.

The fountains plasma discharge is occurring during present interglacial cycle early stages, which is evidence of globose atmosphere's air, ionosphere mass, forms are at the largest volumes.

Aforesaid budget inventory short summary has the Earth water ice/fluids mass as follows:
I. Least glaciation ice masses on historical record with noted much younger ice thicknesses.
II. Continental crusts deeply cut riverbed channels, for lakes, groundwater lowest elevations.
III. Said least glaciation ice surfaces globose atmospheric air and ionosphere largest volumes.

Said water ice/fluids masses budget quantities rates show the following evidence:
I. Scientific reports have the glacial masses retreat and melting at accelerating rates.
II. Deeply eroded river beds are generally delivering water mass in largest quantities to tropical belt, based on the continental crusts corresponding groundwater levels.
III. Rivers and continental groundwater levels constituted largest exposed waters free air interface surfaces with air masses near historical high or highest temperatures.
IV. Largest oceans' waters masses surfaces free air interface, and ice caps by far least historical surfaces areas, and air masses with said historical highest temperatures.
V. Enlarging volume fluids cool currents masses with glacial ice by far least masses.
VI. Said historically largest, most compacted air masses retain, contain Sun's, cosmic radiations, solids and vapors clouds reradiation with historically highest amounts.
VII. Aforesaid has plasma fountains start at glaciation period historically earliest time.

VIII. Smallest polar ice caps coldest air least mass least engulfs magnetic field's cusps.

The following show that the Earth's heating is at historically higher rate:
I. Smallest polar ice caps are observed melting at accelerated rates,
II. Said malting ice caps rates create surfaces accelerated water rate,
III. Historical glaciation periods early times plasmas fountains starts,
IV. Unfriendly/adverse WVMUSCV growth bulbs plasma fountains,
V. Said WVMUSCV bulbs growth is ionosphere ions faster growth,
VI. WVMUSCV, ionosphere rate is atmosphere volume growth rate,
VII. Atmosphere fastest growth is evaporated water mass growth rate,
VIII. Evaporated water mass rate reflects ice caps fastest melting rates.

The aforesaid, enumerated water budget inventory, quantities, and rates repeat cyclically, through the interglacial periods with continually smaller ice caps mass quantities with each cycle. Afore enumerations show the fountains pass sufficient ion mass energy to space for the respective hemisphere to avoid the forbidden mechanism partial blow-off, except at said glacial trigger time.

The forgoing summarizes the SG processes following glacial interglacial period changes:
I. Retreating ice caps, enlarged oceans and lowered continental groundwater levels,
II. Significantly lower budget water-ice, ice and water-vapor water respective ratios,
III. Atmosphere significantly enlarged WVMUSCV bulb and ionosphere forms Sets,
IV. The atmosphere, WVMUSCV bulbs, ionosphere forms climate, ecology changes,
V. Ice caps and cool air smaller mass magnetic line disconnects greater possibilities,
VI. Faster glacial ice retreats, higher evaporation rates with greater vapor-ions losses,
VII. Glacial history shown greenhouse gases no contributions and insignificant effect.

Said Earth's SG processes forced-changes are inseparable from ecosystems' evolutionary changes. Fundamentally, glacial ice caps retreats, prehistoric animals' bones discovery in Sahara Desert and armadillo's migration to higher latitudes or polar bear habitats disappearance are more recent climate changes noted among many others. Sahara hot and dry air mass extended high into the atmosphere creating moisture void in the WVMUSCV bulb is compensated by the oceans and Amazon River basin evaporation. Otherwise, the equatorial regions would go entirely dry, which would split WVMUSCV bulbs into hemispherical forms moving toward Polar Regions. This, off course, cannot occur as long the melting polar ice caps provide cool water to the oceans' currents.

The Solar System SG processes show the planets, especially the Earth, in their creation or evolution were blessed with enormous water budget quantity. Based on its distance from the Sun, a planet with its WVMUSCV bulbs sizes atmospheric mass retained heat energy reflects on water mass retained currently. In respective orbits equilibrium outside Venus inside Mars, the Earth has fortuitous, close to if not in most preferred, stable orbit about the Sun based on said planets' high, low, and moderate respective temperatures. However, the Earth's glaciation history points to Sun and cosmic radiations notable water budget depletions with generated greenhouse gases presence.

Mars's crustal geology shows massive fluids caused erosion with the fluids nearly absent. The only fluid the Sun can evaporate or blow-off at such a distance is water. The surface of Mars is rocky, dust covered dry mostly frozen under a low mostly carbon dioxide atmospheric pressure. Venus's atmosphere is believed more like the Earth's several billion years ago, with water budget lost to evaporations that generated gaseous extremely thick atmosphere mainly of carbon dioxide. Thus, including Mercury, the Earth is at equilibriums with the first four planets, that orbit the Sun and has a large water budget, while the others do not. Also, the Earth's magnetic field ionosphere as a huge boundary layer protects air masses water vapor from cosmic/solar winds and radiations; conversely, the Earth's, the Mars's ices caps composition appearances show ominous similarities.

For the conclusive responses to the aforesaid question, one must know: what the “tipping point” defines. The scientific community has assigned superficially the “tipping point”, related to said ‘global warming’ symptoms misnomer herein taken to mean rising atmospheric temperatures Earth's cooling. It is superficial, because the aforesaid geologic history of the Earth and said first four planets status clearly show the Earth, without any doubt, is loosing its water budget. To state that by reversing the last several decades of the humans' generated greenhouse gas emissions will forcefully combat said stratifications, gradations processes peak momentum after 4.5 billion years in the making is less than intelligent. It is clear: the Earth may heat up as Venus or freeze as Mars as its water budgets evaporate/blow-off into space unless immediate measures are not undertaken. Aforesaid described atmosphere's water vapor masses retain radiation and irradiation heat energy. Thus the Earth, without the polar ice caps/water adequately conserved budgets, is trending toward below freezing temperatures, sterile Mars's environment. The Earth's greenhouse gas masses and polar ice caps budgets projected into next millenniums begin to resemble those observed on Mars. Also, conservatively correctly, herein, the current glaciation period at the Earth's aforesaid orbital mechanics first peak will cause a partial blow-off leading into next glacial period, which normally would start with enormous water vapor precipitation due to sudden atmospheric air mass cooling. In our case the cooling could occur but temperature rebound may not, for the atmosphere may not contain sufficient water vapor mass to create magnetic field ionosphere perimeter boundary forms that would avoid the remaining water vapor ionizations then evaporation and the Earth's freezing. Through the SG processes the Earth's mass is the last of the four planets to still hold onto parts of its water budget. When said three planets lost water, undoubtedly parts of the water landed on the Earth. The Nebraskan-Kansan ice advances aforesaid glaciation limits anomalies are attributed to water vapor partial or full blow-off that most like occurred on Mars. The Earth orbital mechanics constitute three identical periods of interglacial peaks spread at equal time intervals thus in groups generally in clusters of three. Currently the Earth nears midpoint of the first of the three intervals. The clustering occurred because at the time of the aforesaid peaks said WVMUSCV, water vapor, bulbs have not sufficiently enlarged with polar ice caps sufficient retreat for atmospheric globose-inverse form to transpose into the higher energy globose forms through plasma fountains activity. Scientific community reporting most recent extensive atmosphere's rising temperatures document the Earth's climate is near aforesaid “tipping point”. However, the rising temperatures symptoms are erroneously correlated with the rising temperatures byproducts: greenhouse gases. Simplistic, unfounded views not viable solutions, that cut greenhouses gases emissions by 20%, do not attack the cause of aforesaid 4.5 billion years old SG processes, said WVMUSCV water vapor enlarging bulbs. Thus, rising temperatures alarming symptoms attributed to greenhouse gases constitute red light warning on broad scope of much more comprehensive histories. Whereas, greenhouse gases cause health and ecosystem issues, they retain radiation irradiation heat energy said proportions in separated air masses from the water vapor bulbs; their air masses oppose water vapor rises to high elevations or their expanded movements to higher latitude, for their eventual downward one cycle paths into tropical regions. Such paths reduce the Earth's air masses volumes magnetic field lines resistance loads, thus, counter said plasma fountains activities. Said emissions cuts without water vapor accompanied cuts constitute unintended detriments rather than benefits. Energy generation no matter how small especially those that implement the emission cuts can generate water vapors. Inside a magnetic cusp, air water vapor masses permittivities resist magnetic field high speed ion-electrons flow enhancing lines disconnects. Said planets condition, more advanced SG processes than the Earth's, further supports evidence that the greenhouse gases emission cuts are essentially erroneous solutions. Observations of Earth's magnetic field weakened strength are clear warning that a blow-off could occur at aforesaid first orbital peak, unless urgent initiatives are undertaken. The fountain forbidden mechanisms, Earth's thermodynamics outflows are irreversible processes.

Prior applications classical globose-conduits processes forms energy dissipates randomly, whereas extensive claims show methodologies that compute perimeter details crucial information.

Aqueducts GC, QCNDMEHC, globose-conduit forms Sets, quantum mass highest energy conserving hydro-thermodynamics make intelligent arrangements, IA-transistor processor Orders. Whereas, electrical circuits' transistors process quantum electrical charges through binary method information processing, the IA-transistors process quantum mass QCNDMEHC density/buoyancy (thus, specific gravity, molecular and/or atomic weights), suction, and evaporation, for nonsteady, nonuniform, nonhomogeneous quanta masses prototype rigid perimeter forms and Sets. Wherein combined as shown by drain traps, said classical globose-conduit forms, Sets as the IA-transistors assemble into processors, especially with interstitial spaces or hydro-thermodynamics information processing. The analogies extended to include the Earth's magnetic field electro-thermodynamics forms and Sets make for assembly systems advanced Order IA-main processor; the Solar System, Milky Way, Universe as advanced IA-processors Orders, highest, multi-core highest, the highest, respectively. The analogies continue known correlation among respective energy form transitions from one into another, frequently applied procedure for the electric and fluid flows energy, which verifies said globose-conduit aqueducts as the countermeasure to fountains forbidden mechanism. Aforesaid thermal aqueducts contained QCNDMEHC quantum water mass energy can seamlessly mirror ionosphere heat energy dissipated into space as heat energy transferred into the continental crust, seamlessly integrating into IA-transistors, advanced, high, and highest IA-processor Orders. The IA-transistors/processors Orders Sets and forms force their GC Universe inside GC Universe.

The Earth's ecosystems, geophysical reserves allow the QCNDMEHC energy utilizations or conversions but not water vapors or heat energy which generates water vapor as its byproducts. Said stratifications gradations processes arrest or containment requires enormous energy demands that are not in the current technologies arsenal. Prior applications' GC Sets, forms disclose, claim infinite water or energy conserving, showing mass energy frictional losses calculations two orders of magnitude better than in ubiquitous drain traps present art. However that is not enough, for we consume more, continuously demand more energy. The buried, thermal aqueducts QCNDMEHC technology matches in energy conserving the stratifications gradations processes but only when in unisons with said globose-conduit, GC, Sets forms constitutes GC Universe IA-processors Orders which ubiquitously confront stratifications gradations processes. The aqueducts required lifespan mandates GC Sets and forms QCNDMEHC perimeters. Foreseen enormous energy demands will forever transform rivers geophysical energy into buried thermal aqueducts, except for recreational conservation. Current engineered materials, heat energy transfer, and geotechnical technology for the aqueducts apply, but millenniums-lifespan requires structures aging incorporated into designs, especially heat energy transfer with dissipation; natural river bed, water free surface, groundwater elevation variations; and the intake, discharge structures, and aqueducts elevation and settlements. Highest densities/specific gravities, least interstitial space subgrades; noncorrosive metal, mineral or plastics materials, composites and surfaces; aqueducts inner surfaces polished are all preferred. Grade constructions should not include aqueducts crowns and may extend to approximately three feet below grade; all materials and workmanship constructions shall constitute the highest quality.

The Mars observations confirm, without doubt, the aqueducts water masses shielded from direct sunlight is the viable technology. The QCNDMEHC perimeters, buried, thermal aqueducts hydrodynamics thermodynamics transfer precipitated water vapor heat energy aqueduct contained into the continental crusts mass. Most importantly, said aqueducts irrigation systems network can remove the water vapor from the atmosphere into the continental crusts groundwater storage up to highest permissible elevations. Water vapor precipitation aqueduct or groundwater shielded from the sunlight eliminates immediate or delays significant water masses evaporations, which re-enter the Earth's atmosphere heating/cooling cycles forced by said Sun's radiation, Earth's, and clouds' irradiations. Thus removed heat energy from the atmosphere into the Earth crustal masses lowers said ‘global warming’ temperatures with reduced irradiation and radiation heat energy retained by the atmosphere with their greater portion irradiated into space. Again, most importantly, said GC, QCNDMEHC Sets and forms aforesaid least frictional losses with or without irrigation, with land masses least pitched aqueduct networks, longest paths longest passing time duration that conducts water masses heat energy highest amounts into the crust with water masses at lowest temperatures as aqueduct discharges require radiations or irradiations heat energy largest amounts to evaporate. Aforesaid effects lower slightly the upper troposphere, stratosphere's temperatures, enhancing the water vapor precipitation; this in turn reverses aforesaid WVMUSCV water vapor enlarging bulbs processes, which sets up reverse water masses directed cyclical flows through rivers or aqueducts toward atmospheric continual very slightly lower temperatures trends established cyclical control. Yet most important is reversing said WVMUSCV water vapors enlarging bulbs processes forcing correspondingly enlarged globose molecular air, ionosphere, and globose-inverse electromagnetic field lines' forms. The WVMUSCV bulbs shrinkages give correspondingly magnified ionosphere and magnetopause perimeter boundaries shrinkages, which move said perimeter boundaries much closer to the gravitational, magnetic field respective centers. Said globose-inverse magnetopause perimeter boundary forms significantly shorten the electro magnetic field ions and electrons paths lowering their velocities demands generally increasing densities along perimeters boundaries; this simultaneously lowers the load on the magnetic field motor/generator, and therefore precludes the magnetic lines disconnect. Said lower loads result in higher ionosphere density for more resilient boundary perimeters to counter space plasmas correspondingly higher densities that are generated by intensified cosmic and solar radiations energy but on said significantly shrunk globose-inverse forms, surface area. The significantly reduced magnetic field motor/generator electrons velocities that curtail and stop plasmas fountains' flows avoid said orbital forces blow-offs at said first peak.

The thick band thin disk plate vast population of small bodies around the ecliptic referred to as the Kuiper Belt merged into trillions of comets nuclei spherical cloud postulated to extend to the Solar System's outer boundary together with celestial bodies referred to as the Solar System is the miniature model of the Universe's forbidden mechanisms, stratifications gradations processes.

Circumnavigated aforesaid ions cloud circumferential infinite-period of atomic chart ions least weights can constitute infinite periods of figure eight harmonics. Such cloud trajectories can have any approach angle and blow-off the Earth's magnetic field along with its air, fluids masses. The Earth's atmosphere thermodynamics with electromagnetic field lines electro-superconducting is much lower than speed of light for said magnetic field curved paths and is least in molecular air with the water vapor permittivities. Said cloud phenomena noted geological formations variances once within one-billion years which ties to the magnetic field shifts dating are not clearly defined.

Unquestionably, however, aforesaid timely, globally implemented water vapor cuts avoid a potential, partial blow-off, which when prolonged could cause a magnetic field shift. Aforesaid continental groundwater rises, stored enormous water volume weights, must rise gradually across continents, and thus, avoids destabilizing eccentric weight that could cause wobbles in the Earth's rotations. Aforesaid aqueducts strategic location along river banks is groundwater levels restored. Said irrigation would utilize lawns watering progressive activation to manage the water available.

Curtailing or shutting-off the plasma fountains alters the Earth's, Solar System discharges into the Milky Way Galaxy, the space, as mass energy communication from the main, multi-cores to highest IA-processors Order as interne IA-Orders networks of processors Orders, respectively. The caused extremely small changes in comparisons to the Solar System's energy releases cannot alter significantly the Earth's Solar System or Milky Way Galaxy respective location, orientation. No choices; said GC IA-processors Orders must counter said stratifications, gradations processes.

Machinery mechanism processes are following—a regulatory and two constructions Part:
I. Photoelectric-cell or film machines upper shell, least latitudes transcontinental routes and air routes least altitudes, converted solar radiations to electrical energy enact the regulatory Part. Least latitude has the machines in reduced interstitial space, highest water vapor air mass for least greenhouse gases ambient temperature difference, greenhouse gases shortest downward paths to their settling places. The routes concentrations concentrate greenhouse gases within remaining least interstitial spaces heavier air mass volumes rises, enhanced downward move opposing water vapors air masses rises to highest altitude, movements toward the poles. The machines entirely, the greenhouses gases partially block out Sun's most intensive radiations. Said machines and emissions enhance positive effects, counter WVMUSCV bulbs enlarging.
II. Floated over water blankets or tarpaulin, photoelectric-cell or film fields that block radiation, structurally anchored grids that allow movement, wherein spacings or holes avoid dead spots or underside molding. Plastics, not limited to PVC, floating tubes frames restricted rotations joint connections allow the field movements yet positively stiffen the frames entire structure. Electric cables through tubes, joints, and circuit breakers feed localized power demand grids.
III. Machinery mechanisms' versions solar mirrors or panels' field instead of said photoelectric-cells/film steam and hot water suitable piping instead of electrical cables provide the energy. Floated versions are most suitable for medium size recreational lakes. Said machinery fields supported above water from water/river bed make for said machines assembly versions, also.

Said machinery mechanisms resilient, water environment, and weather proof construction workmanship technologies block said stratifications, gradations processes, water evaporations. A current dollar, projected fifty-trillion budgets is estimated entire construction for coming decades.

Said GC respective IA-processors Orders of said QCNDMEHC Sets and forms make up a living cell, cells local system, an organ, organs network universe and organisms living networks living cells Universe IA-processors Orders, as intelligent GC conforming embodiments Universe. As GC Sets, forms, living cells' epidermis traits make local, ‘global’, networks, and GC Universe inflow Inlets, outlets, internal globose-conduit forms, respective position rotation and orientation. Again, GC Sets, forms Inlets, outlets, globose-conduit, basin-outlets, with internals are defined by the forms structures lengths, cross-sections, shapes, sized perimeters, and overall dimensions with flexibility, elasticity, strength through cyclical histories, growth, repair, longevity or regeneration; structures, fluids submicroscopic, microscopic, microbes, electric charges, ions, atoms, molecules compounds interstitial spaces; compositions, boundaries membrane, interstitial spaces uniformity, homogeneity, consistency, steadiness, color, cyclical variability, flux range, longevity; forms Sets internal, external boundaries, perimeters, deformations creep, temporary, cyclic, permanent, axial, longitudinal, transverse; perimeters membranes wall thicknesses changes, normal, active, excited, very excited, stressed, overstressed states; physical, chemical, density, energy transfers processes, electric, muscular, nervous impulses flux, period; any, and all dynamics and interactions changes.

Human's intelligence center, the brain, and energy provider, heart, belong to closed Sets, forms Globose-Conduits versions, with limbs outreach perimeters, boundaries as special versions.

The Earth's molten core, magma, lava flows, rivers, streams, creaks is taken analogous to humans' cardio-vascular system. Living cells, Globose-Conduit or Conduits of Globose Sets and forms have infinite number varieties pooled into aforesaid Universe of said IA-Processors, Order.

Cells' positive or negative ionic discharges known as “action potential” transmissions that travel along the cell membrane are used most extensively by the nervous system to communicate, to transmit information to other body tissues and organs. Cells' action potentials with ‘polarized’, ‘threshold and initiation’, ‘plateau phase’, with “phases”, ‘resting potential’, ‘stimulation’, ‘rising phase’, ‘peak’, ‘falling phase’ and ‘undershoot’ model as reactor/capacitor, RC, potential circuits; Cells' ionic ‘action potentials’ and nervous system are taken analogous to Earth's electromagnetic field ions/electrons charges flows, air masses thermodynamics, globose forms magnetopause flux.

The analogies group humans and Earth as the respective advanced Globose-Conduit Sets, main IA-processors Orders two separate categories. Humans possess living organisms' cognitive, intelligence, communication and motive energy directional changes skills, whereas the Earth does not but supports said activities and skills. Three changes are at the forefront, herewith. Aforesaid QCNDMEHC GC, Sets, forms, and buried aqueducts-networks timely revitalized Earth's ‘cardio-vascular’ and magnetic systems functions force processes that extend indefinitely the Earth's life; the two systems masses entirely changed said fluids gases interactions forms force a third change; said third and as most important of human, Earth comparative analogies applies to life extensions. Said GC respective IA-processors Orders, said QCNDMEHC Sets and forms at the center of said extended life have mass and energy highest conserving laminar flows four unique, generic claims, especially devised for sole purpose of arriving at quantum masses flows highest conserved energy perimeters and boundaries. The four generic claims quantum masses compliance with the Law of Conservation of Energy thus encompasses the First Law of Thermodynamics, also. Said thermal, buried aqueducts quantum masses, potential, kinetic, and heat energy transfers QCNDMEHC Sets and forms transistors by aforesaid analogy are GC, Sets ‘processors ’, henceforth, thus referenced. The human cells skin surfaces membrane, the magnetopause GC Sets' forms respective perimeter boundaries and heat energy transfers verify their comparative biologic, inorganic taken analogies.

Said buried aqueducts implemented hydro-thermodynamics QCNDMEHC which assures the Earth's longevity constitutes humans intelligence highest achievements. As continental crusts underground GC QCNDMEHC structures, said aqueducts are geologic ‘inorganic intelligence’ of parts that provide the Earth's hydrodynamics thermodynamics electromagnetics system longevity. This blurs the humans and the Earth's intelligence said comparative biologic, inorganic analogies.

Aforesaid points out that human lifespan, infinitesimal compared to the Earth's longevity, can improve through GC QCNDMEHC Sets, forms invention, methodologies, and principles said comparative biologic, inorganic analogies, especially the inorganic features related to the organic. Human physiology—impulses, submicroscopic, microscopic, atomic, molecular, and electrolytes, medical jargon ‘lytes’,—elementary substances forms from subatomic to compounds are varieties of globose forms, wherein living cells globose forms make globose-inverse versions as well. The living cells interrelation intercommunications among globose, globose-inverse forms, within their respective advanced IA-processors Orders utilize their respective conduits' forms. Here, medical, profession arts and sciences fail to assign respective critical importance to cells interstitial spaces.

Analogous to the Earth's masses there is respective human compositions per cent weights and volumes in respect to total weights and volumes where the differences are specific perimeters and boundaries; globose, conduit, globose-conduit, forms and interstitial spaces locations, shapes, distributions, percentages and total of each; perimeters enclosed masses, volumes, and boundaries thicknesses. GC Sets', forms' structures and fluids compositions, internal boundaries, perimeters; physical, chemical, densities; living cells traits and any and all changes dynamics and interactions through magnetic resonance imaging highest magnification can constitute all living cells database referral. The database must include cells normal, numerous excitations and their abnormal states, their respective interstitial spaces locations, shapes, percentages, and total volume with perimeters enclosed masses, volumes, and boundaries thicknesses. Earth's analogies with inorganic budgets suggest with human bodies needed substances required least budgetary masses and their reserves; thus, fluids pressures, in addition to blood pressure, and fluids, electrolytes, and gases masses and interstitial spaces, and cells advanced IA-processors Orders interactions and intercommunications and most importantly among them, the brain taken well being status, account for their longevities. Thus, GC inventions principles, methodologies provide the most important comparative analogies which the Law of Conservation of Energy including the First Law of Thermodynamics mandates.

Human biological processes' longevities cruces, Earth's systems supported processes, are brain-nervous system, (Earth's electromagnetism) liquids and gases perimeters interactions as GC Sets, forms masses or heat energy boundaries, hydrodynamics, thermodynamics optimal transfers.

Physiologies, biological processes with interstitial spaces identical to inorganic processes highest conserving mass energy QCNDMEHC Sets and forms serve as processes aging inhibitors; electromagnetic thermodynamics hydrodynamics enclosed mass GC QCNDMEHC aqueducts are energy shunts, cosmic radiations, irradiations said ‘global warming’ excess heat balanced systems energy reroutes into nominally reheated crust, thereby extending said Earth's systems longevities.

Clinical tests, diagnostics evaluations, surgical and biopsy results complete database with cells forms, critical substances—reserves, distributions, interstitial spaces, locations, coordination, rotations, orientations for all globose, GC Sets, forms domains said characterizations, for humans, to match DNA, genetics, and stem-cells work, state of art requires present dollars tens of trillions.

Energy conservation laws identify “mass-energy” as the substance that makes everything. Analogous to water seeking its lowest energy level, the “mass-energy” seeks its least energy state. Space omnipresent infinity matrixes stratifications and or gradations seek their least energy states. GC buried aqueducts Sets and forms QCNDMEHC intelligent arrangements advanced IA-Orders, synchronous operation with the Earth as the advanced Order IA-main processor, mass and energy highest conserving by strategically transferring excess heat balance the Earth's enclosed systems.

Mass energy perimeters, boundaries of said Earth's enclosed system processes, except for radiations into space, counter enforcing stratifications gradations, extending the Earth's longevity. Human, Earth comparative analogies applied, using the Earth as the example, with cells strings as advanced transistors, processors arranged and bound into organs as advanced local networks, with organs operated by their advanced main processor, the brain, join the Internet networks of organs. Cells Sets and forms sizes, perimeters boundaries thicknesses, least temperatures or pressures flux variations; least ambient temperatures or pressures, variations difference, least largest-magnitudes fluxing of each; best cell-walls, fluids compositions and interstitial spaces especially at interfaces; cells, organs ideal boundaries molecular genetics GC forms Sets sizes, compositions, continuities, growth; systems' integrations, fluids hydrodynamics thermodynamics; ideal cells IA integrity and interactions continuation mass energy flows define longevities and comparative system analogies.

Fluids mass and energy flows must comply with the First Law of Thermodynamics which the Conservation of Energy Law includes; prior applications four generic claims continuations for conforming embodiments, PAP, PPLD, PP, and PPLLS, paths-of-passage lengths least sum based on quantum masses QCNDMEHC GC Sets and form ultimate boundaries' or perimeters condense said two Laws to mass energy highest conserving ultimate classic fluids' transistors or processors. Theoretical, physical mass energy highest conserving is the filed First Application Sets and forms embodiments “laminar” flows caused by perimeters or boundaries forms as “flow control means”. The Earth's magnetopause electromagnetic field lines make for the atmosphere's outer perimeters boundary mass energy “flow control means”; liquids mainly of water masses and the Earth's crust constitute innermost perimeters boundaries, wherein said buried thermal aqueducts QCNDMEHC GC, Sets and forms boundaries perimeters transfer radiations irradiations excess heat energy from the collected atmosphere precipitations water masses into the crust. In this process, infinite water masses are conserved as no water loss occurs, for atmosphere's radiations irradiations excess heat energy transferred into the Earth's crusts stops plasma fountains mass energy outflows into space. Said aqueducts perimeters boundaries cause fluids masses kinetic energy least frictional losses for least potential energy aqueducts slopes ultimate heat energy transfers. Prior applications claimed QCNDMEHC, mass energy highest conserving the application Ser. No. 11/809,132 validates, wherein the GC drain-trap, viscosity and boundary frictional losses are two-orders of magnitude better, lower, than such losses in a simple-trap used ubiquitously. A fluids mass with no viscosity or perimeters boundaries frictional losses, as ionosphere masses approach, translational motion and rotation that stays in its gravity, magnetic fields gradient stays translational, unless hit by another mass-energy.

The First Application general forms make Sets. Continuation applications conforming, least mass energy, least boundary surfaces specific forms, and mass energy and surfaces areas are much smaller than those of known arts conventional, manmade prototypes. Conforming embodiments, or a globose-conduit, globose conduit, ‘laminar’, ‘flow control’ mass energy is inside the first application, the known arts forms enclosure perimeters, surfaces boundaries. Globose-conduit mass energy self-preserving, self-conserving, quintessential core natural dispositions, mass energy highest conserving QCNDMEHC makes other forms immaterial or insignificant. The QCNDMEHC easily dissipates; as phenomena, they are most apparent in pure most intensive state boundaries. The continuations applications conforming least mass perimeters of the first application forms by algorithm approximations define the QCNDMEHC mass energy boundaries.

The First Application structures specification and drawings ‘laminar flow’ herein defines a liquid, gas, solids, or fluids of adjacent or neighboring layers which do not mix, enhanced by a relative density or a specific gravity, that flow at different speeds, perimeters forms confined, to a velocities direction having globose-conduits conforming least quanta mass energy least rotations. ‘Flow control means’ are PAP, PP, and PPLD FESD forms geometrics conforming embodiments least quanta mass algorithm approximations PP lengths least sum constituted perimeters interface boundaries surface globose-conduits classical forms.

GC perimeters enclose QCNDMEHC classis; light energy QCNDMEHC contained within gravity force field makes a black hole. Light and gravity energy force fields unique common boundary constitutes cosmos enclosure. If it is electrons electric charge perimeters boundaries about nuclei, it is atoms. Herein designed best approximations enclosed QCNDMEHC makes for said GC Sets and forms globose-conduits. A flexible or elastic or a solid epidermis membrane boundary energy perimeter makes GC living cells Set. The Generic Claims: conforming embodiments, PAP, path-angle-of-passage; PP, paths-of-passage; paths-of-passage lengths least sum; and PPLD, path-of-passage-of-least-energy-demand, perimeter forms and or Sets are the application Ser. No. 08/950,898 specified “flow control means” “laminar flow”, Figures claimed; Ser. No. 60/123,153, Ser. No. 60/123,207, Ser. No. 60/123,504, thereto shown 115 Figures claims mass energy highest conserving, (is Ser. No. 60/123,153 “lead to, cause low energy demand, least amount of energy needed to pass the waste”). Ser. No. 09/376,957, Ser. No. 09/158,884 continues the 115 with 119 Figures for the Arts or Sciences engineering disciplines invention of four Generic Claims principles and methodologies. Ser. No. 60/217,308, Ser. No. 220,358, Ser. No. 231,514, Ser. No. 226,750 details the Ser. No. 09/376,957 and Ser. No. 09/158,884 continue layman language graphical description of the four Generic Claims PP, PP lengths sum, PPLD (PPLED), and PAP that are the Law of Conservation of Energy for crafts and trades constructions from Arts and Sciences and engineering disciplines, license procedures globose-conduits GC Sets and forms three modes of operation. The inventions, principles, methodologies conforming embodiments continuations of said “laminar flow”, “flow control means”, mass energy highest conserving, arise within said Laws of Conservation of Energy. The four Generic Claims apply the Law of Conservation of Energy most basic law to most basic elements to define QCNDMEHC GC forms, Sets aqueducts, sewers, drain lines and traps perimeter boundaries; the four Generic Claims in layman's language intellectual summary takes the GC forms Sets into force fields. Electrostatic ionic, electromagnetic magneto-rheological fluids said S/N 09/158,884 describes and claims. Three operating modes: crafts and trades standards; engineering disciplines finite elements; Arts, Sciences infinitesimal to exact solutions are taken fundamentally as best functional, finite extended to infinitesimal, or the infinitesimal extendable to exact solutions/constructions of QCNDMEHC GC classical forms, Sets.

The pending application Forms Presence argues existence of absolute science angled Inlets, only; the Forms application is for crafts or trades constructed Sets; the Forms Phenomena application takes the appropriate no perceived deviations from sciences ‘upright’, for a structure angles, at least infinitesimally. Off course, Inlet angles do not matter to the four Generic Claims derivations or perimeters boundaries, for forms and Sets, inventions QCNDMEHC GC natural mass energy natural disposition has the four Generic Claims the Laws of Conservation of Energy mass energy highest conserving. Herein, computing methods approximations following the known universally mass energy classic forms familiar examples universally CONTINUE the accepted comparative, parallel, energy forms analogies to the GC perimeters boundaries.

Said Earth's fluids GC forms, Sets superimpose the gravity field gradients with the magnetic field lines magnetopause for a solar, cosmic winds highly deformed common perimeters boundaries. Said field lines along with the gravitational field streamlines constitute the PP said “flow control means” streamlines that are orthogonal to the gradients. The PPLD is the Earth's perimeters boundaries magnetopause forms; all three operational modes are useful; all three transmit naturally heat energy across the outer boundaries. The PPLD form rotates as the magnetic field magnetopause and ions' surfaces flux under the atmospheric internal thermodynamics temperatures, pressures and solar, cosmic winds pressures, radiations variations. Said PAP is a tangent line to the air masses perimeter constituted globose form and to the magnetopause's cusp innermost magnetic line. As with PPLD, the PAP rotates with the Earth's rotation into an imaginary surface. By definition the PAP is in an upright plane of quantum mass energy system symmetry; the PAP as a linear path of least energy maximum demand, least energy consumed path in the ionosphere becomes curvilinear or discontinuous primarily due to magnetic lines flux and mass densities' variations dynamics.

Clearly, the Earth's mass energy low irradiations into space cause atmosphere's ‘global warming’ dangerous depletion of the fresh water reserves in the polar caps, for water ions plasma fountain outflows. Said GC buried thermal aqueducts partially reroute natural heat energy emission from the Earth's matured core masses for their geological times long periods slowed down cooling processes, which simultaneously slow down water vapor generation into the atmosphere, causing higher heat energy irradiations, thus, lead to the atmospheric ‘global cooling’ plasma fountains shut-offs to water masses energy highest conserving; the Earth's water phases heat energy partial reroutes postpone cooling processes stratifications gradations. Said reroutes utilize atmospheric masses stored excess radiations irradiations, industrial, power generation heat energy byproduct for crust partial rejuvenation, which avoids Earth's eventual drying-out or freezing.

Buried, thermal, GC, aqueducts networks empower industrial electrical energy generation by their byproduct heat energy important usage, for Earth's prolonged longevity preserved ice caps water reserves fluids hydrodynamics, thermodynamics, electromagnetics, inner boundary heat energy balanced transfers; thus, the magnetopause as outer boundary, the two cusps are restricted in mass energy outflow into space.

Vapor WVMUSCV bulbs, GC aqueducts water heat energy transfers moderate ‘global warming, cooling’. The water vapor mass heat energy greater WVMUSCV bulbs generate global warming; the GC aqueducts water networks diminish geological crustal cooling with important aqueducts irrigational effects function. The WVMUSCV bulbs partially smaller water vapor masses allow more heat energy to escape into space. The aqueducts irrigations groundwater elevations controlled rise, retained water masses least evaporations reduce WVMUSCV bulbs, replace/reverse lower groundwater levels processes greater WVMUSCV bulbs and glaciation periods billions of years of groundwater levels cycling, water-loosing heat energy transfers. The buried thermal aqueducts water masses substitute for glacial masses effect of groundwater levels rise. Many fold condensed vapor volumes into aqueducts water masses decouple the Earth's and Solar System, cosmic gradations stratifications water ions mass energy demand with larger heat energy radiations across magnetopause, as fluids forced boundaries; the GC aqueducts networks utilized as globose-conduits shunt switches decouple industrial, power generation and human demands for water, with heat energy processes avoiding water evaporation; most significantly, byproduct heat energy usages delay Earth's aging process.

Forms and Sets, QCNDMEHC, GC perimeters, aqueducts water inside the fluids/ions GC forms masses is GC boundaries laminated enclosures of cosmos unique, Earth's super-advanced Order IA-main processor.

Said hydrodynamics thermodynamics electromagnetics, basic physics, chemistry laws, geological histories, and astronomical observances validate QCNDMEHC GC Sets, forms said heat energy transfers.

This application claims processes, only. Thus, no new drawing is shown, described and depicted. Specifically, the application claims QCNDMEHC mass energy conserving confronting said stratifications gradations with QCNDMEHC effects which confront effects broadly referred to as the “global warming”.

Because of referrals to prior applications GC QCNDMEHC prototype drawings or related claims, engineering disciplines ‘operational mode’ prior Application Forms Phenomena, elementary, GC, upright Sets and forms are repeated herein for quick reference, only. This application resolves “global warming”. Said four generic claims, inventions, methodologies, and principles apply equally and comprehensively to Sets and forms that are infinitesimally, finitely, and highly angled; an absolutely straight or a vertical line, in real infinity, does not exist. Thus, the Forms Phenomena application equally represents methodologies or inventions, principles and claims of Forms' Presence and Forms applications where differences among said tree are the finite, infinitesimal, and crafts, and trades constructions ‘modes of operations’ tolerances. Of note is prior application claimed “conforming embodiments conforming least mass, height, hydrostatic pressures, surface area, quantum mass rotations, PP lengths least sum thus frictional losses making for mass energy constituted highest self-conserving globose-conduit universe FESD forms, Sets, and domains; globose-conduit forms forgoing properties highest mass energy conservation from infinite to infinitesimal ranges constitute higher “best mode of operation” over existing and prior patents;” Of note also, is a subject verb agreements wherein multiple subjects that implies one, such as GC QCNDMEHC, appropriately may take a singular verb rather than conventional plural. Also, note, said “a highest”, or stated QCNDMEHC, if for a specific orientation or rotation, does not deserve “the” article, reserved for absolute straight line constituted mass energy conserving; not utilized in cosmos or Universe terms, also.

For quick reference purposes only, the Forms Phenomena application Claim conforming revision describes here, in the Claim, and the Detail Description of the Drawings prototype Sets, forms as follows:

Globose-conduit spouts drainage lines universe, conforming embodiments' energy mass highest conserving, quintessential, core, natural disposition complete complement of completely matched forms compact composites constitutes Sets; an inflow Inlet, a perimeter enclosure part, makes a Set; a mass varied composition, a conforming least quanta mass at highest elevations, a one length continuous least height compact composite, a free-surfaces one continuous composite, a least height perimeter for a least rotated quanta mass most conserve mass energy; said quanta, quantum mass paths-of-passage, PP, lengths least sum has an upper retention part submerging a transition region part above a globose Inlet lower end, an End 2, or a globose-inverse ascending outlet spout lower end, a First End, respective undersurfaces forms; forms of FESDs, an Inlet, a Sub-outlet, an outlet lower smaller areas, short heights, a narrow breadths cross-sections, a PPLD band narrowest widths, an open channel quanta mass globose breach, breadths, a least perimeter large globose areas free-surface complete complement of forms, and a PAP least angles less than 180 degrees effect a least quanta mass least rotations, mass energy highest conserving; globose-conduit spouts retain much smaller quanta mass than ubiquitous arts do; mass steady transports through narrow breadths, narrowest PPLD widths of bands, lowest surfaces short slopes, height, length conduit priorities manipulated cross-sections areas varied breadths complete complement raises, sets up a high-specific gravity mass ahead of a globose mass detention large free surface much larger mass uniform hydrostatic, atmospheric steady pressure energy push; said End 2 or a First End various migrating locations from sidelong to anti-sidelong makes up domain Sets; a Globose and a circumferential strain mutation make up hybrid domains Sets; a globose-conduit complete complement breadths drainage line has a small lower, a transition region, and an upper globose, cross-section area one composite form; said composition nonhomogeneous heavy mass is nonuniform nonsteady energy a structure perimeter lifted repeatedly, continually, indefinitely, replaced continually by smaller quanta masses through shorter heights and or distances conserves infinite mass and or energy; mass and energy forms unique origin perimeters evolve or devolve, rotate, mutate, transpose, and transfer to contain, retain, detain and transport highest mass energy modes to forms universe perfection beyond human creating skill; flush Apparatus pre-assembled wall structure assemblies adeptly flush, sterilize, coat surfaces or a Set and or maintain retention; a globose-conduit is a quintessential, core, natural disposition classis of mass energy perimeter mass energy classic enclosing perimeters that is infinitesimal to infinite mass energy conserving;

the first application general forms make Sets; continuation applications is conforming, least mass energy, least boundary surfaces specific forms, whose mass energy and surfaces areas are much smaller than those of conventional, know arts; conforming embodiments, or a globose-conduit, globose conduit, ‘laminar’, ‘flow control’ mass energy is inside the first application, the known art forms enclosure surfaces boundaries; the most self-conserving, most self-preserving mass energy core, quintessential, natural disposition makes the competing forms immaterial and or insignificant; while omnipresent, mass energy core, quintessential, natural disposition readily dissipates and is intellectually most visible in its purest, most intensive forms; mass energy, core, quintessential, natural disposition boundaries least mass forms perimeter constitute continuation applications conserving mass energy algorithm approximations computed perimeter forms;

omnipresence of mass energy core, quintessential, natural disposition boundaries small mass or surface perimeter inside the first application forms constitutes continuation applications continually filed requested allowances for highest conserving quantum mass approximated mass energy perimeter forms;

the first application first paragraph most broadly specifies forms of fluid mass-energy containers; the continuation applications provide globose-conduit as a least Sets of contained, retained, detained and transported mass energy, figures illustrated methodologies, inventions, and principles accepted universally as belonging to classic highest self-conserving, preserving mass energy quintessential, core, natural disposition environment;

globose-conduit perimeters enclose quintessential, core, natural disposition mass energy highest conserving classis; sciences' highest conserving mass energy paralleling analogies make analogous forms; quintessential core natural dispositions light energy enclosed inside an energy mass force field is a black hole; light and gravity energy force fields unique common boundary constitutes cosmos enclosure; if it is electrons electric charge boundary about nuclei, it is atoms; if it is a man devised best approximations mass energy core, quintessential, natural disposition enclosure boundaries, it is an aforesaid globose-conduit; such mass energy perimeters of elastic or a flexible or a solid epidermis membrane boundary constitute a living cell; details of best, computing approximations follow; examples of the known universally familiar mass energy classic forms are universally drawn paralleling analogies accepted to exist referred to here as classic forms, which universally involve aforesaid globose-conduit perimeter forms;

the first application structures specification and drawings ‘laminar flow’ herein defines a liquid, gas, or solids fluid adjacent or neighboring layers that do not mix, enhanced by a relative density or a specific gravity, that flow at different speeds perimeter forms confined to a velocities direction having globose-conduit conforming least quanta mass energy least rotations; said ‘flow control means’ is FESD forms a PAP, PP, PPLD geometrics conforming least quanta mass that is algorithm computed continued PP lengths least sum respective perimeter interface surfaces forms from an Inlet fluid free surface to at least a DCSS for it to constitute globose-conduit classic form; a PP lengths as a least sum inherently constitutes conforming least quanta mass least rotations, highest conserving mass energy perimeter phases compact composite forms; an FESD origin is PP least sum thus conforming least mass least perimeter surface that, evolve, modify, and continues from the first application as shrunk, compressed figures of illustrated, specified ‘flow control means’;

for a narrow breadth conduit nearly infinite Inlet or outlet forms drain or a sewer line for a natural gravitational uniform mass energy highest conserving is globose-conduit form that most readily evolves devolves into spherical, globose retention forms or negotiates a grade rising slope with cross-sections area manipulations; a mass energy composition transports with free surfaces higher than conduit springing points disclose globose conduit unmatched mass energy transports superiority with a conforming least quanta mass least height, least rotations, a lowest hydrostatic pressure largest free surface least boundary friction, for sewer or drain lines highest elevations;

sets contain, retain, detain and transport mass energy that is the first application figures shrunk to quintessential, core, natural disposition said inventions, principles, and methodologies best self-conserving mass energy classic forms; continuation applications mass energy boundary as least mass forms is inside the first application, first paragraph fluid mass perimeter to arrive at classic perimeter globose conduit unchanged drawings of Sets that is continued from the second application; nothing is added; sets' universe consists of a basin, outlet, and Inlet forms, a Set or Set clusters where Sets partitions subdivide clusters; continuation applications depict, describe, and continue the fourth application classic globose conduit Sets unique genome forms origin, a ‘parent’ that FIG. 1 shows, also parent of the first application FIG. 1-2, especially FIG. 12 forms cylindrical versions extensively depicted, continued further with the continuation applications, herein FIG. 12 globose forms Set; flow-energy-surface-dispensators, FESD, originated with the first application that are entirely the second application illustrated and detailed are this drawings continued ‘flow control’ as classic globose-conduit perimeters or continued mechanics of forms; said FIGS. 1-2 and 12 forms conforming to generic claims constitute a conduit Inlet, a basin outlet globose-conduit mass energy classic, FESD, conversions from primarily one to multidimensional forms with a conduit, a globose basin mainly a one, two dimensional forms, respectively; this drawings introduction, mechanics of forms, shows FESD(s) originate with the first application;

nonhomogeneous, nonsteady, nonuniform mass-energy composition inflows are globose-conduit cross-sections area perimeter boundary; mass-energy, mass energy, refers to a globose-conduit quantum, quanta fluid mass contained energy; globose-conduit units of mass, quantum energy, is contained continually, a transported, retained, contained mass energy or a transported, contained, retained, detained, mass energy phases; a quanta mass has varying phases' amounts in variable percentages; globose-conduit open channel vented forms specific gravities stratified mass-energy under atmospheric pressure is mechanics of forms introduction to the drawings;

globose-conduit forms boundary contains, retains, detains, transports air, gas, and a least conforming nonhomogeneous, nonuniform, nonsteady mass-energy has least PPLD widths band, quanta mass height, conduit perimeters friction forces for energy modes phases highest sum;

globose-conduit universe Sets' genomes are a least conforming mass, energy boundary, internal rotations, hydrostatic pressures and friction, making energy modes' phases highest sum;

generic PAP, PPLD, PP lengths least sum, conforming embodiments, evolve or devolve globose-conduit forms into rounded or entirely round conduit cross-sections or globose spherical or spherical retained mass forms that rotate, mutate, transpose, transfer, and make unique origin universe constituted highest conserving mass energy phases, forms, Sets, hybrids, and domains;

a globose-conduit confines, retains, transports; its lower conduit confines, transports; its mechanics of forms detention highest conserving mass energy phases least confine its transport;

globose-conduit unique origin forms phenomena evolve, devolve; rotate, mutate, transpose transfer; contain, detain, retain, or transport conforming least mass varied composition at continuously highest elevations;

a least height perimeter one length compact composite of free surfaces least rotated mass phenomena most conserves mass energy; globose-conduit perimeters enclose quintessential, core, natural disposition mass energy highest conserving classis;

globose-conduit highest mass energy forms drawn analogies and schematic evaluations confirm infinitesimal perimeter boundary analyses substantiate nonhomogeneous, nonuniform, and nonsteady mass energy highest conserving universal environmentally important innovations;

core mechanics of drawings, mechanics of forms, FESD forms, Flush Apparatus inventions, principles, methodologies highest quantum mass-energy quintessential, core, natural disposition globose-conduit classic perimeter forms with the following summary:
A. microbes' submicroscopic, atomic subatomic to cosmos makeup as described;
B. craft's ordinary scale implemented inventions, principles, and methodologies:
a. inflows nonhomogeneous, nonsteady, nonuniform mass-energy stratifies,
   1. a globose-conduit detention, upper retention least transport-fluid height,
   2. heaviest fluid topside, inside narrowest PPLD widths, conduit breadths, gravity separated nonsteady, nonuniform mass energy into following;
b. uniform atmospheric, detention pressures with detention one-length globose largest free-surface form steadies nonuniform, nonsteady mass energy to a DCCS;
c. narrow PPLD widths, forms' breadths confine heaviest fluid mass with,
   1. heaviest fluid mass modes of energy at highest elevations,
   2. confined heaviest fluid mass centroid raised by narrow breadths,
   3. mass-energy rotations, modes of energy losses minimized;
d. a globose-conduit conduit contained mass inflows entirely into mass-energy;
e. mass-energy mass inflows are topside PPLD forms surface into heavy fluid,
   1. separating, tearing, breaking, releasing heaviest fluid particles,
   2. heaviest particles that are narrow PPLD widths confined,
      a. with natural fluid mass quintessential, core, disposition forms,
      b. displaced contained mass, by or with FESD surface forms,
      c. heavy fluid mass least perimeter least adhesion friction losses,
         1. least cross-sectional area,
         2. least friction coefficient,
         3. inflows mass-energy centroids are below a heavier mass centroids computed for:
            a. mass-energy, perimeter friction, and adhesion least losses;
            b. centroids alignment rotations that tend to lift heavier mass;
            c. flush Apparatus are adeptly fitted into globose-conduit forms;
f. a most of steady inflow outflow fluid mass is through a conduit form,
   1. a DCSS First Sub-outlet PPLD PP of highest mass velocity,
   2. inflows are entirely through a conduit Inlet,
   3. a DCSS FESD form First Sub-outlet discharges continual outflow,
   4. a DCSS globose form passes through rare unusual events fluid;
g. most of energy modes losses occur with a lower one-half of lowest conduit,
   1. manipulations of cross-sectional areas forms minimize mass rotations,
   2. a mainly transport fluid upper retention has least or no friction losses,
   3. from under an Inlet to an outlet DCSS to an Exhaust most energy loss occurs between lowest conduit springing points;
   4. a PPLD form is at highest elevations in respect to its Inlet End 1, an End 1 higher than a globose-conduit is a safety factor convenience,
   5. shrunken PPLD least height and length conforming,
      a. PAP least angle, with best alignment and symmetry,
      b. least perimeter losses, least contained mass, PP lengths least sum,
      c. PP lengths least sum inventions, principles, methods, FESD forms,
         a. with algorithm computing up to smallest elements,
         b. entire quanta subdivided mass computed PP lengths,
         c. with graphical prototypes scaled measurements,
         d. with laboratory testing confirmations;
h. mechanics of forms mass-energy absolute highest conserving globose-conduit perimeter forms, conforming quantum mass least rotations classic genome Sets,
   1. globose, spherical form conforming mass retained mass-energy,
   2. retained mass-energy least surface perimeter globose, spherical form,
   3. least surface perimeter friction, adhesion mass-energy losses,
   4. heavier mass least retained mass-energy rounded conduit form,
      a. with statistical analysis of heavy fluid mass-energy inflows, rate,
      b. with conformance to PPLD width of band and length forms,
      c. retained mass-energy least surface perimeter conduit form,
      d. least surface perimeter friction, adhesion mass-energy losses,
      e. amalgamated with upper retention that is a low friction fluid,
   5. least PAP angle, PP lengths, sum of, PPLD height and length forms;
i. universe of Globose-conduit mechanics originated from unique genome form,
   1. retention genome graphical intellectual, inclusion, exclusion shown,
      a. illustrates retention unique genome globose-conduit forms,
      b. unique genome form universe domains;
   2. globose-conduits evolve or devolve conforming-conduit forms contained least mass into out of globose, spherical contained mass retention least surface forms;
   3. amalgamated globose-conduit forms rotate, mutate, transpose, transfer to contain, retain, detain and transport highest conserving mass-energy modes made up of mass-energy contain, detained, transferred phases;
   3. globose conduit forms manipulated cross-sections areas manipulate, raise a smaller heavy fluid mass centroid ahead of larger transport fluid mass, or vice versa detain transport fluid to pant-up hydrostatic pressures for heavier fluid mass confined discharge four times;
      a. under an End 2 undersurface a least height separated from a PPLD lowest surface form at highest elevations,
      b. with gradual devolution from a globose to a rounded, or called for by statistical analysis of fluid mass composition, rate to a curvilinear globose-conduit conduit perimeter transition form,
      c. with a DCSS form First Sub-outlet conduit form with a higher energy, smaller heavy mass pushed ahead of a much larger globose detention transport fluid mass; a forth time is with Industrial forms DCSS areas manipulation with transport fluid discharge through Second Sub-outlet;
   4. globose-conduits are classic perimeters alongside globose, spherical, with parallelism to homogeneous round conductors as described,
      a. a globose-conduit's globose area height vary, from about 5% to about 95% of entire cross-section height, globose breadths manipulated up to orders of magnitude greater than a venting pipe (the first application shown up to three times greater);

inventions, principles, methodologies quintessential highest self-preserving, self-conserving, core, natural mass energy modes dispositions is globose-conduit universally manipulated forms, Sets, and domains that constitute unique origin universe is as follows:

quantum mass conforming PAP, PP, and PPLD energy demand self-preserving, self-compliance to mass energy, omnipotent force fields make Sets' conforming forms, globose-conduit energy conserving universe of conformed forms Sets, herein,

gas, air, and fluid mass inflows outflow through a vented discharging pipe;

globose-conduit classic cross-section areas, perimeters, surface interface forces at boundaries, and mass centroids respective locations are computed for least or no rotations about fluid mass “flow control” mass and energy highest conservation;

basin-outlets least Set includes Inlet forms inside, a conforming retention mass, a globose form transported detention, and said Inlet fluid mass outside of said basin-outlet;

continued first application FIG. 1-2, 10-12 versions show conduit Inlet least height that is barely outside of a basin upper casing; a conforming and a detained fluid mass make up retention mass; the former precludes venting or backups, the latter moves mass; fluids free surface essential elevations pass largest size submerged particle through a First Sub-outlet and DCSS forms;

inlet inflows provide paths-of-passage, PP, mass potential, kinetic energy modes sum; an Inlet End 2 separation from a PPLD form barely exceeds largest particle sizes;

for drain traps, a globose End 2, a globose-inverse First End undersurface lowest point elevation is globose conduit springing points' elevation;

transition region cross-section areas are from conduit to globose springing points; cross-sections fluid structure interface perimeter are two symmetrical smooth curvilinear lines which connect lower conduit upper globose cross-section perimeter springing points ranging from a rounded cross-section to a globose area having springing points breadths a multi order magnitude wider than those of its counterpart conduit form springing points;

within transition region FESD forms make up permanent retention conduit forms, wherein permanent retention is a mass-volume that precludes venting of gas or backups;

transition region fluid mass least rotations computed viscosity least friction, least breadth or height cross-section area forms having highest conserving modes of energy are listed FESD forms that seamlessly convert classic globose retention into conduit forms;

generic claims' PPLD forms constitute a part or a counterpart to FESD forms;

for purposes of presenting describing, depicting, the following free falling fluid mass is taken generally for an entire End 1 cross-sectional area under continual hydrostatic pressure;

globose-conduit conduit springing points constitutes an elevation no higher then conduit entire height; rounded conduit forms may make a Trough, a Trough inside a Trough, or Troughs inside Troughs curvilinear forms, a Ridge, a Partition FESD lowest surface forms with sides slopes constituted transition region forms complete complement;

especially Trough(s), Ridge(s) including upright, Partition(s), or indented Ridges as turning veins Troughs, along with End 2, First End basin lower surfaces, side surfaces includes Dimensions 44 spaced counterparts among listed FESD forms, for PAP upright plane symmetric fluid mass radial outflow, inflow into a basin-outlet, ordinary trades or crafts fabrication scale to arts sciences microscopic near infinitesimal units of mass FESD forms complete engagement of globose-conduit retained, detained fluid mass constitutes a range of FESD forms complete complement; first and foremost globose-conduit forms constitute open channel conduit forms that contain, retain, detain and transport fluid mass energy with highest conservation of both, including rare events such as high hydrostatic pressures, a hundred year, or once in a lifetime storms;

for a PPLD form slope rise, in tandem, increases its area form side surface slopes into narrower breadths that with cross-sections height narrows transition region breadths, giving upper retention, globose form breadths curvilinear or elliptical upright major axis forms; forgoing algorithm computing methodology carries out to a highest computational accuracy cross-sectional areas and perimeter fluid mass forms for least or no entire fluid mass rotations in PAP upright plane toward highest conserving of mass energy modes; a PAP upright plane horizontal orientation in space constitute absolute symmetry of forms up to DCSS springing points elevations having least or no detrimental retained, detained, transported fluid mass rotations constitutes in PAP upright plane symmetry said “flow control means” laminar fluid mass;

globose gravitational field energy modes classic containment spherical, globose highest energy modes genome classic forms retain mass units constituting computed least resistance paths, said paths-of-passage, PP, lengths least sum that here applies to retained, detained, and transported nonsteady, nonhomogeneous, and nonuniform mass; conduit forms must exist for transfer of energy modes; generic claims PAP, PPLD, PP with PP lengths least sum defines confined mass modes of energy transfer self-conservation with units of mass PP of least resistance make up of basin-outlet classic globose-conduit forms conformed embodiments, Sets; said PP lengths least sum computes open channel fluid said centroid locations and least height classic forms for retained and transported fluid mass with least or no rotation forms, for ordinary design use, with infinitesimal elements designs for scientific purposes; practical construction purposes, crafts finest tolerances constitute said finest units, least mass, lowest surfaces, slopes, shortest or least height, length, and said stated required construction implements stated principles that conserves fluid mass and energy;

each breadth different width above PPLD width of band highest elevation makes on infinitesimal scale a stair step like change; a step constitutes summation of mass units widths that make least resistance paths of least elevations derived by said PP lengths least sum; forgoing statistically compiled fluid mass properties, especially specific gravity of particles, into curvilinear forms computing methodology for influx of units of fluid mass constitutes each mass unit path of least resistance that algorithm amalgamates into entire mass PP with lengths least sum; units of mass PP lengths least sum makes lower cross-sections a viable conduit area with a perimeter form; by definitions, inverts of globose-conduit forms, PPLD width of band horizontal segments, constitute highest elevations; a horizontal chord, breadths at respective elevations, by PP lengths least sum computing is a least transfer of kinetic to potential mode of energy, highest conservation for fluid mass and energy; rising PPLD widths with length constitutes potential energy increase, while descending PPLD cross-sections respective breadths, conduit horizontal chords, lowering of elevations with length is potential to kinetic mode transfer highest energy conservation for statistically compiled fluid mass and energy composition, foregoing methodology for cross-section areas, perimeter computed effects least fluid mass least rotations in a PAP plane of symmetry, which requires exact areas and perimeter forms with length; with no PAP upright plane rotations, units of mass moves are confined by surrounding units of mass at respective elevations or move down, up governed by mass units' specific gravity; in chords, breadths, horizontal planes units of mass are confined by surrounding units of mass eventually confined by cross-sectional area form perimeter form which implements least or no rotations in PAP upright plane of symmetry, least or no rotations in horizontal planes for no fluid mass energy influx changes; said changes require at least a change in retention free surface elevations and that also require areas, perimeter change effected by aforesaid computing for highest probability statistical fluid mass influx, outflow balance; this requires a continual slight narrowing of conduit forms lengthwise breadths with an even smaller transition region breadths increase toward a DCSS or next Inlet fluid mass influx, which constitutes immaterial change for crafts, trades fabrication; upper globose and transition region cross-sections computed similarly makes complete complement of forms that constitute cross-sections classic areas and classic perimeter of entire globose-conduit Set of nonhomogeneous, nonuniform, nonsteady fluid mass FESD forms;

a PPLD constitutes globose-conduit unit of mass lowest path of least resistance for said globose form conforming least mass, fluid mass least height conduit form highest elevation highest conservation of fluid mass energy conversion from kinetic to potential mode; gravity force pulls higher specific gravity particles toward a path-of-passage-of-least-energy-demand, PPLD, with lighter particles moved to equal or low specific gravity mass higher elevations; confined by narrowing of a globose, conduit ascending spout, heaviest particles are squeezed into a PPLD narrowest width highest slope single largest sphere that just passes through said spout rounded lowest surface area cross-section that is said PP lengths least sum FESD form; surrounded by highest specific gravity transport fluid mass of highest viscosity said largest sphere is pushed in back pulled by transport fluid drag while allowed to rotate in PPLD direction toward summit without rotations of entire fluid mass, sub-outlets, First Sub-outlets, detention fluid free surfaces essential elevation height is said largest sphere passing through Sets submerged height elevation at summit;

an End 2 undersurface is located at about one half of upper retention depth that with a free fall locates inflows mass centroid into a lowest ¼ of a basin retention depth; ignoring viscosity friction, adhesion, at a DCSS form, velocity of water at depths below a fluid free surface equals the square root of twice gravity acceleration times a fluid depth;

high specific gravity inflows, outflows fluid mass is entirely through lower conduit form of globose-conduit cross-sections, globose-inverse First End located about one half of basin retention depth is entirely consistent with said heavier mass inflows, outflows;

ordinary fluid mass retention outflows are mostly through a lower small conduit cross-sectional area of a globose-conduit composite, ahead of a larger detention mass;

unusual, out of ordinary fluid mass outflows pass through globose cross-sectional forms;

heaviest mass centroid short height to a summit is most mass energy conserving; a globose-conduit shallowest retention also has heaviest fluid mass most raised centroid;

globose-conduit least conforming retention mass of least height of least rotations is least magnitude potential, kinetic exchanges of energy modes, kinetic potential energy mode exchange has rotational friction and viscosity losses; compared to round or similar piping, globose-conduit Sets forms complete complement amalgamated, least mass, least conforming retention, least rotations multi raise retained mass centroids, PPLD forms to highest elevations for modes of mass energy highest conservation; less is more, more is less, less energy transferred conserves mass, energy either one or both; Least rotations of least mass centroid at highest elevation a least height from fluid free surface set at highest elevations have Sets' forms highest conserving mass modes of energy; narrowest conduit breadths move heaviest fluid mass higher into entire cross-sections form, raising its mass, area, perimeter centroids to highest elevations matched by globose breaths, PPLD forms, fluid mass highest elevations, energy modes highest conserving;

least conforming fluid mass least rotations constitute least rotational frictional, viscosity loss higher potential, kinetic energy exchanges magnitude, mass energy highest conservation; globose-conduit conforming detention least height globose largest breadths, lengths raise entire mass centroid elevation eight times, once for each of four horizontal direction that is in unison with the other three, repeated again four times for conforming globose mass retention at rest, with fluid free surface elevations as kinetic, potential energy modes exchanges governing reference for least energy demand with PPLD forms at highest elevations; as a system amalgamated globose-conduits raise fluid mass centroids three times once for each globose conduit forms raised mass centroids once for highest PPLD elevations; globose-conduit sewer lines detention basin-outlet least mass conforming retention fluid mass centroids rotations are least distance from fluid free surface which makes for highest conserving mass energy modes balanced exchanges that inflicts least abuse or damage to earth's ecosystem mass energy balance as it follows energy balanced modes for conforming least mass least rotations conserves mass energy;

a detained larger mass at insignificant or no energy loss is conserving mass energy; globose forms detain transport fluid mass that counterpart conduit uses to transport mass;

pent up initial hydrostatic pressures cause discharge of nonhomogeneous heaviest mass, particles; pent up initial hydrostatic pressures are to fluid free surface essential elevations, only;

a globose-conduit conduit outlet, First Sub-outlet, DCSS greatly narrowed breadths with much larger globose breadths adeptly manipulates PP pent up hydrostatic pressures;

detention large breadths, lengths mitigate nonsteady mass flows to a least change from conserving mass energy fluid free surface highest elevations respective hydrostatic pressures;

herewith listed, also referred to, FESD specific forms are part of FESD globose-conduit forms whose specific purpose is prevention or restriction of fluid mass rotations for highest conservation of energy exact transfer of kinetic to potential energy requires energy path-of-passage-of-least-demand, PPLD, for a unit of mass that passes a summit; for near frictionless transport fluid critical path lengths are those against gravity direction as then mass energy required contains 32.2 (ft/sec; squared) multiple; smallest entire mass makes for least mass that requires said multiple for highest conservation of energy; such mass must preclude venting or backups found by nearly universal or ubiquitous empirical use conforming least mass contained by most compact least volume spherical modified to a globose form units of mass constituted PP lengths least height forms; nonhomogeneous fluid mass paths-of-passage, PP, lengths least sum contains horizontal components, also; conduit inverts, fluid mass units energy paths-of-passage-of-least-demand (most energy required), PPLD, identical PP length forms are referred to as such;

nonhomogeneous, nonsteady nonuniform conforming least mass high conserving energy modes fluid mass least rotations globose-conduit complete complement PP lengths least sum retention genome round, rounded, curvilinear forms has these globose-conduit transpositions,
round or rounded areas transposed to a conduit, an intermediate, and a globose form area higher centroids of retained fluid mass potential and kinetic modes of energy;
transposed round, rounded conduit cross-sections, fluid mass essential height as for a First Sub-outlet, constitutes fluid mass least rotations curvilinear least height form,
least rotations curvilinear fluid mass forms raise centroids of following,
fluid mass perimeter, FESD structure interface curvilinear surface, thus
viscosity, cohesion, adhesion, and solids surfaces friction centroid,
boundary layer perimeter laminar respective forces centroid location, as
transposed centroids, forces constitute one common centroid force with least rotations, for fluid mass varied compositions respective least height forms,
breadths, breach least height FESD make for fluid mass forms least rotations,
contained, retained, detained transported fluid mass-energy phases forms least PPLD width of band, lower conduit perimeter, and quintessential, core, self-conservation, self-preservation for a quanta mass form least height, a mass centroid highest elevations;

thus, a classic globose upper retention form and a classic lower conduit form constitute elevations of fluid free surfaces that is for a transfer of energy mode near or at highest elevations; a classic globose lower form amalgamates a lowest surface shrunk PPLD conduit form at highest elevations which conserves most of fluid energy transfer to potential mode to transport highest specific gravity fluid mass specifically effected by said classic conduit to globose form transition region, said PP lengths least sum of finite to infinitesimal retained fluid mass inherently constitutes self-conserved preserved energy highest conservation paths of least resistance which make open channel transition region of globose-conduit fluid mass forms; said globose-conduit transition region computing of forms forgoing figures wherein globose-conduit conduit basin-outlet, Inlet fluid mass forms may constitute an Inlet contained fluid mass outside a basin-outlet, especially fluid mass and Inlet forms that precludes suction or venting; transition region forms conserve fluid mass energy with computed highest elevations of PPLD and fluid free surfaces least height difference constantly continually that with a conduit form fluid mass constitutes an essential height; said PPLD constitutes lowest surface rounded form unless fluid mass highest specific gravity are highly uniform inflows that PP lengths least sum computes to a round form; rounded lowest surface forms constitute highest elevation for a statistical continual inflow rate that constitutes fluid mass detention wherein said inflows of a nonhomogeneous, nonsteady, nonuniform fluid is accounted for by lowest surfaces PPLD forms; for statistical standard deviations higher inflow rates rounded forms open into PP lengths least sum computed wide form of low slope sides surfaces or parabolic horizontal major axis forms; highest elevations PPLD forms govern unless cross-sections breadth or breach computed PP lengths least sum mandates a PPLD lower form;

shrunk PPLD forms rounded, elliptical upright major axis, or curvilinear globose-conduit forms makeup, transition region forms, PAP angles less than 180 degrees, and PP lengths least sum forms complete complement constitute claimed universe fundamentals,
a PAP two points as “surveyor stakes” that space align fluid mass energy forms with conduit, globose springing points constituted lower, upper transition region limits,
“self-designed” conforming PP lengths with least sum, fluid mass least energy resistance paths constituted fluid mass perimeter surfaces that are globose-conduit forms,
said PP paths as “self-designed” units of fluid mass paths that use least energy,
said PPLD forms as “self-designed primary paths” most efficient energy forms,
said classic retention genome, as contained retained energy genomes “parent”,
mass units' paths of gravity force least resistance is said PP mass energy modes quintessential highest conserving, self-preservation with natural disposition visible forms,
most self-conserved preserved fluid mass energy self-generates least magnitude of energy modes full transfer most shrunk PPLD form, globose-conduit compact forms;
said “parent” near spherical classic conforming retention amalgamates, its outlet conduit to make up highest conserving fluid mass energy globose-conduit Sets;
said infinitesimal units of mass PAP symmetric orderly outflows, inflows into, out of classic retention genome form as “old”, “new” units of fluid mass and energy;
said fluid mass energy units as “participants” in “parent” mass energy universe;
said laminar flows mass units as a “confined unit” for fluid mass energy forms;
mass units PP lengths least sum makes least PAP angle unique Set symmetrical forms through a discharge-cross-section-surface, DCSS, and springing points elevations,
globose-conduit forms are within “genus” conforming “citizens”, Sets, by PP lengths least sum fluid mass energy highest conserving forms that constitute its universe,
lower globose basin globose forms amalgamate into a rounded or a curvilinear globose-conduit, First End, outlet, Sub-outlets, FESD, and DCSS FESD respective forms,
a Paths-of-passage compute PP lengths least sum, globose-conduit, PPLD, FESD retention conforming least fluid mass least rotations PAP upright plane symmetric forms,
classic genomes Set of forms conforming retention least mass least height is mass modes of energy highest conservation thus PP lengths (least resistance) least sum,
quantum units of mass PP least sum amalgamates mass units' paths into least height shallowest retained mass genome forms mass energy modes highest conservation,
genome Sets make for retained fluids least height, conforming least mass potential, kinetic energy modes quantum mass units least sum amalgamate into fluid mass and forms Sets,
said PP lengths least sum for a form constitutes a conforming or a genome form, genome forms complete complement conforming embodiments are genome Sets,
embodiment forms PP lengths least sum causes nonhomogeneous fluid mass conforming permanent retention kinetic potential energy modes passing heaviest particle,
heaviest particles, highest specific gravity mass PPLD entire length least height form, conforming retention least mass, height, and energy modes inflows transport mass through PP, quantum mass least rotations, mass energy physical forces compute a conforming embodiment,
a PPLD units of mass paths to summit topside PPLD width of band surface forms make for least rise slopes for said mass units PP lengths least sum narrowest breadths,
outlet FESD and DCSS forms PP lengths large breadth upper area cross-sections higher than globose forms springing points elevation limit fluid free surface rises to hold least height, least conforming mass fluid retention kinetic energy transfer to potential energy mode,
further fluid free surface rise potentially wastes both,
a greatest particle height constitutes a free-fluid surface detention essential elevation, PP lengths least sums lowest elevation and First Sub-outlet forms least height,
essential detention free-surface elevations require no kinetic to potential energy energy-demand transfer required for continual mass and energy highest conservation,
open channel globose-conduit forms nonhomogeneous fluid solids mixtures mass energy self-preservation containment, detainment, and transport are within one form,
globose-conduit forms contain Inlet retention and forms, that altogether inside a basin-outlet constitutes a globose-conduit conforming least mass least forms Set high modes of energy,
quantum-mass PP complete complement computes Sets' least resistance forms;

generic globose-conduit claims: path-angle-of-passage, PAP; path-of-passage-of-least-energy-demand, PPLD; paths-of-passage, PP, with a least sum constitute fluid mass globose-conduit conforming embodiments self generated Sets; globose universe conforming embodiments, Sets genus, is generic claim classic Sets conservation of mass and energy of fluids and solids mixtures that originate from said classic unique retention form genome; a PP, paths-of-passage, lengths generic claim to algorithm computed least sum is energy balance for entire retention mass quantum mass upright components with gravity acceleration multiple which through reiterative process arrives at fluid mass and structure forms interface ultimate Sets, genomes; forgoing specified at least two points aligns Sets to a linear PAP least angle alignment and symmetry of forms; genomes best construction of surface forms narrows the first application globose conduit construction and forms tolerances to commercial, industrial forms herein said complete complement of completely matched forms of Sets; sciences, art fields' nuclei or subatomic, microscopic or submicroscopic complete complement of forms is quintessential of globose-conduit potential, kinetic near infinitesimal quantum mass energy modes transfers perfection that is beyond human skill to create or duplicate;

globose-conduit conforming embodiments classic universe forms contain, retain, detain, transfer and conserve mass energy that transposes globose-conduit, open channel, nonhomogeneous to homogeneous high pressure round water pipe, electric wire or vice-versa or round, globose, spherical retained mass with generic PP lengths least sum claim;

microbes microscopic, submicroscopic thin disk or short rod line like, single form cells contain, retain, transport, or detain submicroscopic ecosystem inflow, outflow mass constitute an Inlet, a basin-outlet forms of globose-conduits basic types least Sets make;

conforming embodiments conforming least mass, height, hydrostatic pressures, surface area, quantum mass rotations, PP lengths least sum thus frictional losses makes for mass energy constituted highest self-conserving globose-conduit universe FESD forms, Sets, and domains; globose-conduit forms forgoing properties are highest mass energy conservation from infinite to infinitesimal ranges constitute highest “best mode of operation” over existing and prior patents; least separation of heaviest mass and detention transport fluid mass centroids require less transport fluid mass and its energy; two, three dimensional FESD forms of globose conduits much wider breadths larger area compared to entirely round or otherwise similar conduit forms hold transport fluid mass with least or shallowest detention, retention mass height that is set at highest elevations for respective Set fluid mass inflows, outflows; for continually raised heavier fluids centroids toward a DCSS with entire fluid mass least or no rotations in PAP upright plane makes for highest mass and energy, especially transport fluid mass variable inflows with specific gravity variations mass, energy conservation;

frictionless fluid least rotations consume least to insignificant amounts of energy modes; globose-conduit systemic highest self-conserving energy modes retains, detains, and transports manipulated mass energy mass, area, and perimeter centroids as follows,

two PAP points align upright plane symmetric globose-conduit forms flexible to rigid least Set rotated forms to a finite or infinitesimal PAP angles accuracy analogous to “positioning members” with forms having up to near infinitesimal “flow control means”,

globose-conduits PP make paths of least resistance cross-section areas breadths for fluid free surface least elevations difference from PPLD forms at highest elevations,

sets contain retain detain, and transport nonuniform, nonhomogeneous, nonsteady classic area, perimeter conforming least mass, height, fluid mass for least or no detrimental rotations;

globose-conduit quintessential fundamental, evolutionary, natural, highest self-conserving self-preserving superiorities self-generated mass energy forms is as follows,

1. globose-conduit mass inflows preferentially distribute transport energy modes into heaviest fluid mass PP, PPLD forms at highest elevations with respect to its summit,

2. globose-conduit forms push highest specific gravity mass ahead of a transport fluid mass at three locations: a) under an End 2, b) prior to a summit, c) after a summit,
a. under globose End 2 least conduit height, with a lowest PPLD form at highest elevation, with separations that need not exceed much inflows mass largest particle size,
b. with narrow breadths conduit transported heaviest mass risen centroid pushed in front, ahead of detention mass ahead of a First Sub-outlet by conforming quantum mass least rotations,
c. passed summit with transport fluid greater drop into pushed ahead heavier fluid mass similar to fluid mass Inlet inflows, accentuated by Industrial Sets heavy, transported fluid mass passed through a lower First, a higher Second Sub-outlet forms, respectively,

3. a globose detention in tandem rise behind a risen transported mass centroid,

4. transported, transport fluid tandem raised, lowered respective mass centroids,

5. a much small transported mass in front of significantly larger detention mass,

6. compact retention, detention highest mass centroids in respect to its summit,

7. highest mass centroids a least distance, rotations from a respective summit, constitute a viscosity, boundary layer friction conforming retention least mass modes of energy least losses,

8. a narrow conduit breadth at summit raises up globose detention pressure,

9. a globose-conduit, one-form, least energy modes demand raised detention pressure, heaviest mass centroid retains or detains, transfers mass energy highest modes; kinetic, potential is useful energy mode; least mass rotation is conserving both,

conserving of both is because energy modes are least energy demand transfers,

quantum mass energy modes are exchanges for inflows mass energy same sum,

10. a globose detention mass pant up pressures separate, dilute, or dissolve a transported mass in its path with raised centroid least apart from transport mass centroid,

11. open channel forms adeptly manipulate energy-modes gravity force caused,

12. globose-conduit nonhomogeneous nonuniform nonsteady modes of energy mass, cross-section areas, perimeter centroids align for highest mass energy conserving,

13. generic PAP, PPLD, PP lengths sum, conforming embodiments, evolve or devolve globose-conduit forms into round or entirely round conduit cross-sections and or globose spherical or spherical retained mass forms that rotate, mutate, transpose, transfer, make unique origin universe highest conserving mass energy phases, Sets, and domains,

14. globose open channel basin-outlet spouts manipulate, adeptly amalgamate mass energy modes one-directional linear or circumferential globose or circumferential cross-section areas of retention, detention that otherwise requires three-elbows assembly,

globose, circumferential are highest self-preserving mass energy two strains of forms; a one-directional less than 180 degrees alignment is one within cosmos' gravity fields,

15. self-conserved energy process among naturally evolved or man made forms constitute classic chains with globose-conduits as natural, quintessential dominant links,

16. fluid mass forms of energy, composition, and physical properties highest self-conservation globose-conduit forms evolve into classical round forms and vice versa,

17. a transport of high specific gravity mass heaviest mass classic globose-conduit detention PP lengths least sum height mass energy absolutely dilutes, tears up, disintegrates, moves or transports which conserves useful energy modes mass energy, a fluid mass air is controlled into out of open channel forms as an enclosed boundary,

18. basin-outlets least Set includes Inlet forms inside, a conforming retention, a globose-conduit transported detention, and an Inlet fluid mass outside of its basin-outlet,
a. conserving mass energy inside enclosing boundaries; mass energy modes stated inventions, principles, and methodologies requires respective boundary of physical, nuclear molecular, living cells chemical mass energy modes forms,
b. contained modes mass energy forms require at least one enclosing boundary,
c. globose-conduit open channel forms transport of fluids and solid particles of nonhomogeneous mass energy is comparable to round pipes, electrical wires transport of homogeneous mass, energy, and atomic subatomic round forms retained mass, energy;
d. paths-of-passage lengths least sum amalgamates nonhomogeneous, nonsteady, nonuniform, mass-energy units viscosity, adhesion, cohesion and fluid structure interface perimeter boundary layer adhesion, friction into highest mass energy conserving forms,
e. classic globose-conduit genome forms constitute classic perimeter form Sets; globose-conduit principles, methodologies are homogeneous mass applicable; partial suctions of globose-conduit smaller than ubiquitous permanent retention is safest quickest recovery of upper retention of highly conserved fluid mass and energy,
f. a rise in globose-conduit, basin-outlet PPLD band in tandem with narrower lower conduit cross-sections breadths is completely complimented by transitions regions least height wide globose breadths forms having essential height or greater elevations,
g. mechanics of forms contain modes energy highest sum at highest elevations,
h. a retained fluid mass defines a lower retention, an upper retention and a detention form; an upper retention at rest makes a free surface; a detention makes a free surface that is higher than said free surface at rest,
i. globose-conduit said fluid mass energy least sum PP lengths are one forms for highest statistical-probability of nonhomogeneous, nonsteady, nonuniform, retention detention least PAP angle, quanta mass least rotations, FESD forms PP lengths least sum classic perimeter forms that contain, retain, detain, and transport fluid mass energy of globose-conduits, which themselves constitute FESD forms;

domains of globose-conduit universe FESD forms with said PP lengths least sum surfaces restrict rotations of mass in three orthogonal planes especially prominent among named makeup Troughs, Ridges, Partitions, globose End 2, globose-inverse First End forms and undersurfaces, doming Cavities, Bridging-Wall, Fin and DCSS FESD forms; troughs raise globose forms sides lowest surfaces wherein Ridge, Partition FESD forms raised PPLD lowest surfaces into two PPLD higher elevation forms; troughs, Ridges and Partitions are globose conduit forms integral parts concepts that raise heaviest fluid mass centroid twice, once as a part of globose-conduit forms lowest surface highest elevation raised with a presence of such forms makes least fluid mass least height narrower breadth two cross-sectional areas to thus again raise nonhomogeneous heavier mass centroid; a narrower PPLD form initiates earlier lowest surfaces rise with narrower breadths constituting lowest, lower surfaces faster rise by said FESD forms;

figures of globose upright, angled to about upright, angled, industrial, low angled, Inline, inverse and hybrid forms claim globose-conduit universe of Sets, forms, hybrids, migrations, mutations, entire G-C universe domains, genomes, along with classic forms classic perimeter Sets inventions, methodology, and principles, and concepts disclosed;
energy and fluids mass finest elements algorithm computed PP lengths least sum perimeter boundaries constitute science academia infinitesimally exact fluid mass energy perimeters; plugs, Caps Portals, and nozzles are replaceable by continued streamlined surfaces; nozzles especially high inside an Inlet is tolerable as fluid free surfaces at this elevation is at or above said detained fluid mass essential elevation; sidelong Sets make for one-directional PP lengths sum; a sidelong offset to an anti sidelong, a near upright Inlet is respectively closer to respective DCSS forms, PP forms and PAP aligned save mass-energy, Trough, Ridge, Trough-Ridge, Partition, or Trough-Ridge-Partition FESD removes and or manipulates excessive mass-energy PP bundles, FESD forms conserve fluid mass-energy by a reduction of mass or mass rotations or both;
the first application specifies gravitational field forms that contain, retain, detain, and transport modes of mass energy; continuations, this application continues describing forms process to one that has mass and energy conservation laws, conforming conditions, to energy-modes transfers including boundary, perimeter, energy losses to define forms; no maximum or minimum boundary conditions restrict generic claims PP PAP, PPLD, conforming embodiments, other than universal laws of mass energy conservation which allows for various conditions of various conforming boundaries to define modes of mass energy phases conserving conforming embodiment forms, Sets, and domains; the first application first paragraph embodies piping universe without an exception; unrestricted mass modes of said piping universe and globose-conduit forms are one space universe; globose-conduit perimeter forms are imposed boundary conditions for a quantified mass energy highest self-conservation self-preservation graphical visual illustration of useful, contained, quintessential, mass energy phases' perimeter; continuation applications revise restrict, by said generic claims boundary conditions, perimeters of the first paragraph of the first application to quantum mass PP lengths least sum computed mass energy highest conserving perimeters;
by imposing ecosystem universally most friendly boundary requirements, entirely releases, removes artificial, unnatural boundary conditions quantum mass PP quanta mass constitute entire universe, cosmos contained, retained, detained or transported phases of mass energy bodies with gravitational energy or force; omnipotent potent contained one-mass energy forms constitute globose spherical, spherical perimeters gravitational field of same forms with intellectual boundary surface visualization enclosing gravitational force field energy; orbiting mass energy modes phases detained by its omnipotent gravitational energy mass constitutes potential conduit forms; analogous parallelism on atomic scale is nuclei mass energy spherical forms contained mass energy with orbiting electrons that constitute a perimeter form that allow inflow outflow of other electrons as an omnipotent atoms mass energy respective detention;
mass energy inflows, outflows on microscopic, submicroscopic scale constitute an inlet, an outlet with a single cell, or a most primitive organism globose or cylindroid detention forms with cell membranes boundary as conforming conditions perimeters; partitioned mass energy conservations subdivide into globose-conduit cells; accepted omnipresent parallelisms among mass modes of energy forms by universal mass and energy conservation laws herein extend to nonhomogeneous, nonuniform, nonsteady mass energy respective phases of mass energy perimeter forms;

globose-conduit classic forms contain detain and transport nonhomogeneous fluid comparable to subatomic, atomic; microscopic, submicroscopic; high pressure water pipe or electric wire classic forms, perimeters contained, detained, and delivered mass energy;
straight lines constitute mass energy highest conserving path between two points; a straight-line path away from a rotating mass traces a circumferential path in respect to its starting point; a linear, a circumferential PAP constitutes two most conserving mass energy paths of quintessential, core, or natural disposition, each with perimeter boundary respective conforming conditions; a linear or a circumferential PAP of equal boundary conditions PP lengths least sum with equal quantum mass equal energy have an equal core, quintessential, perimeter form and vice versa, wherein least or equal is not exact; globose-conduit and globose-circumferential universe domains of Sets PAP angle paths constitute a finite linear increment in upright plane with counterpart orthogonal upright plane containing a quintessential core image of highest preserving mass energy natural disposition perimeter; said image at best is statistical approximations derived with its exact form that is perfection beyond human skill ability to compute or construct;
a PPLD form defines a conduit perimeter for containment of mass energy modes or mass energy perimeter dissipates into ecosystem, universe mass energy natural disposition boundary perimeter forms;
as with other modes of energy, globose-conduit perimeter forms universe extends from microbes' submicroscopic, atomic subatomic to a cosmos makeup or vice versa; as most self-conserving mass energy modes exchanges quintessential, core, natural disposition form, globose-conduit forms classic perimeters alongside spherical globose form constitute parallelism analogy to homogeneous mass energy round conductors; as created suitable boundary conditions allow, quintessential, core, natural disposition of mass energy self-conserving, preserving will result in globose-conduit perimeter forms; unless globose-conduit boundary perimeter condition laminar mass perimeter is maintained a globose-conduit highest conserving mass energy quintessential, core, or natural disposition perimeter readily dissipates;
globose-conduit Sets make spouts lower surfaces contained fluid mass-energy one-transformation half-mode cycle, kinetic to potential energy highest conservation and PPLD FESD least height and length forms much shorter than are those of ubiquitous art;

a Nozzle FESD form may constitute a part of its End 2 undersurface form;
spherical globose highest energy modes genome classic forms retain mass units constituting computed least resistance paths, said paths-of-passage, PP, lengths least sum;
Inlet inflows provide fluid mass potential, kinetic energy modes with PP energy;
a PPLD width midpoint, said undersurfaces one point align tangentially for a Set of forms having a PAP direction horizontal orientation, PAP upright plane symmetry, and a basin-outlet rotation through a PAP angle in respect to the gravitational direction;
energy transfers cycle contained potential and kinetic mass-energy modes; forms of PPLD least height and length constitute PP least demand for transfer of energy-modes;
potential to kinetic mode quantum mass transfers constitute units of mass PP three components length; upright quantum mass-energy units contain the gravity acceleration multiple for computing quantum mass kinetic energy quanta sum that is PP lengths sum;
a fluid mass volume form with a center of mass located at a higher elevation or closer to a DCSS form constitutes conserved conforming mass energy conforming PP lengths lower sum;

globose-conduits correlate nonhomogeneous, nonsteady, nonuniform high mass energy conserving to elevations breadth specific deviations from lower to upper springing points breach;
an upper retention quanta mass conforming retention constitutes retained fluids surface-tension, adhesion height higher than a globose End 2, a globose-inverse First End undersurface, horizontal, radial, infinitesimal width highest finite increment continually entirely submerged;
a lower retention constitutes a region basin-outlet conduit spouts cross-sections forms gradual increase from PPLD width of band forms to said globose End 2, a globose-inverse First End undersurface, horizontal, radial, infinitesimal width highest increment;
a globose-conduit lower retention, smaller, short mass volume unified with a detention, an upper retention, dominant mass volume, least height hydrostatic pressures conserves energy;
basin-outlets, DCSS, PPLD widths of band, and drain lines smaller lower areas of rounded surfaces and narrower breaths than equivalent round areas breadths at a same rise from respective inverts constitutes FESD forms; round or rounded cross-sections length segment constituting said PP lengths least sum constitutes an FESD form part;
an outlet FESD rounded cross-section, DCSS sub-outlets First Sub-outlet height constitutes a fluid elevation height that clears fluid mixture largest submerged particle;
a retained fluid mass free surface elevation differences vary with inflows and are enhanced or controlled by composite forms cross-sections of a DCSS or an outlet FESD, and various Sets FESD forms respective areas breadths, breaches, and heights;
globose forms large lengths and breadths free surfaces areas minimize its rise; outlet and DCSS FESD cross-sections continue lower area conduit forms through a First Sub-outlet height into larger Second Sub-outlet cross-sections which also resists fluid free surface further rise conserving energy by transfer of energy-modes at a lower height;
said PP lengths computed least sum is for statistically compiled particles ranges, volume specific gravity, and shape sizes of mass mixture;
said Sets PPLD form retention volume “at-rest” is half as tall, of shorter length, and has a smaller to several folds smaller retained fluid volume than ubiquitous art forms;

conforming embodiments, PAP, PP, PPLD least quantum mass PP lengths least sum mass energy enclosure constitutes interface surfaces least resistance PP, forms;

inlet inflows provide nonhomogeneous, nonuniform, nonsteady contained retained, detained, transported fluid mass potential kinetic energy-modes;
quantum mass complete complement computed PP(s) are least resistance forms Set;
genome Sets PP lengths least sum makes conforming retention mass least height;
globose conduit, globose-conduit, basin-outlet, G-C, cross-sections are made up of a lower smaller area rounded conduit form, a transition region intermediate area form, and an upper area rounded globose form for a compact composite curvilinear form;
a globose-conduit globose area height can vary from about 5% to 95% of entire cross-section height with its globose form area breadth varied up to three times a breadth of a vented pipe to which its conduit outlet descending spout connects;
a least mass half-cycle energy mode change conserves energy and fluid mass;
a conforming least mass energy modes PP lengths least sum change is a Sets genome;
Sets may constitute genomes for specific fluid mixtures, only;
forms of PPLD band make for PP lengths least sum, conforming retention least mass, least height side-view “5”, “C”, or “S” and “C” forms, a PAP direction and a least angle, smooth fluid surface interface forms, from basin lowest PPLD forms ending with a DCSS form;
a PAP makes an angle less than 180 degrees in respect to gravitational direction, entirely aligns Set forms upright plane symmetric from a basin blind side through at least a DCSS, and upwardly entirely to at least include a globose form springing points;
a summit is a DCSS lowest infinitesimal width finite horizontal increment, outlet ascending spouts and PPLD forms highest infinitesimal end furthest from its respective Inlet, and a fluid tension and adhesion height higher than an upper retention free surface “at-rest” elevations retaining conforming continual least fluid mass, volume, and height;
globose-conduit paths-of-passage-of-least-energy-demand, PPLD, and PAP rotational angles less than 180 degrees that constitute least height basin-outlet PPLD for ascending lowest surfaces highest slopes smaller angles, inherently smaller angles shorter smaller slopes for a shorter entire length, with a smallest conforming retention fluid mass;
globose-conduit forms constitute domains of generic and circumferential strain hybrids of horizontal and upright orthogonal planes rotated globose genus form; generic circumferential globose hybrid domains are claimed as forms of globose domains;
migrations of globose Inlets End 2, globose-inverse outlets First End from basin-outlets blind side to an anti-sidelong location on opposite end of basin-outlet retention forms constitutes Sidelong, Sidelong Offset, Offset Centric, Centric, Anti Offset Centric, Anti Sidelong Offset, and Anti Sidelong Sets;
illustrating and describing a domain Set, entire domain Sets, its hybrids and Sets migrations within entire G-C universe range constituted Sets genomes is claimed together with Sets inventions, principles, methodologies, and concepts for retained fluids mass and energy conserving by globose conduit forms Sets and their circumferential hybrids;
basin-outlets basin upper retention constitutes largely one of five: truncated about largest cross-sections of globose, spheroidal, ellipsoidal, cylinder, or cylindroid forms of a short height that is shorter than a largest horizontal dimension of a respective basin;
globose basin lowest surfaces make largely one of following large forms: a rounded, an annular, a crescent, an about flat to doming annular, and an annular crescent, among many PPLD FESD geometrics forms of single or various streamlined compositions of least surfaces forms;
Inlet, basin-outlet retention forms with PAP upright plane of symmetry horizontal plane rotated about an upright axis, especially its Inlet axis, staying upright constitutes an upright Inlet Set; no perceived deviations from sciences upright make engineered upright Inlets and Sets, here;
a basin-outlet conduit outlet spout ascends from a globose Set First End surface inflection, an outlet basin end cross-section, or a globose-inverse submerged spout form lower end inside a basin-Inlet retention of respective globose, globose-inverse forms;
basin-outlets outlet spout cross-sections are made up largely by one of following FESD forms: a rounded, an elliptical, or a curvilinear geometrics composite areas form;
outlets, DCSS, and Sub-outlets FESD forms constitute PAP upright plane aligned symmetric a lower, smaller, rounded conduit form, a transition region cross-sections, and an upper largest area largely a rounded, an elliptical, a parabolic or a curvilinear form;

globose-conduits correlate nonhomogeneous, nonsteady, nonuniform mass energy conserving to an elevation specific breadth deviations from lower and upper springing points breach for conforming retention fluid mass least height and rotations large free surface form;
flow-energy-surface-dispensators, FESD, PAP upright plane symmetric globose-conduit quanta mass, cross-sections, areas, shapes, heights, breaches, or entire breadths as G-C forms transform globose to conduit forms and vice versa; they make up conforming quanta mass least volume, rotations, perimeters, and PP lengths sum that constitute versions of following forms:
a three-dimensional Set (TD), circumferential, axial or transverse Trough, Ridge, an Inlet upright Ridge a Trough, a Trough in a Trough, a Ridge, a Partition with/without a Window(s), a Troughs-Ridge, a Troughs-Ridge-Partition and a Window(s);
a Disk FESD;
a baffle Partition FESD and a Window FESD;
a Circumferential Trough, a Ridge, a Partition, a three-dimensional Window and a Troughs-Ridge and a Troughs-Ridge-Partition and a three-dimensional Window(s);
a Nozzle local highly directional spout forms;
a globose End 2, globose-inverse First End and PPLD counterpart forms of a Set;
a Bridging-Wall with Domed-Cavities about Inlet forms;
a Fin FESD forms dividing globose-conduit cross-sections upper retention;
a Trough, a Ridge, an upright Ridge, a Partition with/without a Window(s), a Trough inside a Trough, a Troughs-Ridge, a Troughs-Ridge, a Troughs-Ridge-Partition with/without Window(s) upright plane axially symmetric forms;
an FESD manager enhanced control of fluid free surfaces height differences;
an FESD space manager exchange of air and fluid manages retention form free surface areas and elevations, thus cross-sections areas, height, breadth, breach and length;
cavities; dome Cavities FESD;
a rounded End 2, First End; a flared; an infant boot; a Fin End 2 FESD form;
a Migration Dimension(s) 44, (44, 44′);
a crescent PPLD conical form FESD;
outlets, DCSS and globose-conduit cross-sections areas breadth, breach, and height FESD forms managed effects of retained fluid free surface elevations, elevation differences, as counterparts of FESD mangers' and FESD space managers' forms;
flush Apparatus parts, entirely contained within walls of a Set with access to most Set locations, separately or concurrently to disinfect, flush, surface coat, repair or protect damaged surfaces; flush Apparatus prefabricated pre-assemblies use design fluids and or gases, or air, jointly individually or, to a separate sequence and intervals or concurrently, to a surface location or a Set entire with a single, a set, or a nozzles network, with tie-ins, or sets of tie-ins located conveniently about a Set; said Flush Apparatus assemblies are entirely inside conduit walls, except for tie-ins, and capable flushing any basin or Inlet retention space or location, such as, Inlet surfaces and or basin-outlet lowest surface PPLD width of band lengths or an entire length; shown capped a tie-in or at least one of shown tie-ins connects to a tie-in apparatus that may include line sensing device to initiate or stop a design fluid injection should basin retention drop to preset pressures; said Flush Apparatus deliver predetermined fluid, or gas, or air separately or jointly is delivered under controlled pressure to tie-in or tie-ins is discharged through any of sub-nozzles, 301, sub-passageways, 303, major nozzles, 405, major passageways, 304, and passageways, 310, respective branches set of tie-ins, 307, a set of sub-passageways branches, 311, a set of sub nozzles, 314, selectively pre-assembled; specific shape passageways such as upright Ridges FESD, FIG. 8, 12, 16, and, 85-89 depict, a double wall inner space, 310, passageway FIG. 81 shown; a major nozzle 405 spray type flushes entire basin lower, lowest surface and into an outlet and lower Inlet;
a double wall inner space and gravitational direction compliant tubing show and warn expeditiously by dripping leak evidence that a wall leak has occurred;
said Sets exact globose-conduit construction is beyond human creative skills;
a descending outlet spout Second End connects to a vented drainage line with a positive rigid connection, which is one of two connections that support a Set;
connections are generally shown threaded or welded; compression couplings and flexible installed in place rigid with or without gaskets, washers, or bushings, and locked or double treaded or said connections suitable mix constitutes globose Set connections;
a top quality highest accuracy highest pressure moldings of plastics, metals, and their composites and or semi-rigid materials that are adequately rigid or are with positive provisions for sufficient stiffness or a fabrication combination of above makes said Sets;
one-way air nozzles are suction precluding measures; forms constitute smallest mass and height known to stop suction and or venting; forms are to crafts finite or scientific infinitesimal accuracy algorithm computed as needed;
fluids and solids particles of non-homogenous mixtures inflow through an End 1 into globose Set forms and by gravity force outflow through an outlet Exhaust;
inventions not restricted only to highest conservation of fluid mass or energy genomes disclosed narrow highly defined scope of fluid mass, and energy conservation of said inventions, which unify fields of arts and sciences;

this and continuation applications continue the first application specification, drawings scope is narrowed to fluid mass energy conservation by defined globose retention genus forms to the first application FIG. 9 “laminar flow” and its stated description and specification “flow control means” herein FESD forms; globose-conduit Sets originate with the first application open channel Set of FIG. 1-2, and 12; globose-conduit forms shown short height, in respect to length, especially short for the first application shown FIG. 1-2 and 12 Set, connect to building code vented pipe constituting open channel construction, its elliptical outlet descending form spout and channels about basin originates outlet FESD and DCSS FESD forms Figures herein show; the first application FIG. 1-2, 9, 12 stated “transition region” “means” that maintains “the transition region submerged” herein and continuation application numerous Figures define as upper, herein permanent retention extended upwardly from lower conduit form springing points and not taken higher than globose form springing points;

said classic retention genome, prior applications FIG. 1, shows globose-conduit parent form that uniquely originates globose-conduit universe domains of Sets FIG. 1 Set basin-outlet nonhomogeneous, nonuniform, nonsteady fluid mass forms modifies; a Set retains, contains, detains, and transports fluid mass that subdivides into finite units of mass having said PP lengths least sum; units of mass, PP length least sum algorithm, mathematically computes kinetic energy required for each mass unit to pass; a PP least sum constitutes quanta mass quantum mass paths respective path lengths sum with upright components having the gravity acceleration multiple;

figures of this application are the second application drawings; said Figures show open channel forms and are continuation from the first application Figures, especially said FIG. 1-2, 9, and 12; basin-outlet continuations of FIG. 1-2, and 12 shown major axis upright elliptical outlet and DCSS FESD forms and a Trough, a Partition, and a Trough, a Ridge, a Partition of FIG. 12 and FIG. 9 showed upright Ridges, nozzles and diffuser FESD forms; said FIG. 12 shows basin-outlet, globose-conduit forms with capped tubing about basin blind side through upper basin-outlet casing; enlarged, streamlined, said tubing constitutes a Bridging-Wall FESD which with globose basin-outlet makes for domed Cavities FESD forms about Inlet; capped at a specific detained fluid free surface elevation said tubing constitutes a space manager, SM, in respect to retained fluid free surface elevations; said SM not capped but connected to a one-way air inflow having basin-outlet perforations constitutes SM that precludes suction;

much larger cross-sections than those of a vented pipes a FIG. 12 Set basin-outlet spout constitutes and thus will not experience suction; a Flush Apparatus connected to SM outside air inflows is both, a Flush Apparatus and SM, and said perforations extended through walls of said Set constitute numerous Flush Apparatus assembles parts said continuation applications and herein Figures show; globose-conduit computed classic cross-section areas, perimeter, surfaces interface boundary forces, and centroid locations for least or no rotations about fluid mass centroid constitute said “flow control” mass and energy highest conservation;

said classic perimeter PP mass laminar fluid finite segments constitutes viscosity, adhesion, fluid pressure internal and boundary layer related forces with no rotation of fluid mass which is identical for homogeneous mass-energy; classic perimeter globose-conduit nonhomogeneous mass energy forms with parallelism travel across arts, science fields analogous to classic, homogeneous, mass energy round forms; classic perimeters mass no rotations or boundary friction constitutes translational energy mode ultimately conserved mass energy;

ascending globose-outlet spout Sub-outlets make either a rounded, or an elliptical major axis upright, or a curvilinear cross-section area form that passes statistically most prevailing continual detention mass with detention free surface at said essential elevation height that also passes said largest sphere as single most unusual event; globose-conduit classic forms constitute classic conduit forms that evolve or devolve from classic globose retention basin forms that also evolve or devolve into rounded, or curvilinear, or elliptical major axis upright forms; the first application FIG. 1-2, and especially FIG. 12 cylindrical basin-outlet globose form upright cross-sections behind and in front of its Inlet toward outlet, which transferred into elliptical major axis upright forms transposed into a round Exhaust cross-section are an open channel globose-conduit cylindrical versions the generic claims, the continuation applications and herein continues;

said generic claims mass energy self-conserving self-preservations allow computing of accelerated aging whose energy modes among depicted Figures or as described constitute scope of inventions, methodologies and principles of globose-conduit forms; classic globose-conduit spout rounded basic PP lengths least sum forms surfaces, a life span aged or specific events form make up globose-conduit universe respective forms, Sets, Sets' hybrids, mutations and domains, FIG. 16-18 shown Inline domain Sets primarily make up globose-inverse domain forms that with described mutations, and partitioned into multiple-cells, transfer into globose domain Sets; here, FIG. 2, 3, Section A-A forms shown ascending outlet spout rotated to 165 degrees PAP angle with a DCSS, descending upright spout as in FIG. 18 transposes a globose-conduit Sidelong Set to one cell of said Partitioned Inline Set which reassembled into a globose-inverse Set constitutes depicted Inline forms, said Angled domains described forms rotations constitute deviations rotated Sets from upright forms Sets mass energy conforming to the generic claims;

classic globose-conduit, FESD complete complement constitutes least cross-sections, breadths, fluid mass, mass rotations, surface lengths, and energy modes entire energy transfer;

hydrostatic pressure centroids of basin-outlet nonhomogeneous, gravity segregated, transported fluid mass is more than ⅔ of a hydrostatic height below retained fluid free surface elevations;

classic globose-conduit open channel forms complete complement conforming retention has least depth of PPLD forms quantum mass PP lengths least sum highest elevations fluid free surfaces large breadths and thus least PAP angle fluid mass rotations and hydrostatic pressures;

generic claims classic Sets, conduit Inlets basin-outlets open channel with conduit, outlet spouts narrow breadths conforming detained least height mass precludes suction and or venting;

globose-conduit open channel classic forms complete complement conforming quantum mass has the generic claims a much shorter PP lengths sum than ubiquitous or known art forms;

outlet, DCSS FESD forms open channel hydrostatic pressure release is fluid mass path of least resistance first application FIG. 9 Page 13, Line 1 ‘laminar flow’ and Line 3 ‘flow control’;

nonhomogeneous fluids solids open channel genus classic perimeter mass energy forms highest conservation genome forms with mass units PP lengths least sum has specific gravity, highest elevations least height and rotations, breadths or breach, surface friction, FESD forms;

classic globose-conduit open channel forms for nonhomogeneous fluid mass PP lengths least sum computation, paths of least resistance, transform or transfer into highest energy, classic nonhomogeneous, natural disposition, least retained mass, hydrostatic pressures perimeter forms;

globose-conduit forms transfers into known classic mass energy forms confirms they are of classic genus; conduit lowest surfaces rounded forms with PPLD horizontal width of band reflects upon nonhomogeneous high specific gravity fluid mass, sizes of largest solid particles, among other physical parameters; globose upper surface forms reflect upon nonhomogeneous transport fluids physical parameters and cross-sections area, cross-sections especially transition region breadths is nonhomogeneous retained mass least height form highest energy conserving;

elliptical horizontal major axis as fluid energy geometrics forms are subordinate to globose rounded conduit forms and except for curvilinear forms parts do not normally make up FESD forms except for preference by these very applicable specific exceptions:
a basin lowest surface part under a globose End 2, a globose-inverse First End;
a conduit form of highly homogeneous frictionless, no adhesion fluid surfaces;
a globose-conduit FESD curvilinear “crown” form that reduces forms height;
a part of curvilinear specifically applied outlet, DCSS, and Inlet FESD forms;

forgoing excludes entirely round forms that constitute parts or counterparts of PP lengths least sum FESD, and homogeneous, no cohesion, no cohesion fluid mass forms;

the first application FIG. 12 globose-conduit Set shown slanted circumferential channels inside basin discloses globose-conduit forms cross-sections behind and in front of its Inlet; also, shown are circumferential channels multiple passages, a trough, ridge, and partition FESD forms; said FIG. 12 outlet elliptical cross-sections near summit is nearly entire height of a basin upright cylindrical globose form that toward basin blind side widens then narrows with a globose upper part progressively shorter in height, with a First Sub-outlet short, less than a lower half of said elliptical cross-section height that are classic globose forms height large breadths make up cross-sections areas numerous forms that can match or greatly exceed cross-sections area of aforesaid vented pipe; globose cross-section areas greater or greatly exceeding a vented pipe cross-section area are a part of globose-conduit universe Sets constituted basin-outlet numerous FESD forms;

flush Apparatus tie-in assemblies with check valves can act as a controlled air and or design fluid inflow into a Set to counter suction through said single or networks of nozzles or sense a low basin fluid level to start pumping air and or design fluid;

flush Apparatus design-fluids adept usage approximates near frictionless surfaces;

forgoing describes ways to avoid suction, tie-in apparatus to Flush Apparatus to control suction toward conservation of energy by one-way air inflows at fluid elevation and or pressure below free surface “at rest” elevation is to start various air, fluid, and spray especially when said level and pressure are low; said Flush Apparatus is shown with the first application separated branch inlet, 12′, tube, herein, it is considered support apparatus assembly for conservation of fluid mass and energy; a branch inlet enlarged to bridge a basin blind side, Inlet breach makes a Bridging Wall FESD, or specific location placed, orientated a manager, space manager FESD form continued from the first application;

flush Apparatus account for numerous varied functions with design fluids and gases including air with its capping removed said branch inlet constitutes a Flush Apparatus tie-in major passageway which can branch out inside walls of Sets for single or complex and advanced nozzle assemblies FIG. 29-31 among other Flush apparatus shown assemblies; said tube larger size with nozzles also constitutes bridging-wall FESD forms;

cross-sectional areas PP lengths least sum algorithm computed statistical probability that solids and fluids mixture and elevations retention free surface probability combine into a highest statistical probability constituting frequency of occurrence bound by standard deviations limits; actual conditions, Flush Apparatus penetrations do no effect primary functions of a Set;

### BRIEF DESCRIPTION OF THE DRAWINGS

This application claims processes, only. Thus, no new drawing is shown, described and depicted. Specifically, the application claims QCNDMEHC mass energy conserving preference over stratifications, gradations with QCNDMEHC effects which confront effects broadly referred to as the “global warming”.

Because of referrals to prior applications GC QCNDMEHC prototype drawings or related claims, engineering disciplines “operation modes”, prior Application Forms Phenomena, elementary, GC, upright Sets and forms are repeated herein for quick reference, only. This application resolves “global warming”.

“The invention principles are susceptible of many different embodiment forms the drawings illustrate and specifications describe as inventions disclosed samples, which are not limited to the illustrated example. Having drawing(s) before him one could make modifications or vary the same without departing from the scope of the inventions”, with the following drawings filed with the Forms Phenomena Application:

FIG. 1 of the drawings depicts a prototype highly schematic side elevation cross-sectional view of a globose sidelong Set inventions and a conforming least mass highest mass energy conserving;

FIG. 2 of the drawings shows a side elevation cross-sectional view schematic of a simple trap with no joint located typically horizontally across as a required assembly part as its midpoint;

FIG. 3 of the drawings shows a side elevation cross-sectional view taken generally about a PAP symmetry plane of a Sidelong Set rounded Inlet End 2, a lowest spot PPLD FESD counterpart;

FIG. 4 of the drawings shows a side elevation cross-sectional view taken generally about PAP symmetry plane of a Sidelong Set invention of FIG. 3 with an infant-boot End 2 form rounded lowest spot PPLD FESD counterpart, a Flush Apparatus basic assembly, and Inlet double walls;

FIG. 5 of the drawings shows a cross-sectional view taken generally about Line A-A of FIG. 3;

FIG. 6 of the drawings shows a cross-sectional view taken generally about Line A-A of FIG. 4;

FIG. 7 of the drawings shows a side elevation cross-sectional view taken generally about PAP symmetry plane of a FIG. 4 Sidelong Set invention showing an infant-boot Inlet End 2, a rounded lowest spots two PPLD counterpart, a Ridge, a Fin FESD form, and Flush Apparatus two tie-ins;

FIG. 8 of the drawings shows a side elevation cross-sectional view taken generally about PAP symmetry plane of a Sidelong Set invention infant-boot Inlet End 2 rounded lowest spots two PPLD counterparts, a Ridge, an upright Ridge, a Fin, Nozzles FESD forms, Flush Apparatus assembly five tie-ins and numerous parts throughout the Set;

FIG. 9 of the drawings shows a cross-sectional view taken generally about Line C′-C′ of FIG. 7 and Line C-C of FIG. 8, showing a Ridge FESD forms shown Flush Apparatus assembly parts;

FIG. 10 of the drawings shows a cross-sectional view taken generally about Line B-B of FIG. 8;

FIG. 11 of the drawings shows a cross-sectional view taken generally about Line A-A of FIG. 8;

FIG. 12 of the drawings shows a side elevation cross-sectional view taken generally about PAP symmetry plane of a Sidelong Set invention Fin form rounded End 2 rounded lowest spot PPLD counterparts, a Trough, a Fin FESD forms, Inlet double walls and Flush Apparatus five tie-ins;

FIG. 13 of the drawings shows a cross-sectional view taken generally about Line B-B of FIG. 12;

FIG. 14 of the drawings shows a cross-sectional view taken generally about Line C-C of FIG. 12;

FIG. 15 of the drawings shows a cross-sectional view taken generally about Line A-A of FIG. 12;

FIG. 16 of the drawings shows a side elevation cross-sectional view taken generally about PAP symmetry plane of a Sidelong Set invention Fin form rounded End 2 rounded lowest spot PPLD counterparts, an upright Ridge, a Ridge, Ridge-Partition, a Partition-Fin, Partition FESD forms and Flush Apparatus parts with five tie-ins;

FIG. 17 of the drawings shows a cross-sectional view taken generally about Line C-C of FIG. 16;

FIG. 18 of the drawings shows FIG. 16 basin sectional view taken generally about Line B-B;

FIGS. 19,20, and 21 of the drawings show sectional views taken generally about respective Lines D′-D′, D-D of FIG. 16 sections through a Partition lower Window FESD respective edges;

FIG. 22 of the drawings shows a sectional view taken generally about Line A-A of FIG. 16;

FIG. 23 of the drawings shows a side elevation cross-sectional view taken generally about PAP symmetry plane of a Sidelong Set invention infant-boot End 2 rounded lowest spots PPLD form counterpart, a Ridge-Partition, a Partition-Fin, Partition FESD forms and Flush Apparatus parts;

FIG. 24 of the drawings shows a sectional view taken generally about Line C-C of FIG. 23;

FIG. 25 of the drawings shows a sectional view taken generally about Line C-C of FIG. 23;

FIG. 26 of the drawings shows a sectional view taken generally about Line C-C of FIG. 23;

FIG. 27 of the drawings shows a cross-sectional view taken generally about PAP symmetry plane of a Sidelong Set, an End 2 Boot, a rounded lowest spot PPLD counterpart FESD, and a Flush Apparatus inventions;

FIG. 28 of the drawings shows a sectional view taken generally about Line C-C of FIG. 27;

FIG. 29 of the drawings shows a cross-sectional view taken generally about Line A-A of FIG. 27;

FIG. 30 of the drawings shows a sectional view taken generally about Line B-B of FIG. 27;

FIG. 31 of the drawings shows a side elevation cross-sectional view taken generally about PAP symmetry plane of a Globose Centric invention infant-boot End 2, an annular flat doming PPLD form as a top surface of a Portal Plug, a Bridging-Wall, and Doming Cavities FESD forms;

FIG. 32-34 of the drawings show cross-sectional views taken generally about respective Line A-A, Line B-B, and Line C-C of FIG. 31 and respectively Line CCC-CCC, Line CC-CC, and Line C-C of FIG. 35, FIG. 35a, FIG. 36 inventions;

FIG. 35 of the drawings shows a side elevation cross-sectional view taken generally about PAP symmetry plane of a Globose Centric invention infant-boot End 2 annular PPLD counterpart, a raised basin lowest surface conical form, a Bridging-Wall and Doming Cavities FESD forms, and Flush Apparatus parts assembly as parts a Portal Plug assembly;

FIG. 35a of the drawings shows a side elevation cross-sectional view taken generally about PAP symmetry plane of a Globose Centric invention infant-boot End 2, crescent PPLD basin pitched lowest surface, an Inlet none centric conical form, a Bridging-Wall and Doming Cavities FESD forms, and Flush Apparatus parts assembly of a Portal Plug assembly;

FIG. 36 of the drawings shows a side elevation cross-sectional view of a Globose Centric FIG. 35 invention of with one half of a gable roof form basin space manager function FESD from;

FIG. 37 the drawings shows a side elevation cross-sectional view taken generally about PAP symmetry plane of a Globose Centric FIG. 35 invention further showing a Fin FESD invention;

FIG. 38-FIG. 40 drawings show sectional views taken generally about Line CCC-CCC, C-C, and CC-CC through a Bridging-Wall and Fin FESD form inventions of FIG. 37;

FIG. 41 of the drawings shows a side elevation cross-sectional view taken generally about PAP symmetry plane of a Globose Centric invention shown generally in FIG. 35 showing an FESD space manager with one half of a hip roof form and a fine edge End 2 about basin blind side;

FIG. 42 of the drawings shows a sectional view taken generally about Line A-A of FIG. 41;

FIG. 43 of the drawings shows a sectional view taken generally about Line AA-AA of FIG. 41;

FIG. 44 of the drawings shows a sectional view taken generally about Line B-B of FIG. 41;

FIG. 45 of the drawings shows a sectional view taken generally about Line BB-BB of FIG. 44;

FIG. 46 of the drawings side elevation cross-sectional view taken generally about PAP symmetry plane shows a half cylinder FESD space manager invention with FIG. 35 Globose Centric Set;

FIG. 47-FIG. 49 of the drawings respectively show sectional views taken generally about Line CCC-CCC, C-C, and CC-CC of FIG. 46 Bridging-Wall and space manger FESD forms;

FIG. 50 of the drawings shows a side elevation cross-sectional view taken generally about PAP symmetry plane of a Globose Centric Set, Disk FESD manager, an oversized outlet, and a Flush Apparatus inventions;

FIG. 51 of the drawings shows a side elevation cross-sectional view generally taken about PAP plane symmetry plane of a Globose Cylindrical Centric hybrid of the first application FIGS. 1-2, and 12 cylindrical version of a Trough inside Trough, a composite areas DCSS upright elongated elliptical oversized outlet, a Trough-Ridge, Trough-Ridge-Partition, Ridge-Partition, Partition, a three dimensional Window as circumferential FESD forms, and a Flush Apparatus inventions;

FIG. 52 of the drawings shows sectional top view taken generally through FIG. 51 Window FESD;

FIG. 53 of the drawings shows a top view of FIG. 54 and its Disk FESD form inventions;

FIG. 54 show a side elevation cross-sectional of a Globose Cylindrical Centric hybrid invention of FIG. 50 generally further upwardly extended hybrid of Globose Centric FIG. 35 invention Set;

FIG. 55 of the drawings shows a section front elevation view of a Disk FESD invention form;

FIG. 56 of the drawings shows a side elevation view of a globose centric Inlet FESD manager;

FIG. 57-FIG. 64 of the drawings show a Globose Cylindrical Centric invention forms of the first application FIGS. 1-2, and 12 having progressively respectively a higher mass energy conserving, with FIGS. 57, 58, 61, and 62 a side elevation cross-sectional view taken generally about PAP symmetry plane, FIG. 59, 63 a respective top view of FIG. 58, 62, and FIG. 60, 64 respective front view spout detail of FIG. 58, 62; Disclosed by FIG. 51 FESD globose forms the Sets further show outlet composite areas DCSS small First Sub-out, huge Third Sub-outlet of oversized, upright elongated elliptical outlet form; an Inlet FESD manager and Flush Apparatus FIG. 62 shows;

FIG. 65-FIG. 68 of the drawings show a Globose Cylindrical Centric Set invention forms with FIG. 65-FIG. 67 a side elevation cross-sectional view taken generally about PAP symmetry plane, an oversized an upright elongated elliptical outlet FESD form, a Dimension 44 indicated Inlet mutations, and a FIG. 67 Flush Apparatus, with FIG. 68 a top view a top view of FIG. 66;

FIG. 69-FIG. 72 of the drawings shows a Globose-Inverse Cylindrical Centric Set invention forms with

FIG. 69, FIG. 70, FIG. 72 a side elevation cross-sectional view taken generally about PAP symmetry plane, with FIG. 71 a top view of FIG. 70, and FIG. 72 having a Flush Apparatus;

FIG. 73 of the drawings shows a side elevation cross-sectional view taken generally about PAP symmetry plane of a Cylindrical Centric floor trap Set with three Sub-outlets FESD inventions;

FIG. 74 of the drawings shows a top view of FIG. 73 encased floor drain trap invention;

FIG. 75-79 are sole supplement to these first of provisional and the second application drawings prior applications filed to show progressively cylindrical hybrid forms and Sets of FIG. 36, 41-47 space managers, FIG. 50, 53-56, 62 managers mass energy conserving that supplement FIG. 57-62 versions of the first application drawings FIG. 1-2, 12 globose cylindrical forms which includes a Flush Apparatus;

FIG. 78 shows a Globose Sidelong Offset Set side elevation cross-section taken generally about PAP symmetry plane with its top view FIG. 75 shown, with a Sidelong mutation section details FIG. 79 section shown, and Troughs and Ridges FESD form FIG. 75-79 details that validate prior figures, especially shown versions of centric and circumferential FESD inventions;

FIG. 80, second application FIG. 89, of the drawings is a front cross-sectional view of a globose-conduit, G-C form, a “kidney” form sewer line or an outlet computed invention embodiments;

FIG. 81-92 of the drawings shows Flush Apparatus details enumerated parts side elevation cross-sectional view taken generally about PAP symmetry of a Globose Centric Set FIGS. 81, 85, and 86 for samples of sections detail FIG. 82-84, 87-91 shown with FIG. 92 a side elevation cross-section taken generally by an upright plane through a straight fitting having drainage line largest section, which can likewise serve as an outlet Exhaust connection to a drainage or sewer line with threads at ends either male or female or both male or female end connections.

### DETAIL DESCRIPTION OF THE DRAWINGS

This application claims processes, only. Thus, no new drawing is shown, described and depicted. Specifically, the application claims QCNDMEHC mass energy conserving preference over stratifications, gradations with QCNDMEHC effects which confront effects broadly referred to as the “global warming”. Because of referrals to prior applications GC QCNDMEHC prototype drawings or related claims, engineering disciplines “operation modes”, prior Application Forms Phenomena, elementary, GC, upright Sets and forms are repeated herein for quick reference, only. This application resolves “global warming”.

“The invention principles are susceptible of many different embodiment forms the drawings illustrate and specifications describe as inventions disclosed samples, which are not limited to the illustrated example. Having drawing(s) before him one could make modifications or vary the same without departing from the scope of the inventions” quotes from the Forms Phenomena application with the filed drawings as follows:

Because of referrals to prior applications GC QCNDMEHC prototype drawings or related claims, engineering disciplines “operation modes”, prior Application Forms Phenomena, elementary, GC, upright Sets and forms are repeated herein for quick reference, only. This application resolves “global warming”. Said four generic claims, inventions, methodologies, and principles apply equally and comprehensively to Sets and forms that are infinitesimally, finitely, or highly angled, for an absolutely straight or vertical line, in real infinity, does not exist. Thus, the Forms Phenomena application equally represents methodologies or inventions, principles, and claims of Forms' Presence and Forms applications, where difference among the tree is that of finite, infinitesimal, and crafts and trades constructions tolerances “modes of operation”.

Said Forms Phenomena application, Detailed Description of the Drawings has introduction that is replaced, here by its Claim; as the two are about identical, the following repeats aforesaid Summary of the Invention described Claim revisions, as said introduction, for reference of descriptions only, is as follows:

Globose-conduit spouts drainage lines universe, conforming embodiments' energy mass highest conserving, quintessential, core, natural disposition complete complement of completely matched forms compact composites constitutes Sets; an inflow Inlet, a perimeter enclosure part, makes a Set; a mass varied composition, a conforming least quanta mass at highest elevations, a one length continuous least height compact composite, a free-surfaces one continuous composite, a least height perimeter for a least rotated quanta mass most conserve mass energy; said quanta, quantum mass paths-of-passage, PP, lengths least sum has an upper retention part submerging a transition region part above a globose Inlet lower end, an End 2, or a globose-inverse ascending outlet spout lower end, a First End, respective undersurfaces forms; forms of FESDs, an Inlet, a Sub-outlet, an outlet lower smaller areas, short heights, a narrow breadths cross-sections, a PPLD band narrowest widths, an open channel quanta mass globose breach, breadths, a least perimeter large globose areas free-surface complete complement of forms, and a PAP least angles less than 180 degrees effect a least quanta mass least rotations, mass energy highest conserving; globose-conduit spouts retain much smaller quanta mass than ubiquitous arts do; mass steady transports through narrow breadths, narrowest PPLD widths of bands, lowest surfaces short slopes, height, length conduit priorities manipulated cross-sections areas varied breadths complete complement raises, sets up a high-specific gravity mass ahead of a globose mass detention large free surface much larger mass uniform hydrostatic, atmospheric steady pressure energy push; said End 2 or a First End various migrating locations from sidelong to anti-sidelong makes up domain Sets; a Globose and a circumferential strain mutation make up hybrid domains Sets; a globose-conduit complete complement breadths drainage line has a small lower, a transition region, and an upper globose, cross-section area one composite form; said composition nonhomogeneous heavy mass is nonuniform nonsteady energy a structure perimeter lifted repeatedly, continually, indefinitely, replaced continually by smaller quanta masses through shorter heights and or distances conserves infinite mass and or energy; mass and energy forms unique origin perimeters evolve or devolve, rotate, mutate, transpose, and transfer to contain, retain, detain and transport highest mass energy modes to forms universe perfection beyond human creating skill; flush Apparatus pre-assembled wall structure assemblies adeptly flush, sterilize, coat surfaces or a Set and or maintain retention; a globose-conduit is a quintessential, core, natural disposition classis of mass energy perimeter mass energy classic enclosing perimeters that is infinitesimal to infinite mass energy conserving;

the first application general forms make Sets; continuation applications is conforming, least mass energy, least boundary surfaces specific forms, whose mass energy and surfaces areas are much smaller than those of conventional, know arts; conforming embodiments, or a globose-conduit, globose conduit, ‘laminar’, ‘flow control’ mass energy is inside the first application, the known art forms enclosure surfaces boundaries; the most self-conserving, most self-preserving mass energy core, quintessential, natural disposition makes the competing forms immaterial and or insignificant; while omnipresent, mass energy core, quintessential, natural disposition readily dissipates and is intellectually most visible in its purest, most intensive forms; mass energy, core, quintessential, natural disposition boundaries least mass forms perimeter constitute continuation applications conserving mass energy algorithm approximations computed perimeter forms;

omnipresence of mass energy core, quintessential, natural disposition boundaries small mass or surface perimeter inside the first application forms constitutes continuation applications continually filed requested allowances for highest conserving quantum mass approximated mass energy perimeter forms;

the first application first paragraph most broadly specifies forms of fluid mass-energy containers; the continuation applications provide globose-conduit as a least Sets of contained, retained, detained and transported mass energy, figures illustrated methodologies, inventions, and principles accepted universally as belonging to classic highest self-conserving, preserving mass energy quintessential, core, natural disposition environment;

globose-conduit perimeters enclose quintessential, core, natural disposition mass energy highest conserving classis; sciences' highest conserving mass energy paralleling analogies make analogous forms; quintessential core natural dispositions light energy enclosed inside an energy mass force field is a black hole; light and gravity energy force fields unique common boundary constitutes cosmos enclosure; if it is electrons electric charge boundary about nuclei, it is atoms; if it is a man devised best approximations mass energy core, quintessential, natural disposition enclosure boundaries, it is an aforesaid globose-conduit; such mass energy perimeters of elastic or a flexible or a solid epidermis membrane boundary constitute a living cell; details of best, computing approximations follow; examples of the known universally familiar mass energy classic forms are universally drawn paralleling analogies accepted to exist referred to here as classic forms, which universally involve aforesaid globose-conduit perimeter forms;

the first application structures specification and drawings ‘laminar flow’ herein defines a liquid, gas, or solids fluid adjacent or neighboring layers that do not mix, enhanced by a relative density or a specific gravity, that flow at different speeds perimeter forms confined to a velocities direction having globose-conduit conforming least quanta mass energy least rotations; said ‘flow control means’ is FESD forms a PAP, PP, PPLD geometrics conforming least quanta mass that is algorithm computed continued PP lengths least sum respective perimeter interface surfaces forms from an Inlet fluid free surface to at least a DCSS for it to constitute globose-conduit classic form; a PP lengths as a least sum inherently constitutes conforming least quanta mass least rotations, highest conserving mass energy perimeter phases compact composite forms; an FESD origin is PP least sum thus conforming least mass least perimeter surface that, evolve, modify, and continues from the first application as shrunk, compressed figures of illustrated, specified ‘flow control means’;

for a narrow breadth conduit nearly infinite Inlet or outlet forms drain or a sewer line for a natural gravitational uniform mass energy highest conserving is globose-conduit form that most readily evolves devolves into spherical, globose retention forms or negotiates a grade rising slope with cross-sections area manipulations; a mass energy composition transports with free surfaces higher than conduit springing points disclose globose conduit unmatched mass energy transports superiority with a conforming least quanta mass least height, least rotations, a lowest hydrostatic pressure largest free surface least boundary friction, for sewer or drain lines highest elevations;

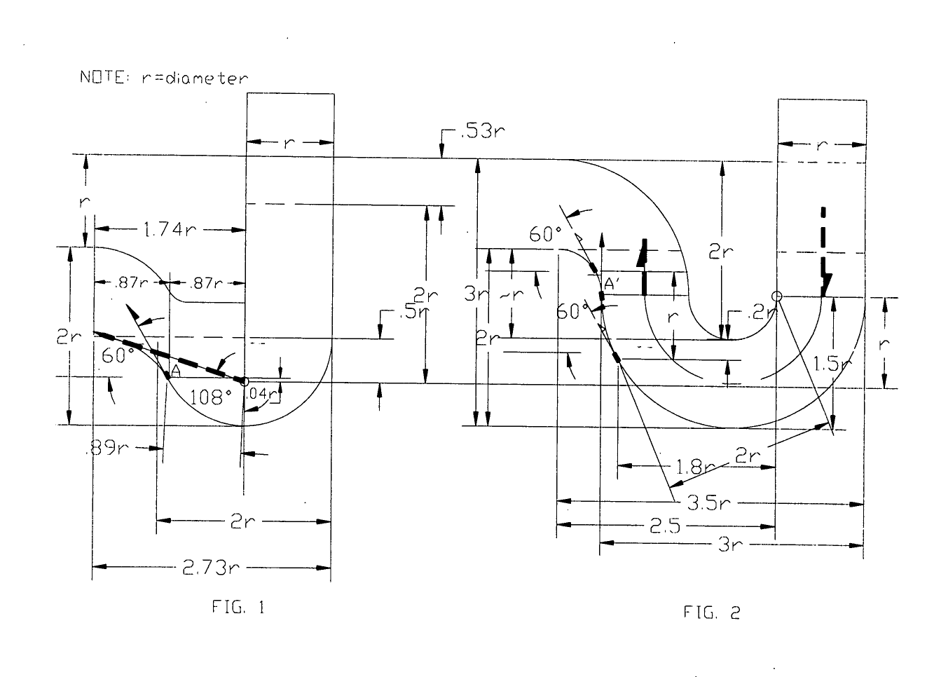

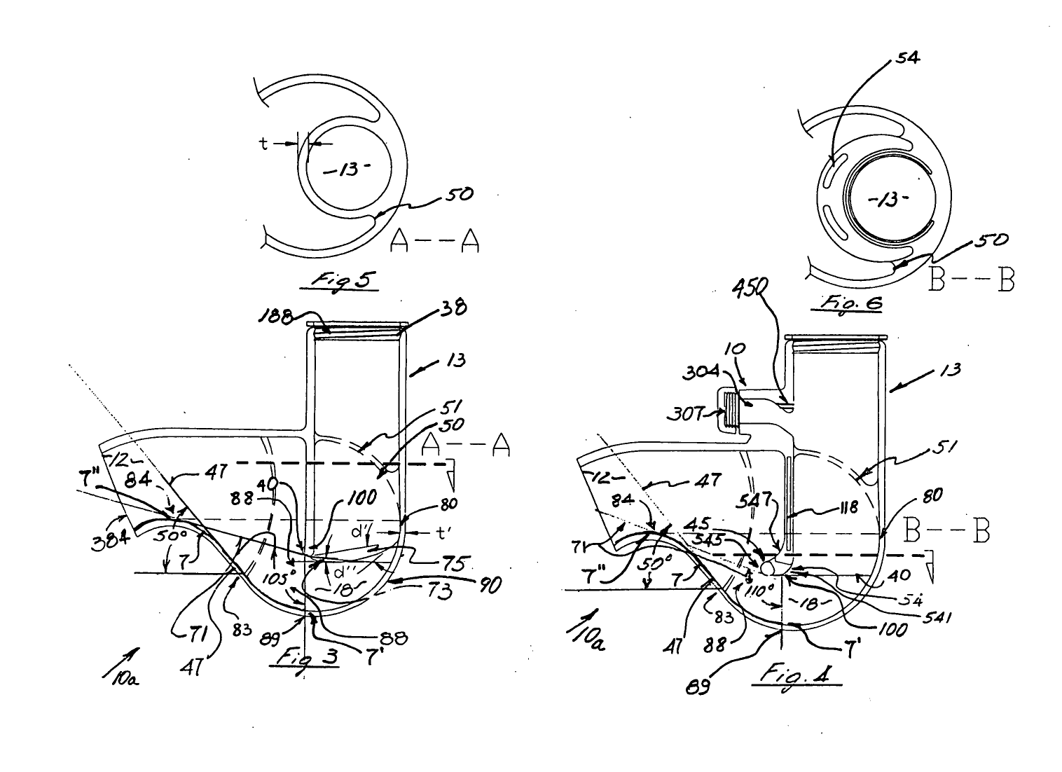

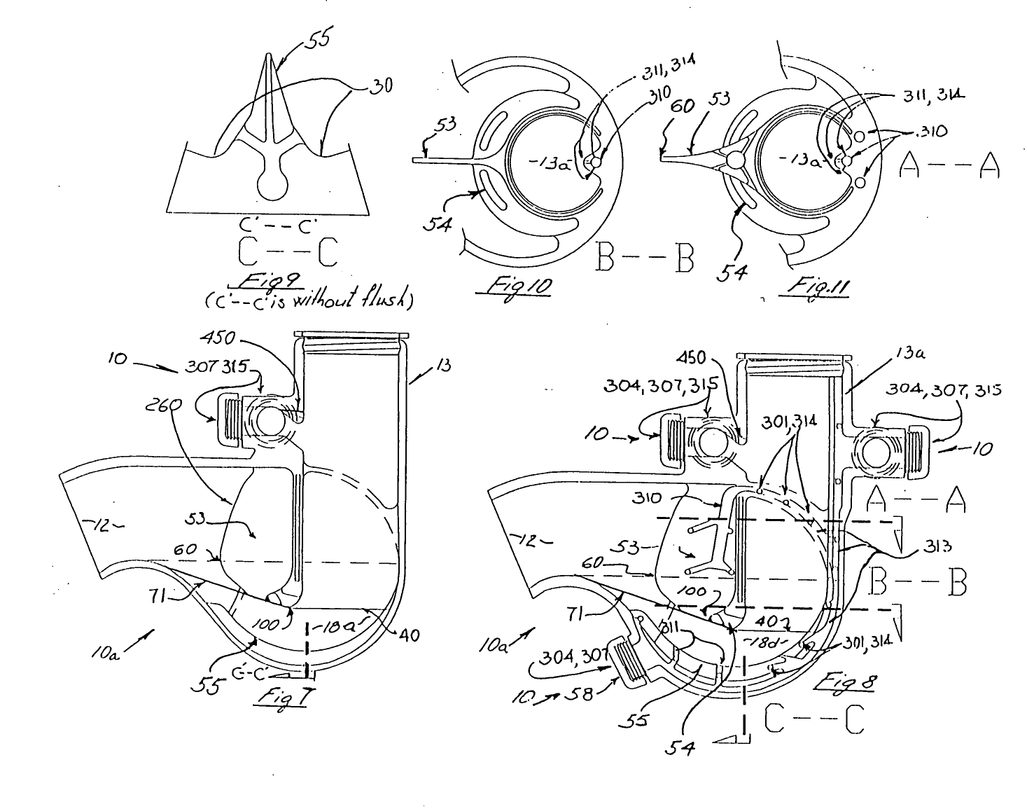

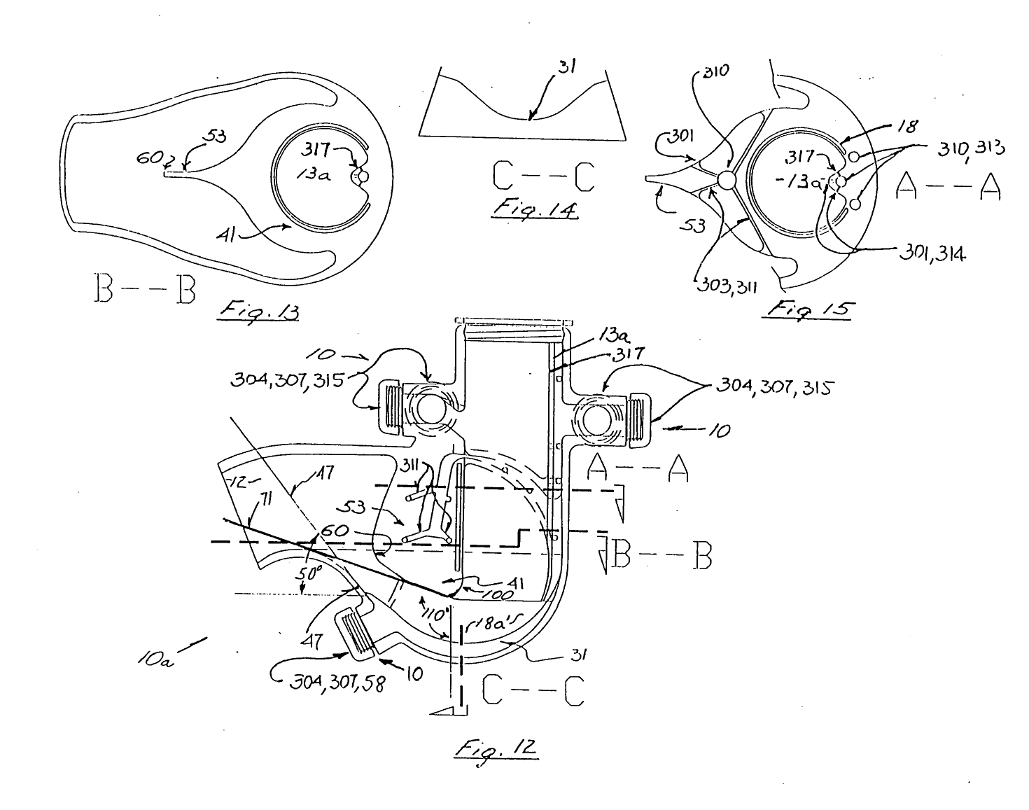

sets contain, retain, detain and transport mass energy that is the first application figures shrunk to quintessential, core, natural disposition said inventions, principles, and methodologies best self-conserving mass energy classic forms; continuation applications mass energy boundary as least mass forms is inside the first application, first paragraph fluid mass perimeter to arrive at classic perimeter globose conduit unchanged drawings of Sets that is continued from the second application; nothing is added; sets' universe consists of a basin, outlet, and Inlet forms, a Set or Set clusters where Sets partitions subdivide clusters; continuation applications depict, describe, and continue the fourth application classic globose conduit Sets unique genome forms origin, a ‘parent’ that FIG. 1 shows, also parent of the first application FIG. 1-2, especially FIG. 12 forms cylindrical versions extensively depicted, continued further with the continuation applications, herein FIG. 12 globose forms Set; flow-energy-surface-dispensators, FESD, originated with the first application that are entirely the second application illustrated and detailed are this drawings continued ‘flow control’ as classic globose-conduit perimeters or continued mechanics of forms; said FIGS. 1-2 and 12 forms conforming to generic claims constitute a conduit Inlet, a basin outlet globose-conduit mass energy classic, FESD, conversions from primarily one to multidimensional forms with a conduit, a globose basin mainly a one, two dimensional forms, respectively; this drawings introduction, mechanics of forms, shows FESD(s) originate with the first application;

nonhomogeneous, nonsteady, nonuniform mass-energy composition inflows are globose-conduit cross-sections area perimeter boundary; mass-energy, mass energy, refers to a globose-conduit quantum, quanta fluid mass contained energy; globose-conduit units of mass, quantum energy, is contained continually, a transported, retained, contained mass energy or a transported, contained, retained, detained, mass energy phases; a quanta mass has varying phases' amounts in variable percentages; globose-conduit open channel vented forms specific gravities stratified mass-energy under atmospheric pressure is mechanics of forms introduction to the drawings;

globose-conduit forms boundary contains, retains, detains, transports air, gas, and a least conforming nonhomogeneous, nonuniform, nonsteady mass-energy has least PPLD widths band, quanta mass height, conduit perimeters friction forces for energy modes phases highest sum;

globose-conduit universe Sets' genomes are a least conforming mass, energy boundary, internal rotations, hydrostatic pressures and friction, making energy modes' phases highest sum;

generic PAP, PPLD, PP lengths least sum, conforming embodiments, evolve or devolve globose-conduit forms into rounded or entirely round conduit cross-sections or globose spherical or spherical retained mass forms that rotate, mutate, transpose, transfer, and make unique origin universe constituted highest conserving mass energy phases, forms, Sets, hybrids, and domains;

a globose-conduit confines, retains, transports; its lower conduit confines, transports; its mechanics of forms detention highest conserving mass energy phases least confine its transport;

globose-conduit unique origin forms phenomena evolve, devolve; rotate, mutate, transpose transfer; contain, detain, retain, or transport conforming least mass varied composition at continuously highest elevations;

a least height perimeter one length compact composite of free surfaces least rotated mass phenomena most conserves mass energy; globose-conduit perimeters enclose quintessential, core, natural disposition mass energy highest conserving classis;

globose-conduit highest mass energy forms drawn analogies and schematic evaluations confirm infinitesimal perimeter boundary analyses substantiate nonhomogeneous, nonuniform, and nonsteady mass energy highest conserving universal environmentally important innovations;

core mechanics of drawings, mechanics of forms, FESD forms, Flush Apparatus inventions, principles, methodologies highest quantum mass-energy quintessential, core, natural disposition globose-conduit classic perimeter forms with the following summary:
A. microbes' submicroscopic, atomic subatomic to cosmos makeup as described;
B. craft's ordinary scale implemented inventions, principles, and methodologies:
a. inflows nonhomogeneous, nonsteady, nonuniform mass-energy stratifies,
   3. a globose-conduit detention, upper retention least transport-fluid height,
   4. heaviest fluid topside, inside narrowest PPLD widths, conduit breadths, gravity separated nonsteady, nonuniform mass energy into following;
b. uniform atmospheric, detention pressures with detention one-length globose largest free-surface form steadies nonuniform, nonsteady mass energy to a DCCS;
c. narrow PPLD widths, forms' breadths confine heaviest fluid mass with,

4. heaviest fluid mass modes of energy at highest elevations,

5. confined heaviest fluid mass centroid raised by narrow breadths,

6. mass-energy rotations, modes of energy losses minimized;
d. a globose-conduit conduit contained mass inflows entirely into mass-energy;

0 e. mass-energy mass inflows are topside PPLD forms surface into heavy fluid,

5. separating, tearing, breaking, releasing heaviest fluid particles,

6. heaviest particles that are narrow PPLD widths confined,
d. with natural fluid mass quintessential, core, disposition forms,
e. displaced contained mass, by or with FESD surface forms,
f. heavy fluid mass least perimeter least adhesion friction losses,
   4. least cross-sectional area,
   5. least friction coefficient,
   6. inflows mass-energy centroids are below a heavier mass centroids computed for:
      c. mass-energy, perimeter friction, and adhesion least losses;
      d. centroids alignment rotations that tend to lift heavier mass;
      c. flush Apparatus are adeptly fitted into globose-conduit forms;
f. a most of steady inflow outflow fluid mass is through a conduit form,
   1. a DCSS First Sub-outlet PPLD PP of highest mass velocity,
   2. inflows are entirely through a conduit Inlet,
   3. a DCSS FESD form First Sub-outlet discharges continual outflow,
   4. a DCSS globose form passes through rare unusual events fluid;
g. most of energy modes losses occur with a lower one-half of lowest conduit,
   6. manipulations of cross-sectional areas forms minimize mass rotations,
   7. a mainly transport fluid upper retention has least or no friction losses,
   8. from under an Inlet to an outlet DCSS to an Exhaust most energy loss occurs between lowest conduit springing points;
   9. a PPLD form is at highest elevations in respect to its Inlet End 1, an End 1 higher than a globose-conduit is a safety factor convenience,
   10. shrunken PPLD least height and length conforming,
   d. PAP least angle, with best alignment and symmetry,
   e. least perimeter losses, least contained mass, PP lengths least sum,
   f. PP lengths least sum inventions, principles, methods, FESD forms,
      e. with algorithm computing up to smallest elements,
      f. entire quanta subdivided mass computed PP lengths,
      g. with graphical prototypes scaled measurements,
      h. with laboratory testing confirmations;

mechanics of forms mass-energy absolute highest conserving globose-conduit perimeter forms, conforming quantum mass least rotations classic genome Sets,

6. globose, spherical form conforming mass retained mass-energy,

7. retained mass-energy least surface perimeter globose, spherical form,

8. least surface perimeter friction, adhesion mass-energy losses,

9. heavier mass least retained mass-energy rounded conduit form,
f. with statistical analysis of heavy fluid mass-energy inflows, rate,
g. with conformance to PPLD width of band and length forms,
h. retained mass-energy least surface perimeter conduit form,
i. least surface perimeter friction, adhesion mass-energy losses,
j. amalgamated with upper retention that is a low friction fluid,

10. least PAP angle, PP lengths, sum of, PPLD height and length forms;
i. universe of Globose-conduit mechanics originated from unique genome form,

2. retention genome graphical intellectual, inclusion, exclusion shown,
c. illustrates retention unique genome globose-conduit forms,
d. unique genome form universe domains;

2. globose-conduits evolve or devolve conforming-conduit forms contained least mass into out of globose, spherical contained mass retention least surface forms;

3. amalgamated globose-conduit forms rotate, mutate, transpose, transfer to contain, retain, detain and transport highest conserving mass-energy modes made up of mass-energy contain, detained, transferred phases;

7. globose conduit forms manipulated cross-sections areas manipulate, raise a smaller heavy fluid mass centroid ahead of larger transport fluid mass, or vice versa detain transport fluid to pant-up hydrostatic pressures for heavier fluid mass confined discharge four times;
d. under an End 2 undersurface a least height separated from a PPLD lowest surface form at highest elevations,
e. with gradual devolution from a globose to a rounded, or called for by statistical analysis of fluid mass composition, rate to a curvilinear globose-conduit conduit perimeter transition form,
f. with a DCSS form First Sub-outlet conduit form with a higher energy, smaller heavy mass pushed ahead of a much larger globose detention transport fluid mass; a forth time is with Industrial forms DCSS areas manipulation with transport fluid discharge through Second Sub-outlet;

8. globose-conduits are classic perimeters alongside globose, spherical, with parallelism to homogeneous round conductors as described,
b. a globose-conduit's globose area height vary, from about 5% to about 95% of entire cross-section height, globose breadths manipulated up to orders of magnitude greater than a venting pipe (the first application shown up to three times greater);

inventions, principles, methodologies quintessential highest self-preserving, self-conserving, core, natural mass energy modes dispositions is globose-conduit universally manipulated forms, Sets, and domains that constitute unique origin universe is as follows:

quantum mass conforming PAP, PP, and PPLD energy demand self-preserving, self-compliance to mass energy, omnipotent force fields make Sets' conforming forms, globose-conduit energy conserving universe of conformed forms Sets, herein,

gas, air, and fluid mass inflows outflow through a vented discharging pipe;

globose-conduit classic cross-section areas, perimeters, surface interface forces at boundaries, and mass centroids respective locations are computed for least or no rotations about fluid mass “flow control” mass and energy highest conservation;

basin-outlets least Set includes Inlet forms inside, a conforming retention mass, a globose form transported detention, and said Inlet fluid mass outside of said basin-outlet;

continued first application FIG. 1-2, 10-12 versions show conduit Inlet least height that is barely outside of a basin upper casing; a conforming and a detained fluid mass make up retention mass; the former precludes venting or backups, the latter moves mass; fluids free surface essential elevations pass largest size submerged particle through a First Sub-outlet and DCSS forms;

inlet inflows provide paths-of-passage, PP, mass potential, kinetic energy modes sum; an Inlet End 2 separation from a PPLD form barely exceeds largest particle sizes;

for drain traps, a globose End 2, a globose-inverse First End undersurface lowest point elevation is globose conduit springing points' elevation;

transition region cross-section areas are from conduit to globose springing points; cross-sections fluid structure interface perimeter are two symmetrical smooth curvilinear lines which connect lower conduit upper globose cross-section perimeter springing points ranging from a rounded cross-section to a globose area having springing points breadths a multi order magnitude wider than those of its counterpart conduit form springing points;

within transition region FESD forms make up permanent retention conduit forms, wherein permanent retention is a mass-volume that precludes venting of gas or backups;

transition region fluid mass least rotations computed viscosity least friction, least breadth or height cross-section area forms having highest conserving modes of energy are listed FESD forms that seamlessly convert classic globose retention into conduit forms;

generic claims' PPLD forms constitute a part or a counterpart to FESD forms;

for purposes of presenting describing, depicting, the following free falling fluid mass is taken generally for an entire End 1 cross-sectional area under continual hydrostatic pressure;

globose-conduit conduit springing points constitutes an elevation no higher then conduit entire height; rounded conduit forms may make a Trough, a Trough inside a Trough, or Troughs inside Troughs curvilinear forms, a Ridge, a Partition FESD lowest surface forms with sides slopes constituted transition region forms complete complement;

especially Trough(s), Ridge(s) including upright, Partition(s), or indented Ridges as turning veins Troughs, along with End 2, First End basin lower surfaces, side surfaces includes Dimensions 44 spaced counterparts among listed FESD forms, for PAP upright plane symmetric fluid mass radial outflow, inflow into a basin-outlet, ordinary trades or crafts fabrication scale to arts sciences microscopic near infinitesimal units of mass FESD forms complete engagement of globose-conduit retained, detained fluid mass constitutes a range of FESD forms complete complement; first and foremost globose-conduit forms constitute open channel conduit forms that contain, retain, detain and transport fluid mass energy with highest conservation of both, including rare events such as high hydrostatic pressures, a hundred year, or once in a lifetime storms;

for a PPLD form slope rise, in tandem, increases its area form side surface slopes into narrower breadths that with cross-sections height narrows transition region breadths, giving upper retention, globose form breadths curvilinear or elliptical upright major axis forms; forgoing algorithm computing methodology carries out to a highest computational accuracy cross-sectional areas and perimeter fluid mass forms for least or no entire fluid mass rotations in PAP upright plane toward highest conserving of mass energy modes; a PAP upright plane horizontal orientation in space constitute absolute symmetry of forms up to DCSS springing points elevations having least or no detrimental retained, detained, transported fluid mass rotations constitutes in PAP upright plane symmetry said “flow control means” laminar fluid mass;

globose gravitational field energy modes classic containment spherical, globose highest energy modes genome classic forms retain mass units constituting computed least resistance paths, said paths-of-passage, PP, lengths least sum that here applies to retained, detained, and transported nonsteady, nonhomogeneous, and nonuniform mass; conduit forms must exist for transfer of energy modes; generic claims PAP, PPLD, PP with PP lengths least sum defines confined mass modes of energy transfer self-conservation with units of mass PP of least resistance make up of basin-outlet classic globose-conduit forms conformed embodiments, Sets; said PP lengths least sum computes open channel fluid said centroid locations and least height classic forms for retained and transported fluid mass with least or no rotation forms, for ordinary design use, with infinitesimal elements designs for scientific purposes; practical construction purposes, crafts finest tolerances constitute said finest units, least mass, lowest surfaces, slopes, shortest or least height, length, and said stated required construction implements stated principles that conserves fluid mass and energy;

each breadth different width above PPLD width of band highest elevation makes on infinitesimal scale a stair step like change; a step constitutes summation of mass units widths that make least resistance paths of least elevations derived by said PP lengths least sum; forgoing statistically compiled fluid mass properties, especially specific gravity of particles, into curvilinear forms computing methodology for influx of units of fluid mass constitutes each mass unit path of least resistance that algorithm amalgamates into entire mass PP with lengths least sum; units of mass PP lengths least sum makes lower cross-sections a viable conduit area with a perimeter form; by definitions, inverts of globose-conduit forms, PPLD width of band horizontal segments, constitute highest elevations; a horizontal chord, breadths at respective elevations, by PP lengths least sum computing is a least transfer of kinetic to potential mode of energy, highest conservation for fluid mass and energy; rising PPLD widths with length constitutes potential energy increase, while descending PPLD cross-sections respective breadths, conduit horizontal chords, lowering of elevations with length is potential to kinetic mode transfer highest energy conservation for statistically compiled fluid mass and energy composition, foregoing methodology for cross-section areas, perimeter computed effects least fluid mass least rotations in a PAP plane of symmetry, which requires exact areas and perimeter forms with length; with no PAP upright plane rotations, units of mass moves are confined by surrounding units of mass at respective elevations or move down, up governed by mass units’ specific gravity; in chords, breadths, horizontal planes units of mass are confined by surrounding units of mass eventually confined by cross-sectional area form perimeter form which implements least or no rotations in PAP upright plane of symmetry, least or no rotations in horizontal planes for no fluid mass energy influx changes; said changes require at least a change in retention free surface elevations and that also require areas, perimeter change effected by aforesaid computing for highest probability statistical fluid mass influx, outflow balance; this requires a continual slight narrowing of conduit forms lengthwise breadths with an even smaller transition region breadths increase toward a DCSS or next Inlet fluid mass influx, which constitutes immaterial change for crafts, trades fabrication; upper globose and transition region cross-sections computed similarly makes complete complement of forms that constitute cross-sections classic areas and classic perimeter of entire globose-conduit Set of nonhomogeneous, nonuniform, nonsteady fluid mass FESD forms;

a PPLD constitutes globose-conduit unit of mass lowest path of least resistance for said globose form conforming least mass, fluid mass least height conduit form highest elevation highest conservation of fluid mass energy conversion from kinetic to potential mode; gravity force pulls higher specific gravity particles toward a path-of-passage-of-least-energy-demand, PPLD, with lighter particles moved to equal or low specific gravity mass higher elevations; confined by narrowing of a globose, conduit ascending spout, heaviest particles are squeezed into a PPLD narrowest width highest slope single largest sphere that just passes through said spout rounded lowest surface area cross-section that is said PP lengths least sum FESD form; surrounded by highest specific gravity transport fluid mass of highest viscosity said largest sphere is pushed in back pulled by transport fluid drag while allowed to rotate in PPLD direction toward summit without rotations of entire fluid mass, sub-outlets, First Sub-outlets, detention fluid free surfaces essential elevation height is said largest sphere passing through Sets submerged height elevation at summit;

an End 2 undersurface is located at about one half of upper retention depth that with a free fall locates inflows mass centroid into a lowest ¼ of a basin retention depth; ignoring viscosity friction, adhesion, at a DCSS form, velocity of water at depths below a fluid free surface equals the square root of twice gravity acceleration times a fluid depth;

high specific gravity inflows, outflows fluid mass is entirely through lower conduit form of globose-conduit cross-sections, globose-inverse First End located about one half of basin retention depth is entirely consistent with said heavier mass inflows, outflows;

ordinary fluid mass retention outflows are mostly through a lower small conduit cross-sectional area of a globose-conduit composite, ahead of a larger detention mass;

unusual, out of ordinary fluid mass outflows pass through globose cross-sectional forms;

heaviest mass centroid short height to a summit is most mass energy conserving; a globose-conduit shallowest retention also has heaviest fluid mass most raised centroid;

globose-conduit least conforming retention mass of least height of least rotations is least magnitude potential, kinetic exchanges of energy modes, kinetic potential energy mode exchange has rotational friction and viscosity losses; compared to round or similar piping, globose-conduit Sets forms complete complement amalgamated, least mass, least conforming retention, least rotations multi raise retained mass centroids, PPLD forms to highest elevations for modes of mass energy highest conservation; less is more, more is less, less energy transferred conserves mass, energy either one or both; Least rotations of least mass centroid at highest elevation a least height from fluid free surface set at highest elevations have Sets' forms highest conserving mass modes of energy; narrowest conduit breadths move heaviest fluid mass higher into entire cross-sections form, raising its mass, area, perimeter centroids to highest elevations matched by globose breaths, PPLD forms, fluid mass highest elevations, energy modes highest conserving;

least conforming fluid mass least rotations constitute least rotational frictional, viscosity loss higher potential, kinetic energy exchanges magnitude, mass energy highest conservation; globose-conduit conforming detention least height globose largest breadths, lengths raise entire mass centroid elevation eight times, once for each of four horizontal direction that is in unison with the other three, repeated again four times for conforming globose mass retention at rest, with fluid free surface elevations as kinetic, potential energy modes exchanges governing reference for least energy demand with PPLD forms at highest elevations; as a system amalgamated globose-conduits raise fluid mass centroids three times once for each globose conduit forms raised mass centroids once for highest PPLD elevations; globose-conduit sewer lines detention basin-outlet least mass conforming retention fluid mass centroids rotations are least distance from fluid free surface which makes for highest conserving mass energy modes balanced exchanges that inflicts least abuse or damage to earth's ecosystem mass energy balance as it follows energy balanced modes for conforming least mass least rotations conserves mass energy;

a detained larger mass at insignificant or no energy loss is conserving mass energy; globose forms detain transport fluid mass that counterpart conduit uses to transport mass;

pent up initial hydrostatic pressures cause discharge of nonhomogeneous heaviest mass, particles; pent up initial hydrostatic pressures are to fluid free surface essential elevations, only;

a globose-conduit conduit outlet, First Sub-outlet, DCSS greatly narrowed breadths with much larger globose breadths adeptly manipulates PP pent up hydrostatic pressures;

detention large breadths, lengths mitigate nonsteady mass flows to a least change from conserving mass energy fluid free surface highest elevations respective hydrostatic pressures;

herewith listed, also referred to, FESD specific forms are part of FESD globose-conduit forms whose specific purpose is prevention or restriction of fluid mass rotations for highest conservation of energy exact transfer of kinetic to potential energy requires energy path-of-passage-of-least-demand, PPLD, for a unit of mass that passes a summit; for near frictionless transport fluid critical path lengths are those against gravity direction as then mass energy required contains 32.2 (ft/sec; squared) multiple; smallest entire mass makes for least mass that requires said multiple for highest conservation of energy; such mass must preclude venting or backups found by nearly universal or ubiquitous empirical use conforming least mass contained by most compact least volume spherical modified to a globose form units of mass constituted PP lengths least height forms; nonhomogeneous fluid mass paths-of-passage, PP, lengths least sum contains horizontal components, also; conduit inverts, fluid mass units energy paths-of-passage-of-least-demand (most energy required), PPLD, identical PP length forms are referred to as such;

nonhomogeneous, nonsteady nonuniform conforming least mass high conserving energy modes fluid mass least rotations globose-conduit complete complement PP lengths least sum retention genome round, rounded, curvilinear forms has these globose-conduit transpositions,
round or rounded areas transposed to a conduit, an intermediate, and a globose form area higher centroids of retained fluid mass potential and kinetic modes of energy;
transposed round, rounded conduit cross-sections, fluid mass essential height as for a First Sub-outlet, constitutes fluid mass least rotations curvilinear least height form,
least rotations curvilinear fluid mass forms raise centroids of following,
fluid mass perimeter, FESD structure interface curvilinear surface, thus
viscosity, cohesion, adhesion, and solids surfaces friction centroid,
boundary layer perimeter laminar respective forces centroid location, as
transposed centroids, forces constitute one common centroid force with least rotations, for fluid mass varied compositions respective least height forms,
breadths, breach least height FESD make for fluid mass forms least rotations,
contained, retained, detained transported fluid mass-energy phases forms least PPLD width of band, lower conduit perimeter, and quintessential, core, self-conservation, self-preservation for a quanta mass form least height, a mass centroid highest elevations;

thus, a classic globose upper retention form and a classic lower conduit form constitute elevations of fluid free surfaces that is for a transfer of energy mode near or at highest elevations; a classic globose lower form amalgamates a lowest surface shrunk PPLD conduit form at highest elevations which conserves most of fluid energy transfer to potential mode to transport highest specific gravity fluid mass specifically effected by said classic conduit to globose form transition region, said PP lengths least sum of finite to infinitesimal retained fluid mass inherently constitutes self-conserved preserved energy highest conservation paths of least resistance which make open channel transition region of globose-conduit fluid mass forms; said globose-conduit transition region computing of forms forgoing figures wherein globose-conduit conduit basin-outlet, Inlet fluid mass forms may constitute an Inlet contained fluid mass outside a basin-outlet, especially fluid mass and Inlet forms that precludes suction or venting; transition region forms conserve fluid mass energy with computed highest elevations of PPLD and fluid free surfaces least height difference constantly continually that with a conduit form fluid mass constitutes an essential height; said PPLD constitutes lowest surface rounded form unless fluid mass highest specific gravity are highly uniform inflows that PP lengths least sum computes to a round form; rounded lowest surface forms constitute highest elevation for a statistical continual inflow rate that constitutes fluid mass detention wherein said inflows of a nonhomogeneous, nonsteady, nonuniform fluid is accounted for by lowest surfaces PPLD forms; for statistical standard deviations higher inflow rates rounded forms open into PP lengths least sum computed wide form of low slope sides surfaces or parabolic horizontal major axis forms; highest elevations PPLD forms govern unless cross-sections breadth or breach computed PP lengths least sum mandates a PPLD lower form;

shrunk PPLD forms rounded, elliptical upright major axis, or curvilinear globose-conduit forms makeup, transition region forms, PAP angles less than 180 degrees, and PP lengths least sum forms complete complement constitute claimed universe fundamentals,
a PAP two points as “surveyor stakes” that space align fluid mass energy forms with conduit, globose springing points constituted lower, upper transition region limits,
“self-designed” conforming PP lengths with least sum, fluid mass least energy resistance paths constituted fluid mass perimeter surfaces that are globose-conduit forms,
said PP paths as “self-designed” units of fluid mass paths that use least energy,
said PPLD forms as “self-designed primary paths” most efficient energy forms,
said classic retention genome, as contained retained energy genomes “parent”,
mass units' paths of gravity force least resistance is said PP mass energy modes quintessential highest conserving, self-preservation with natural disposition visible forms,
most self-conserved preserved fluid mass energy self-generates least magnitude of energy modes full transfer most shrunk PPLD form, globose-conduit compact forms;
said “parent” near spherical classic conforming retention amalgamates, its outlet conduit to make up highest conserving fluid mass energy globose-conduit Sets;
said infinitesimal units of mass PAP symmetric orderly outflows, inflows into, out of classic retention genome form as “old”, “new” units of fluid mass and energy;
aid fluid mass energy units as “participants” in “parent” mass energy universe;
said laminar flows mass units as a “confined unit” for fluid mass energy forms;
mass units PP lengths least sum makes least PAP angle unique Set symmetrical forms through a discharge-cross-section-surface, DCSS, and springing points elevations,
globose-conduit forms are within “genus” conforming “citizens”, Sets, by PP lengths least sum fluid mass energy highest conserving forms that constitute its universe,
lower globose basin globose forms amalgamate into a rounded or a curvilinear globose-conduit, First End, outlet, Sub-outlets, FESD, and DCSS FESD respective forms,
a Paths-of-passage compute PP lengths least sum, globose-conduit, PPLD, FESD retention conforming least fluid mass least rotations PAP upright plane symmetric forms,
classic genomes Set of forms conforming retention least mass least height is mass modes of energy highest conservation thus PP lengths (least resistance) least sum,
quantum units of mass PP least sum amalgamates mass units' paths into least height shallowest retained mass genome forms mass energy modes highest conservation,
genome Sets make for retained fluids least height, conforming least mass potential, kinetic energy modes quantum mass units least sum amalgamate into fluid mass and forms Sets,
said PP lengths least sum for a form constitutes a conforming or a genome form, genome forms complete complement conforming embodiments are genome Sets,
embodiment forms PP lengths least sum causes nonhomogeneous fluid mass conforming permanent retention kinetic potential energy modes passing heaviest particle,
heaviest particles, highest specific gravity mass PPLD entire length least height form, conforming retention least mass, height, and energy modes inflows transport mass through PP, quantum mass least rotations, mass energy physical forces compute a conforming embodiment,
a PPLD units of mass paths to summit topside PPLD width of band surface forms make for least rise slopes for said mass units PP lengths least sum narrowest breadths,
outlet FESD and DCSS forms PP lengths large breadth upper area cross-sections higher than globose forms springing points elevation limit fluid free surface rises to hold least height, least conforming mass fluid retention kinetic energy transfer to potential energy mode,
further fluid free surface rise potentially wastes both,
a greatest particle height constitutes a free-fluid surface detention essential elevation, PP lengths least sums lowest elevation and First Sub-outlet forms least height,
essential detention free-surface elevations require no kinetic to potential energy energy-demand transfer required for continual mass and energy highest conservation,
open channel globose-conduit forms nonhomogeneous fluid solids mixtures mass energy self-preservation containment, detainment, and transport are within one form,
globose-conduit forms contain Inlet retention and forms, that altogether inside a basin-outlet constitutes a globose-conduit conforming least mass least forms Set high modes of energy,
quantum-mass PP complete complement computes Sets' least resistance forms;

generic globose-conduit claims: path-angle-of-passage, PAP; path-of-passage-of-least-energy-demand, PPLD; paths-of-passage, PP, with a least sum constitute fluid mass globose-conduit conforming embodiments self generated Sets; globose universe conforming embodiments, Sets genus, is generic claim classic Sets conservation of mass and energy of fluids and solids mixtures that originate from said classic unique retention form genome; a PP, paths-of-passage, lengths generic claim to algorithm computed least sum is energy balance for entire retention mass quantum mass upright components with gravity acceleration multiple which through reiterative process arrives at fluid mass and structure forms interface ultimate Sets, genomes; forgoing specified at least two points aligns Sets to a linear PAP least angle alignment and symmetry of forms; genomes best construction of surface forms narrows the first application globose conduit construction and forms tolerances to commercial, industrial forms herein said complete complement of completely matched forms of Sets; sciences, art fields' nuclei or subatomic, microscopic or submicroscopic complete complement of forms is quintessential of globose-conduit potential, kinetic near infinitesimal quantum mass energy modes transfers perfection that is beyond human skill to create or duplicate;

globose-conduit conforming embodiments classic universe forms contain, retain, detain, transfer and conserve mass energy that transposes globose-conduit, open channel, nonhomogeneous to homogeneous high pressure round water pipe, electric wire or vice-versa or round, globose, spherical retained mass with generic PP lengths least sum claim;

microbes microscopic, submicroscopic thin disk or short rod line like, single form cells contain, retain, transport, or detain submicroscopic ecosystem inflow, outflow mass constitute an Inlet, a basin-outlet forms of globose-conduits basic types least Sets make;

conforming embodiments conforming least mass, height, hydrostatic pressures, surface area, quantum mass rotations, PP lengths least sum thus frictional losses makes for mass energy constituted highest self-conserving globose-conduit universe FESD forms, Sets, and domains; globose-conduit forms forgoing properties are highest mass energy conservation from infinite to infinitesimal ranges constitute highest “best mode of operation” over existing and prior patents; least separation of heaviest mass and detention transport fluid mass centroids require less transport fluid mass and its energy; two, three dimensional FESD forms of globose conduits much wider breadths larger area compared to entirely round or otherwise similar conduit forms hold transport fluid mass with least or shallowest detention, retention mass height that is set at highest elevations for respective Set fluid mass inflows, outflows; for continually raised heavier fluids centroids toward a DCSS with entire fluid mass least or no rotations in PAP upright plane makes for highest mass and energy, especially transport fluid mass variable inflows with specific gravity variations mass, energy conservation;

frictionless fluid least rotations consume least to insignificant amounts of energy modes; globose-conduit systemic highest self-conserving energy modes retains, detains, and transports manipulated mass energy mass, area, and perimeter centroids as follows,

two PAP points align upright plane symmetric globose-conduit forms flexible to rigid least Set rotated forms to a finite or infinitesimal PAP angles accuracy analogous to “positioning members” with forms having up to near infinitesimal “flow control means”,

globose-conduits PP make paths of least resistance cross-section areas breadths for fluid free surface least elevations difference from PPLD forms at highest elevations,

sets contain retain detain, and transport nonuniform, nonhomogeneous, nonsteady classic area, perimeter conforming least mass, height, fluid mass for least or no detrimental rotations;

globose-conduit quintessential fundamental, evolutionary, natural, highest self-conserving self-preserving superiorities self-generated mass energy forms is as follows,

1. globose-conduit mass inflows preferentially distribute transport energy modes into heaviest fluid mass PP, PPLD forms at highest elevations with respect to its summit,

2. globose-conduit forms push highest specific gravity mass ahead of a transport fluid mass at three locations: a) under an End 2, b) prior to a summit, c) after a summit,
a. under globose End 2 least conduit height, with a lowest PPLD form at highest elevation, with separations that need not exceed much inflows mass largest particle size,
b. with narrow breadths conduit transported heaviest mass risen centroid pushed in front, ahead of detention mass ahead of a First Sub-outlet by conforming quantum mass least rotations,
c. passed summit with transport fluid greater drop into pushed ahead heavier fluid mass similar to fluid mass Inlet inflows, accentuated by Industrial Sets heavy, transported fluid mass passed through a lower First, a higher Second Sub-outlet forms, respectively,

3. a globose detention in tandem rise behind a risen transported mass centroid,

4. transported, transport fluid tandem raised, lowered respective mass centroids,

5. a much small transported mass in front of significantly larger detention mass,

6. compact retention, detention highest mass centroids in respect to its summit,

7. highest mass centroids a least distance, rotations from a respective summit, constitute a viscosity, boundary layer friction conforming retention least mass modes of energy least losses,

9. a narrow conduit breadth at summit raises up globose detention pressure,

9. a globose-conduit, one-form, least energy modes demand raised detention pressure, heaviest mass centroid retains or detains, transfers mass energy highest modes; kinetic, potential is useful energy mode; least mass rotation is conserving both,

conserving of both is because energy modes are least energy demand transfers,

quantum mass energy modes are exchanges for inflows mass energy same sum,

11. a globose detention mass pant up pressures separate, dilute, or dissolve a transported mass in its path with raised centroid least apart from transport mass centroid,

11. open channel forms adeptly manipulate energy-modes gravity force caused,

12. globose-conduit nonhomogeneous nonuniform nonsteady modes of energy mass, cross-section areas, perimeter centroids align for highest mass energy conserving,

13. generic PAP, PPLD, PP lengths sum, conforming embodiments, evolve or devolve globose-conduit forms into round or entirely round conduit cross-sections and or globose spherical or spherical retained mass forms that rotate, mutate, transpose, transfer, make unique origin universe highest conserving mass energy phases, Sets, and domains,

14. globose open channel basin-outlet spouts manipulate, adeptly amalgamate mass energy modes one-directional linear or circumferential globose or circumferential cross-section areas of retention, detention that otherwise requires three-elbows assembly,

globose, circumferential are highest self-preserving mass energy two strains of forms; a one-directional less than 180 degrees alignment is one within cosmos' gravity fields,

15. self-conserved energy process among naturally evolved or man made forms constitute classic chains with globose-conduits as natural, quintessential dominant links,

16. fluid mass forms of energy, composition, and physical properties highest self-conservation globose-conduit forms evolve into classical round forms and vice versa,

17. a transport of high specific gravity mass heaviest mass classic globose-conduit detention PP lengths least sum height mass energy absolutely dilutes, tears up, disintegrates, moves or transports which conserves useful energy modes mass energy, a fluid mass air is controlled into out of open channel forms as an enclosed boundary,

18. basin-outlets least Set includes Inlet forms inside, a conforming retention, a globose-conduit transported detention, and an Inlet fluid mass outside of its basin-outlet,
a. conserving mass energy inside enclosing boundaries; mass energy modes stated inventions, principles, and methodologies requires respective boundary of physical, nuclear molecular, living cells chemical mass energy modes forms,
b. contained modes mass energy forms require at least one enclosing boundary,
c. globose-conduit open channel forms transport of fluids and solid particles of nonhomogeneous mass energy is comparable to round pipes, electrical wires transport of homogeneous mass, energy, and atomic subatomic round forms retained mass, energy;
d. paths-of-passage lengths least sum amalgamates nonhomogeneous, nonsteady, nonuniform, mass-energy units viscosity, adhesion, cohesion and fluid structure interface perimeter boundary layer adhesion, friction into highest mass energy conserving forms,
e. classic globose-conduit genome forms constitute classic perimeter form Sets; globose-conduit principles, methodologies are homogeneous mass applicable; partial suctions of globose-conduit smaller than ubiquitous permanent retention is safest quickest recovery of upper retention of highly conserved fluid mass and energy,
f. a rise in globose-conduit, basin-outlet PPLD band in tandem with narrower lower conduit cross-sections breadths is completely complimented by transitions regions least height wide globose breadths forms having essential height or greater elevations,
g. mechanics of forms contain modes energy highest sum at highest elevations,
h. a retained fluid mass defines a lower retention, an upper retention and a detention form; an upper retention at rest makes a free surface; a detention makes a free surface that is higher than said free surface at rest,
i. globose-conduit said fluid mass energy least sum PP lengths are one forms for highest statistical-probability of nonhomogeneous, nonsteady, nonuniform, retention detention least PAP angle, quanta mass least rotations, FESD forms PP lengths least sum classic perimeter forms that contain, retain, detain, and transport fluid mass energy of globose-conduits, which themselves constitute FESD forms;

domains of globose-conduit universe FESD forms with said PP lengths least sum surfaces restrict rotations of mass in three orthogonal planes especially prominent among named makeup Troughs, Ridges, Partitions, globose End 2, globose-inverse First End forms and undersurfaces, doming Cavities, Bridging-Wall, Fin and DCSS FESD forms; troughs raise globose forms sides lowest surfaces wherein Ridge, Partition FESD forms raised PPLD lowest surfaces into two PPLD higher elevation forms; troughs, Ridges and Partitions are globose conduit forms integral parts concepts that raise heaviest fluid mass centroid twice, once as a part of globose-conduit forms lowest surface highest elevation raised with a presence of such forms makes least fluid mass least height narrower breadth two cross-sectional areas to thus again raise nonhomogeneous heavier mass centroid; a narrower PPLD form initiates earlier lowest surfaces rise with narrower breadths constituting lowest, lower surfaces faster rise by said FESD forms;

figures of globose upright, angled to about upright, angled, industrial, low angled, Inline, inverse and hybrid forms claim globose-conduit universe of Sets, forms, hybrids, migrations, mutations, entire G-C universe domains, genomes, along with classic forms classic perimeter Sets inventions, methodology, and principles, and concepts disclosed;
energy and fluids mass finest elements algorithm computed PP lengths least sum perimeter boundaries constitute science academia infinitesimally exact fluid mass energy perimeters; plugs, Caps Portals, and nozzles are replaceable by continued streamlined surfaces; nozzles especially high inside an Inlet is tolerable as fluid free surfaces at this elevation is at or above said detained fluid mass essential elevation; sidelong Sets make for one-directional PP lengths sum; a sidelong offset to an anti sidelong, a near upright Inlet is respectively closer to respective DCSS forms, PP forms and PAP aligned save mass-energy, Trough, Ridge, Trough-Ridge, Partition, or Trough-Ridge-Partition FESD removes and or manipulates excessive mass-energy PP bundles, FESD forms conserve fluid mass-energy by a reduction of mass or mass rotations or both;
the first application specifies gravitational field forms that contain, retain, detain, and transport modes of mass energy; continuations, this application continues describing forms process to one that has mass and energy conservation laws, conforming conditions, to energy-modes transfers including boundary, perimeter, energy losses to define forms; no maximum or minimum boundary conditions restrict generic claims PP PAP, PPLD, conforming embodiments, other than universal laws of mass energy conservation which allows for various conditions of various conforming boundaries to define modes of mass energy phases conserving conforming embodiment forms, Sets, and domains; the first application first paragraph embodies piping universe without an exception; unrestricted mass modes of said piping universe and globose-conduit forms are one space universe; globose-conduit perimeter forms are imposed boundary conditions for a quantified mass energy highest self-conservation self-preservation graphical visual illustration of useful, contained, quintessential, mass energy phases' perimeter; continuation applications revise restrict, by said generic claims boundary conditions, perimeters of the first paragraph of the first application to quantum mass PP lengths least sum computed mass energy highest conserving perimeters;
by imposing ecosystem universally most friendly boundary requirements, entirely releases, removes artificial, unnatural boundary conditions quantum mass PP quanta mass constitute entire universe, cosmos contained, retained, detained or transported phases of mass energy bodies with gravitational energy or force; omnipotent potent contained one- mass energy forms constitute globose spherical, spherical perimeters gravitational field of same forms with intellectual boundary surface visualization enclosing gravitational force field energy; orbiting mass energy modes phases detained by its omnipotent gravitational energy mass constitutes potential conduit forms; analogous parallelism on atomic scale is nuclei mass energy spherical forms contained mass energy with orbiting electrons that constitute a perimeter form that allow inflow outflow of other electrons as an omnipotent atoms mass energy respective detention;
mass energy inflows, outflows on microscopic, submicroscopic scale constitute an inlet, an outlet with a single cell, or a most primitive organism globose or cylindroid detention forms with cell membranes boundary as conforming conditions perimeters; partitioned mass energy conservations subdivide into globose-conduit cells; accepted omnipresent parallelisms among mass modes of energy forms by universal mass and energy conservation laws herein extend to nonhomogeneous, nonuniform, nonsteady mass energy respective phases of mass energy perimeter forms;

globose-conduit classic forms contain detain and transport nonhomogeneous fluid comparable to subatomic, atomic; microscopic, submicroscopic; high pressure water pipe or electric wire classic forms, perimeters contained, detained, and delivered mass energy;
straight lines constitute mass energy highest conserving path between two points; a straight-line path away from a rotating mass traces a circumferential path in respect to its starting point; a linear, a circumferential PAP constitutes two most conserving mass energy paths of quintessential, core, or natural disposition, each with perimeter boundary respective conforming conditions; a linear or a circumferential PAP of equal boundary conditions PP lengths least sum with equal quantum mass equal energy have an equal core, quintessential, perimeter form and vice versa, wherein least or equal is not exact; globose-conduit and globose-circumferential universe domains of Sets PAP angle paths constitute a finite linear increment in upright plane with counterpart orthogonal upright plane containing a quintessential core image of highest preserving mass energy natural disposition perimeter; said image at best is statistical approximations derived with its exact form that is perfection beyond human skill ability to compute or construct;
a PPLD form defines a conduit perimeter for containment of mass energy modes or mass energy perimeter dissipates into ecosystem, universe mass energy natural disposition boundary perimeter forms;
as with other modes of energy, globose-conduit perimeter forms universe extends from microbes' submicroscopic, atomic subatomic to a cosmos makeup or vice versa; as most self-conserving mass energy modes exchanges quintessential, core, natural disposition form, globose-conduit forms classic perimeters alongside spherical globose form constitute parallelism analogy to homogeneous mass energy round conductors; as created suitable boundary conditions allow, quintessential, core, natural disposition of mass energy self-conserving, preserving will result in globose-conduit perimeter forms; unless globose-conduit boundary perimeter condition laminar mass perimeter is maintained a globose-conduit highest conserving mass energy quintessential, core, or natural disposition perimeter readily dissipates;
globose-conduit Sets make spouts lower surfaces contained fluid mass-energy one-transformation half-mode cycle, kinetic to potential energy highest conservation and PPLD FESD least height and length forms much shorter than are those of ubiquitous art;

a Nozzle FESD form may constitute a part of its End 2 undersurface form;
spherical globose highest energy modes genome classic forms retain mass units constituting computed least resistance paths, said paths-of-passage, PP, lengths least sum;
Inlet inflows provide fluid mass potential, kinetic energy modes with PP energy;
a PPLD width midpoint, said undersurfaces one point align tangentially for a Set of forms having a PAP direction horizontal orientation, PAP upright plane symmetry, and a basin-outlet rotation through a PAP angle in respect to the gravitational direction;
energy transfers cycle contained potential and kinetic mass-energy modes; forms of PPLD least height and length constitute PP least demand for transfer of energy-modes;
potential to kinetic mode quantum mass transfers constitute units of mass PP three components length; upright quantum mass-energy units contain the gravity acceleration multiple for computing quantum mass kinetic energy quanta sum that is PP lengths sum;
a fluid mass volume form with a center of mass located at a higher elevation or closer to a DCSS form constitutes conserved conforming mass energy conforming PP lengths lower sum;

globose-conduits correlate nonhomogeneous, nonsteady, nonuniform high mass energy conserving to elevations breadth specific deviations from lower to upper springing points breach;
an upper retention quanta mass conforming retention constitutes retained fluids surface-tension, adhesion height higher than a globose End 2, a globose-inverse First End undersurface, horizontal, radial, infinitesimal width highest finite increment continually entirely submerged;
a lower retention constitutes a region basin-outlet conduit spouts cross-sections forms gradual increase from PPLD width of band forms to said globose End 2, a globose-inverse First End undersurface, horizontal, radial, infinitesimal width highest increment;
a globose-conduit lower retention, smaller, short mass volume unified with a detention, an upper retention, dominant mass volume, least height hydrostatic pressures conserves energy;
basin-outlets, DCSS, PPLD widths of band, and drain lines smaller lower areas of rounded surfaces and narrower breaths than equivalent round areas breadths at a same rise from respective inverts constitutes FESD forms; round or rounded cross-sections length segment constituting said PP lengths least sum constitutes an FESD form part;
an outlet FESD rounded cross-section, DCSS sub-outlets First Sub-outlet height constitutes a fluid elevation height that clears fluid mixture largest submerged particle;
a retained fluid mass free surface elevation differences vary with inflows and are enhanced or controlled by composite forms cross-sections of a DCSS or an outlet FESD, and various Sets FESD forms respective areas breadths, breaches, and heights;
globose forms large lengths and breadths free surfaces areas minimize its rise; outlet and DCSS FESD cross-sections continue lower area conduit forms through a First Sub-outlet height into larger Second Sub-outlet cross-sections which also resists fluid free surface further rise conserving energy by transfer of energy-modes at a lower height;
said PP lengths computed least sum is for statistically compiled particles ranges, volume specific gravity, and shape sizes of mass mixture;
said Sets PPLD form retention volume “at-rest” is half as tall, of shorter length, and has a smaller to several folds smaller retained fluid volume than ubiquitous art forms;

conforming embodiments, PAP, PP, PPLD least quantum mass PP lengths least sum mass energy enclosure constitutes interface surfaces least resistance PP, forms;

inlet inflows provide nonhomogeneous, nonuniform, nonsteady contained retained, detained, transported fluid mass potential kinetic energy-modes;
quantum mass complete complement computed PP(s) are least resistance forms Set;
genome Sets PP lengths least sum makes conforming retention mass least height;
globose conduit, globose-conduit, basin-outlet, G-C, cross-sections are made up of a lower smaller area rounded conduit form, a transition region intermediate area form, and an upper area rounded globose form for a compact composite curvilinear form;
a globose-conduit globose area height can vary from about 5% to 95% of entire cross-section height with its globose form area breadth varied up to three times a breadth of a vented pipe to which its conduit outlet descending spout connects;
a least mass half-cycle energy mode change conserves energy and fluid mass;
a conforming least mass energy modes PP lengths least sum change is a Sets genome;
Sets may constitute genomes for specific fluid mixtures, only;
forms of PPLD band make for PP lengths least sum, conforming retention least mass, least height side-view “S”, “C”, or “S” and “C” forms, a PAP direction and a least angle, smooth fluid surface interface forms, from basin lowest PPLD forms ending with a DCSS form;
a PAP makes an angle less than 180 degrees in respect to gravitational direction, entirely aligns Set forms upright plane symmetric from a basin blind side through at least a DCSS, and upwardly entirely to at least include a globose form springing points;
a summit is a DCSS lowest infinitesimal width finite horizontal increment, outlet ascending spouts and PPLD forms highest infinitesimal end furthest from its respective Inlet, and a fluid tension and adhesion height higher than an upper retention free surface “at-rest” elevations retaining conforming continual least fluid mass, volume, and height;

globose-conduit paths-of-passage-of-least-energy-demand, PPLD, and PAP rotational angles less than 180 degrees that constitute least height basin-outlet PPLD for ascending lowest surfaces highest slopes smaller angles, inherently smaller angles shorter smaller slopes for a shorter entire length, with a smallest conforming retention fluid mass;
globose-conduit forms constitute domains of generic and circumferential strain hybrids of horizontal and upright orthogonal planes rotated globose genus form; generic circumferential globose hybrid domains are claimed as forms of globose domains;
migrations of globose Inlets End 2, globose-inverse outlets First End from basin-outlets blind side to an anti-sidelong location on opposite end of basin-outlet retention forms constitutes Sidelong, Sidelong Offset, Offset Centric, Centric, Anti Offset Centric, Anti Sidelong Offset, and Anti Sidelong Sets;
illustrating and describing a domain Set, entire domain Sets, its hybrids and Sets migrations within entire G-C universe range constituted Sets genomes is claimed together with Sets inventions, principles, methodologies, and concepts for retained fluids mass and energy conserving by globose conduit forms Sets and their circumferential hybrids;
basin-outlets basin upper retention constitutes largely one of five: truncated about largest cross-sections of globose, spheroidal, ellipsoidal, cylinder, or cylindroid forms of a short height that is shorter than a largest horizontal dimension of a respective basin;
globose basin lowest surfaces make largely one of following large forms: a rounded, an annular, a crescent, an about flat to doming annular, and an annular crescent, among many PPLD FESD geometrics forms of single or various streamlined compositions of least surfaces forms;
Inlet, basin-outlet retention forms with PAP upright plane of symmetry horizontal plane rotated about an upright axis, especially its Inlet axis, staying upright constitutes an upright Inlet Set; no perceived deviations from sciences upright make engineered upright Inlets and Sets, here;
a basin-outlet conduit outlet spout ascends from a globose Set First End surface inflection, an outlet basin end cross-section, or a globose-inverse submerged spout form lower end inside a basin-Inlet retention of respective globose, globose-inverse forms;
basin-outlets outlet spout cross-sections are made up largely by one of following FESD forms: a rounded, an elliptical, or a curvilinear geometries composite areas form;
outlets, DCSS, and Sub-outlets FESD forms constitute PAP upright plane aligned symmetric a lower, smaller, rounded conduit form, a transition region cross-sections, and an upper largest area largely a rounded, an elliptical, a parabolic or a curvilinear form;
globose-conduits correlate nonhomogeneous, nonsteady, nonuniform mass energy conserving to an elevation specific breadth deviations from lower and upper springing points breach for conforming retention fluid mass least height and rotations large free surface form;
flow-energy-surface-dispensators, FESD, PAP upright plane symmetric globose-conduit quanta mass, cross-sections, areas, shapes, heights, breaches, or entire breadths as G-C forms transform globose to conduit forms and vice versa; they make up conforming quanta mass least volume, rotations, perimeters, and PP lengths sum that constitute versions of following forms:
a three-dimensional Set (TD), circumferential, axial or transverse Trough, Ridge, an Inlet upright Ridge a Trough, a Trough in a Trough, a Ridge, a Partition with/without a Window(s), a Troughs-Ridge, a Troughs-Ridge-Partition and a Window(s);
a Disk FESD;
a baffle Partition FESD and a Window FESD;
a Circumferential Trough, a Ridge, a Partition, a three-dimensional Window and a Troughs-Ridge and a Troughs-Ridge-Partition and a three-dimensional Window(s);
a Nozzle local highly directional spout forms;
a globose End 2, globose-inverse First End and PPLD counterpart forms of a Set;
a Bridging-Wall with Domed-Cavities about Inlet forms;
a Fin FESD forms dividing globose-conduit cross-sections upper retention;
a Trough, a Ridge, an upright Ridge, a Partition with/without a Window(s), a Trough inside a Trough, a Troughs-Ridge, a Troughs-Ridge, a Troughs-Ridge-Partition with/without Window(s) upright plane axially symmetric forms;
an FESD manager enhanced control of fluid free surfaces height differences;
an FESD space manager exchange of air and fluid manages retention form free surface areas and elevations, thus cross-sections areas, height, breadth, breach and length;
cavities; dome Cavities FESD;
a rounded End 2, First End; a flared; an infant boot; a Fin End 2 FESD form;
a Migration Dimension(s) 44, (44, 44′);
a crescent PPLD conical form FESD;
outlets, DCSS and globose-conduit cross-sections areas breadth, breach, and height FESD forms managed effects of retained fluid free surface elevations, elevation differences, as counterparts of FESD mangers' and FESD space managers' forms;
flush Apparatus parts, entirely contained within walls of a Set with access to most Set locations, separately or concurrently to disinfect, flush, surface coat, repair or protect damaged surfaces; flush Apparatus prefabricated pre-assemblies use design fluids and or gases, or air, jointly individually or, to a separate sequence and intervals or concurrently, to a surface location or a Set entire with a single, a set, or a nozzles network, with tie-ins, or sets of tie-ins located conveniently about a Set; said Flush Apparatus assemblies are entirely inside conduit walls, except for tie-ins, and capable flushing any basin or Inlet retention space or location, such as, Inlet surfaces and or basin-outlet lowest surface PPLD width of band lengths or an entire length; shown capped a tie-in or at least one of shown tie-ins connects to a tie-in apparatus that may include line sensing device to initiate or stop a design fluid injection should basin retention drop to preset pressures; said Flush Apparatus deliver predetermined fluid, or gas, or air separately or jointly is delivered under controlled pressure to tie-in or tie-ins is discharged through any of sub-nozzles, 301, sub-passageways, 303, major nozzles, 405, major passageways, 304, and passageways, 310, respective branches set of tie-ins, 307, a set of sub-passageways branches, 311, a set of sub nozzles, 314, selectively pre-assembled; specific shape passageways such as upright Ridges FESD, FIGS. 8, 12, 16, and, 85-89 depict,a double wall inner space, 310, passageway FIG. 81 shown; a major nozzle 405 spray type flushes entire basin lower, lowest surface and into an outlet and lower Inlet;
a double wall inner space and gravitational direction compliant tubing show and warn expeditiously by dripping leak evidence that a wall leak has occurred;
said Sets exact globose-conduit construction is beyond human creative skills;
a descending outlet spout Second End connects to a vented drainage line with a positive rigid connection, which is one of two connections that support a Set;
connections are generally shown threaded or welded; compression couplings and flexible installed in place rigid with or without gaskets, washers, or bushings, and locked or double treaded or said connections suitable mix constitutes globose Set connections;
a top quality highest accuracy highest pressure moldings of plastics, metals, and their composites and or semi-rigid materials that are adequately rigid or are with positive provisions for sufficient stiffness or a fabrication combination of above makes said Sets;
one-way air nozzles are suction precluding measures; forms constitute smallest mass and height known to stop suction and or venting; forms are to crafts finite or scientific infinitesimal accuracy algorithm computed as needed;
fluids and solids particles of non-homogenous mixtures inflow through an End 1 into globose Set forms and by gravity force outflow through an outlet Exhaust;
inventions not restricted only to highest conservation of fluid mass or energy genomes disclosed narrow highly defined scope of fluid mass, and energy conservation of said inventions, which unify fields of arts and sciences;

this and continuation applications continue the first application specification, drawings scope is narrowed to fluid mass energy conservation by defined globose retention genus forms to the first application FIG. 9 “laminar flow” and its stated description and specification “flow control means” herein FESD forms; globose-conduit Sets originate with the first application open channel Set of FIG. 1-2, and 12; globose-conduit forms shown short height, in respect to length, especially short for the first application shown FIG. 1-2 and 12 Set, connect to building code vented pipe constituting open channel construction, its elliptical outlet descending form spout and channels about basin originates outlet FESD and DCSS FESD forms Figures herein show; the first application FIG. 1-2, 9, 12 stated “transition region” “means” that maintains “the transition region submerged” herein and continuation application numerous Figures define as upper, herein permanent retention extended upwardly from lower conduit form springing points and not taken higher than globose form springing points;

said classic retention genome, prior applications FIG. 1, shows globose-conduit parent form that uniquely originates globose-conduit universe domains of Sets FIG. 1 Set basin-outlet nonhomogeneous, nonuniform, nonsteady fluid mass forms modifies; a Set retains, contains, detains, and transports fluid mass that subdivides into finite units of mass having said PP lengths least sum; units of mass, PP length least sum algorithm, mathematically computes kinetic energy required for each mass unit to pass; a PP least sum constitutes quanta mass quantum mass paths respective path lengths sum with upright components having the gravity acceleration multiple;

figures of this application are the second application drawings; said Figures show open channel forms and are continuation from the first application Figures, especially said FIG. 1-2, 9, and 12; basin-outlet continuations of FIG. 1-2, and 12 shown major axis upright elliptical outlet and DCSS FESD forms and a Trough, a Partition, and a Trough, a Ridge, a Partition of FIG. 12 and FIG. 9 showed upright Ridges, nozzles and diffuser FESD forms; said FIG. 12 shows basin-outlet, globose-conduit forms with capped tubing about basin blind side through upper basin-outlet casing; enlarged, streamlined, said tubing constitutes a Bridging-Wall FESD which with globose basin-outlet makes for domed Cavities FESD forms about Inlet; capped at a specific detained fluid free surface elevation said tubing constitutes a space manager, SM, in respect to retained fluid free surface elevations; said SM not capped but connected to a one-way air inflow having basin-outlet perforations constitutes SM that precludes suction;

much larger cross-sections than those of a vented pipes a FIG. 12 Set basin-outlet spout constitutes and thus will not experience suction; a Flush Apparatus connected to SM outside air inflows is both, a Flush Apparatus and SM, and said perforations extended through walls of said Set constitute numerous Flush Apparatus assembles parts said continuation applications and herein Figures show; globose-conduit computed classic cross-section areas, perimeter, surfaces interface boundary forces, and centroid locations for least or no rotations about fluid mass centroid constitute said “flow control” mass and energy highest conservation;

said classic perimeter PP mass laminar fluid finite segments constitutes viscosity, adhesion, fluid pressure internal and boundary layer related forces with no rotation of fluid mass which is identical for homogeneous mass-energy; classic perimeter globose-conduit nonhomogeneous mass energy forms with parallelism travel across arts, science fields analogous to classic, homogeneous, mass energy round forms; classic perimeters mass no rotations or boundary friction constitutes translational energy mode ultimately conserved mass energy;

ascending globose-outlet spout Sub-outlets make either a rounded, or an elliptical major axis upright, or a curvilinear cross-section area form that passes statistically most prevailing continual detention mass with detention free surface at said essential elevation height that also passes said largest sphere as single most unusual event; globose-conduit classic forms constitute classic conduit forms that evolve or devolve from classic globose retention basin forms that also evolve or devolve into rounded, or curvilinear, or elliptical major axis upright forms; the first application FIG. 1-2, and especially FIG. 12 cylindrical basin-outlet globose form upright cross-sections behind and in front of its Inlet toward outlet, which transferred into elliptical major axis upright forms transposed into a round Exhaust cross-section are an open channel globose-conduit cylindrical versions the generic claims, the continuation applications and herein continues;

said generic claims mass energy self-conserving self-preservations allow computing of accelerated aging whose energy modes among depicted Figures or as described constitute scope of inventions, methodologies and principles of globose-conduit forms; classic globose-conduit spout rounded basic PP lengths least sum forms surfaces, a life span aged or specific events form make up globose-conduit universe respective forms, Sets, Sets' hybrids, mutations and domains, FIG. 16-18 shown Inline domain Sets primarily make up globose-inverse domain forms that with described mutations, and partitioned into multiple-cells, transfer into globose domain Sets; here, FIG. 2, 3, Section A-A forms shown ascending outlet spout rotated to 165 degrees PAP angle with a DCSS, descending upright spout as in FIG. 18 transposes a globose-conduit Sidelong Set to one cell of said Partitioned Inline Set which reassembled into a globose-inverse Set constitutes depicted Inline forms, said Angled domains described forms rotations constitute deviations rotated Sets from upright forms Sets mass energy conforming to the generic claims;

classic globose-conduit, FESD complete complement constitutes least cross-sections, breadths, fluid mass, mass rotations, surface lengths, and energy modes entire energy transfer;

hydrostatic pressure centroids of basin-outlet nonhomogeneous, gravity segregated, transported fluid mass is more than ⅔ of a hydrostatic height below retained fluid free surface elevations;

classic globose-conduit open channel forms complete complement conforming retention has least depth of PPLD forms quantum mass PP lengths least sum highest elevations fluid free surfaces large breadths and thus least PAP angle fluid mass rotations and hydrostatic pressures;

generic claims classic Sets, conduit Inlets basin-outlets open channel with conduit, outlet spouts narrow breadths conforming detained least height mass precludes suction and or venting;

globose-conduit open channel classic forms complete complement conforming quantum mass has the generic claims a much shorter PP lengths sum than ubiquitous or known art forms;

outlet, DCSS FESD forms open channel hydrostatic pressure release is fluid mass path of least resistance first application FIG. 9 Page 13, Line 1 ‘laminar flow’ and Line 3 ‘flow control’;

nonhomogeneous fluids solids open channel genus classic perimeter mass energy forms highest conservation genome forms with mass units PP lengths least sum has specific gravity, highest elevations least height and rotations, breadths or breach, surface friction, FESD forms;

classic globose-conduit open channel forms for nonhomogeneous fluid mass PP lengths least sum computation, paths of least resistance, transform or transfer into highest energy, classic nonhomogeneous, natural disposition, least retained mass, hydrostatic pressures perimeter forms;

globose-conduit forms transfers into known classic mass energy forms confirms they are of classic genus; conduit lowest surfaces rounded forms with PPLD horizontal width of band reflects upon nonhomogeneous high specific gravity fluid mass, sizes of largest solid particles, among other physical parameters; globose upper surface forms reflect upon nonhomogeneous transport fluids physical parameters and cross-sections area, cross-sections especially transition region breadths is nonhomogeneous retained mass least height form highest energy conserving;

elliptical horizontal major axis as fluid energy geometrics forms are subordinate to globose rounded conduit forms and except for curvilinear forms parts do not normally make up FESD forms except for preference by these very applicable specific exceptions:
a basin lowest surface part under a globose End 2, a globose-inverse First End;
a conduit form of highly homogeneous frictionless, no adhesion fluid surfaces;
a globose-conduit FESD curvilinear “crown” form that reduces forms height;
a part of curvilinear specifically applied outlet, DCSS, and Inlet FESD forms;

forgoing excludes entirely round forms that constitute parts or counterparts of PP lengths least sum FESD, and homogeneous, no cohesion, no cohesion fluid mass forms;

the first application FIG. 12 globose-conduit Set shown slanted circumferential channels inside basin discloses globose-conduit forms cross-sections behind and in front of its Inlet; also, shown are circumferential channels multiple passages, a trough, ridge, and partition FESD forms; said FIG. 12 outlet elliptical cross-sections near summit is nearly entire height of a basin upright cylindrical globose form that toward basin blind side widens then narrows with a globose upper part progressively shorter in height, with a First Sub-outlet short, less than a lower half of said elliptical cross-section height that are classic globose forms height large breadths make up cross-sections areas numerous forms that can match or greatly exceed cross-sections area of aforesaid vented pipe; globose cross-section areas greater or greatly exceeding a vented pipe cross-section area are a part of globose-conduit universe Sets constituted basin-outlet numerous FESD forms;

flush Apparatus tie-in assemblies with check valves can act as a controlled air and or design fluid inflow into a Set to counter suction through said single or networks of nozzles or sense a low basin fluid level to start pumping air and or design fluid;

flush Apparatus design-fluids adept usage approximates near frictionless surfaces;

forgoing describes ways to avoid suction, tie-in apparatus to Flush Apparatus to control suction toward conservation of energy by one-way air inflows at fluid elevation and or pressure below free surface “at rest” elevation is to start various air, fluid, and spray especially when said level and pressure are low; said Flush Apparatus is shown with the first application separated branch inlet, 12′, tube, herein, it is considered support apparatus assembly for conservation of fluid mass and energy; a branch inlet enlarged to bridge a basin blind side, Inlet breach makes a Bridging Wall FESD, or specific location placed, orientated a manager, space manager FESD form continued from the first application;

flush Apparatus account for numerous varied functions with design fluids and gases including air with its capping removed said branch inlet constitutes a Flush Apparatus tie-in major passageway which can branch out inside walls of Sets for single or complex and advanced nozzle assemblies FIG. 29-31 among other Flush apparatus shown assemblies; said tube larger size with nozzles also constitutes bridging-wall FESD forms;

cross-sectional areas PP lengths least sum algorithm computed statistical probability that solids and fluids mixture and elevations retention free surface probability combine into a highest statistical probability constituting frequency of occurrence bound by standard deviations limits; actual conditions, Flush Apparatus penetrations do no effect primary functions of a Set. Detailed describing follows:

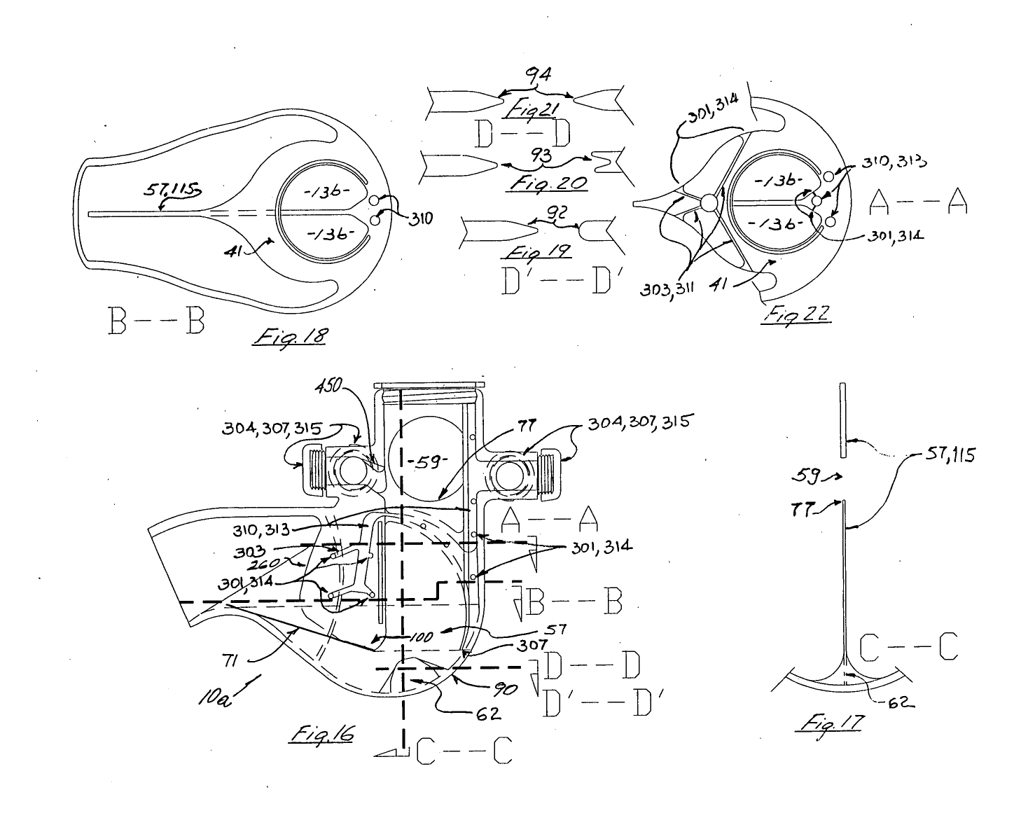

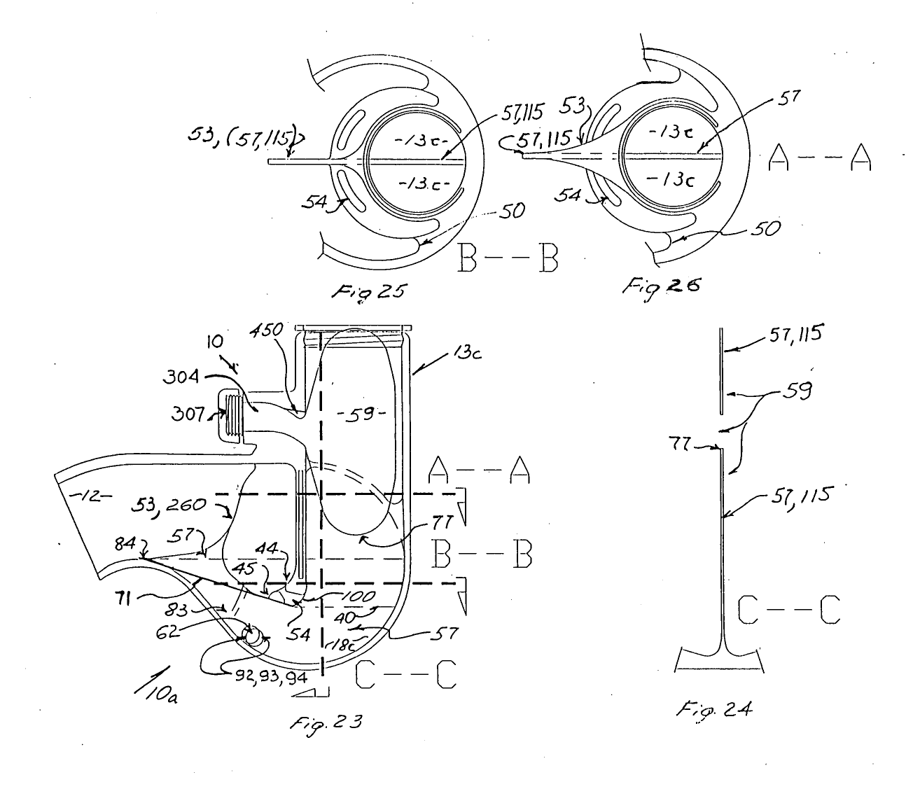

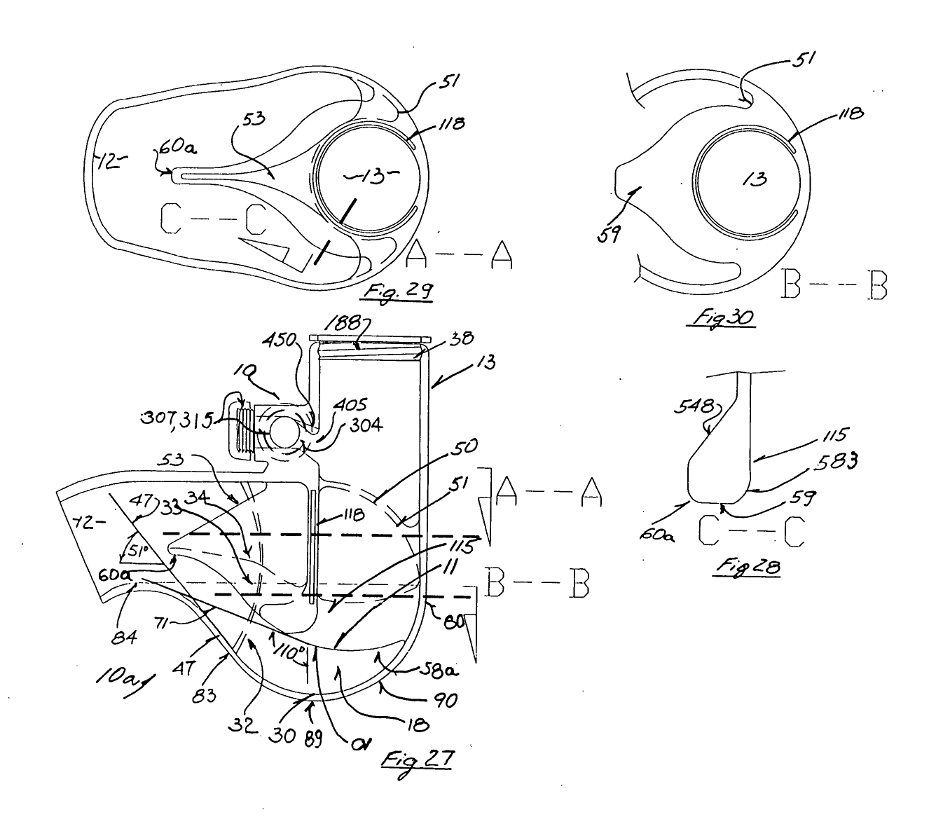

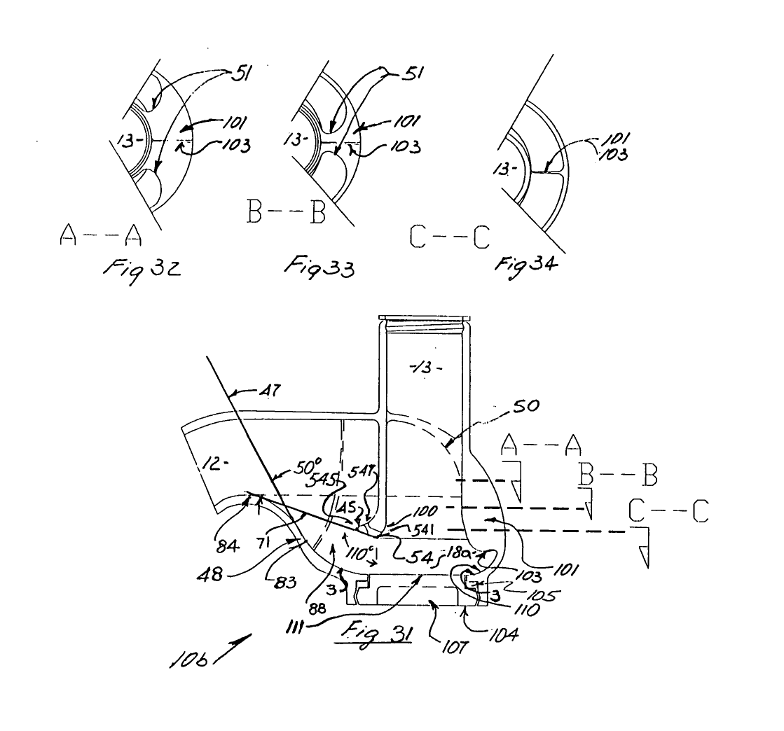

Graphical intellectual visualization side elevation view of globose-conduit universe genus ‘parent’ taken generally about a PAP upright plane of symmetry FIG. 3 imitates. Advanced forms may constitute Troughs, Ridges, Partitions and FESD forms as inflows outflows controls through globose basins cells conduit passages, the first application channels, especially FIGS. 1-2, and 12, especially with numerous figures a least Inlet, basin-outlet for said ‘flow control’ laminar flow'. Mass energy forms unique origin perimeters evolve or devolve, rotate, mutate, transpose, and or transfer to thus contain, retain, detain and transport highest mass energy modes to forms universe perfection beyond human creating skill. Globose-conduit quintessential, core, natural disposition mass energy conserving classic enclosing perimeters classis ranges from infinitesimal to infinite. The fourth application FIG. 1 generic ‘parent’ enumeration nomenclature illustrates rotations and orientations of this ‘parent’ form evolved figures, herein, illustrated unchanged Sets with the first Provisional application and the second application. Sets contain, retain, detain and transport mass energy as the first application shrunk forms to quintessential, core, natural disposition inventions, principles, and methodologies classic globose-conduits illustrated mass energy self-conserving.

FIG. 1, FIG. 2 of the drawings shows a schematic outline side elevation view generally about PAP symmetry plane of a Globose Sidelong Set, and ubiquitous trap, respectively. Said outlines show comparison of the two based on identical Inlet's cross-section diameter “r”. FIG. 1 shows PAP angle of 108 degrees. A surface highest slope of 60 degrees has location A. as the known ubiquitous trap FIG. 2 does not constitute a linear PAP, makes a rotational directional conduit change of 180 degrees, shown by dashed, bold broken line arrows, and has location A′ surface highest slope of 90 degrees. A construction joint required at A′ not shown constitutes ⅛^{th} of an inch a length of 90 degree slope and thus maximum hydrostatic normal pressure of 2.125 inches of water compared to 0.5 inches for FIG. 1 Globose Sidelong Set.

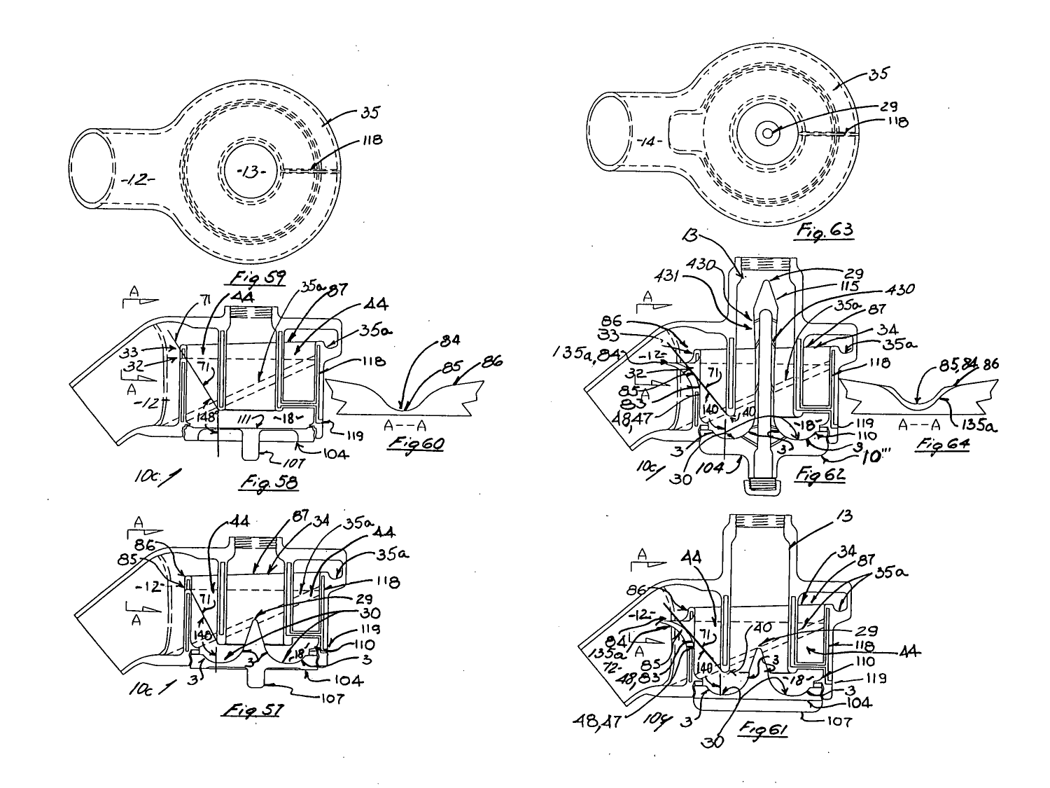

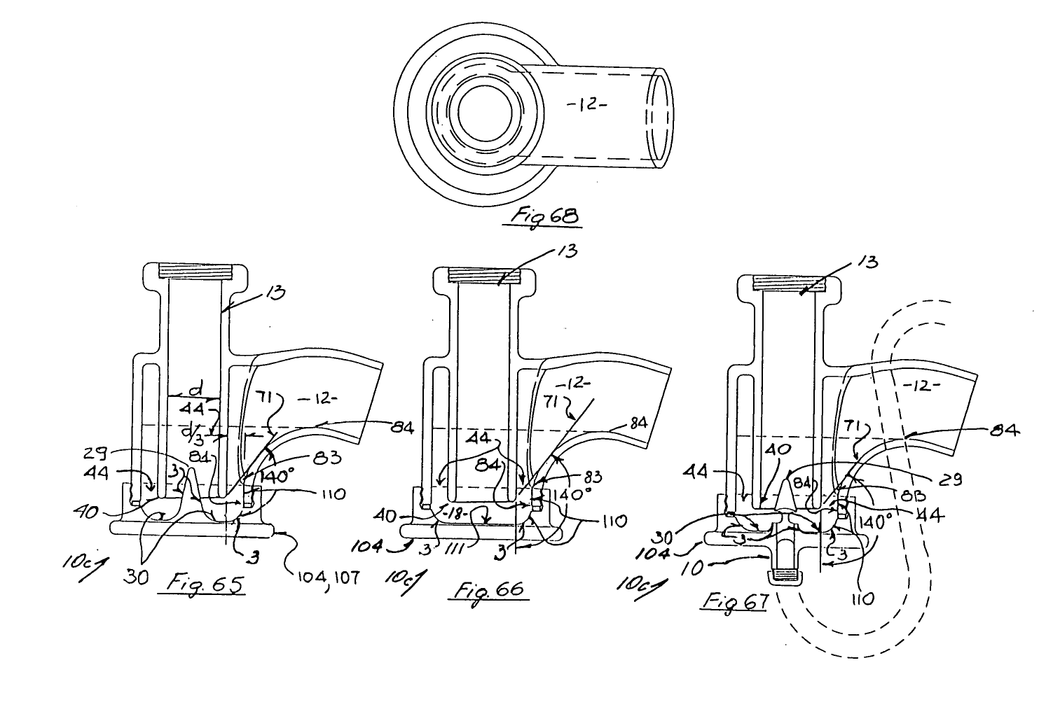

This operating pressure drop is equivalent to systolic pressure drop from normal of 120 to less than 29 mm. of mercury, a 75% drop. This assumes a highest systolic pressure of 240 mm. or more for an engineering safety factor of 2, wherein for the two figures it is 4. Said drop becomes greater when fluid free surface rise has globose-conduit fluid mass minimized height upper cross-section globose area. Least perimeter interface area of FIG. 1 equivalent to about a half spherical figure, compared to FIG. 2 cylindrical length of 3.25r, has a surface area reduction factor of about 70% and its comparative frictional energy loss of only 8.4%, or less than one order of magnitude. Further, DCSS FESD Sub-outlets such as FIG. 62 shown greatly restrict hydrostatic pressure rises.

Simple traps retained fluid mass is more than twice that of Globose Sets. Energy that lifts entire retained fluid mass passed summit is at least than five times greater for ubiquitous traps, for DCSS FESD Sub-outlets retained mass lifts to elevations not significantly higher than its summit. Most importantly, Inlet heights need not extend much passed a basin-outlet perimeter as claimed by the first application Figures, especially FIGS. 1-2, and 9-12, herein FIG. 50-59, and said ‘parent’ of the globose-conduit universe, which significantly contributes toward realizing laminar flows. Aforesaid raw numbers must include a PAP directional multiple, herein, a difference exemplified with surface slopes, said highest sloped forms lengths respective inflection point 50 degree slope verses 90 degrees, or at least 0.55 reduction factor for ⅛ inch length, graphically represented an energy demand magnitude that is continually much smaller for FIG. 1. Globose-conduits quantum mass perimeter least rotations imitate variable cross-sections straight pipe laminar flow compared to ubiquitous traps uncontrolled mass rotations through a curved pipe more than two times longer.

Energy savings difference for the two figures is closing on two orders of magnitude that for a nonhomogeneous mass particle passing or not passing is difference that implies infinity. Clearly, globose-conduit classic form confirms its place with mass energy classis of classic forms.

Globose-conduit parallel analogies, schematic FIG. 1-2 evaluations verify universally, nonsteady, nonhomogeneous, mass energy, most significant innovations massive environment conserving.

FIG. 3 of the drawings shows a Globose Sidelong invention Set 10a cross-sectional side view taken generally about PAP upright plane of symmetry. A most upright inflow Inlet, 13, makes a rounded lower end annular form, an End 2, 40, an upper end, and an End 1, 38. A basin-outlet makes a near spherical globose basin form, 18, a narrow finite length horizontal widths merged into a band side elevation viewed shrunk “S” PPLD form, 7, initiates makes a basin rounded lowest spot, 89, ends with aforesaid outlet form with a summit, 84, narrowest width of band that is lowest horizontal segment of a DCSS form, which is orthogonal to said summit PPLD form. Basin-outlet outlet, 12, forms consist of an ascending spout that makes up said PPLD form from an outlet First End, 83, surface inflection into said summit DCSS and an outlet descending spout from said DCSS into an outlet Second End, Exhaust, 384, round form. Set's invention basin-outlet, a classic retention genome mutated form, amalgamates forms into a basin complete complement, mechanics of forms. Inlet sides and globose near hemispherical basin constitute narrow breach, an upper retention short height cross-sectional area, Cavities FESD, 50, conduit forms to merge by basin's narrowing into said outlet conduit ascending spout First End. Said End 1 topside of said End 2 undersurface above a short height, 88, is a lowest, also a lower, conduit form under Inlet that starts with said undersurface, basin blind side common surface, and is an Inlet perimeter closes to said outlet DCSS topside said basin PPLD rounded lowest surface spot location. PPLD forms make retained and inflow fluid, nonhomogeneous, nonuniform, and nonsteady, mass energy forms that computed statistically constitute highest transfer from kinetic to potential energy mode by PP lengths least sum till entire retention quanta mass is replaced by random and mass equivalent mass energy inflows. Energy mass detention topside said randomly replaced permanent, continual, retention the forgoing defines as fluid mass above free surface at rest, dashed line. Continual and detention retention free-surface elevations, largest breadth and longest length PP lengths least sum computed finest approximations that constitute successive shortest height elevations difference from said lowest PPLD FESD round spot to having highest PP springing points elevations and said symmetry upper limits. Globose End 2 (or for globose-inverse First End) forms are entirely submerged in a conduit to globose transition region rounded surface area forms breadth's transition for a globose to conduit intermediate region, below upper retention. Transition regions from lower conduit, 88, springing points at most extend to DCSS springing points. Ascending outlet conduit rounded spout from a First End surface inflection, 83, to summit, DCSS, continues as a descending spout ending in an outlet Second End Exhaust, 384. Said End 2 side elevation view convex undersurface sustains short ,88, conduit height separation from said basin lower, lowest forms counterpart FESD surfaces that from said basin blind side perimeter surface slopes to effect kinetic potential energy said modal changes. Said change starts with PPLD rounded lowest spot under said undersurface that by PP length least sum is shortest distance to said DCSS narrowest, PPLD highest width of band summit. Said PPLD, 7, globose generic “S” highly shrunk, highly forward slanted form has a PAP, 47, angle of 105 degrees PP lengths least sum, and an End 2 separation, 88.

Open channel mechanics of forms for a potential to kinetic energy half mode change by said PPLD narrow width of band form is most suitable for a laminar flow, flow control means stated by the first application. Other half part of energy mode cycle is potential to kinetic energy change that starts with said End 1 inflow. Upright sections that cut through basin clear of Inlet consist of globose-conduit short height of an upper area globose form, a lower area conduit form, and a transitions region form least height from said conduit to at most globose springing points, for globose conduit largest breadth fluid free surface, PPLD orthogonal cross-sections about as FIG. 80 shown. Said three cross-section make globose-conduit, G-C cross-sections area forms of the first application FIG. 1-2, especially FIG. 12, shown continued here, in pending applications as globose, or as cylindrical versions of globose-conduit generic, classic cross-section area forms.

Globose-conduit cross-sections upper globose, transition regions and lower conduit forms allow varying breadths, breaches respective length restricted by least conforming mass continual retention free surface forms, and globose-conduit classic forms genomes least mass least height constituted energy mass highest preserving generated by its classic least perimeter height forms.

Globose-conduit nonhomogeneous nonuniform nonsteady inflows of fluids mass specific gravity and gradation of solid particles generate fluid detention mass high pent up hydrostatic pressures classic conduit forms amalgamated into classic perimeters conserve inflows generated mass energy and pressures continually consistently for transported waste mass highest passing.

Said End 1 cross-section net inflow area and the first application FIGS. 1-2, 9, and 12 is a multiple smaller than either area of its respective DCSS or Second End Exhaust cross-sections. Wherefore, hydrostatic pressures in a container of said fluid mass mixture that almost always has a round drain that has a counterpart End 1 round net area flowing full and not under a hydrostatic pressure causes in turn a rise of retained fluid free surface into its detention range. Said rounded DCSS lower area FESD form resembles and here is a First Sub-outlet oblong form widening thru its full height, then from DCSS springing points makes a globose upper cross-section crown part. Fluid mass inflow that causes End 1 entire net area flowing full has fluid free surface elevations proximate DCSS springing points. Said Exhaust, 384, round cross-section equivalent here to its DCSS, 84, cross-sectional area is under a potential pressure hydrostatic drop that extends from its DCSS, which for this example, is less than half full of flowing fluid. This off course allows for hydrostatic pressures rising in said fluid mass container that is accounted by a globose upper cross-section part. To minimize higher hydrostatic pressures in fluid mass a modified form of said DCSS with upper transition region area enlarged breadths into large globose form breadths, which the first application FIG. 1-2, 12 shown circumferential channels FESD forms, enlarge up to three times that is herein similarly shown by FIG. 51-62 forms. Aforesaid figures DCSS classic forms, especially the latter of the Figures show globose forms breadths increased for a preferred DCSS least height First, 85, Second, 86, Third, 87, Sub-outlet cross-sections areas forms is typical, with PP lengths least sum upright lengths 32 times multiplied. Further, a one way air inflow nozzle, suction relief when utilized, in globose crown avoids suction for extreme events of fluid mass passing. Said DCSS make an outlet and a summit FESD forms.

Said basin blind side shows a surface inflection, 80, said rounded surface having said basin and PPLD lowest surface, 89, a PPLD highest slope 50 degrees, 47, for a PAP angled leg, 71, of 105 degrees, a basin, 18, respective upper, lower retention, 18a thru d. Said undersurface shows convex form about a blind side and a front end. Kinetic to potential energy modal change extends through summit. Said PPLD “S” form smooth surface and PPLD PP are fluid mass and globose-conduit form thin boundary layer separated. Of infinitesimal difference, the two forms are taken identical except an infinitesimal fluid PPLD PP is topside of PPLD structure form and are considered as such herein. A threaded End 1 connects positively to a fluid solids mixtures source. Continued from the first application, Inlet form constitutes a very short or least height.

Aforesaid forms along with enumerated nomenclature through said generic FIG. 3 parent unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Mechanics of forms introduction to the drawings details globose-conduit universe, as sample Sets illustrate domains. Principles, inventions, and methodologies universe of presented forms which the drawings depict or specifications describe or sample figures illustrate reaffirms the inventions universal presence.

FIG. 5, Section A-A of FIG. 3 shows a partial section top view generally taken about Line A-A illustrating narrow breach conduit forms on Inlet sides inside described basin Sidelong form having narrow breach Cavities FESD, 50. An Inlet and an End 2 FESD forms make basin-outlet retention genome forms locations, especially as outlet and DCSS FESD counterpart forms. Round Inlets extend a reservoir round drain with non-round Inlets as PP lengths least sum forms.

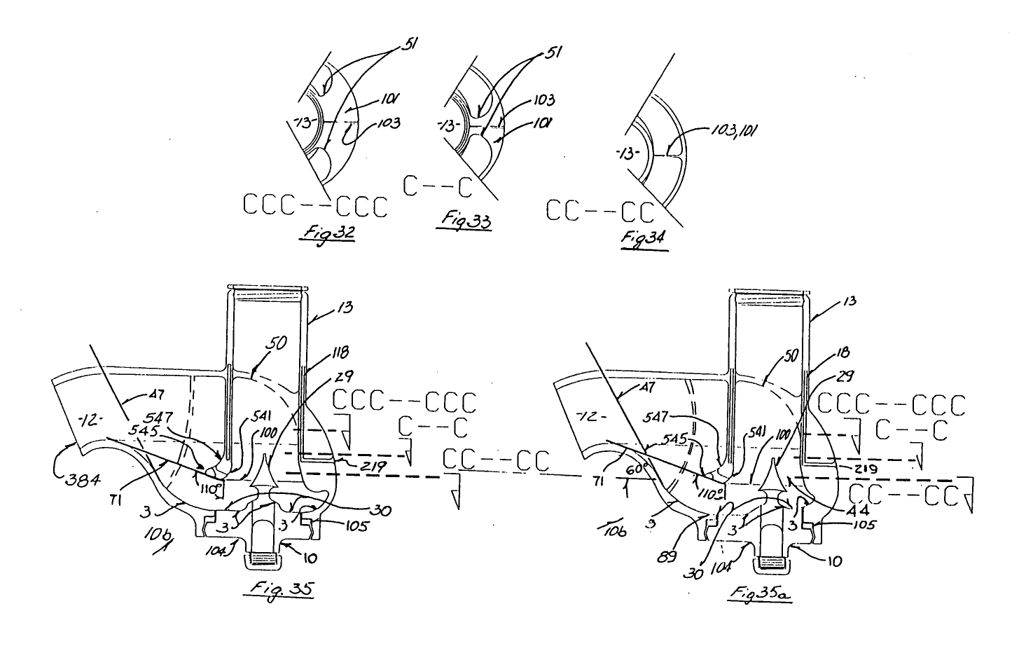

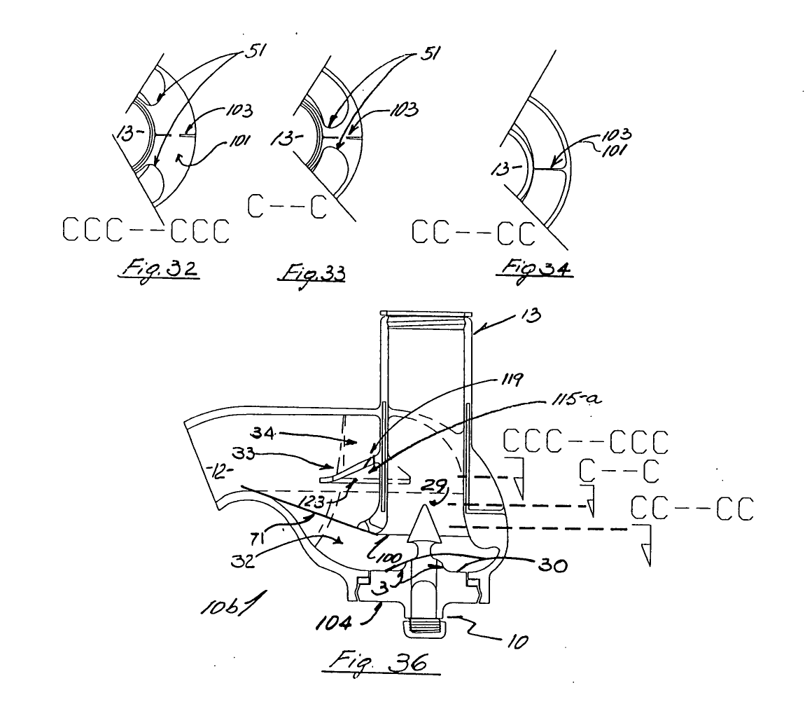

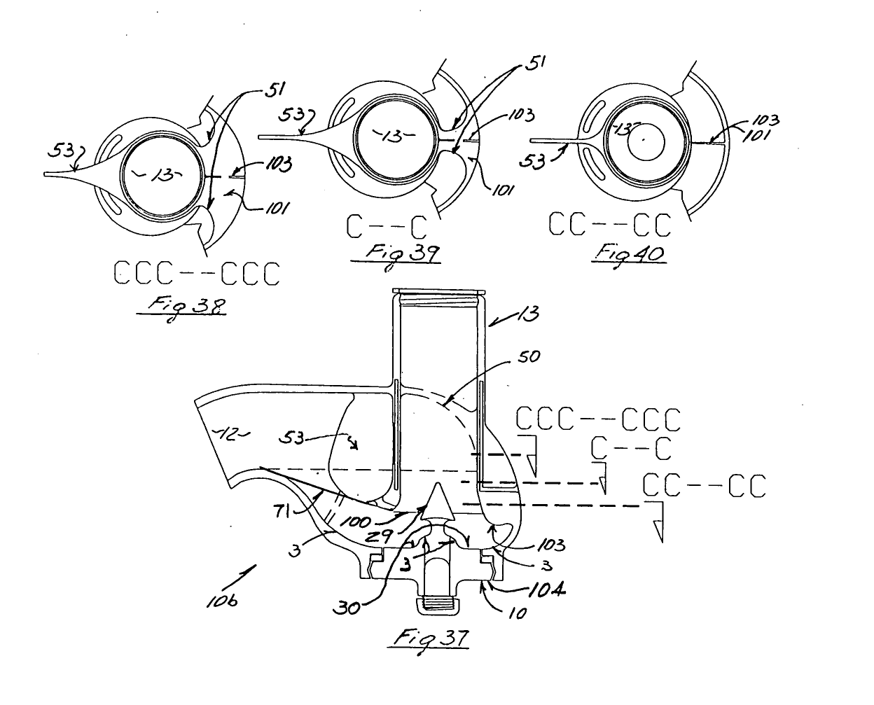

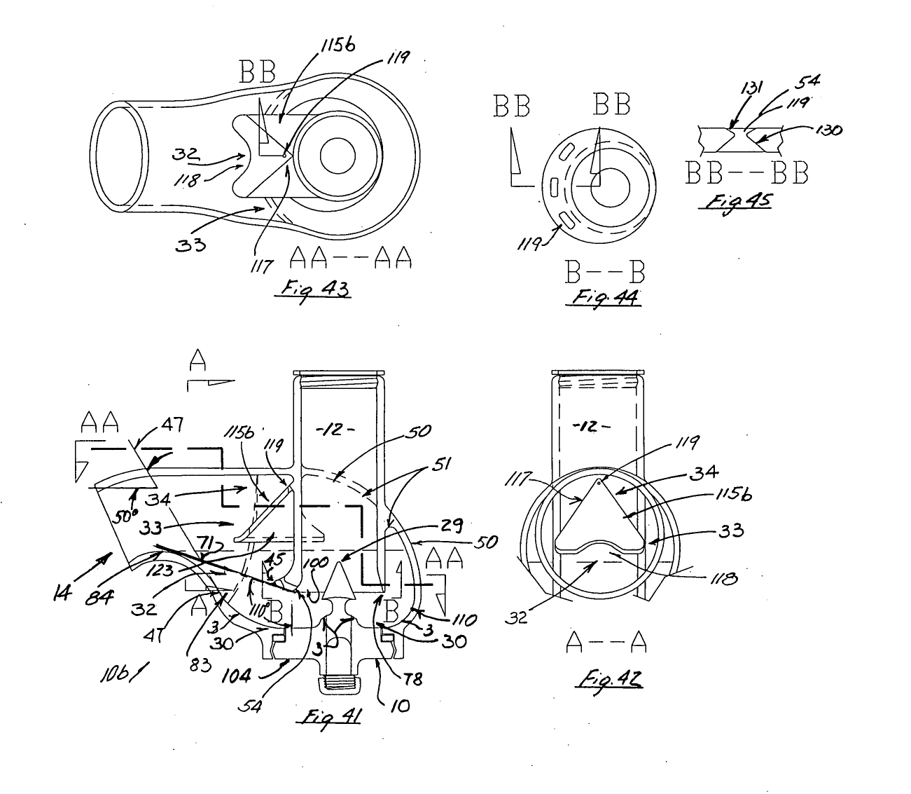

FIG. 4 of the drawings is a Globose Sidelong, Form 10a, side elevation cross-sectional view taken generally about a PAP upright plane symmetry with form and mechanics of forms generally as described with FIG. 3. Further shown is an Infant-boot, 45, End 2, 40, FESD form seamlessly extending Inlet's conduit cross-section through a globose cross-section breadth with a short height orthogonal separation, 88, to a PPLD form conduit cross-section area form and also short height separated from an upper retention free surface. A basin, a First End, an End 2 FESD rounded streamlined control surface form of short among shortest of surface lengths forms constitutes counterpart surfaces to a PPLD form, to divide or to remove a basin-outlet large or detrimental retention volume cross-sections areas, generally to cause a narrower, shorter form. Said PPLD shrunk “S” form is forwarded slanted with a maximum grade pitch, 47, of about 50 degrees. At least one elongated Nozzle, 54, FESD form through said End 2 form, and one on each side of a PAP upright plane are a conduit spouts highly directional nozzles form. A Flush Apparatus basic, 10, assembly with a major and a nozzle form aim toward a basin blind side.

FIG. 6 of the drawings shows section generally taken about Line B-B of FIG. 4 to show said FIG. 5 forms further illustrating infant-boot End 2 and elongated Nozzles, 54, FESD forms.

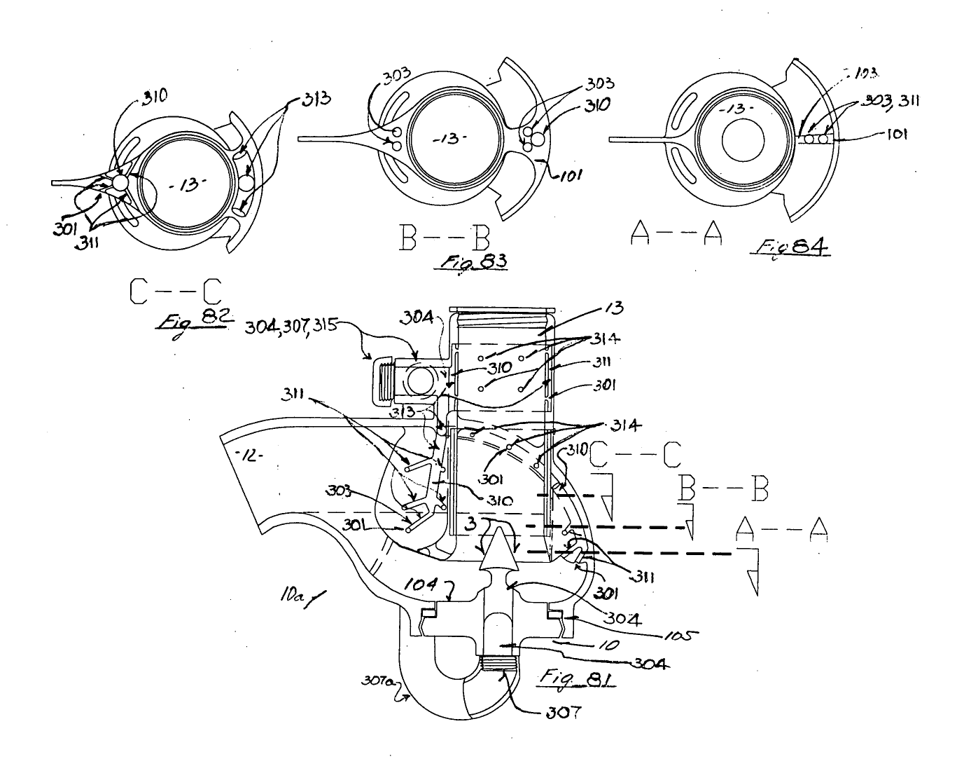

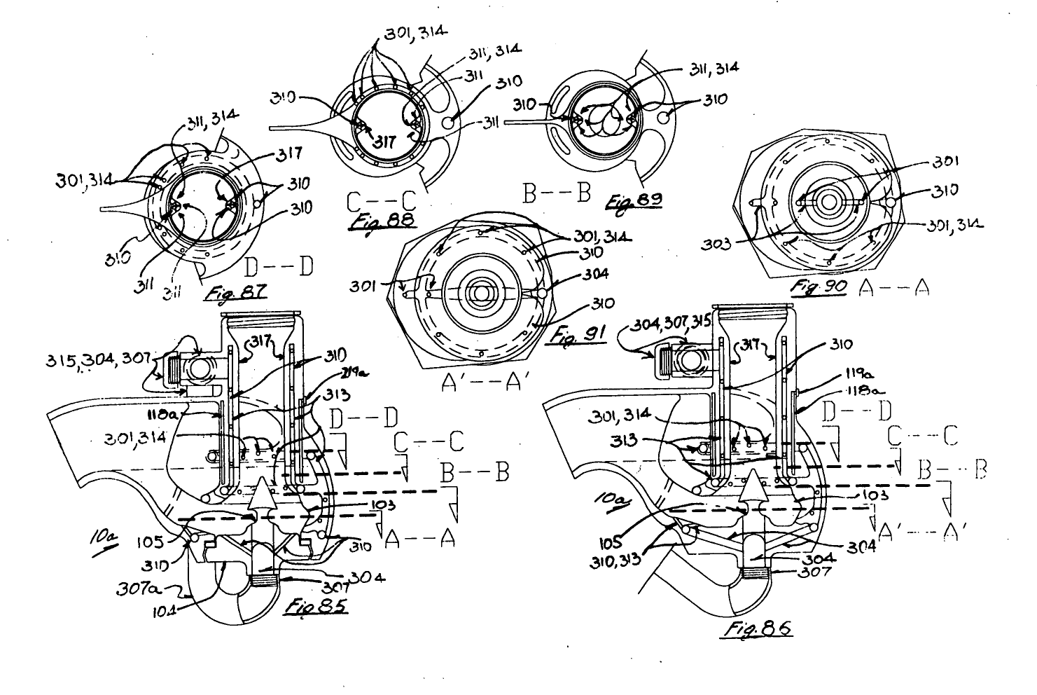

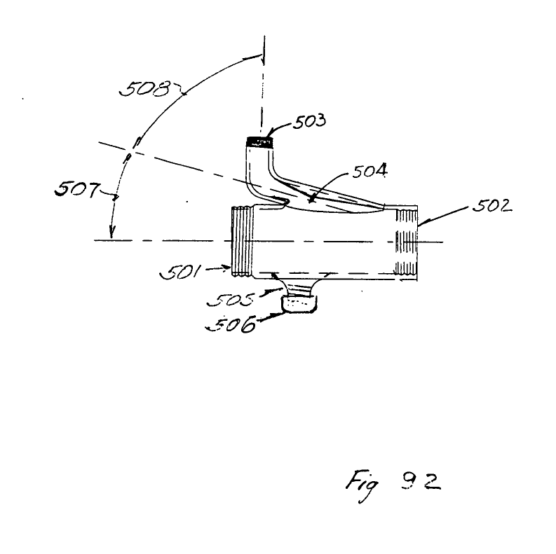

FIG. 7, 8, FIG. 12 of the drawings is a Globose Sidelong Invention Set 10a cross-sectional view taken generally about PAP plane of symmetry with FIG. 12 and Section C-C shown Trough; FIGS. 7 and 8, Section C-C shown Ridge shown Ridge for a Circumferential Hybrid. FIGS. 3 and 5 depiction of Set 10a applies except for Flushing Apparatus assembly shown and a Trough, or a Ridge with PPLD narrowed or split forms, with an infant-boot End 2, and Nozzles FIGS. 7 and 8; a Fin FESD, a Fin End 2 FIG. 12 shown. A Trough narrows a lowest surface areas cross-sections breach, PPLD width of band and narrows and elongates said PPLD width of band and its lowest surface forms. Importantly, a Trough narrows cross-sectional areas that contain PP with largest upright components. Said Trough, 31, FESD cross-section taken about Line C-C FIG. 14 shows its globose basin lowest surface with its narrowed PPLD, 31, form narrowed breadths. A Ridge about halves a lowest surface breach, a PPLD width of band, and its lowest surface forms by its widths and heights raised lowest surface of cross-sections lowest part. Said Ridge splits thus to narrow cross-sections lowest surface breach more than a Trough does, removes centric, lowest, longest PP and raises PPLD entire band. Two PPLD forms one on each side of said Ridge form make circumferential hybrid forms PAP aligned symmetric for Globose forms with linear PAP to align symmetrically said two circumferential PAP forms. Said Ridge FESD cross-section taken generally about Line C-C of FIG. 9 shows, with two PPLD, 30, forms. A Ridge extended higher than upper retention constitutes a Partition. Said infant boot, 54, End 2 FESD, form extends an Inlet conduit cross-section through a globose basin cross-section breadth and provides FIG. 3,4 shown said least, 88, height, needed to sustain conduit cross-sections short height. At least one End 2 Nozzle, 54, FESD form on each side of said Fin FESD constitute shown conduit spout cross-sections highly one-directional form that provides PP shortcuts and direction alignment for adjacent PP. Inflow outflow cones into a nozzle throat constitute entirely streamlined surfaces. Said Fin, 53, subdivides upper retention into two conduits narrow breadth mainly one directional forms. Said Inlets make Cavities FESD forms and very narrow cross-section areas on its sides to initiate Fin basin blind side forms complete complement. The first application FIG. 9 and FIG. 12 said flow control means show versions of these FESD forms. Introduction to drawings foresaid mechanics of forms describe and FIG. 81-91 depict and enumerate Flush Apparatus assemblies.

Aforesaid forms along with enumerated nomenclature through said generic parent unique globose origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Mechanics of forms introduction to the drawings details globose-conduit universe, as sample Sets illustrate domains. Principles, inventions, and methodologies universe of presented forms which the drawings depict or specifications describe or sample figures illustrate reaffirms the inventions universal presence.

FIG. 9 of the drawings shows a sectional view of a Ridge, 55, FESD form taken generally about Line C′-C′ of FIG. 7, FIG. 8 respectively without, with Flush Apparatus also illustrating two circumferential conduit spouts lowest surface cross forms. Shown Ridge FESD subdivides lower surface into two narrower breach PPLD width of band and lowest surfaces FESD forms raised by a ridge form for a ridge thickness along its entire length, also narrowing rounded lower lowest surface breach and two PPLD width of band forms aligned directional by a PAP angled leg.

FIG. 10, FIG. 11 of the drawings show Inlet, Fin and basin sectional views taken generally about Line B-B, Line A-A of FIG. 8 shown mechanics of forms, with Flush Apparatus parts.

FIG. 13, 14, 15 of the drawings shows sections generally taken about respective Line B-B, C-C, and A-A of a basin, a Fin End 2; a Trough; a basin, a Fin End 2, and Fin forms FESD; Flush Apparatus, FIG. 12, introduction to drawings mechanics of forms described, and FIG. 81-91 listed.

FIG. 16 FIG. 23 of the drawings shows a Set 10a side elevation cross-sectional view taken generally about PAP(s) upright symmetry plane of a Dual Globose Sidelong Circumferential Set Hybrid showing a Fin, a Fin-End 2 FESD, a Partition, a Fin-Partition FESD forms and a Flush Apparatus invention. Mechanics of forms and prior figures depiction or similar forms, especially FIG. 1-5, 7 and FIG. 8 generally depicts a Fin, Inlet End 2, and basin-outlet similar side elevation view. A Partition-Fin, 57, FESD bisects symmetrically said Inlet and basin-outlet retentions and forms except for tie-ins. Two circumferential PAP and PPLD widths of band one on each side of said Partition-Fin FESD constitute separate narrow widths bands from two rounded lowest PPLD forms that elongate toward outlet, FIG. 16 shows merged into a common rounded PPLD form by a Partition Lower Window, 62. Said Fin-End 2 FESD sustains said lower conduit short height, 88, from a lowest PPLD form and through a PPLD grade highest pitch of about 50 degrees, thru said, 83, First End surface inflection. One PAP upright surface on each side of a Partition, Fin aligns respective forms and PPLD widths of band. Two PAPs make a symmetry plane for this hybrid forms Set. A Partition Upper Window rounded form, side truncated by an Upright Ridge, 317, FESD form, spans uppermost Inlet Partition part to engage entire Set with fluid free surface rise.

Aforesaid forms along with enumerated nomenclature through said generic parent unique globose origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 17, 24 of the drawings shows a sectional view of FIG. 16, 25 respective Partition FESD inventions generally taken about Line C-C through Partition Lower, 62, and Upper, 59A, Windows. PPLD forms, basin rounded lowest surface raised into Partition as depicted and very much FIG. 7, 8 Ridge FESD form similar lowest surfaces, herein, entirely separate breach spouts.

FIG. 18, 22, and FIG. 25, 26 of the drawings show sectional views generally taken about respective Line B-B, A-A of FIG. 16, 23 with FIG. 16 infant boot End 2, FIG. 23 Fin End 2, a Fin, basin FESD forms, and Flush Apparatus mechanics of forms described, FIG. 81-91 listed parts.

FIG. 19-FIG. 21 of the drawings show sectional views generally taken about a Partition lower Window FESD of FIG. 16, Line D′-D′, FIG. 19, 20 Line D-D, FIG. 20, FIG. 21, respective details 92,93, and 94 of FIG. 23 for preferred matching of opposing sides edges matched detail variations.

FIG. 27 of the drawings shows a cross-sectional side elevation view generally taken about a PAP upright plane of Globose Sidelong inventions mechanics of forms Set 10a depicted such as FIG. 3 and FIG. 4, herein with a boot FESD, 115, form. Said Boot FESD form s-form curvatures underside, 59, on sides, 60a, its instep, 548, respective cross-sections underside, 32, about boot sides, 33 and topside, 34, maintaining said, 88, short height underside, a narrow breach on sides, a short height upper retention topside, which with globose basin subdivides into conduit spout forms. Said conduit under boot FESD starts from said basin blind side to said short height, 88, herein largest, 32, height about a basin valley, 30, lowest spot, 89, to continue decreasing height, 32, to its, 60a, toe end near summit. A PAP, 71, angle of, 110 degrees, a PPLD largest, 47, slope of 51 degrees makes boot FESD form basin-outlet mechanics of forms wherein a boot FESD extends for a length of basin and almost entire ascending outlet spout from a basin blind side heal.

Aforesaid forms with depicted, enumerated nomenclature through generic parent unique globose origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 28 of the drawings shows a sectional view taken generally about Line C-C of FIG. 29 of a boot FESD form about its side that generally illustrates boot FESD perimeter surfaces form.

FIG. 29 of the drawings shows a sectional view taken generally about Line A-A of FIG. 27 doming Cavities, 51, boot Fin, 53, FESD and an Inlet with a double wall inner, 118, space.

FIG. 30 of the drawings shows a sectional view taken generally about Line B-B of FIG. 27 lower of the two sectional views of Inlet, doming cavities, and boot FESD perimeter forms.

FIG. 31 and FIG. 35 show a side elevation cross-sectional view taken generally about PAP symmetry plane of a Globose Centric invention Set 10b with an infant boot End 2, a FIG. 31 flat to about doming, FIG. 35 annular valley respective PPLD, doming Cavities, and a Bridging-Wall FESD, a portal cap, and Flush Apparatus inventions. About upright Inlet lower end with infant boot End 2 submerged about centric inside a globose basin constitutes a short PAP length, Inlet to DCSS separation. Except for a Bridging-Wall and domed Cavities and said annular PPLD, infant boot End 2 centric as counterpart FESD forms said mechanics of forms and FIGS. 3 and 4 describe this Set. A conical form, 29, initiates Inlet's reduced net area cross-section. Bridging-Wall surfaces with dome Cavities provide PP guidance, which makes basin blind side PP longer than for a Sidelong Set; however, that is offset by Inlet's centric location shorter distance to its DCSS. Bridging-Walls taking out a good part of longest PP, originate with the first application FIG. 12 branch inlet, 12′, about a basin blind side, there and herein, constitute Flush Apparatus major passageways. FIG. 8-10 sections show a Bridging-Wall, 101, curved fine edge lower end, 103, which thickened and widened to bridge a basin blind side breach constitutes dome Cavities FESD, 51. Said least height conduit, 88, under about said End 2 constitutes said lowest PPLD FESD form. Portal Plug Flush Apparatus, tie-in, passageway and nozzle, FIG. 81-91 enumerate.

Aforesaid forms with depicted, enumerated nomenclature through generic parent globose unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 32, FIG. 33, and FIG. 34 show sectional views of FIGS. 31, 35, and 35a Bridging-Wall, and Cavities FESD taken generally about Line CC-CC, C-C, CC-CC respectively illustrate a conduit narrow breach about Inlet conforming retained least mass PP lengths least sum to DCSS.

Aforesaid forms with depicted, enumerated nomenclature through generic parent globose unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 35a of the drawings show a side elevation cross-sectional view taken generally about PAP symmetry plane of a Globose Centric Set 10b with an infant boot End 2, a FIG. 31 flat or to about doming, FIG. 35 annular valley respective PPLD, doming Cavities, and a Bridging-Wall FESD, a portal cap, and Flush Apparatus inventions mechanics of forms described previously similar except for a FESD lowest pitched crescent form PPLD surface that is also a counterpart to said End 2 FESD form raised into an offset conical form. A conical form offset inside Inlet shifts Inlet's cross-section area centroid closer to its DCSS that shortens PP, while reducing an area of PP toward its basin blind side for a PP lengths lower sum. A prior application addresses Inlets other than round PP lengths. A pitched crescent PPLD lowest form of basin lower surface toward outlet sustains said conduit, 88, height of Inlet cross-sectional area, while basin blind side height shortens, which reduces PP upright components for PP lower. A conical, 29, form with a PPLD crescent counterpart qualifies as a FESD form whenever a structural perimeter confirmed conduit form of least breach PP lengths infinitesimally least sum, which excludes a fluid or fluid similar forms. A pitched lowest basin surface PPLD FESD crescent form makes with its End 2 a preferred cross-section Inlet's shortened distance to DCSS. Basin, Inlet conical form, 29, breach Distances 44, 44′ adjust for a part, most of, or entire apex to merge into Inlet and Bridging-Wall form transposes Set forms to respective Globose Centric Offset or Sidelong Offset hybrid or Set.

Aforesaid forms with depicted, enumerated nomenclature through generic parent globose unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 36, 37, 41, 46, Globose Centric Set 10b FIG. 50 Set 10c″; FIG. 54 Globose Cylindrical Offset hybrid 10b; and FIG. 78 Sidelong Offset Set 10b of the drawings show side elevation view taken generally about PAP symmetry plane depict FIG. 36, 41, 46, and FIG. 78 space managers; FIG. 37 partial space manager; and FIG. 50, 54 basin disk FESD forms. As listed Sets depict prior embodiments enclose space manager of a gable roof, 115-a; hip roof, 115b; half cylinder, 115c, a three-dimensional, TD, FESD respective forms. A FESD space manager, SM, constitutes a two-way nozzle, 119, at its enclosure upper most location, which delays exchange of air and fluid in and out of a respective enclosure, and steadies and extends fluid free surface preferred elevations duration of potential energy hydrostatic pressure within enclosure perimeter cross-sectional areas lower, 32, on sides, 33, and topside, 34, as basin-outlet three conduit forms. Three cross-sections plus nozzle throat areas as sum is less than vented pipe greater than descending outlet spout that has smaller than End 1 cross-section area with mainly waste fluid in lower rounded area, 32, and transport fluid sides and topside conduits. Mechanics of forms introduction to drawings explains transport fluid mass detention further detained transport conserves mass energy, herein by FESD SM enclosures of trapped fluid mass nozzle throat air inflow outlaw caused delayed free surface deviations response to free flowing fluid free surfaces variations. Said cross-section relationships break suction from vented pipe direction. Said End 1 least cross-section area avoids basin-outlet suction. If suction were to occur in outlet descending spout, transport fluid flow thru said nozzle throat retains fluid mass and breaks suction with sufficient basin fluid to keep End 2 submerged. Said suction wastes transport fluid that FESD SM nozzle, on sides and End 1 cross-sections stop.

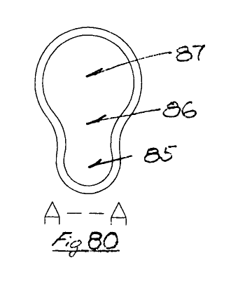

FIG. 37 Bridging-Wall and Fig partial FESD SM consist of their volume displace fluid mass from undesirable basin-outlet space with said conforming least mass replacement with respective least height in directly in front of DCSS. A Fin hollow form converts such Fin into a FESD SM form. Thus, FIG. 41 hip roof FESD SM retention with a bevel pointed End 2 about basin blind side has a sorter height conforming least mass form. Round or rounded nozzle cones with a cross-section take generally about Line BB-BB of said two-way nozzle, 119, FIG. 45 shows. Enlarged nozzles cones and throat similar top side view of said FIG. 78 FESD SM is FIG. 79 shown having a baffle, 115, Partition FESD entire basin enclosure. A baffle Partition dormer window, 117, FESD cross-sectional area is greater than that of its outlet descending spout and with addition of nozzle throat, 130a, cross section areal is less than that of a vented pipe into which it discharges. This stops suction, also. A Flush Apparatus tie-in apparatus line with a low pressure sensing device can keep submerged End 2 undersurface and allow for air or specific fluid from pressurized tank to continue a waste fluid discharge until suction is broken.

FESD space managers and FIG. 50, 54 shown FESD, 115d, disks direct fluids sustained mass energy transport topside respective bands of PPLD. A FESD disk avoids a basin retention suction caused by a descending outlet spout. Sets shown Disks FESD include descending outlet spouts with cross-sectional area about equal or greater than respective vented pipe cross-section into which they discharge. For said hip roof FESD SM rounded edges and dormer window, 118, forms, top and front elevation view FIG. 43, FIG. 44 show, respectively. Except for its roof lines said gable roof makes similar top and front elevation views. Cylindrical FESD SM with dormer window FIG. 47, 48 sectional views depict along with Bridging Wall details. Said Disk FESD top view and a front elevation view respective FIG. 53 and FIG. 55 show. FIG. 50 disk FESD Set has a least forms version of basin-outlet whose outside perimeter contains said Set Inlet entire form.

Aforesaid forms with depicted, enumerated nomenclature through generic parent globose unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 38-FIG. 40 of the drawings show sectional views of an Inlet, basin, Fin, Bridging-Wall FESD taken generally about Lines CCC-CCC, C-C, and CC-CC of FIG. 37, respectively. Fin FESD variations FIG. 7, 12, 16, 23, 27, 37 shows, depicts, and mechanics of forms describes.

FIG. 42 of the drawings shows generally rounded outlet spout form sectional view taken generally about Line A-A, showing a front view of a dormer window hip roof FESD SM, 118, with cross-section areas lower, 32, sides, 33, and top side, 34, conduit forms, a rounded or round nozzle spout, 119, preferred highest location, with nozzle cones axial cross-section taken about Line BB as shown in FIG. 45 that illustrates an identical detail for End 2 nozzle FIG. 44 shown.

FIG. 43 of the drawings shows a sectional top view taken generally about Line AA-AA of FIG. 41 hip roof FESD SM form, and mechanics of forms and prior figures also describe.

FIG. 44, 45 of the drawings shows a section view taken generally about Line B-B End 2 undersurface and a nozzle cones axial section taken about Line BB of respective FIG. 41, FIG. 45.

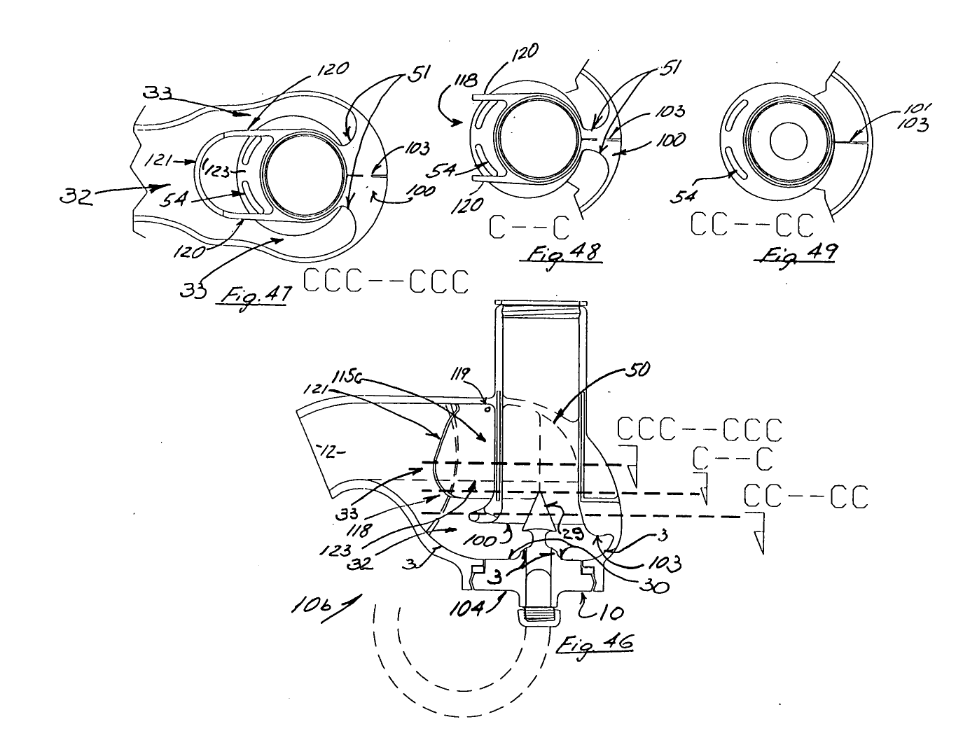

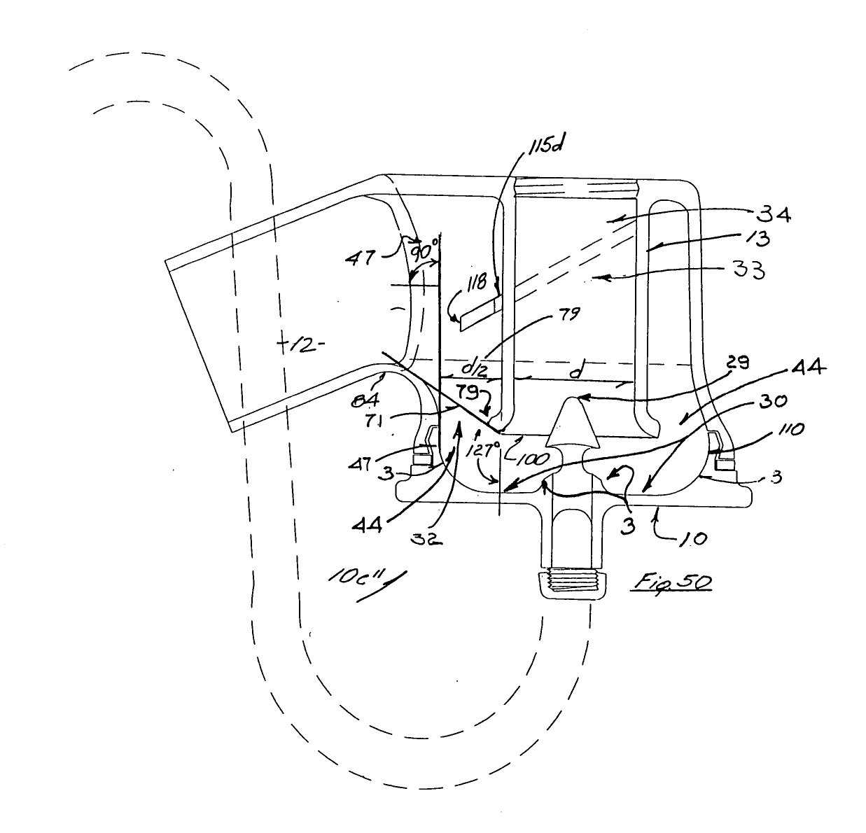

FIG. 47-FIG. 49 of drawings show sectional views taken generally about respective Line CCC-CCC, C-C, CC-CC of FIG. 46 space manager, Bridging-Wall and doming Cavities, 51, FESD. Drawings introduction mechanics of forms and prior figures describe further respective FESD space manager and an End 2 infant-boot FESD described and depicted underside, 32, and sides, 33, globose-conduit nonhomogeneous, nonuniform, nonsteady, mass energy conserving.

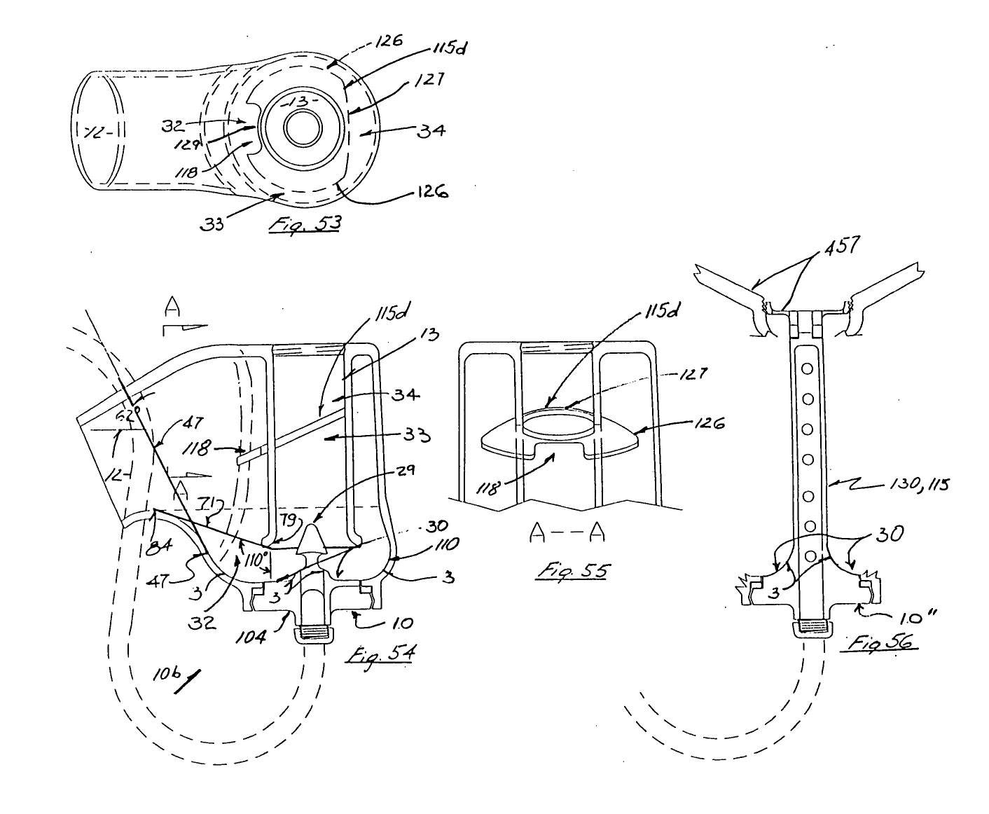

FIG. 51 of the drawings shows a side elevation cross-section view taken generally about PAP symmetry plane of a Globose-Cylindrical hybrid Offset invention, Set 10b, with a Trough, 32, inside a Circumferential Trough, 34a, a Ridge, 134a; a Partition, 34, a Tough-Ridge, and a Trough-Ridge-Partition, a Ridge-Partition, a Flared End 2, an outlet and a DCSS FESD forms. Said End 2 FESD extends into a fine rounded edge and a conical rounded apex, 29, counterpart form which confirms a narrow breach for a globose cylindrical basin form that with said FESD forms constitute narrow breach multiple passages forms. An oversized outlet spout DCSS FESD topside of basin constitutes a First Sub-outlet, 85; a Second Sub-outlet, 86, a third Sub-outlet, 87, lowest smallest to highest largest distinctively oversized cross-section areas and breach of outlet, which exceed basin cross-sections area and preclude suction. Said outlet spout ascends as Trough inside Trough, 34a, circumferential FESD two channels, which descend from a basin blind side. A basin perimeter rim about Inlet makes said circumferential Trough, a Trough-Ridge, a Trough-Ridge-Partition, and a Trough-Partition FESD form. A three dimensional Window FESD makes a Ridge, Ridge-Partition, and Partition separation from a basin outlet upper casing. Flared End 2 and its counterpart annular PPLD FESD and globose-conduit forms mechanics of forms describe including prior figures shown similar Flush Apparatus FIGS. 81-91 enumerated and described. This Set is a globose version of FIG. 57-59, FIG. 73, 74 respective Globose Cylindrical, encased Globose Sets continued from the first application respective FIG. 1-2, 12 and FIG. 10-11, wherein entire Inlet is within an outside perimeter of a globose-conduit forms of a globose cylindrical Set.

Aforesaid forms along with depicted, enumerated nomenclature through generic parent unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

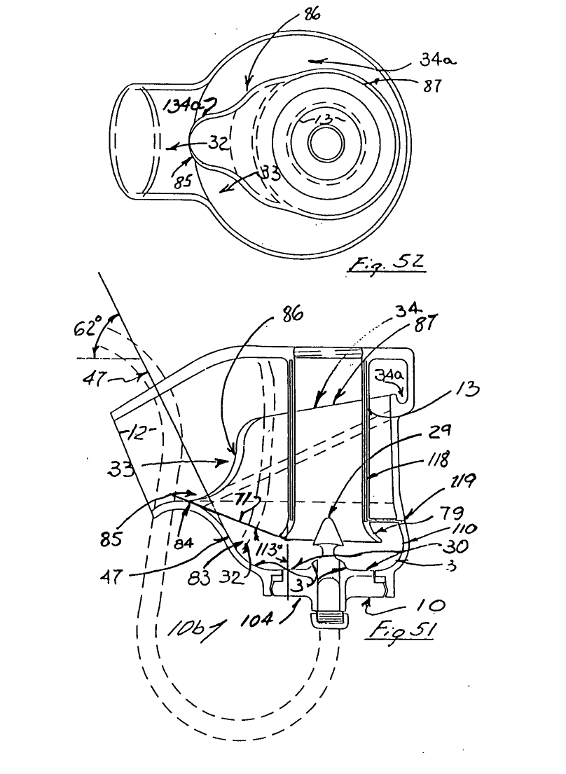

FIG. 52 of the drawing shows generally a top view of Troughs and Ridge and Partition FESD forms, constituting a curvilinear Ridge slanted section with circumferential Troughs from a basin blind side into a descending oversized outlet spout, which discharges to a vented pipe.

FIGS. 56 and 57 of the drawings show a side elevation section taken generally about PAP symmetry plane of an Inlet FESD manager connected to a Flush Apparatus tie-in. Nozzle forms show round form and other know forms are acceptable herein shown aligned whereas staggered alignments which sprays entire Inlet space are acceptable. An Inlet FESD manager displaces an Inlet, basin mass centrically located longest PP to a DCSS that constitute a stagnant conical form fluid mass under Inlet, for a respective laminar flow.

FIG. 57, 58, 61, 62 Set 10c; FIG. 73 Set 11c of the drawings shows an elevation side view of respective Globose Cylindrical Centric Set inventions taken generally about a PAP symmetry plane. A Partition, a Ridge-Partition, a circumferential Windows, Ridge, Trough-Ridge, Trough inside Trough FESD three dimensional forms that constitute an outlet FESD first, 85, Second, 86, and Third extremely large, 87, Sub-outlet respective cross-section areas, 32, 33, 34. Said three sub-outlets constitute a globose-conduit, basin-outlet, G-C globose cross-sections forms shown as cylindrical Set. FIG. 51 shows said FESD forms primarily as Globose Set of forms. Except for a first or second sub-outlet, FIG. 12 of the first application shows extremely similar circumferential Window, Trough, Ridge, and Partition FESD, as version of FIG. 1-2 Set. Breach Dimension, 44, prior figures and herein denotes Inlet mutation to PAP symmetry upright plane Sidelong, Anti Sidelong respective Sets. An outlet spout upright major axis at a DCSS constitutes about 200% of Inlet inside diameter with a DCSS much greater than Inlet cross-section area precludes suction. FIG. 3, FIG. 4, and prior Figures including FIG. 51 depicted circumferential FESD, Inlet, and basin-outlet basic mechanics of forms describe these Sets. FIG. 58 conforming retention absolutely least mass crafts and trade forms Set makes a stagnant mass conical form which has Inlet centric apex higher than rounded End 2 form from a flat to doming annular valley PPLD basin lowest surface. FIG. 57 conical form, 29, extends from a rounded lower surface form valley side, 3, lowest surface, 30, annular PPLD FESD form counterpart to an End 2 FESD rounded form and a PAP matching symmetric surface shorter length “S” form, which remove longest PP and stagnant retention mass. Inlet fluid mass removed constitutes FIG. 56, 62 described Inlet FESD manager PP lengths lower least sum. FIG. 61, 62 shows spout outlets ending with a rim, which reduces FIG. 57, 58 crafts and trades conforming least height for volume of mass a spout contains, which lowers PP lengths least sum for quantum fluid mass smaller upright components. Clearly, an Inlet contained or retained fluid mass at elevations higher than conical apex or an Inlet FESD manager form constitutes mass energy highest conserving FIGS. 56, 57, 58, 61, 62, and 73 Inlet detention, including FIG. 56 shown strainer basket. Without Inlet Sidelong Set migration, PAP angles show 133 to 148 degrees. Sets adept deftly disk FESD. With oversized outlet descending spout suction is entirely of no concern.

Sets show their globose form from about 5% to 95% of entire Set height, globose breadths manipulated up to orders of magnitude greater that is also the first application FIG. 1-2, 12 shown.

Aforesaid forms along with depicted, enumerated nomenclature through generic parent unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

Globose-conduit parallel analogies, schematic evaluations, verify universal, nonsteady, nonhomogeneous, mass energy conserving enormously significant environmental innovations.

FIG. 60, 64 of the drawings shows a composite DCSS FESD First and Second Sub-outlet front elevation section view taken generally about Line A-A of FIG. 58, FIG. 62, respectively.

FIG. 59, 63, 74 of the drawings shows a top view of said FIG. 58, 62, 73 respective forms.

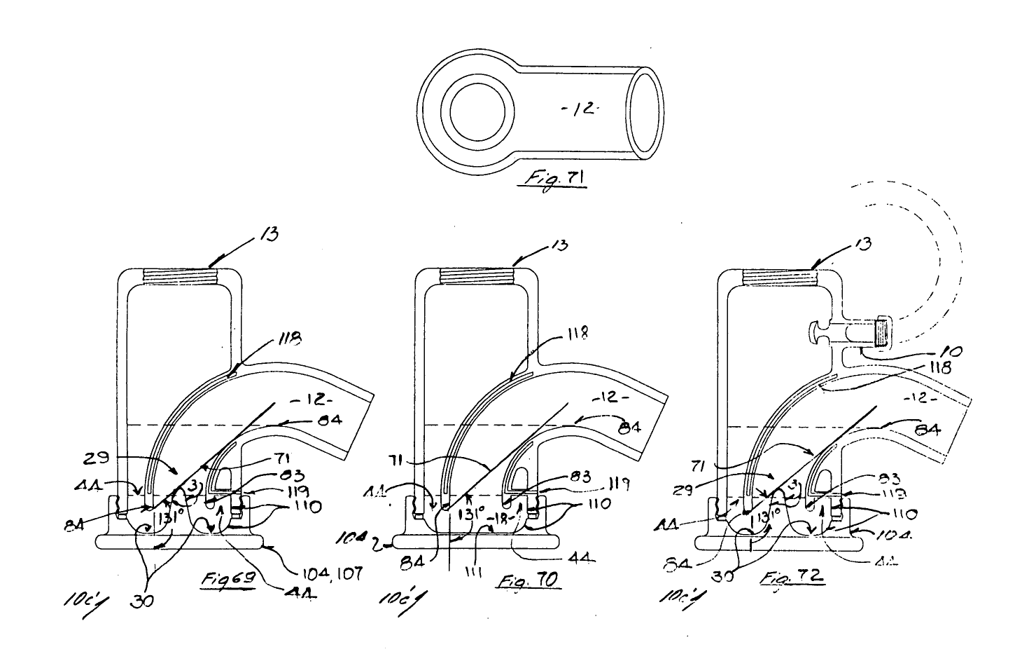

FIG. 65-67 of the drawings shows a Globose Centric Cylindrical invention, Set 10c, cross-sectional view taken generally about PAP symmetry plane of through a rounded End 2, a PPLD annular FESD respective counterpart conical form, a flat to doming, a conical form major nozzle Flush Apparatus. A rounded End 2 FESD, an annular valley PPLD form separation, 88, is prior and these Figures mechanics of forms including a major upright axis oversized outlet ascending spout elliptical FESD form with a First, 83, End minor axis cross-section area of a narrow breach conduit form. As globose basin Sets counterpart, these Sets also migrate toward basin blind side Sidelong Sets with Inlet and its related counterpart FESD forms transposed exchange of breach Dimensions 44. Sets adept deftly disk FESD, which with aforesaid outlet spout avoids suction.

Aforesaid forms along with depicted, enumerated nomenclature through generic parent unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 68 of the drawings shows a general top view of FIG. 65-67 Centric Cylindrical Sets.

FIG. 69 of the drawings shows a side elevation cross-sectional view taken generally about PAP symmetry plane of a Globose-Inverse Centric Cylindrical invention, Set 10c′. This domain preferred version is a sidelong Set that constitutes FIG. 80 general forms cross-section view outlet spouts three sub-outlets evolved into a DCSS FESD globose Third Sub-outlet breadth a multiple of its height where needed to preclude suction with a one-way air inflow nozzle in its crown, and which holds shown lowest PPLD FESD annular valley counterpart forms: a rounded First End, a basin lowest surface conical form. Figures depicted End 2 and PPLD FESD narrow separation is most suitable herein to said First End and extends into narrow breach basin blind side separation upward extension of a basin casing. An Inlet form shown as a threaded basin casing, constitutes a lower unthreaded length threaded portion adjustable Inlet length separation from its ascending outlet spout. Dimensions 44 side elevation view shows shrunk S, C PPLD, and First End forms. A pitched basin lowest surface crescent PPLD lone S form makes a hybrid sidelong inverse Set.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 70, 72 of the drawings shows a side elevation cross-sectional view taken generally about PAP symmetry plane of FIG. 69 Globose-Inverse Centric Cylindrical invention except for shown herein a flat to doming, an annular valley conical form and Flush Apparatus, respectively.

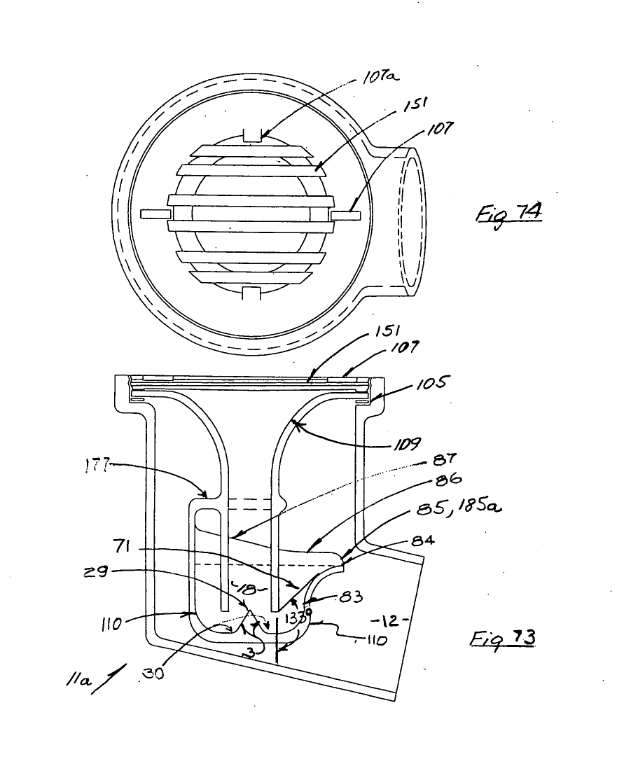

FIG. 74 of the drawings shows generally top view of FIG. 71 Globose-Inverse Centric Set.

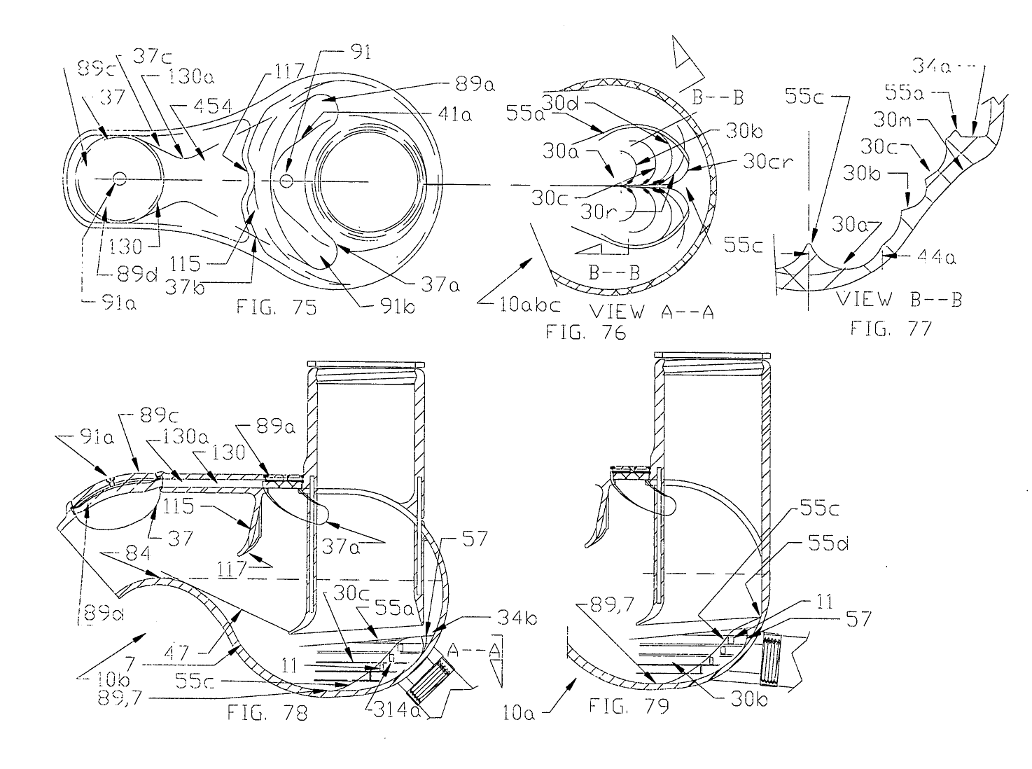

FIG. 75 of the drawings shows a top view of previously generally described side elevation view of FIG. 78 shown Globose Sidelong Offset Set of a FESD space manager, 115, herein shown basin and ascending outlet spout entire length about largest nozzle forms, 37b, 37c, throat, 130a, that fits into their upper casing. Nozzles respective intake, discharge contains mesh strainers, 89a, 89d, holding plates, 91b, 89c, held in place with screws, 91, 91a, respectively. Nozzles suction, if suction develops through ascending path of outlet descending spout, provides a highest energy conserving, alternate, arched passageway to basin highest elevations. This allows and enhances basin fluid free surface rise and thus slows mass flow through said baffle Window FESD, which is gravity force reversed at a first opportunity simultaneously breaking suction with transport fluid basin detained mass free surface at highest elevations, mass energy highest conserving. Window, 117, baffle detains basin transport fluid as retained potential mass and energy highest conserving.

FIG. 76 of the drawings sectional view generally taken about Line A-A of FIG. 78 shows a pitched circumferential Trough-Ridge, 55a, extended about a basin blind side from Trough-Ridge general confluence of two ends about an ascending outlet spout First End for a centric Ridge form, 55c, FESD, said Ridge extended from a surface inflection, 55d. Trough inside Trough, 30a, 30c, and, 30r, FESD, along with enumerated FESD including flared End 2 and counterpart PPLD two lowest rounded forms merging into one constitute a TD FESD Set, which also is FIG. 51 FESD forms disclosed by the first application FIGS. 12 and 9 Partition, Trough, Ridge, and Fin versions.

FIG. 77 of the drawings sectional view generally taken about Line B-B of FIG. 76 section about Line A-A of FIG. 78 shown pitched circumferential Trough-Ridge, 55a, extended about a basin blind side from Trough-Ridge general confluence of two ends about an ascending outlet spout First End, a centric Ridge form, 55c, FESD; said Ridge extended from a surface inflection, 55d. Trough inside Trough, 30a, 30c, and, 30r, FESD, along with enumerated FESD including flared End 2 and two lowest rounded forms merged into one PPLD counterpart form of a conduit two, basin three, outlet two directional dimensionality, TD, Set. A globose form breadth height of said Troughs constitute perimeter outline profile, 30m, very much similar generally to FIG. 80 and high PPLD slope cross-sections for globose-conduit prototype forms, that make with higher elevations continually a much larger breadth, finite height ratios, generally until nearing globose springing points proximity. Transition region surface successive breadths extent, quanta mass weight hydrostatic pressure on quantum mass infinitesimal scale strip respective sloped surfaces confined by hydrostatic pressures against structure with down or up direction confinements by its relative specific gravity and surface slope move unidirectionally toward low hydrostatic pressure shortest paths direction through conduit outlet and DCSS highly directing forms. A computing algorithm derives conforming quanta mass least mass, mass rotations and height, thus globose-conduit perimeter quanta mass makes least height and rotations, and respective least angle PAP. Transition region perimeter surfaces from rounded lowest surfaces highest specific gravities of nonhomogeneous, nonsteady, nonuniform mass energy to uppermost layer of mostly transport fluid large free surface or increasingly larger globose breadths for free surfaces nearing springing points largest breadths elevations contains aforesaid breadths. Primarily transport fluid detention steadied by one large free surface, least height from lowest surfaces highest elevations, perimeter surface least boundary layer quantum and quanta mass rotations constitutes mass energy highest conserving, wherein said multiple troughs progressively reduced into infinitesimal forms makes a smooth surface. For varied mass fluid composition, globose-conduit much rounded “V” form, as prior figures shown, varies curvilinear forms of near least slope FIGS. 60 and 62 front elevation shown, moderate slope FIG. 51 side elevation shown, to one most confining FIG. 80 shown cross-section, to this figures shown section. Forms encompass fluid mass nonconforming, nonuniform, nonsteady composition that constitutes data verified statistically for contained fluids and solids and quanta mass variations. Classic globose-conduit open channel forms complete complement conforming retention has least depth of PPLD forms, quantum mass PP lengths least sum highest elevations, fluid free surfaces large breadths, and thus least PAP angle, fluid mass rotations, and hydrostatic pressures, figures illustrated, depicted. Globose-conduits correlate nonhomogeneous, nonsteady, nonuniform mass energy conserving to an elevation specific breadth deviations from lower and upper springing points breach. Said “V” enclosed specific angles generalize contained mass respective height, as elevations breadths net change linear rather than curvilinear perimeter is for visualization purposes, only. Clearly, a globose upper surface crown from globose conduit upper springing points encloses said highly rounded “V” form of mainly rounded appearance, for conforming retention fluid mass least height and rotations large free surface form;

Globose-conduit, highest mass energy forms drawn analogies and schematic evaluations confirm infinitesimal perimeter boundary analyses substantiated nonhomogeneous, nonuniform, and nonsteady mass energy highest conserving universal environmentally important innovations.

FIG. 79 of the drawings is a side elevation sectional view of a Set of Globose Sidelong Set forms inventions generally depicting a FIG. 78, FIG. 77 respectively shown FESD space manger, and TD FESD forms version. A tie-in apparatus pressure sensing device starts Flush Apparatus Nozzles, 11, FESD design fluid injection, mechanically or by gravity, through FIG. 78, FIG. 79 shown basin blind side tie-in Flush Apparatus should upper retention height drop to ¼ inch. Said Nozzles are situated within rising surfaces of said Troughs proximity of said centric Ridge FESD.

FIG. 80 of the drawings shows a G-C, globose conduit, “kidney”, globose-conduit cross-section form, a lower small rounded conduit area, 85, a rounded transition surfaces intermediate, 86, varied breadths area, and a rounded upper area, 87, for a globose-conduit compact composite area curvilinear perimeter form about as shown PAP upright plane symmetric. Such a composite form constitutes nonhomogeneous, nonuniform, nonsteady fluid mass gravitational weight least pressures least rotations frictional forces, for mainly laminar flow fluid mass. As mass transport constituted by said PP lengths least sum for entire length. Its finite length makes classic globose-conduit forms, a classic perimeter form, a G-C DCSS FESD form, a composite three dimensional conduit form, and DCSS forms readily makes three sub-outlets forms, figures shown. Globose-conduits basic generic compact composite forms make conduit FESD forms to transport a fluid mass mixture that constitutes highest mass energy conserving classic forms. For various mass energy transports or forms transitions, globose conduit perimeter makes a generic building block to change a conduit transport to a globose retention form, or vice versa, or transfer potential to kinetic energy or vice versa. G-C FESD forms highest mass energy self-conserving is based on mass properties said PP lengths least sum transfers into a rounded, an elliptical, or a curvilinear form, wherefore pure fluid mass under hydrostatic pressure has entirely round forms. Properties of fluid mass must include not only its composition but quantity and its duration, also. Thus, G-C transfers of forms conforming least quantum mass, rotations, and height make largest free surface perimeter most energy efficient. Clearly one form compared with others conserves most energy for a specific use. G-C FESD forms conserve potential energy modal change transfer to kinetic energy or vice versa especially suitable to transport fluid mass mixtures thru drain traps, drainage lines, or sewers. Said globose-conduit universe of forms has a specific classic form classic perimeter for a specific cross-section at a specific location statistical data probabilities computed for fluid mass composition, quality, and quantity, this, prior figures and DCSS forms shown and FIG. 77 infinitesimal perimeter boundary analyses substantiated. Mass energy forms drawn analogies and said perimeter flexibility illustrated globose conduit classic forms status.

Conduit inverts PPLD forms of infinitesimal to a finite to infinite length of cross-sections constitute highest elevations for a contained fluid mass least height largest free surface perimeter form. First Sub-outlet forms constitute continual inflow rounded conduit forms detention, sewer and drainage lines continually contained mass energy that has statistical probabilities constituted said PP lengths least sum highest fluid free surface elevation respective breadth and depth forms that pass particles largest sizes. A continual detention free surface elevation constitutes preferred fluid mass least height passing largest submerged particles size. Conduit springing point highest elevations initiates a transition or intermediate regions for out of ordinary fluid mass inflows said composition, quality, and quantity change constitute said PP length least sum, which makes fluid free surface highest elevation for a respective event cross-section breadths, such as sewers storm water runoff. For extreme events, such as a 100-year storm, said runoff is primarily a huge clean rainwater quantity, wherein solid particles segregated toward fluid mass lower elevations require globose forms upper perimeter of computed, PP lengths least sum. From said conduit to globose forms springing points constitutes transition regions where said PP least sum of highest fluid free surface elevations constitutes a computed breadths classic curvilinear form conduit, intermediate, and globose classic perimeter forms. Aforesaid is a sewer line example of perimeter computing. Described methodologies for perimeter algorithm computed forms provide a nearly exact highly specific perimeter forms for fluid mass and energy highest conserving which must include highly specific events, forms' aging models, with fluids gaseous state exceptions that applications have. This form is angled, based on infinitesimally angled PAP symmetry plane extended into infinity. It is shown as a cross-section perimeter extended from a PPLD forms rising slope with detention phases highest confined globose-conduit globose form for initial pant-up hydrostatic pressures, a transport fluid highest conserving initiated from a conduit spout PPLD forms. A globose-conduit globose area height vary from about 5% to about 95% of entire cross-section height with globose breadths up to magnitudes order greater than a vented pipe to which it connects. FIG. 1-2, 12 of the first application illustrate globose basin and channels said relationship multiple times greater.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

Wherefore, depicted Figures disclosed nonhomogeneous, nonuniform, nonsteady highest conserving fluid mass universe Sets that contain, retain, detain and transport which constitute said globose-conduit universe of classic forms, Sets, and domains classic perimeter of forms.

Whereas, nonhomogeneous, nonuniform, nonsteady highest conserving fluid mass makes retention, detention, and transport said PP lengths least sum globose-conduit form universe is figures exemplified where PAP angles graphically represent PP lengths least sum. A laminar mass transport through classic perimeters frictionless boundary constitutes translational mass.

Mass blocks translation transports with no perimeter friction constitute absolute highest mass energy conserving for solid mass and are equivalent to frictionless boundary layer fluid mass transports with no internal fluid frictional or viscosity losses, for laminar fluid mass transport that is prior application inclusive. By accounting for frictional boundary layer energy losses said PP lengths least sum algorithm computes fluid form and perimeter for a least energy loss due to gravitational effects on nonhomogeneous fluid mass and for a statistical probability of fluid mass anticipated variability with cross-section forms, specifically breadths. An infinite number of globose conduit variations represented by only one form highest conserving fluid mass energy amount constitutes said PP lengths least sum. Again, one arrives at said classic forms for nonuniform quality, nonhomogeneous fluid mass and nonsteady pressures that vary with fluid free surface elevations, which differs from entirely round conduits construction. A profound, sewer lines crucial part of an open channel energy conservation is just one within a significant or infinite number of globose-conduit perimeter forms, which said PP length least sum can identify for a specific location, specific statistical data, and events. Again one needs highest fluid free surface and invert elevations for a globose-conduit form least height varied breadths that make a globose-conduit mass and energy least height highest conserving forms.

Globose conduit forms by said generic claims evolve devolve into, out of class round forms, transpose into or out of classic conduit and classic globose spherical retention forms, transfer among Sets of globose, globose-inverse, hybrids, and mutations domains that constitute mass and energy highest conservation universe of unique origin. FESD forms with their perimeter forms restrict fluid mass rotations. Partitions, and Widows, Ridges, and Troughs FESD forms are especially suited for sewer construction.

FIGS. 81-92 show a cross-sectional taken generally about PAP upright symmetry plane of Set 10BF, 10AF, 10FA illustrating Flush Apparatus parts to flush, disinfect, surface protect or repair a deterioration and wear. FIGS. 4, 7, 8, 10-13, 15, 16, 18, 22, 23, 27, 35, 35a, 36, 37, 41, 46, 50, 51, 54, 56, 62, 67, 72, 78, 79, and 92 show Flush Apparatus assemblies, with at least one tie-in, generally with a major nozzle; many are basin lowest surface portal capping or plug member assembly parts. Said Flush Apparatus assemblies are entirely inside conduit walls, except for tie-ins, and capable flushing any basin or Inlet retention space or location, such as, Inlet surfaces and or basin-outlet lowest surface PPLD width of band lengths or an entire length. Shown capped a tie-in or at least one of shown tie-ins connects to a tie-in apparatus that may include line sensing device to initiate or stop a design fluid injection should basin retention drop to preset pressures. Said Flush Apparatus deliver predetermined fluid, or gas, or air separately or jointly is delivered under controlled pressure to tie-in or tie-ins is discharged through any of sub-nozzles, 301, sub-passageways, 303, major nozzles, 405, major passageways, 304, and passageways, 310, respective branches set of tie-ins, 307, a set of sub-passageways branches, 311, a set of sub nozzles, 314, selectively pre-assembled. Apparatus numerous parts assemblies are simplified by molded a molded fabrication of parts inside conduit walls. Specific shape passageways such as upright Ridges FESD, FIGS. 8, 12, 16, and, 85-89 depict, a double wall inner space, 310, passageway FIG. 81 shown. A major nozzle 405 spray type flushes entire basin lower, lowest surface and into an outlet and lower Inlet. FIG. 92 of the drawings shows a side elevation view of a drainage line pipe connection straight fitting with a tie-in and a nozzle for flushing. Know standard connection fittings with provision for similar flushing and connection to Flush Apparatus readily construct with a nozzle-preferred direction, herein shown for a straight pipe flushing. A treaded tie-in flush apparatus connections standard fitting and a drain tap about pipe bottom face are provided on fittings' opposite sides.

1. Four generic claims, physics, chemistry, thermodynamics and forbidden mechanisms laws merge; Quintessential, core, natural, buried GC aqueducts perimeters heat energy transfer up to insulated globose crown with or without irrigation for mass energy highest conserving combats fluxing ocean levels ‘global warming’ effects, the Earth's surface cooling; near vacuum, least density globose masses light pushed to infinity, globose-conduits (GC) Sets approach the speeds of light; the GC aqueducts cycle heat energy of subatomic submicroscopic to cosmos mass energy systems for electro-thermodynamics, electromagnetics perimeters bound universe having buoyancy/density, evaporation, and suction forcing; atmospheric GC mass forms energy sequential equilibriums transport, generic claims compliant, forcing temperatures with pressures funnel spouts, gravitational potential energy, dipolar electromagnetic field, ions driven electrons boundaries flux forces mass hydrodynamic thermodynamics electro-superconducting, up to speed of light;
said aqueducts are the first and only pro growth, supplied side economics, geological age periods direct interventions for the Earth's living organisms' survival within the Milky Way Galaxy or for highest conserving mass energy transport that saves orbital mass irreplaceable, most precious commodity—water;
aqueducts GC mass energy highest conserving makes least potential energy elevation drop toward planned immediate water vapor emissions cuts more effective than ‘global warming’—‘greenhouse gases’ emissions cuts, in what are called the atmosphere's “fast heating” potentially “irreversible” global effects;
aqueducts conducted, radiated heat energy transfers from atmospheric precipitation to the Earth's crust are essential, especially with aqueducts irrigation raised groundwater elevations to preselected levels that control watershed runoffs, topsoil transports, ecosystem support hydronic farming agriculture similar; crust water evaporation controls conforming to crustal geology, groundwater, and recent topsoil historical data remove significant water vapor mass contained by the gaseous atmosphere in global efforts to control water mass transports by safe best technologies most cost efficient method for payback through centuries; the GC Sets, forms conserve infinite water masses and energy on prototypes, global and planetary scales, as they curtail or shut-off plasma fountains, prior applications proven mass energy prototypes conserving; thus, globose-conduits universe makes perimeters boundaries, internal structures intelligent arrangements (IA) functions and stratifications gradations arrangements (SGA) Order atomic weights compositions, IA, SGA continual conflicts of one against the other, confrontations for forbidden mechanisms final outcome;
in conflicts between the two the one with the higher QCNDMEHC² for least dissipations prevails, QCNDMEHC mass energy transitions constitute hydrodynamics energy transformations with perfections;
² QCNDMEHC is abbreviated quintessential, natural disposition, mass energy highest conserving.
The Generic Claims QCNDMEHC GC Sets, forms highly defined nonhomogeneous, nonuniform, nonsteady laminar flows perimeters, boundaries make the IA functions perimeters, boundaries constituted GC aqueducts, sewer/drainage lines and drain traps as hydrodynamics, thermodynamics, electromagnetics mass energies respective transistors and processors; aqueducts GC mass energy stratifications gradations are less diverse than those in sewer/drainage lines; forms Sets GC conduct, process quantum mass energy properties instead of transistors, processors electrons charges binary methods; aqueducts, sewer/drainage line, drain traps GC QCNDMEHC flows are analogous to respective transistors, processors, programmed laminar flows for quantum masses energies, densities state, perimeter forms, and quantum mass interfaces boundary forces; fluids/solids specific gravities reflect density respective evaporation/buoyancy, suction;
aqueducts GC, QCNDMEHC, globose-conduit forms Sets, quantum mass highest energy conserving hydro-thermodynamics make intelligent arrangements, IA-transistor processor Orders; whereas, electrical circuits' transistors process quantum electrical charges through binary method information processing, the IA-transistors process quantum mass QCNDMEHC density/buoyancy (thus, specific gravity, molecular and/or atomic weights), suction, and evaporation, for nonsteady, nonuniform, nonhomogeneous quanta masses prototype rigid perimeter forms and Sets; wherein combined as shown by drain traps, said classical globose-conduit forms, Sets as the IA-transistors assemble into processors, especially with interstitial spaces or hydro-thermodynamics information processing; the analogies extended to include the Earth's magnetic field electro-thermodynamics forms and Sets make for assembly systems advanced Order IA-main processor, the Solar System, Milky Way, Universe as advanced IA-processors Orders, highest, multi-core highest, the highest, respectively; said analogy continues known correlation among respective energy form transitions from one into another, frequently applied procedure for the electric and fluid flows energy, which verifies said globose-conduit aqueducts as the countermeasure to fountains forbidden mechanism; aforesaid thermal aqueducts contained QCNDMEHC quantum water mass energy can seamlessly mirror ionosphere heat energy dissipated into space as heat energy transferred into the continental crust, seamlessly integrating into IA-transistors, advanced, high, and highest IA-processor Orders; the Sets forms, the IA-transistors/processors Orders constitute their GC Universe about Universe;
the aqueducts required lifespan mandates GC Sets and forms QCNDMEHC perimeters; said irrigation would utilize lawns watering progressive activation to manage the water available; highest densities/specific gravities, least interstitial space subgrades; noncorrosive metal, mineral or plastics materials, composites and surfaces; aqueducts inner surfaces polished are all preferred; grade constructions should not include aqueducts crowns and may extend to approximately three feet below grade; all materials and workmanship constructions shall constitute the highest quality;
machinery mechanism processes are following—a regulatory and two constructions Part,
I. photoelectric-cell or film machines upper shell, least latitudes transcontinental routes and air routes least altitudes, converted solar radiations to electrical energy enact the regulatory Part;
II. floated over water blankets or tarpaulin photoelectric-cell or film fields that block radiation;
III. machinery mechanisms' versions solar mirrors or panels' field instead of said photoelectric-cells/film steam and hot water suitable piping instead of electrical cables provide the energy;
prior applications' GC Sets, forms disclose, claim infinite water energy conserving shown mass energy frictional losses calculations two orders of magnitude better than in ubiquitous drain traps;
said GC respective IA-processors Orders of said QCNDMEHC Sets and forms make up a living cell, cells local system, an organ, organ network universe, and organisms living networks, living cells Universe IA-processors Orders, as intelligent GC conforming embodiments Universe; as GC Sets, forms, living cells' epidermis traits make local, ‘global’, networks, and GC Universe inflow Inlets, outlets, internal globose-conduit forms, respective position rotation and orientation; again, GC Sets, forms Inlets, outlets, globose-conduit, basin-outlets, with internals are defined by the forms structures lengths, cross-sections, shapes, sized perimeters, and overall dimensions with flexibility, elasticity, strength through cyclical histories, growth, repair, longevity or regeneration; structures, fluids submicroscopic, microscopic, microbes, electric charges, ions, atoms, molecules compounds interstitial spaces; compositions, boundaries membrane, interstitial spaces uniformity, homogeneity, consistency, steadiness, color, cyclical variability, flux range, longevity; forms Sets internal, external boundaries, perimeters, deformations creep, temporary, cyclic, permanent, axial, longitudinal, transverse; perimeters membranes wall thicknesses changes, normal, active, excited, very excited, stressed, overstressed states; physical, chemical, density, energy transfers processes, electric, muscular, nervous impulses flux, period; any, and all dynamics and interactions changes; human's intelligence center, the brain, and energy provider, heart, belong to closed Sets, forms Globose-Conduits versions, with limbs outreach perimeters, boundaries as special versions;
the Earth's molten core, magma, lava flows, rivers, streams, creaks is taken analogous to humans' cardio-vascular system; living cells, Globose-Conduit or Conduits of Globose Sets and forms have infinite number varieties pooled into aforesaid Universe of said IA-Processors, Order;
cells' positive or negative ionic discharges known as “action potential” transmissions that travel along the cell membrane are used most extensively by the nervous system to communicate, to transmit information to other body tissues and organs; cells' action potentials with ‘polarized’, ‘threshold and initiation’, ‘plateau phase’, with “phases”, ‘resting potential’, ‘stimulation’, ‘rising phase’, ‘peak’, ‘falling phase’ and ‘undershoot’ model as reactor/capacitor, RC, potential circuits; cells' ionic ‘action potentials’ and nervous system are taken analogous to Earth's electromagnetic field ions/electrons charges flows, air masses thermodynamics, globose forms magnetopause flux;
the analogies group humans and Earth as the respective advanced Globose-Conduit Sets, main IA-processors Orders two separate categories; humans possess living organisms' cognitive, intelligence, communication and motive energy directional changes skills, whereas the Earth does not but supports said activities and skills; three changes are at the forefront, herewith; aforesaid QCNDMEHC GC, Sets, forms, and buried aqueducts-networks timely revitalized Earth's ‘cardio-vascular’ and magnetic systems functions force processes that extend indefinitely the Earth's life; the two systems masses entirely changed said fluids gases interactions forms force a third change; said third and as most important of human, Earth comparative analogies applies to life extensions; said GC respective IA-processors Orders, said QCNDMEHC Sets and forms at the center of said extended life have mass and energy highest conserving laminar flows four unique, generic claims, especially devised for sole purpose of arriving at quantum masses flows highest conserved energy perimeters and boundaries; the four generic claims quantum masses compliance with the Law of Conservation of Energy thus encompasses the First Law of Thermodynamics, also; said thermal, buried aqueducts quantum masses, potential, kinetic, and heat energy transfers QCNDMEHC Sets and forms transistors by aforesaid analogy are GC, Sets ‘processors’, henceforth, thus referenced; the human cells skin surfaces membrane, the magnetopause GC Sets' forms respective perimeter boundaries and heat energy transfers verify their comparative biologic, inorganic taken analogies;
aforesaid points out that human lifespan, infinitesimal compared to the Earth's longevity, can improve through GC QCNDMEHC Sets, forms invention, methodologies, and principles said comparative biologic, inorganic analogies, especially the inorganic features related to the organic; human physiology—impulses, submicroscopic, microscopic, atomic, molecular, and electrolytes, medical jargon ‘lytes’,—elementary substances forms from subatomic to compounds are varieties of globose forms, wherein living cells globose forms make globose-inverse versions as well; the living cells interrelation intercommunications among globose, globose-inverse forms, within their respective advanced IA-processors Orders utilize their respective conduits' forms; here, medical, profession arts and sciences fail to assign respective critical importance to cells interstitial spaces;
human biological processes' longevities cruces, Earth's systems supported processes, are brain-nervous system, (Earth's electromagnetism) liquids and gases perimeters interactions as GC Sets, forms masses or heat energy boundaries hydrodynamics thermodynamics optimal transfers;
physiologies, biological processes with interstitial spaces identical to inorganic processes highest conserving mass energy QCNDMEHC Sets and forms serve as processes aging inhibitors; electromagnetic thermodynamics hydrodynamics enclosed mass GC QCNDMEHC aqueducts are energy shunts, cosmic radiations, irradiations said ‘global warming’ excess heat balanced systems energy reroutes into nominally reheated crust, thereby extending said Earth's systems longevities;
buried, thermal, GC, aqueducts networks empower industrial electrical energy generation by their byproduct heat energy important usage, for Earth's prolonged longevity preserved ice caps water reserves fluids hydrodynamics, thermodynamics, electromagnetics, inner boundary heat energy balanced transfers; thus, the magnetopause as outer boundary, the two cusps are restricted in mass energy outflow into space; vapor WVMUSCV bulbs, GC aqueducts water heat energy transfers moderate ‘global warming, cooling’; the water vapor mass heat energy greater WVMUSCV bulbs generate global warming; the GC aqueducts water networks diminish geological crustal cooling with important aqueducts irrigational effects function; the WVMUSCV bulbs partially smaller water vapor masses allow more heat energy to escape into space; the aqueducts irrigations groundwater elevations controlled rise, retained water masses least evaporations reduce WVMUSCV bulbs, replace/reverse lower groundwater levels processes greater WVMUSCV bulbs and glaciation periods billions of years of groundwater levels cycling, water-loosing heat energy transfers; the buried thermal aqueducts water masses substitute for glacial masses effect of groundwater levels rise; many fold condensed vapor volumes into aqueducts water masses decouple the Earth's and Solar System, cosmic gradations stratifications water ions mass energy demand with larger heat energy radiations across magnetopause, as fluids forced boundaries; the GC aqueducts networks utilized as globose-conduits shunt switches decouple industrial, power generation and human demands for water, with heat energy processes avoiding water evaporation; most significantly byproduct heat energy usages delay Earth's aging process; forms and Sets QCNDMEHC GC perimeters aqueducts water inside the fluids/ions GC forms masses is GC boundaries laminated enclosures of cosmos unique, Earth's super-advanced Order IA-main processor;
said hydrodynamics thermodynamics electromagnetics, basic physics, chemistry laws, geological histories, and astronomical observances validate QCNDMEHC GC Sets, forms said heat energy transfers, GC are cosmos mass energy reservoirs; quintessential natural disposition, mass energy highest conserving QCNDMEHC core form of globose-conduit, GC, Sets are sequential equilibriums that flow from smallest particles to cosmic infinities from submicroscopic microbes to living cells to humans, and by evolutionary processes into omnipotent and omnipresent intelligence constituted masses energy in space time infinities;
said hydrodynamics thermodynamics electromagnetics, basic physics, chemistry laws, geological histories, and astronomical observances validate QCNDMEHC GC Sets, forms said heat energy transfers; prior applications claim “conforming embodiments conforming least mass, height, hydrostatic pressures, surface area, quantum mass rotations, PP lengths least sum thus frictional losses makes for mass energy constituted highest self-conserving globose-conduit universe FESD forms, Sets, and domains; globose-conduit forms forgoing properties highest mass energy conservation from infinite to infinitesimal ranges constitute highest “best mode of operation” over existing and prior patents”;
prior applications, conforming revisions Forms Phenomena Claim follows for reference, only:
globose-conduit spouts drainage lines universe, conforming embodiments' energy mass highest conserving, quintessential, core, natural disposition complete complement of completely matched forms compact composites constitutes Sets; an inflow Inlet, a perimeter enclosure part, makes a Set; a mass varied composition, a conforming least quanta mass at highest elevations, a one length continuous least height compact composite, a free-surfaces one continuous composite, a least height perimeter for a least rotated quanta mass most conserve mass energy; said quanta, quantum mass paths-of-passage, PP, lengths least sum has an upper retention part submerging a transition region part above a globose Inlet lower end, an End 2, or a globose-inverse ascending outlet spout lower end, a First End, respective undersurfaces forms; forms of FESDs, an Inlet, a Sub-outlet, an outlet lower smaller areas, short heights, a narrow breadths cross-sections, a PPLD band narrowest widths, an open channel quanta mass globose breach, breadths, a least perimeter large globose areas free-surface complete complement of forms, and a PAP least angles less than 180 degrees effect a least quanta mass least rotations, mass energy highest conserving; globose-conduit spouts retain much smaller quanta mass than ubiquitous arts do; mass steady transports through narrow breadths, narrowest PPLD widths of bands, lowest surfaces short slopes, height, length conduit priorities manipulated cross-sections areas varied breadths complete complement raises, sets up a high-specific gravity mass ahead of a globose mass detention large free surface much larger mass uniform hydrostatic, atmospheric steady pressure energy push; said End 2 or a First End various migrating locations from sidelong to anti-sidelong makes up domain Sets; a Globose and a circumferential strain mutation make up hybrid domains Sets; a globose-conduit complete complement breadths drainage line has a small lower, a transition region, and an upper globose, cross-section area one composite form; said composition nonhomogeneous heavy mass is nonuniform nonsteady energy a structure perimeter lifted repeatedly, continually, indefinitely, replaced continually by smaller quanta masses through shorter heights and or distances conserves infinite mass and or energy; mass and energy forms unique origin perimeters evolve or devolve, rotate, mutate, transpose, and transfer to contain, retain, detain and transport highest mass energy modes to forms universe perfection beyond human creating skill; flush Apparatus pre-assembled wall structure assemblies adeptly flush, sterilize, coat surfaces or a Set and or maintain retention; a globose-conduit is a quintessential, core, natural disposition classis of mass energy perimeter mass energy classic enclosing perimeters that is infinitesimal to infinite mass energy conserving;
the first application general forms make Sets; continuation applications is conforming, least mass energy, least boundary surfaces specific forms, whose mass energy and surfaces areas are much smaller than those of conventional, know arts; conforming embodiments, or a globose-conduit, globose conduit, ‘laminar’, ‘flow control’ mass energy is inside the first application, the known art forms enclosure surfaces boundaries; the most self-conserving, most self-preserving mass energy core, quintessential, natural disposition makes the competing forms immaterial and or insignificant; while omnipresent, mass energy core, quintessential, natural disposition readily dissipates and is intellectually most visible in its purest, most intensive forms; mass energy, core, quintessential, natural disposition boundaries least mass forms perimeter constitute continuation applications conserving mass energy algorithm approximations computed perimeter forms;
omnipresence of mass energy core, quintessential, natural disposition boundaries small mass or surface perimeter inside the first application forms constitutes continuation applications continually filed requested allowances for highest conserving quantum mass approximated mass energy perimeter forms;
the first application first paragraph most broadly specifies forms of fluid mass-energy containers;
the continuation applications provide globose-conduit as a least Sets of contained, retained, detained and transported mass energy, figures illustrated methodologies, inventions, and principles accepted universally as belonging to classic highest self-conserving, preserving mass energy quintessential, core, natural disposition environment;
globose-conduit perimeters enclose quintessential, core, natural disposition mass energy highest conserving classis; sciences' highest conserving mass energy paralleling analogies make analogous forms; quintessential core natural dispositions light energy enclosed inside an energy mass force field is a black hole; light and gravity energy force fields unique common boundary constitutes cosmos enclosure; if it is electrons electric charge boundary about nuclei, it is atoms; if it is a man devised best approximations mass energy core, quintessential, natural disposition enclosure boundaries, it is an aforesaid globose-conduit; such mass energy perimeters of elastic or a flexible or a solid epidermis membrane boundary constitute a living cell; details of best, computing approximations follow; examples of the known universally familiar mass energy classic forms are universally drawn paralleling analogies accepted to exist referred to here as classic forms, which universally involve aforesaid globose-conduit perimeter forms;
the first application structures specification and drawings ‘laminar flow’ herein defines a liquid, gas, or solids fluid adjacent or neighboring layers that do not mix, enhanced by a relative density or a specific gravity, that flow at different speeds perimeter forms confined to a velocities direction having globose-conduit conforming least quanta mass energy least rotations; said ‘flow control means’ is FESD forms a PAP, PP, PPLD geometrics conforming least quanta mass that is algorithm computed continued PP lengths least sum respective perimeter interface surfaces forms from an Inlet fluid free surface to at least a DCSS for it to constitute globose-conduit classic form; a PP lengths as a least sum inherently constitutes conforming least quanta mass least rotations, highest conserving mass energy perimeter phases compact composite forms; an FESD origin is PP least sum thus conforming least mass least perimeter surface that, evolve, modify, and continues from the first application as shrunk, compressed figures of illustrated, specified ‘flow control means’;
for a narrow breadth conduit nearly infinite Inlet or outlet forms drain or a sewer line for a natural gravitational uniform mass energy highest conserving is globose-conduit form that most readily evolves devolves into spherical, globose retention forms or negotiates a grade rising slope with cross-sections area manipulations; a mass energy composition transports with free surfaces higher than conduit springing points disclose globose conduit unmatched mass energy transports superiority with a conforming least quanta mass least height, least rotations, a lowest hydrostatic pressure largest free surface least boundary friction, for sewer or drain lines highest elevations;
sets contain, retain, detain and transport mass energy that is the first application figures shrunk to quintessential, core, natural disposition said inventions, principles, and methodologies best self-conserving mass energy classic forms; continuation applications mass energy boundary as least mass forms is inside the first application, first paragraph fluid mass perimeter to arrive at classic perimeter globose conduit unchanged drawings of Sets that is continued from the second application; nothing is added; sets' universe consists of a basin, outlet, and Inlet forms, a Set or Set clusters where Sets partitions subdivide clusters; continuation applications depict, describe, and continue the fourth application classic globose conduit Sets unique genome forms origin, a ‘parent’ that FIG. 1 shows, also parent of the first application FIG. 1-2, especially FIG. 12 forms cylindrical versions extensively depicted, continued further with the continuation applications, herein FIG. 12 globose forms Set; flow-energy-surface-dispensators, FESD, originated with the first application that are entirely the second application illustrated and detailed are this drawings continued ‘flow control’ as classic globose-conduit perimeters or continued mechanics of forms; said FIGS. 1-2 and 12 forms conforming to generic claims constitute a conduit Inlet, a basin outlet globose-conduit mass energy classic, FESD, conversions from primarily one to multidimensional forms with a conduit, a globose basin mainly a one, two dimensional forms, respectively; this drawings introduction, mechanics of forms, shows FESD(s) originate with the first application;
nonhomogeneous, nonsteady, nonuniform mass-energy composition inflows are globose-conduit cross-sections area perimeter boundary; mass-energy, mass energy, refers to a globose-conduit quantum, quanta fluid mass contained energy; globose-conduit units of mass, quantum energy, is contained continually, a transported, retained, contained mass energy or a transported, contained, retained, detained, mass energy phases; a quanta mass has varying phases' amounts in variable percentages; globose-conduit open channel vented forms specific gravities stratified mass-energy under atmospheric pressure is mechanics of forms introduction to the drawings;
globose-conduit forms boundary contains, retains, detains, transports air, gas, and a least conforming nonhomogeneous, nonuniform, nonsteady mass-energy has least PPLD widths band, quanta mass height, conduit perimeters friction forces for energy modes phases highest sum;
globose-conduit universe Sets' genomes are a least conforming mass, energy boundary, internal rotations, hydrostatic pressures and friction, making energy modes' phases highest sum;
generic PAP, PPLD, PP lengths least sum, conforming embodiments, evolve or devolve globose-conduit forms into rounded or entirely round conduit cross-sections or globose spherical or spherical retained mass forms that rotate, mutate, transpose, transfer, and make unique origin universe constituted highest conserving mass energy phases, forms, Sets, hybrids, and domains;
a globose-conduit confines, retains, transports; its lower conduit confines, transports; its mechanics of forms detention highest conserving mass energy phases least confine its transport;
globose-conduit unique origin forms phenomena evolve, devolve; rotate, mutate, transpose transfer; contain, detain, retain, or transport conforming least mass varied composition at continuously highest elevations;
a least height perimeter one length compact composite of free surfaces least rotated mass phenomena most conserves mass energy; globose-conduit perimeters enclose quintessential, core, natural disposition mass energy highest conserving classis;
globose-conduit highest mass energy forms drawn analogies and schematic evaluations confirm infinitesimal perimeter boundary analyses substantiate nonhomogeneous, nonuniform, and nonsteady mass energy highest conserving universal environmentally important innovations;
core mechanics of drawings, mechanics of forms, FESD forms, Flush Apparatus inventions, principles, methodologies highest quantum mass-energy quintessential, core, natural disposition globose-conduit classic perimeter forms with the following summary:
A. microbes' submicroscopic, atomic subatomic to cosmos makeup as described;
B. craft's ordinary scale implemented inventions, principles, and methodologies:
a. inflows nonhomogeneous, nonsteady, nonuniform mass-energy stratifies,
1. a globose-conduit detention, upper retention least transport-fluid height,
2. heaviest fluid topside, inside narrowest PPLD widths, conduit breadths, gravity separated nonsteady, nonuniform mass energy into following;
b. uniform atmospheric, detention pressures with detention one-length globose largest free-surface form steadies nonuniform, nonsteady mass energy to a DCCS;
c. narrow PPLD widths, forms' breadths confine heaviest fluid mass with,
1. heaviest fluid mass modes of energy at highest elevations,
2. confined heaviest fluid mass centroid raised by narrow breadths,
3. mass-energy rotations, modes of energy losses minimized;
d. a globose-conduit conduit contained mass inflows entirely into mass-energy;
e. mass-energy mass inflows are topside PPLD forms surface into heavy fluid,
1. separating, tearing, breaking, releasing heaviest fluid particles,
2. heaviest particles that are narrow PPLD widths confined,
a. with natural fluid mass quintessential, core, disposition forms,
b. displaced contained mass, by or with FESD surface forms,
c. heavy fluid mass least perimeter least adhesion friction losses,
1. least cross-sectional area,
2. least friction coefficient,
3. inflows mass-energy centroids are below a heavier mass centroids computed for:
a. mass-energy, perimeter friction, and adhesion least losses;
b. centroids alignment rotations that tend to lift heavier mass;
f. flush Apparatus are adeptly fitted into globose-conduit forms;
g. a most of steady inflow outflow fluid mass is through a conduit form,
1. a DCSS First Sub-outlet PPLD PP of highest mass velocity,
2. inflows are entirely through a conduit Inlet,
3. a DCSS FESD form First Sub-outlet discharges continual outflow,
4. a DCSS globose form passes through rare unusual events fluid;
h. most of energy modes losses occur with a lower one-half of lowest conduit,
1. manipulations of cross-sectional areas forms minimize mass rotations,
2. a mainly transport fluid upper retention has least or no friction losses,
3. from under an Inlet to an outlet DCSS to an Exhaust most energy loss occurs between lowest conduit springing points;
4. a PPLD form is at highest elevations in respect to its Inlet End 1, an End 1 higher than a globose-conduit is a safety factor convenience,
5. shrunken PPLD least height and length conforming,
a. PAP least angle, with best alignment and symmetry,
b. least perimeter losses, least contained mass, PP lengths least sum,
c. PP lengths least sum inventions, principles, methods, FESD forms,
1. with algorithm computing up to smallest elements,
2. entire quanta subdivided mass computed PP lengths,
3. with graphical prototypes scaled measurements,
4. with laboratory testing confirmations;
i. mechanics of forms mass-energy absolute highest conserving globose-conduit perimeter forms, conforming quantum mass least rotations classic genome Sets,
1. globose, spherical form conforming mass retained mass-energy,
2. retained mass-energy least surface perimeter globose, spherical form,
3. least surface perimeter friction, adhesion mass-energy losses,
4. heavier mass least retained mass-energy rounded conduit form,
a. with statistical analysis of heavy fluid mass-energy inflows, rate,
b. with conformance to PPLD width of band and length forms,
c. retained mass-energy least surface perimeter conduit form,
d. least surface perimeter friction, adhesion mass-energy losses,
e. amalgamated with upper retention that is a low friction fluid,
5. least PAP angle, PP lengths, sum of, PPLD height and length forms;
j. universe of Globose-conduit mechanics originated from unique genome form,
1. retention genome graphical intellectual, inclusion, exclusion shown,
a. illustrates retention unique genome globose-conduit forms,
b. unique genome form universe domains;
2. globose-conduits evolve or devolve conforming-conduit forms contained least mass into out of globose, spherical contained mass retention least surface forms;
3. amalgamated globose-conduit forms rotate, mutate, transpose, transfer to contain, retain, detain and transport highest conserving mass-energy modes made up of mass-energy contain, detained, transferred phases;
4. globose conduit forms manipulated cross-sections areas manipulate, raise a smaller heavy fluid mass centroid ahead of larger transport fluid mass, or vice versa detain transport fluid to pant-up hydrostatic pressures for heavier fluid mass confined discharge four times;
a. under an End 2 undersurface a least height separated from a PPLD lowest surface form at highest elevations,
b. with gradual devolution from a globose to a rounded, or called for by statistical analysis of fluid mass composition, rate to a curvilinear globose-conduit conduit perimeter transition form,
c. with a DCSS form First Sub-outlet conduit form with a higher energy, smaller heavy mass pushed ahead of a much larger globose detention transport fluid mass; a forth time is with Industrial forms DCSS areas manipulation with transport fluid discharge through Second Sub-outlet;
5. globose-conduits are classic perimeters alongside globose, spherical, with parallelism to homogeneous round conductors as described,
a. a globose-conduit's globose area height vary, from about 5% to about 95% of entire cross-section height, globose breadths manipulated up to orders of magnitude greater than a venting pipe (the first application shown up to three times greater);
inventions, principles, methodologies quintessential highest self-preserving, self-conserving, core, natural mass energy modes dispositions is globose-conduit universally manipulated forms, Sets, and domains that constitute unique origin universe is as follows:
quantum mass conforming PAP, PP, and PPLD energy demand self-preserving, self-compliance to mass energy, omnipotent force fields make Sets' conforming forms, globose-conduit energy conserving universe of conformed forms Sets, herein,
gas, air, and fluid mass inflows outflow through a vented discharging pipe;
globose-conduit classic cross-section areas, perimeters, surface interface forces at boundaries, and mass centroids respective locations are computed for least or no rotations about fluid mass “flow control” mass and energy highest conservation;
basin-outlets least Set includes Inlet forms inside, a conforming retention mass, a globose form transported detention, and said Inlet fluid mass outside of said basin-outlet;
continued first application FIG. 1-2, 10-12 versions show conduit Inlet least height that is barely outside of a basin upper casing; a conforming and a detained fluid mass make up retention mass; the former precludes venting or backups, the latter moves mass; fluids free surface essential elevations pass largest size submerged particle through a First Sub-outlet and DCSS forms;
inlet inflows provide paths-of-passage, PP, mass potential, kinetic energy modes sum; an Inlet End 2 separation from a PPLD form barely exceeds largest particle sizes;
for drain traps, a globose End 2, a globose-inverse First End undersurface lowest point elevation is globose conduit springing points' elevation;
transition region cross-section areas are from conduit to globose springing points; cross-sections fluid structure interface perimeter are two symmetrical smooth curvilinear lines which connect lower conduit upper globose cross-section perimeter springing points ranging from a rounded cross-section to a globose area having springing points breadths a multi order magnitude wider than those of its counterpart conduit form springing points;
within transition region FESD forms make up permanent retention conduit forms, wherein permanent retention is a mass-volume that precludes venting of gas or backups;
transition region fluid mass least rotations computed viscosity least friction, least breadth or height cross-section area forms having highest conserving modes of energy are listed FESD forms that seamlessly convert classic globose retention into conduit forms;
generic claims' PPLD forms constitute a part or a counterpart to FESD forms;
for purposes of presenting describing, depicting, the following free falling fluid mass is taken generally for an entire End 1 cross-sectional area under continual hydrostatic pressure;
globose-conduit conduit springing points constitutes an elevation no higher then conduit entire height; rounded conduit forms may make a Trough, a Trough inside a Trough, or Troughs inside Troughs curvilinear forms, a Ridge, a Partition FESD lowest surface forms with sides slopes constituted transition region forms complete complement;
especially Trough(s), Ridge(s) including upright, Partition(s), or indented Ridges as turning veins Troughs, along with End 2, First End basin lower surfaces, side surfaces includes Dimensions 44 spaced counterparts among listed FESD forms, for PAP upright plane symmetric fluid mass radial outflow, inflow into a basin-outlet, ordinary trades or crafts fabrication scale to arts sciences microscopic near infinitesimal units of mass FESD forms complete engagement of globose-conduit retained, detained fluid mass constitutes a range of FESD forms complete complement; first and foremost globose-conduit forms constitute open channel conduit forms that contain, retain, detain and transport fluid mass energy with highest conservation of both, including rare events such as high hydrostatic pressures, a hundred year, or once in a lifetime storms;
for a PPLD form slope rise, in tandem, increases its area form side surface slopes into narrower breadths that with cross-sections height narrows transition region breadths, giving upper retention, globose form breadths curvilinear or elliptical upright major axis forms; forgoing algorithm computing methodology carries out to a highest computational accuracy cross-sectional areas and perimeter fluid mass forms for least or no entire fluid mass rotations in PAP upright plane toward highest conserving of mass energy modes; a PAP upright plane horizontal orientation in space constitute absolute symmetry of forms up to DCSS springing points elevations having least or no detrimental retained, detained, transported fluid mass rotations constitutes in PAP upright plane symmetry said “flow control means” laminar fluid mass;
globose gravitational field energy modes classic containment spherical, globose highest energy modes genome classic forms retain mass units constituting computed least resistance paths, said paths-of-passage, PP, lengths least sum that here applies to retained, detained, and transported nonsteady, nonhomogeneous, and nonuniform mass; conduit forms must exist for transfer of energy modes; generic claims PAP, PPLD, PP with PP lengths least sum defines confined mass modes of energy transfer self-conservation with units of mass PP of least resistance make up of basin-outlet classic globose-conduit forms conformed embodiments, Sets; said PP lengths least sum computes open channel fluid said centroid locations and least height classic forms for retained and transported fluid mass with least or no rotation forms, for ordinary design use, with infinitesimal elements designs for scientific purposes; practical construction purposes, crafts finest tolerances constitute said finest units, least mass, lowest surfaces, slopes, shortest or least height, length, and said stated required construction implements stated principles that conserves fluid mass and energy;
each breadth different width above PPLD width of band highest elevation makes on infinitesimal scale a stair step like change; a step constitutes summation of mass units widths that make least resistance paths of least elevations derived by said PP lengths least sum; forgoing statistically compiled fluid mass properties, especially specific gravity of particles, into curvilinear forms computing methodology for influx of units of fluid mass constitutes each mass unit path of least resistance that algorithm amalgamates into entire mass PP with lengths least sum; units of mass PP lengths least sum makes lower cross-sections a viable conduit area with a perimeter form; by definitions, inverts of globose-conduit forms, PPLD width of band horizontal segments, constitute highest elevations; a horizontal chord, breadths at respective elevations, by PP lengths least sum computing is a least transfer of kinetic to potential mode of energy, highest conservation for fluid mass and energy; rising PPLD widths with length constitutes potential energy increase, while descending PPLD cross-sections respective breadths, conduit horizontal chords, lowering of elevations with length is potential to kinetic mode transfer highest energy conservation for statistically compiled fluid mass and energy composition, foregoing methodology for cross-section areas, perimeter computed effects least fluid mass least rotations in a PAP plane of symmetry, which requires exact areas and perimeter forms with length; with no PAP upright plane rotations, units of mass moves are confined by surrounding units of mass at respective elevations or move down, up governed by mass units' specific gravity; in chords, breadths, horizontal planes units of mass are confined by surrounding units of mass eventually confined by cross-sectional area form perimeter form which implements least or no rotations in PAP upright plane of symmetry, least or no rotations in horizontal planes for no fluid mass energy influx changes; said changes require at least a change in retention free surface elevations and that also require areas, perimeter change effected by aforesaid computing for highest probability statistical fluid mass influx, outflow balance; this requires a continual slight narrowing of conduit forms lengthwise breadths with an even smaller transition region breadths increase toward a DCSS or next Inlet fluid mass influx, which constitutes immaterial change for crafts, trades fabrication; upper globose and transition region cross-sections computed similarly makes complete complement of forms that constitute cross-sections classic areas and classic perimeter of entire globose-conduit Set of nonhomogeneous, nonuniform, nonsteady fluid mass FESD forms;
a PPLD constitutes globose-conduit unit of mass lowest path of least resistance for said globose form conforming least mass, fluid mass least height conduit form highest elevation highest conservation of fluid mass energy conversion from kinetic to potential mode; gravity force pulls higher specific gravity particles toward a path-of-passage-of-least-energy-demand, PPLD, with lighter particles moved to equal or low specific gravity mass higher elevations; confined by narrowing of a globose, conduit ascending spout, heaviest particles are squeezed into a PPLD narrowest width highest slope single largest sphere that just passes through said spout rounded lowest surface area cross-section that is said PP lengths least sum FESD form; surrounded by highest specific gravity transport fluid mass of highest viscosity said largest sphere is pushed in back pulled by transport fluid drag while allowed to rotate in PPLD direction toward summit without rotations of entire fluid mass, sub-outlets, First Sub-outlets, detention fluid free surfaces essential elevation height is said largest sphere passing through Sets submerged height elevation at summit;
an End 2 undersurface is located at about one half of upper retention depth that with a free fall locates inflows mass centroid into a lowest ¼ of a basin retention depth; ignoring viscosity friction, adhesion, at a DCSS form, velocity of water at depths below a fluid free surface equals the square root of twice gravity acceleration times a fluid depth;
high specific gravity inflows, outflows fluid mass is entirely through lower conduit form of globose-conduit cross-sections, globose-inverse First End located about one half of basin retention depth is entirely consistent with said heavier mass inflows, outflows;
ordinary fluid mass retention outflows are mostly through a lower small conduit cross-sectional area of a globose-conduit composite, ahead of a larger detention mass;
unusual, out of ordinary fluid mass outflows pass through globose cross-sectional forms;
heaviest mass centroid short height to a summit is most mass energy conserving; a globose-conduit shallowest retention also has heaviest fluid mass most raised centroid;
globose-conduit least conforming retention mass of least height of least rotations is least magnitude potential, kinetic exchanges of energy modes, kinetic potential energy mode exchange has rotational friction and viscosity losses; compared to round or similar piping, globose-conduit Sets forms complete complement amalgamated, least mass, least conforming retention, least rotations multi raise retained mass centroids, PPLD forms to highest elevations for modes of mass energy highest conservation; less is more, more is less, less energy transferred conserves mass, energy either one or both; Least rotations of least mass centroid at highest elevation a least height from fluid free surface set at highest elevations have Sets’ forms highest conserving mass modes of energy; narrowest conduit breadths move heaviest fluid mass higher into entire cross-sections form, raising its mass, area, perimeter centroids to highest elevations matched by globose breaths, PPLD forms, fluid mass highest elevations, energy modes highest conserving;
least conforming fluid mass least rotations constitute least rotational frictional, viscosity loss higher potential, kinetic energy exchanges magnitude, mass energy highest conservation; globose-conduit conforming detention least height globose largest breadths, lengths raise entire mass centroid elevation eight times, once for each of four horizontal direction that is in unison with the other three, repeated again four times for conforming globose mass retention at rest, with fluid free surface elevations as kinetic, potential energy modes exchanges governing reference for least energy demand with PPLD forms at highest elevations; as a system amalgamated globose-conduits raise fluid mass centroids three times once for each globose conduit forms raised mass centroids once for highest PPLD elevations; globose-conduit sewer lines detention basin-outlet least mass conforming retention fluid mass centroids rotations are least distance from fluid free surface which makes for highest conserving mass energy modes balanced exchanges that inflicts least abuse or damage to earth's ecosystem mass energy balance as it follows energy balanced modes for conforming least mass least rotations conserves mass energy;
a detained larger mass at insignificant or no energy loss is conserving mass energy; globose forms detain transport fluid mass that counterpart conduit uses to transport mass;
pent up initial hydrostatic pressures cause discharge of nonhomogeneous heaviest mass, particles; pent up initial hydrostatic pressures are to fluid free surface essential elevations, only;
a globose-conduit conduit outlet, First Sub-outlet, DCSS greatly narrowed breadths with much larger globose breadths adeptly manipulates PP pent up hydrostatic pressures;
detention large breadths, lengths mitigate nonsteady mass flows to a least change from conserving mass energy fluid free surface highest elevations respective hydrostatic pressures;
herewith listed, also referred to, FESD specific forms are part of FESD globose-conduit forms whose specific purpose is prevention or restriction of fluid mass rotations for highest conservation of energy exact transfer of kinetic to potential energy requires energy path-of-passage-of-least-demand, PPLD, for a unit of mass that passes a summit; for near frictionless transport fluid critical path lengths are those against gravity direction as then mass energy required contains 32.2 (ft/sec; squared) multiple; smallest entire mass makes for least mass that requires said multiple for highest conservation of energy; such mass must preclude venting or backups found by nearly universal or ubiquitous empirical use conforming least mass contained by most compact least volume spherical modified to a globose form units of mass constituted PP lengths least height forms; nonhomogeneous fluid mass paths-of-passage, PP, lengths least sum contains horizontal components, also; conduit inverts, fluid mass units energy paths-of-passage-of-least-demand (most energy required), PPLD, identical PP length forms are referred to as such;
nonhomogeneous, nonsteady nonuniform conforming least mass high conserving energy modes fluid mass least rotations globose-conduit complete complement PP lengths least sum retention genome round, rounded, curvilinear forms has these globose-conduit transpositions,
round or rounded areas transposed to a conduit, an intermediate, and a globose form area higher centroids of retained fluid mass potential and kinetic modes of energy;
transposed round, rounded conduit cross-sections, fluid mass essential height as for a First Sub-outlet, constitutes fluid mass least rotations curvilinear least height form,
least rotations curvilinear fluid mass forms raise centroids of following,
fluid mass perimeter, FESD structure interface curvilinear surface, thus
viscosity, cohesion, adhesion, and solids surfaces friction centroid,
boundary layer perimeter laminar respective forces centroid location, as
transposed centroids, forces constitute one common centroid force with least rotations, for fluid mass varied compositions respective least height forms,
breadths, breach least height FESD make for fluid mass forms least rotations,
contained, retained, detained transported fluid mass-energy phases forms least PPLD width of band, lower conduit perimeter, and quintessential, core, self-conservation, self-preservation for a quanta mass form least height, a mass centroid highest elevations;
thus, a classic globose upper retention form and a classic lower conduit form constitute elevations of fluid free surfaces that is for a transfer of energy mode near or at highest elevations; a classic globose lower form amalgamates a lowest surface shrunk PPLD conduit form at highest elevations which conserves most of fluid energy transfer to potential mode to transport highest specific gravity fluid mass specifically effected by said classic conduit to globose form transition region, said PP lengths least sum of finite to infinitesimal retained fluid mass inherently constitutes self-conserved preserved energy highest conservation paths of least resistance which make open channel transition region of globose-conduit fluid mass forms; said globose-conduit transition region computing of forms forgoing figures wherein globose-conduit conduit basin-outlet, Inlet fluid mass forms may constitute an Inlet contained fluid mass outside a basin-outlet, especially fluid mass and Inlet forms that precludes suction or venting; transition region forms conserve fluid mass energy with computed highest elevations of PPLD and fluid free surfaces least height difference constantly continually that with a conduit form fluid mass constitutes an essential height; said PPLD constitutes lowest surface rounded form unless fluid mass highest specific gravity are highly uniform inflows that PP lengths least sum computes to a round form; rounded lowest surface forms constitute highest elevation for a statistical continual inflow rate that constitutes fluid mass detention wherein said inflows of a nonhomogeneous, nonsteady, nonuniform fluid is accounted for by lowest surfaces PPLD forms; for statistical standard deviations higher inflow rates rounded forms open into PP lengths least sum computed wide form of low slope sides surfaces or parabolic horizontal major axis forms; highest elevations PPLD forms govern unless cross-sections breadth or breach computed PP lengths least sum mandates a PPLD lower form;
shrunk PPLD forms rounded, elliptical upright major axis, or curvilinear globose-conduit forms makeup, transition region forms, PAP angles less than 180 degrees, and PP lengths least sum forms complete complement constitute claimed universe fundamentals,
a PAP two points as “surveyor stakes” that space align fluid mass energy forms with conduit, globose springing points constituted lower, upper transition region limits,
“self-designed” conforming PP lengths with least sum, fluid mass least energy resistance paths constituted fluid mass perimeter surfaces that are globose-conduit forms,
said PP paths as “self-designed” units of fluid mass paths that use least energy,
said PPLD forms as “self-designed primary paths” most efficient energy forms,
said classic retention genome, as contained retained energy genomes “parent”,
mass units' paths of gravity force least resistance is said PP mass energy modes quintessential highest conserving, self-preservation with natural disposition visible forms,
most self-conserved preserved fluid mass energy self-generates least magnitude of energy modes full transfer most shrunk PPLD form, globose-conduit compact forms;
said “parent” near spherical classic conforming retention amalgamates, its outlet conduit to make up highest conserving fluid mass energy globose-conduit Sets;
said infinitesimal units of mass PAP symmetric orderly outflows, inflows into, out of classic retention genome form as “old”, “new” units of fluid mass and energy;
said fluid mass energy units as “participants” in “parent” mass energy universe;
said laminar flows mass units as a “confined unit” for fluid mass energy forms;
mass units PP lengths least sum makes least PAP angle unique Set symmetrical forms through a discharge-cross-section-surface, DCSS, and springing points elevations,
globose-conduit forms are within “genus” conforming “citizens”, Sets, by PP lengths least sum fluid mass energy highest conserving forms that constitute its universe,
lower globose basin globose forms amalgamate into a rounded or a curvilinear globose-conduit, First End, outlet, Sub-outlets, FESD, and DCSS FESD respective forms,
a Paths-of-passage compute PP lengths least sum, globose-conduit, PPLD, FESD retention conforming least fluid mass least rotations PAP upright plane symmetric forms,
classic genomes Set of forms conforming retention least mass least height is mass modes of energy highest conservation thus PP lengths (least resistance) least sum,
quantum units of mass PP least sum amalgamates mass units' paths into least height shallowest retained mass genome forms mass energy modes highest conservation,
genome Sets make for retained fluids least height, conforming least mass potential, kinetic energy modes quantum mass units least sum amalgamate into fluid mass and forms Sets,
said PP lengths least sum for a form constitutes a conforming or a genome form, genome forms complete complement conforming embodiments are genome Sets,
embodiment forms PP lengths least sum causes nonhomogeneous fluid mass conforming permanent retention kinetic potential energy modes passing heaviest particle,
heaviest particles, highest specific gravity mass PPLD entire length least height form, conforming retention least mass, height, and energy modes inflows transport mass through PP, quantum mass least rotations, mass energy physical forces compute a conforming embodiment,
a PPLD units of mass paths to summit topside PPLD width of band surface forms make for least rise slopes for said mass units PP lengths least sum narrowest breadths,
outlet FESD and DCSS forms PP lengths large breadth upper area cross-sections higher than globose forms springing points elevation limit fluid free surface rises to hold least height, least conforming mass fluid retention kinetic energy transfer to potential energy mode,
further fluid free surface rise potentially wastes both,
a greatest particle height constitutes a free-fluid surface detention essential elevation, PP lengths least sums lowest elevation and First Sub-outlet forms least height,
essential detention free-surface elevations require no kinetic to potential energy energy-demand transfer required for continual mass and energy highest conservation,
open channel globose-conduit forms nonhomogeneous fluid solids mixtures mass energy self-preservation containment, detainment, and transport are within one form,
globose-conduit forms contain Inlet retention and forms, that altogether inside a basin-outlet constitutes a globose-conduit conforming least mass least forms Set high modes of energy,
quantum-mass PP complete complement computes Sets' least resistance forms;
generic globose-conduit claims: path-angle-of-passage, PAP; path-of-passage-of-least-energy-demand, PPLD; paths-of-passage, PP, with a least sum constitute fluid mass globose-conduit conforming embodiments self generated Sets; globose universe conforming embodiments, Sets genus, is generic claim classic Sets conservation of mass and energy of fluids and solids mixtures that originate from said classic unique retention form genome; a PP, paths-of-passage, lengths generic claim to algorithm computed least sum is energy balance for entire retention mass quantum mass upright components with gravity acceleration multiple which through reiterative process arrives at fluid mass and structure forms interface ultimate Sets, genomes; forgoing specified at least two points aligns Sets to a linear PAP least angle alignment and symmetry of forms; genomes best construction of surface forms narrows the first application globose conduit construction and forms tolerances to commercial, industrial forms herein said complete complement of completely matched forms of Sets; sciences, art fields' nuclei or subatomic, microscopic or submicroscopic complete complement of forms is quintessential of globose-conduit potential, kinetic near infinitesimal quantum mass energy modes transfers perfection that is beyond human skill to create or duplicate;
globose-conduit conforming embodiments classic universe forms contain, retain, detain, transfer and conserve mass energy that transposes globose-conduit, open channel, nonhomogeneous to homogeneous high pressure round water pipe, electric wire or vice-versa or round, globose, spherical retained mass with generic PP lengths least sum claim;
microbes microscopic, submicroscopic thin disk or short rod line like, single form cells contain, retain, transport, or detain submicroscopic ecosystem inflow, outflow mass constitute an Inlet, a basin-outlet forms of globose-conduits basic types least Sets make;
conforming embodiments conforming least mass, height, hydrostatic pressures, surface area, quantum mass rotations, PP lengths least sum thus frictional losses makes for mass energy constituted highest self-conserving globose-conduit universe FESD forms, Sets, and domains; globose-conduit forms forgoing properties highest mass energy conservation from infinite to infinitesimal ranges constitute highest “best mode of operation” over existing and prior patents; least separation of heaviest mass and detention transport fluid mass centroids require less transport fluid mass and its energy; two, three dimensional FESD forms of globose conduits much wider breadths larger area compared to entirely round or otherwise similar conduit forms hold transport fluid mass with least or shallowest detention, retention mass height that is set at highest elevations for respective Set fluid mass inflows, outflows; for continually raised heavier fluids centroids toward a DCSS with entire fluid mass least or no rotations in PAP upright plane makes for highest mass and energy, especially transport fluid mass variable inflows with specific gravity variations mass, energy conservation;
frictionless fluid least rotations consume least to insignificant amounts of energy modes; globose-conduit systemic highest self-conserving energy modes retains, detains, and transports manipulated mass energy mass, area, and perimeter centroids as follows,
two PAP points align upright plane symmetric globose-conduit forms flexible to rigid least Set rotated forms to a finite or infinitesimal PAP angles accuracy analogous to “positioning members” with forms having up to near infinitesimal “flow control means”,
globose-conduits PP make paths of least resistance cross-section areas breadths for fluid free surface least elevations difference from PPLD forms at highest elevations,
sets contain retain detain, and transport nonuniform, nonhomogeneous, nonsteady classic area, perimeter conforming least mass, height, fluid mass for least or no detrimental rotations;
globose-conduit quintessential fundamental, evolutionary, natural, highest self-conserving self-preserving superiorities self-generated mass energy forms is as follows,
1. globose-conduit mass inflows preferentially distribute transport energy modes into heaviest fluid mass PP, PPLD forms at highest elevations with respect to its summit,
2. globose-conduit forms push highest specific gravity mass ahead of a transport fluid mass at three locations: a) under an End 2, b) prior to a summit, c) after a summit,
a. under globose End 2 least conduit height, with a lowest PPLD form at highest elevation, with separations that need not exceed much inflows mass largest particle size,
b. with narrow breadths conduit transported heaviest mass risen centroid pushed in front, ahead of detention mass ahead of a First Sub-outlet by conforming quantum mass least rotations,
c. passed summit with transport fluid greater drop into pushed ahead heavier fluid mass similar to fluid mass Inlet inflows, accentuated by Industrial Sets heavy, transported fluid mass passed through a lower First, a higher Second Sub-outlet forms, respectively,
3. a globose detention in tandem rise behind a risen transported mass centroid,
4. transported, transport fluid tandem raised, lowered respective mass centroids,
5. a much small transported mass in front of significantly larger detention mass,
6. compact retention, detention highest mass centroids in respect to its summit,
7. highest mass centroids a least distance, rotations from a respective summit, constitute a viscosity, boundary layer friction conforming retention least mass modes of energy least losses,
10. a narrow conduit breadth at summit raises up globose detention pressure,
9. a globose-conduit, one-form, least energy modes demand raised detention pressure, heaviest mass centroid retains or detains, transfers mass energy highest modes; kinetic, potential is useful energy mode; least mass rotation is conserving both,
conserving of both is because energy modes are least energy demand transfers,
quantum mass energy modes are exchanges for inflows mass energy same sum,
1. a globose detention mass pant up pressures separate, dilute, or dissolve a transported mass in its path with raised centroid least apart from transport mass centroid,
11. open channel forms adeptly manipulate energy-modes gravity force caused,
12. globose-conduit nonhomogeneous nonuniform nonsteady modes of energy mass, cross-section areas, perimeter centroids align for highest mass energy conserving,
13. generic PAP, PPLD, PP lengths sum, conforming embodiments, evolve or devolve globose-conduit forms into round or entirely round conduit cross-sections and or globose spherical or spherical retained mass forms that rotate, mutate, transpose, transfer, make unique origin universe highest conserving mass energy phases, Sets, and domains,
14. globose open channel basin-outlet spouts manipulate, adeptly amalgamate mass energy modes one-directional linear or circumferential globose or circumferential cross-section areas of retention, detention that otherwise requires three-elbows assembly,
globose, circumferential are highest self-preserving mass energy two strains of forms; a one-directional less than 180 degrees alignment is one within cosmos' gravity fields,
15. self-conserved energy process among naturally evolved or man made forms constitute classic chains with globose-conduits as natural, quintessential dominant links,
16. fluid mass forms of energy, composition, and physical properties highest self-conservation globose-conduit forms evolve into classical round forms and vice versa,
17. a transport of high specific gravity mass heaviest mass classic globose-conduit detention PP lengths least sum height mass energy absolutely dilutes, tears up, disintegrates, moves or transports which conserves useful energy modes mass energy, a fluid mass air is controlled into out of open channel forms as an enclosed boundary,
18. basin-outlets least Set includes Inlet forms inside, a conforming retention, a globose-conduit transported detention, and an Inlet fluid mass outside of its basin-outlet,
a. conserving mass energy inside enclosing boundaries; mass energy modes stated inventions, principles, and methodologies requires respective boundary of physical, nuclear molecular, living cells chemical mass energy modes forms,
b. contained modes mass energy forms require at least one enclosing boundary,
c. globose-conduit open channel forms transport of fluids and solid particles of nonhomogeneous mass energy is comparable to round pipes, electrical wires transport of homogeneous mass, energy, and atomic subatomic round forms retained mass, energy;
d. paths-of-passage lengths least sum amalgamates nonhomogeneous, nonsteady, nonuniform, mass-energy units viscosity, adhesion, cohesion and fluid structure interface perimeter boundary layer adhesion, friction into highest mass energy conserving forms,
e. classic globose-conduit genome forms constitute classic perimeter form Sets; globose-conduit principles, methodologies are homogeneous mass applicable; partial suctions of globose-conduit smaller than ubiquitous permanent retention is safest quickest recovery of upper retention of highly conserved fluid mass and energy,
f. a rise in globose-conduit, basin-outlet PPLD band in tandem with narrower lower conduit cross-sections breadths is completely complimented by transitions regions least height wide globose breadths forms having essential height or greater elevations,
g. mechanics of forms contain modes energy highest sum at highest elevations,
h. a retained fluid mass defines a lower retention, an upper retention and a detention form; an upper retention at rest makes a free surface; a detention makes a free surface that is higher than said free surface at rest,
i. globose-conduit said fluid mass energy least sum PP lengths are one forms for highest statistical-probability of nonhomogeneous, nonsteady, nonuniform, retention detention least PAP angle, quanta mass least rotations, FESD forms PP lengths least sum classic perimeter forms that contain, retain, detain, and transport fluid mass energy of globose-conduits, which themselves constitute FESD forms;
domains of globose-conduit universe FESD forms with said PP lengths least sum surfaces restrict rotations of mass in three orthogonal planes especially prominent among named makeup Troughs, Ridges, Partitions, globose End 2, globose-inverse First End forms and undersurfaces, doming Cavities, Bridging-Wall, Fin and DCSS FESD forms; troughs raise globose forms sides lowest surfaces wherein Ridge, Partition FESD forms raised PPLD lowest surfaces into two PPLD higher elevation forms; troughs, Ridges and Partitions are globose conduit forms integral parts concepts that raise heaviest fluid mass centroid twice, once as a part of globose-conduit forms lowest surface highest elevation raised with a presence of such forms makes least fluid mass least height narrower breadth two cross-sectional areas to thus again raise nonhomogeneous heavier mass centroid; a narrower PPLD form initiates earlier lowest surfaces rise with narrower breadths constituting lowest, lower surfaces faster rise by said FESD forms;
figures of globose upright, angled to about upright, angled, industrial, low angled, Inline, inverse and hybrid forms claim globose-conduit universe of Sets, forms, hybrids, migrations, mutations, entire G-C universe domains, genomes, along with classic forms classic perimeter Sets inventions, methodology, and principles, and concepts disclosed;
energy and fluids mass finest elements algorithm computed PP lengths least sum perimeter boundaries constitute science academia infinitesimally exact fluid mass energy perimeters; plugs, Caps Portals, and nozzles are replaceable by continued streamlined surfaces; nozzles especially high inside an Inlet is tolerable as fluid free surfaces at this elevation is at or above said detained fluid mass essential elevation; sidelong Sets make for one-directional PP lengths sum; a sidelong offset to an anti sidelong, a near upright Inlet is respectively closer to respective DCSS forms, PP forms and PAP aligned save mass-energy, Trough, Ridge, Trough-Ridge, Partition, or Trough-Ridge-Partition FESD removes and or manipulates excessive mass-energy PP bundles, FESD forms conserve fluid mass-energy by a reduction of mass or mass rotations or both;
the first application specifies gravitational field forms that contain, retain, detain, and transport modes of mass energy; continuations, this application continues describing forms process to one that has mass and energy conservation laws, conforming conditions, to energy-modes transfers including boundary, perimeter, energy losses to define forms; no maximum or minimum boundary conditions restrict generic claims PP PAP, PPLD, conforming embodiments, other than universal laws of mass energy conservation which allows for various conditions of various conforming boundaries to define modes of mass energy phases conserving conforming embodiment forms, Sets, and domains; the first application first paragraph embodies piping universe without an exception; unrestricted mass modes of said piping universe and globose-conduit forms are one space universe; globose-conduit perimeter forms are imposed boundary conditions for a quantified mass energy highest self-conservation self-preservation graphical visual illustration of useful, contained, quintessential, mass energy phases' perimeter; continuation applications revise restrict, by said generic claims boundary conditions, perimeters of the first paragraph of the first application to quantum mass PP lengths least sum computed mass energy highest conserving perimeters;
by imposing ecosystem universally most friendly boundary requirements, entirely releases, removes artificial, unnatural boundary conditions quantum mass PP quanta mass constitute entire universe, cosmos contained, retained, detained or transported phases of mass energy bodies with gravitational energy or force; omnipotent potent contained one-mass energy forms constitute globose spherical, spherical perimeters gravitational field of same forms with intellectual boundary surface visualization enclosing gravitational force field energy; orbiting mass energy modes phases detained by its omnipotent gravitational energy mass constitutes potential conduit forms; analogous parallelism on atomic scale is nuclei mass energy spherical forms contained mass energy with orbiting electrons that constitute a perimeter form that allow inflow outflow of other electrons as an omnipotent atoms mass energy respective detention;
mass energy inflows, outflows on microscopic, submicroscopic scale constitute an inlet, an outlet with a single cell, or a most primitive organism globose or cylindroid detention forms with cell membranes boundary as conforming conditions perimeters; partitioned mass energy conservations subdivide into globose-conduit cells; accepted omnipresent parallelisms among mass modes of energy forms by universal mass and energy conservation laws herein extend to nonhomogeneous, nonuniform, nonsteady mass energy respective phases of mass energy perimeter forms;
globose-conduit classic forms contain detain and transport nonhomogeneous fluid comparable to subatomic, atomic; microscopic, submicroscopic; high pressure water pipe or electric wire classic forms, perimeters contained, detained, and delivered mass energy;
straight lines constitute mass energy highest conserving path between two points; a straight-line path away from a rotating mass traces a circumferential path in respect to its starting point; a linear, a circumferential PAP constitutes two most conserving mass energy paths of quintessential, core, or natural disposition, each with perimeter boundary respective conforming conditions; a linear or a circumferential PAP of equal boundary conditions PP lengths least sum with equal quantum mass equal energy have an equal core, quintessential, perimeter form and vice versa, wherein least or equal is not exact; globose-conduit and globose-circumferential universe domains of Sets PAP angle paths constitute a finite linear increment in upright plane with counterpart orthogonal upright plane containing a quintessential core image of highest preserving mass energy natural disposition perimeter; said image at best is statistical approximations derived with its exact form that is perfection beyond human skill ability to compute or construct;
a PPLD form defines a conduit perimeter for containment of mass energy modes or mass energy perimeter dissipates into ecosystem, universe mass energy natural disposition boundary perimeter forms;
as with other modes of energy, globose-conduit perimeter forms universe extends from microbes' submicroscopic, atomic subatomic to a cosmos makeup or vice versa; as most self-conserving mass energy modes exchanges quintessential, core, natural disposition form, globose-conduit forms classic perimeters alongside spherical globose form constitute parallelism analogy to homogeneous mass energy round conductors; as created suitable boundary conditions allow, quintessential, core, natural disposition of mass energy self-conserving, preserving will result in globose-conduit perimeter forms; unless globose-conduit boundary perimeter condition laminar mass perimeter is maintained a globose-conduit highest conserving mass energy quintessential, core, or natural disposition perimeter readily dissipates;
globose-conduit Sets make spouts lower surfaces contained fluid mass-energy one-transformation half-mode cycle, kinetic to potential energy highest conservation and PPLD FESD least height and length forms much shorter than are those of ubiquitous art;
a Nozzle FESD form may constitute a part of its End 2 undersurface form;
spherical globose highest energy modes genome classic forms retain mass units constituting computed least resistance paths, said paths-of-passage, PP, lengths least sum;
Inlet inflows provide fluid mass potential, kinetic energy modes with PP energy;
a PPLD width midpoint, said undersurfaces one point align tangentially for a Set of forms having a PAP direction horizontal orientation, PAP upright plane symmetry, and a basin-outlet rotation through a PAP angle in respect to the gravitational direction;
energy transfers cycle contained potential and kinetic mass-energy modes; forms of PPLD least height and length constitute PP least demand for transfer of energy-modes;
potential to kinetic mode quantum mass transfers constitute units of mass PP three components length; upright quantum mass-energy units contain the gravity acceleration multiple for computing quantum mass kinetic energy quanta sum that is PP lengths sum;
a fluid mass volume form with a center of mass located at a higher elevation or closer to a DCSS form constitutes conserved conforming mass energy conforming PP lengths lower sum;
globose-conduits correlate nonhomogeneous, nonsteady, nonuniform high mass energy conserving to elevations breadth specific deviations from lower to upper springing points breach;
an upper retention quanta mass conforming retention constitutes retained fluids surface-tension, adhesion height higher than a globose End 2, a globose-inverse First End undersurface, horizontal, radial, infinitesimal width highest finite increment continually entirely submerged;
a lower retention constitutes a region basin-outlet conduit spouts cross-sections forms gradual increase from PPLD width of band forms to said globose End 2, a globose-inverse First End undersurface, horizontal, radial, infinitesimal width highest increment;
a globose-conduit lower retention, smaller, short mass volume unified with a detention, an upper retention, dominant mass volume, least height hydrostatic pressures conserves energy;
basin-outlets, DCSS, PPLD widths of band, and drain lines smaller lower areas of rounded surfaces and narrower breaths than equivalent round areas breadths at a same rise from respective inverts constitutes FESD forms; round or rounded cross-sections length segment constituting said PP lengths least sum constitutes an FESD form part;
an outlet FESD rounded cross-section, DCSS sub-outlets First Sub-outlet height constitutes a fluid elevation height that clears fluid mixture largest submerged particle;
a retained fluid mass free surface elevation differences vary with inflows and are enhanced or controlled by composite forms cross-sections of a DCSS or an outlet FESD, and various Sets FESD forms respective areas breadths, breaches, and heights;
globose forms large lengths and breadths free surfaces areas minimize its rise; outlet and DCSS FESD cross-sections continue lower area conduit forms through a First Sub-outlet height into larger Second Sub-outlet cross-sections which also resists fluid free surface further rise conserving energy by transfer of energy-modes at a lower height;
said PP lengths computed least sum is for statistically compiled particles ranges, volume specific gravity, and shape sizes of mass mixture;
said Sets PPLD form retention volume “at-rest” is half as tall, of shorter length, and has a smaller to several folds smaller retained fluid volume than ubiquitous art forms;
conforming embodiments, PAP, PP, PPLD least quantum mass PP lengths least sum mass energy enclosure constitutes interface surfaces least resistance PP, forms;
inlet inflows provide nonhomogeneous, nonuniform, nonsteady contained retained, detained, transported fluid mass potential kinetic energy-modes;
quantum mass complete complement computed PP(s) are least resistance forms Set;
genome Sets PP lengths least sum makes conforming retention mass least height;
globose conduit, globose-conduit, basin-outlet, G-C, cross-sections are made up of a lower smaller area rounded conduit form, a transition region intermediate area form, and an upper area rounded globose form for a compact composite curvilinear form;
a globose-conduit globose area height can vary from about 5% to 95% of entire cross-section height with its globose form area breadth varied up to three times a breadth of a vented pipe to which its conduit outlet descending spout connects;
a least mass half-cycle energy mode change conserves energy and fluid mass;
a conforming least mass energy modes PP lengths least sum change is a Sets genome;
Sets may constitute genomes for specific fluid mixtures, only;
forms of PPLD band make for PP lengths least sum, conforming retention least mass, least height side-view “5”, “C”, or “S” and “C” forms, a PAP direction and a least angle, smooth fluid surface interface forms, from basin lowest PPLD forms ending with a DCSS form; a PAP makes an angle less than 180 degrees in respect to gravitational direction, entirely aligns Set forms upright plane symmetric from a basin blind side through at least a DCSS, and upwardly entirely to at least include a globose form springing points;
a summit is a DCSS lowest infinitesimal width finite horizontal increment, outlet ascending spouts and PPLD forms highest infinitesimal end furthest from its respective Inlet, and a fluid tension and adhesion height higher than an upper retention free surface “at-rest” elevations retaining conforming continual least fluid mass, volume, and height;
globose-conduit paths-of-passage-of-least-energy-demand, PPLD, and PAP rotational angles less than 180 degrees that constitute least height basin-outlet PPLD for ascending lowest surfaces highest slopes smaller angles, inherently smaller angles shorter smaller slopes for a shorter entire length, with a smallest conforming retention fluid mass;
globose-conduit forms constitute domains of generic and circumferential strain hybrids of horizontal and upright orthogonal planes rotated globose genus form; generic circumferential globose hybrid domains are claimed as forms of globose domains;
migrations of globose Inlets End 2, globose-inverse outlets First End from basin-outlets blind side to an anti-sidelong location on opposite end of basin-outlet retention forms constitutes Sidelong, Sidelong Offset, Offset Centric, Centric, Anti Offset Centric, Anti Sidelong Offset, and Anti Sidelong Sets;
illustrating and describing a domain Set, entire domain Sets, its hybrids and Sets migrations within entire G-C universe range constituted Sets genomes is claimed together with Sets inventions, principles, methodologies, and concepts for retained fluids mass and energy conserving by globose conduit forms Sets and their circumferential hybrids;
basin-outlets basin upper retention constitutes largely one of five: truncated about largest cross-sections of globose, spheroidal, ellipsoidal, cylinder, or cylindroid forms of a short height that is shorter than a largest horizontal dimension of a respective basin;
globose basin lowest surfaces make largely one of following large forms: a rounded, an annular, a crescent, an about flat to doming annular, and an annular crescent, among many PPLD FESD geometrics forms of single or various streamlined compositions of least surfaces forms;
Inlet, basin-outlet retention forms with PAP upright plane of symmetry horizontal plane rotated about an upright axis, especially its Inlet axis, staying upright constitutes an upright Inlet Set; no perceived deviations from sciences upright make engineered upright Inlets and Sets, here;
a basin-outlet conduit outlet spout ascends from a globose Set First End surface inflection, an outlet basin end cross-section, or a globose-inverse submerged spout form lower end inside a basin-Inlet retention of respective globose, globose-inverse forms;
basin-outlets outlet spout cross-sections are made up largely by one of following FESD forms: a rounded, an elliptical, or a curvilinear geometrics composite areas form;
outlets, DCSS, and Sub-outlets FESD forms constitute PAP upright plane aligned symmetric a lower, smaller, rounded conduit form, a transition region cross-sections, and an upper largest area largely a rounded, an elliptical, a parabolic or a curvilinear form;
globose-conduits correlate nonhomogeneous, nonsteady, nonuniform mass energy conserving to an elevation specific breadth deviations from lower and upper springing points breach for conforming retention fluid mass least height and rotations large free surface form;
flow-energy-surface-dispensatory, FESD, PAP upright plane symmetric globose-conduit quanta mass, cross-sections, areas, shapes, heights, breaches, or entire breadths as G-C forms transform globose to conduit forms and vice versa; they make up conforming quanta mass least volume, rotations, perimeters, and PP lengths sum that constitute versions of following forms:
a three-dimensional Set (TD), circumferential, axial or transverse Trough, Ridge, an Inlet upright Ridge a Trough, a Trough in a Trough, a Ridge, a Partition with/without a Window(s), a Troughs-Ridge, a Troughs-Ridge-Partition and a Window(s);
a Disk FESD;
a baffle Partition FESD and a Window FESD;
a Circumferential Trough, a Ridge, a Partition, a three-dimensional Window and a Troughs-Ridge and a Troughs-Ridge-Partition and a three-dimensional Window(s);
a Nozzle local highly directional spout forms;
a globose End 2, globose-inverse First End and PPLD counterpart forms of a Set;
a Bridging-Wall with Domed-Cavities about Inlet forms;
a Fin FESD forms dividing globose-conduit cross-sections upper retention;
a Trough, a Ridge, an upright Ridge, a Partition with/without a Window(s), a Trough inside a Trough, a Troughs-Ridge, a Troughs-Ridge, a Troughs-Ridge-Partition with/without Window(s) upright plane axially symmetric forms;
an FESD manager enhanced control of fluid free surfaces height differences;
an FESD space manager exchange of air and fluid manages retention form free surface areas and elevations, thus cross-sections areas, height, breadth, breach and length;
cavities; dome Cavities FESD;
a rounded End 2, First End; a flared; an infant boot; a Fin End 2 FESD form;
a Migration Dimension(s) 44, (44, 44′);
a crescent PPLD conical form FESD;
outlets, DCSS and globose-conduit cross-sections areas breadth, breach, and height FESD forms managed effects of retained fluid free surface elevations, elevation differences, as counterparts of FESD mangers' and FESD space managers' forms;
flush Apparatus parts, entirely contained within walls of a Set with access to most Set locations, separately or concurrently to disinfect, flush, surface coat, repair or protect damaged surfaces; flush Apparatus prefabricated pre-assemblies use design fluids and or gases, or air, jointly individually or, to a separate sequence and intervals or concurrently, to a surface location or a Set entire with a single, a set, or a nozzles network, with tie-ins, or sets of tie-ins located conveniently about a Set; said Flush Apparatus assemblies are entirely inside conduit walls, except for tie-ins, and capable flushing any basin or Inlet retention space or location, such as, Inlet surfaces and or basin-outlet lowest surface PPLD width of band lengths or an entire length; shown capped a tie-in or at least one of shown tie-ins connects to a tie-in apparatus that may include line sensing device to initiate or stop a design fluid injection should basin retention drop to preset pressures; said Flush Apparatus deliver predetermined fluid, or gas, or air separately or jointly is delivered under controlled pressure to tie-in or tie-ins is discharged through any of sub-nozzles, 301, sub-passageways, 303, major nozzles, 405, major passageways, 304, and passageways, 310, respective branches set of tie-ins, 307, a set of sub-passageways branches, 311, a set of sub nozzles, 314, selectively pre-assembled; specific shape passageways such as upright Ridges FESD, FIGS. 8, 12, 16, and, 85-89 depict, a double wall inner space, 310, passageway FIG. 81 shown. A major nozzle 405 spray type flushes entire basin lower, lowest surface and into an outlet and lower Inlet;
a double wall inner space and gravitational direction compliant tubing show and warn expeditiously by dripping leak evidence that a wall leak has occurred;
said Sets exact globose-conduit construction is beyond human creative skills;
a descending outlet spout Second End connects to a vented drainage line with a positive rigid connection, which is one of two connections that support a Set;
connections are generally shown threaded or welded; compression couplings and flexible installed in place rigid with or without gaskets, washers, or bushings, and locked or double treaded or said connections suitable mix constitutes globose Set connections;
a top quality highest accuracy highest pressure moldings of plastics, metals, and their composites and or semi-rigid materials that are adequately rigid or are with positive provisions for sufficient stiffness or a fabrication combination of above makes said Sets;
one-way air nozzles are suction precluding measures; forms constitute smallest mass and height known to stop suction and or venting; forms are to crafts finite or scientific infinitesimal accuracy algorithm computed as needed;
fluids and solids particles of non-homogenous mixtures inflow through an End 1 into globose Set forms and by gravity force outflow through an outlet Exhaust;
inventions not restricted only to highest conservation of fluid mass or energy genomes disclosed narrow highly defined scope of fluid mass, and energy conservation of said inventions, which unify fields of arts and sciences;
this and continuation applications continue the first application specification, drawings scope is narrowed to fluid mass energy conservation by defined globose retention genus forms to the first application FIG. 9 “laminar flow” and its stated description and specification “flow control means” herein FESD forms; globose-conduit Sets originate with the first application open channel Set of FIGS. 1-2, and 12; globose-conduit forms shown short height, in respect to length, especially short for the first application shown FIGS. 1-2 and 12 Set, connect to building code vented pipe constituting open channel construction, its elliptical outlet descending form spout and channels about basin originates outlet FESD and DCSS FESD forms Figures herein show; the first application FIG. 1-2, 9, 12 stated “transition region” “means” that maintains “the transition region submerged” herein and continuation application numerous Figures define as upper, herein permanent retention extended upwardly from lower conduit form springing points and not taken higher than globose form springing points;
said classic retention genome, prior applications FIG. 1, shows globose-conduit parent form that uniquely originates globose-conduit universe domains of Sets FIG. 1 Set basin-outlet nonhomogeneous, nonuniform, nonsteady fluid mass forms modifies; a Set retains, contains, detains, and transports fluid mass that subdivides into finite units of mass having said PP lengths least sum; units of mass, PP length least sum algorithm, mathematically computes kinetic energy required for each mass unit to pass; a PP least sum constitutes quanta mass quantum mass paths respective path lengths sum with upright components having the gravity acceleration multiple; figures of this application are the second application drawings; said Figures show open channel forms and are continuation from the first application Figures, especially said FIGS. 1-2, 9, and 12; basin-outlet continuations of FIGS. 1-2, and 12 shown major axis upright elliptical outlet and DCSS FESD forms and a Trough, a Partition, and a Trough, a Ridge, a Partition of FIG. 12 and FIG. 9 showed upright Ridges, nozzles and diffuser FESD forms; said FIG. 12 shows basin-outlet, globose-conduit forms with capped tubing about basin blind side through upper basin-outlet casing; enlarged, streamlined, said tubing constitutes a Bridging-Wall FESD which with globose basin-outlet makes for domed Cavities FESD forms about Inlet; capped at a specific detained fluid free surface elevation said tubing constitutes a space manager, SM, in respect to retained fluid free surface elevations; said SM not capped but connected to a one-way air inflow having basin-outlet perforations constitutes SM that precludes suction;
much larger cross-sections than those of a vented pipes a FIG. 12 Set basin-outlet spout constitutes and thus will not experience suction; a Flush Apparatus connected to SM outside air inflows is both, a Flush Apparatus and SM, and said perforations extended through walls of said Set constitute numerous Flush Apparatus assembles parts said continuation applications and herein Figures show; globose-conduit computed classic cross-section areas, perimeter, surfaces interface boundary forces, and centroid locations for least or no rotations about fluid mass centroid constitute said “flow control” mass and energy highest conservation;
said classic perimeter PP mass laminar fluid finite segments constitutes viscosity, adhesion, fluid pressure internal and boundary layer related forces with no rotation of fluid mass which is identical for homogeneous mass-energy; classic perimeter globose-conduit nonhomogeneous mass energy forms with parallelism travel across arts, science fields analogous to classic, homogeneous, mass energy round forms; classic perimeters mass no rotations or boundary friction constitutes translational energy mode ultimately conserved mass energy;
ascending globose-outlet spout Sub-outlets make either a rounded, or an elliptical major axis upright, or a curvilinear cross-section area form that passes statistically most prevailing continual detention mass with detention free surface at said essential elevation height that also passes said largest sphere as single most unusual event; globose-conduit classic forms constitute classic conduit forms that evolve or devolve from classic globose retention basin forms that also evolve or devolve into rounded, or curvilinear, or elliptical major axis upright forms; the first application FIG. 1-2, and especially FIG. 12 cylindrical basin-outlet globose form upright cross-sections behind and in front of its Inlet toward outlet, which transferred into elliptical major axis upright forms transposed into a round Exhaust cross-section are an open channel globose-conduit cylindrical versions the generic claims, the continuation applications and herein continues;
said generic claims mass energy self-conserving self-preservations allow computing of accelerated aging whose energy modes among depicted Figures or as described constitute scope of inventions, methodologies and principles of globose-conduit forms; classic globose-conduit spout rounded basic PP lengths least sum forms surfaces, a life span aged or specific events form make up globose-conduit universe respective forms, Sets, Sets' hybrids, mutations and domains;
FIG. 16-18 shown Inline domain Sets primarily make up globose-inverse domain forms that with described mutations, and partitioned into multiple-cells, transfer into globose domain Sets; here, FIG. 2, 3, Section A-A forms shown ascending outlet spout rotated to 165 degrees PAP angle with a DCSS, descending upright spout as in FIG. 18 transposes a globose-conduit Sidelong Set to one cell of said Partitioned Inline Set which reassembled into a globose-inverse Set constitutes depicted Inline forms, said Angled domains described forms rotations constitute deviations rotated Sets from upright forms Sets mass energy conforming to the generic claims;
classic globose-conduit, FESD complete complement constitutes least cross-sections, breadths, fluid mass, mass rotations, surface lengths, and energy modes entire energy transfer;
hydrostatic pressure centroids of basin-outlet nonhomogeneous, gravity segregated, transported fluid mass is more than ⅔ of a hydrostatic height below retained fluid free surface elevations;
classic globose-conduit open channel forms complete complement conforming retention has least depth of PPLD forms quantum mass PP lengths least sum highest elevations fluid free surfaces large breadths and thus least PAP angle fluid mass rotations and hydrostatic pressures;
generic claims classic Sets, conduit Inlets basin-outlets open channel with conduit, outlet spouts narrow breadths conforming detained least height mass precludes suction and or venting;
globose-conduit open channel classic forms complete complement conforming quantum mass has the generic claims a much shorter PP lengths sum than ubiquitous or known art forms;
outlet, DCSS FESD forms open channel hydrostatic pressure release is fluid mass path of least resistance first application FIG. 9 Page 13, Line 1 ‘laminar flow’ and Line 3 ‘flow control’;
nonhomogeneous fluids solids open channel genus classic perimeter mass energy forms highest conservation genome forms with mass units PP lengths least sum has specific gravity, highest elevations least height and rotations, breadths or breach, surface friction, FESD forms;
classic globose-conduit open channel forms for nonhomogeneous fluid mass PP lengths least sum computation, paths of least resistance, transform or transfer into highest energy, classic nonhomogeneous, natural disposition, least retained mass, hydrostatic pressures perimeter forms; globose-conduit forms transfers into known classic mass energy forms confirms they are of classic genus; conduit lowest surfaces rounded forms with PPLD horizontal width of band reflects upon nonhomogeneous high specific gravity fluid mass, sizes of largest solid particles, among other physical parameters; globose upper surface forms reflect upon nonhomogeneous transport fluids physical parameters and cross-sections area, cross-sections especially transition region breadths is nonhomogeneous retained mass least height form highest energy conserving;
elliptical horizontal major axis as fluid energy geometrics forms are subordinate to globose rounded conduit forms and except for curvilinear forms parts do not normally make up FESD forms except for preference by these very applicable specific exceptions:
a basin lowest surface part under a globose End 2, a globose-inverse First End;
a conduit form of highly homogeneous frictionless, no adhesion fluid surfaces;
a globose-conduit FESD curvilinear “crown” form that reduces forms height;
a part of curvilinear specifically applied outlet, DCSS, and Inlet FESD forms;
forgoing excludes entirely round forms that constitute parts or counterparts of PP lengths least sum FESD, and homogeneous, no cohesion, no cohesion fluid mass forms;
the first application FIG. 12 globose-conduit Set shown slanted circumferential channels inside basin discloses globose-conduit forms cross-sections behind and in front of its Inlet; also, shown are circumferential channels multiple passages, a trough, ridge, and partition FESD forms; said FIG. 12 outlet elliptical cross-sections near summit is nearly entire height of a basin upright cylindrical globose form that toward basin blind side widens then narrows with a globose upper part progressively shorter in height, with a First Sub-outlet short, less than a lower half of said elliptical cross-section height that are classic globose forms height large breadths make up cross-sections areas numerous forms that can match or greatly exceed cross-sections area of aforesaid vented pipe; globose cross-section areas greater or greatly exceeding a vented pipe cross-section area are a part of globose-conduit universe Sets constituted basin-outlet numerous FESD forms;
flush Apparatus tie-in assemblies with check valves can act as a controlled air and or design fluid inflow into a Set to counter suction through said single or networks of nozzles or sense a low basin fluid level to start pumping air and or design fluid;
flush Apparatus design-fluids adept usage approximates near frictionless surfaces;
forgoing describes ways to avoid suction, tie-in apparatus to Flush Apparatus to control suction toward conservation of energy by one-way air inflows at fluid elevation and or pressure below free surface “at rest” elevation is to start various air, fluid, and spray especially when said level and pressure are low; said Flush Apparatus is shown with the first application separated branch inlet, 12′, tube, herein, it is considered support apparatus assembly for conservation of fluid mass and energy; a branch inlet enlarged to bridge a basin blind side, Inlet breach makes a Bridging Wall FESD, or specific location placed, orientated a manager, space manager FESD form continued from the first application;
flush Apparatus account for numerous varied functions with design fluids and gases including air with its capping removed said branch inlet constitutes a Flush Apparatus tie-in major passageway which can branch out inside walls of Sets for single or complex and advanced nozzle assemblies FIG. 29-31 among other Flush apparatus shown assemblies; said tube larger size with nozzles also constitutes bridging-wall FESD forms;
cross-sectional areas PP lengths least sum algorithm computed statistical probability that solids and fluids mixture and elevations retention free surface probability combine into a highest statistical probability constituting frequency of occurrence bound by standard deviations limits; actual conditions, Flush Apparatus penetrations do no effect primary functions of a Set.
